(19) United States
(12) Patent Application Publication
(10) Pub. No.: US 2026/0035210 A1
(43) Pub. Date: Feb. 5, 2026

(54) ELEVATOR AND DELIVERY SYSTEM

(71) Applicant: Panasonic Intellectual Property Corporation of America, Torrance, CA (US)

(72) Inventors: Mitsuaki OSHIMA, Kyoto (JP); Hideki AOYAMA, Osaka (JP); Yosuke SUMI, Gifu (JP)

(73) Assignee: Panasonic Intellectual Property Corporation of America, Torrance, CA (US)

(21) Appl. No.: 19/352,057

(22) Filed: Oct. 7, 2025

Related U.S. Application Data
(63) Continuation of application No. PCT/JP2024/014890, filed on Apr. 12, 2024.

(30) Foreign Application Priority Data
Apr. 12, 2023 (JP) 2023-065216
May 25, 2023 (JP) 2023-086473
Nov. 16, 2023 (JP) 2023-194872

(51) Int. Cl. B66B 9/187; B61B 13/06; B66B 11/02; B66B 13/30

(52) U.S. Cl. CPC B66B 9/187; B61B 13/06; B66B 11/0206; B66B 13/30

(57) ABSTRACT

An elevator includes: an elevator carriage that moves up and down; a partition that divides a space within the elevator carriage into a first elevator space for a person to board and a second elevator space for an unmanned transport vehicle to board; an elevator rail that includes a movable rail and is arranged in the second elevator space; and an actuator that moves the movable rail. The unmanned transport vehicle travels along the elevator rail, and the movable rail is switched between a first rail state and a second rail state by actuation of an actuator. In the first rail state, the first end of the movable rail is connected to the second end of the story rail, and in the second rail state, the first end is not connected to the second end.

### CROSS REFERENCE TO RELATED APPLICATIONS

This is a continuation application of PCT International Application No. PCT/JP2024/014890 filed on Apr. 12, 2024, designating the United States of America, which is based on and claims priority of Japanese Patent Application No. 2023-065216 filed on Apr. 12, 2023, Japanese Patent Application No. 2023-086473 filed on May 25, 2023, and Japanese Patent Application No. 2023-194872 filed on Nov. 16, 2023. The entire disclosures of the above-identified applications, including the specifications, drawings, and claims are incorporated herein by reference in their entirety.

### FIELD

The present disclosure relates to an elevator.

### BACKGROUND

Patent Literature (PTL) 1 proposes an elevator device including an elevator cage that is used by both automated guided vehicles and people.

### CITATION LIST

### Patent Literature

PTL 1: Japanese Unexamined Patent Application Publication No. 2019-144785

### SUMMARY

### Technical Problem

However, the elevator device disclosed in PTL 1 above can be improved upon.

In view of this, the present disclosure provides an elevator capable of improving upon the above related art.

### Solution to Problem

An elevator according to one aspect of the present disclosure is provided in a building, and includes: an elevator carriage that moves up and down; a partition that divides a space within the elevator carriage into a first space for a person to board and a second space for an unmanned transport vehicle to board; an elevator rail that includes a movable rail and is arranged in the second space; and an actuator that moves the movable rail. The unmanned transport vehicle travels along the elevator rail. The movable rail is switched between a first rail state and a second rail state by actuation of the actuator. In the first rail state, a first end of the movable rail is connected to a second end of a story rail provided on a predetermined story of the building. In the second rail state, the first end is not connected to the second end.

These general and specific aspects may be implemented using a system, a method, an integrated circuit, a computer program, or a computer-readable recording medium such as a CD-ROM, or any combination of systems, methods, integrated circuits, computer programs, and computer-readable recording media. The recording medium may be a non-transitory recording medium.

### Advantageous Effects

The elevator according to the present disclosure is capable of improving upon the related art.

Further advantages and effects of one aspect of the present disclosure will become apparent from the specification and drawings. Such advantages and/or effects are included in each of the several embodiments and configurations described in the specification and drawings, but not all configurations need to be provided in order to obtain such advantages and effects.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an example of a configuration of an office building delivery system according to Embodiment 1.

FIG. 2 is another diagram illustrating an example of a configuration of an office building delivery system according to Embodiment 1.

FIG. 3A illustrates an example of a state of an elevator according to Embodiment 1.

FIG. 3B illustrates another state of an elevator according to Embodiment 1.

FIG. 4 illustrates an example of a configuration of an apartment delivery system according to Embodiment 1.

FIG. 5A illustrates an example of a state of an elevator according to Embodiment 1.

FIG. 5B illustrates another state of an elevator according to Embodiment 1.

FIG. 6 illustrates an example of a configuration of a logistics system according to Variation 1 of Embodiment 1.

FIG. 7 illustrates another example of a configuration of a logistics system according to Variation 1 of Embodiment 1.

FIG. 8 illustrates an example of a configuration of an office building delivery system according to Variation 2 of Embodiment 1.

FIG. 9 illustrates an example of a configuration of an apartment delivery system according to Variation 2 of Embodiment 1.

FIG. 10 illustrates an example of an elevator according to Variation 3 of Embodiment 1.

FIG. 11 is a perspective view illustrating an example of a package transport device according to Embodiment 2.

FIG. 12A illustrates the internal structure of a first connector and a second connector of the package transport device according to Embodiment 2.

FIG. 12B illustrates the internal structure of a third connector of the package transport device according to Embodiment 2.

FIG. 13A illustrates an example of the internal structure of a turntable of the package transport device according to Embodiment 2.

FIG. 13B is a side view illustrating an example of a slide rail of the package transport device according to Embodiment 2.

FIG. 13C is a front view illustrating an example of a slide rail of the package transport device according to Embodiment 2.

FIG. 13D is a front view illustrating an example of the left side components, a ball screw, and a guide of the slide rail of the package transport device according to Embodiment 2.

FIG. 13E is a front view illustrating an example of the right side components, a ball screw, and a guide of the slider of the package transport device according to Embodiment 2.

FIG. 14 is a perspective view illustrating an example of a package transport device according to a variation of Embodiment 2.

FIG. 15A is a perspective view illustrating an example of a rail and a rail coupling according to Embodiment 3.

FIG. 15B is another perspective view illustrating an example of the rail and rail coupling according to Embodiment 3.

FIG. 16 is a perspective view illustrating a first coupling point of a first rail and a second coupling point of a second rail according to Embodiment 3.

FIG. 17 is a top view and a side view illustrating an operation of a package transport device according to Embodiment 4.

FIG. 18A is a top view and a side view illustrating an operation in which the package transport device according to Embodiment 4 turns left at the intersection of the first rail and the second rail.

FIG. 18B is a top view and a side view illustrating an operation in which the package transport device according to Embodiment 4 turns right at the intersection of the first rail and the second rail.

FIG. 19 illustrates an example of a configuration of a logistics system according to Embodiment 5.

FIG. 20 illustrates an example of an elevator of an apartment delivery system according to Embodiment 6.

FIG. 21 illustrates an example of an elevator of an office building delivery system according to Embodiment 6.

FIG. 22 illustrates an example of a configuration of an office building delivery system according to Embodiment 7.

FIG. 23 illustrates an example of an operation in which the unmanned transport vehicle according to Embodiment 7 transfers from one pair of rails to another pair of rails.

FIG. 24 illustrates an example in which the unmanned transport vehicle according to Embodiment 7 is applied to an elevator.

FIG. 25 illustrates an example of a configuration of a logistics system according to Embodiment 7.

FIG. 26 illustrates an example of the size of an unmanned transport vehicle according to Embodiment 7.

FIG. 27 illustrates an example of a configuration for changing the orientation of an unmanned transport vehicle according to Embodiment 7.

FIG. 28A illustrates an example of an operation for changing the orientation of an unmanned transport vehicle according to Embodiment 7.

FIG. 28B illustrates another example of an operation for changing the orientation of an unmanned transport vehicle according to Embodiment 7.

FIG. 29A illustrates an example of a detailed configuration of an unmanned transport vehicle according to Embodiment 7.

FIG. 29B illustrates another example of a detailed configuration of an unmanned transport vehicle according to Embodiment 7.

FIG. 30A is a diagram for explaining an example of an operation in which an unmanned transport vehicle according to Embodiment 7 changes rails.

FIG. 30B is a diagram for explaining an example of an operation in which an unmanned transport vehicle according to Embodiment 7 changes rails.

FIG. 30C is a diagram for explaining an example of an operation in which an unmanned transport vehicle according to Embodiment 7 changes rails.

FIG. 30D is a diagram for explaining an example of an operation in which an unmanned transport vehicle according to Embodiment 7 changes rails.

FIG. 30E is a diagram for explaining an example of an operation in which an unmanned transport vehicle according to Embodiment 7 changes rails.

FIG. 31 illustrates an example of an unmanned transport vehicle entering a building from outside according to Embodiment 7.

FIG. 32 illustrates another example of an unmanned transport vehicle according to Embodiment 7 entering a building from outside.

FIG. 33 illustrates another example of an unmanned transport vehicle according to Embodiment 7 entering a building from outside.

FIG. 34 illustrates another example of an unmanned transport vehicle according to Embodiment 7 entering a building from outside.

FIG. 35 illustrates another example of an unmanned transport vehicle according to Embodiment 7 entering a building from outside.

FIG. 36 illustrates another example of an unmanned transport vehicle according to Embodiment 7.

FIG. 37 illustrates an example of a structure including a rail according to Embodiment 7.

FIG. 38 illustrates an example of a schematic configuration of an unmanned transport vehicle, a structure, and a logistics system according to each embodiment.

FIG. 39A illustrates an example in which an unmanned transport vehicle according to Embodiment 8 is applied to an elevator.

FIG. 39B illustrates connection between a pair of movable rails and a pair of story rails.

FIG. 39C illustrates another example in which an unmanned transport vehicle is applied to an elevator.

FIG. 40 illustrates an example of a configuration of an office building delivery system according to Embodiment 8.

FIG. 41 illustrates an example of a configuration of a logistics system according to Embodiment 8.

FIG. 42 illustrates a groove structure of a rail in Embodiment 8.

FIG. 43 is a block diagram illustrating an example of an unmanned transport vehicle according to Embodiment 8.

FIG. 44 illustrates an example of a first arm and a second arm of an unmanned transport vehicle according to Embodiment 8 traveling on rails in a second arm state.

FIG. 45A illustrates an example of a first arm and a second arm of an unmanned transport vehicle according to Embodiment 8 traveling on elevated rail in a first arm state.

FIG. 45B illustrates an example of a first arm and a second arm of an unmanned transport vehicle according to Embodiment 8 traveling on elevated rail in a third arm state.

FIG. 46 illustrates an example of an office building delivery system applied to an office building.

FIG. 47 illustrates an example of an elevator of an office building delivery system on a story of an office building.

FIG. 48 illustrates an example of applying an office building delivery system to an office building with a story height of 4.5 m.

FIG. 49 illustrates an example of an office building delivery system in which a first carriage door and a first landing door, and a second landing door and a second carriage door through which an unmanned transport vehicle passes are arranged.

FIG. 50 illustrates an example of an office building delivery system applied to an office building.

FIG. 51 illustrates an example of an office building delivery system on the top story of an office building.

FIG. 52 is another diagram illustrating an example of an office building delivery system.

FIG. 53 illustrates an example of an elevator including a second elevator space and a fourth elevator space in an office building delivery system.

FIG. 54 illustrates an example of an elevator including a fourth elevator space in an office building delivery system.

FIG. 55 illustrates an example of a first elevator space of an elevator and a first story space of an office building in an office building delivery system viewed from above.

FIG. 56 illustrates an example of a second elevator space of an elevator and a fourth story space of an office building in an office building delivery system viewed from above.

FIG. 57 illustrates an example of an office building delivery system including a duct in which unmanned transport vehicles can travel.

FIG. 58 illustrates an example of an office building delivery system including a duct in which an unmanned transport vehicle can travel and a beam through which the duct passes.

FIG. 59 illustrates an example of an office building delivery system including a duct applied to an office building.

FIG. 60 illustrates a flowchart illustrating a case in which a duct is installed in an office building.

FIG. 61 illustrates an example of a configuration of an office building delivery system according to Embodiment 8.

FIG. 62 illustrates an example of another configuration of an office building delivery system according to Embodiment 8.

FIG. 63 illustrates another example of a configuration of an office building delivery system according to Embodiment 8.

FIG. 64A illustrates yet another example of a configuration of an office building delivery system according to Embodiment 8.

FIG. 64B illustrates unmanned transport vehicles that have moved to second story rails delivering packages to a second story space.

FIG. 64C illustrates another example of unmanned transport vehicles that have moved to second story rails delivering packages to a second story space.

FIG. 64D illustrates yet another example of unmanned transport vehicles that have moved to second story rails delivering packages to a second story space.

FIG. 64E illustrates yet another example of unmanned transport vehicles that have moved to second story rails delivering packages to a second story space.

FIG. 64F illustrates a plurality of unmanned transport vehicles boarding and alighting from an elevator carriage.

FIG. 65 illustrates an example of a configuration of logistics system Sy4 according to Embodiment 8.

FIG. 66A illustrates an example of an elevator carriage according to Embodiment 8.

FIG. 66B illustrates an example of another elevator carriage according to Embodiment 8.

FIG. 66C illustrates an example of yet another elevator carriage according to Embodiment 8.

FIG. 66D illustrates an example of another elevator carriage according to Embodiment 8.

FIG. 66E illustrates an example of another elevator carriage according to Embodiment 8.

FIG. 67 illustrates an unmanned transport vehicle system.

FIG. 68A illustrates an example of unmanned transport vehicles boarded in an elevator carriage that moves up and down.

FIG. 68B illustrates another example of unmanned transport vehicles riding in an elevator carriage that moves up and down.

FIG. 69A illustrates an example of unmanned transport vehicles boarded in an elevator carriage being rearranged.

FIG. 69B illustrates another example of unmanned transport vehicles being rearranged in an elevator carriage.

FIG. 70 is a diagram illustrating an elevator system.

FIG. 71 illustrates an elevator system with a plurality of unmanned transport vehicles boarded in an elevator carriage.

FIG. 72 illustrates an elevator system with a plurality of unmanned transport vehicles boarded in an elevator carriage.

FIG. 73 illustrates unmanned transport vehicles that have alighted from an elevator carriage bypassing an elevator lobby.

FIG. 74 illustrates an elevator carriage and an unmanned transport vehicle riding in the elevator carriage.

FIG. 75 illustrates a system for adjusting the attitude of a package carriage.

FIG. 76A illustrates an elevator system for moving unmanned transport vehicle c located on a first tier lifting portion to a second tier lifting portion.

FIG. 76B illustrates another elevator system for moving an unmanned transport vehicle located on a first tier lifting portion to a second tier lifting portion.

FIG. 76C illustrates another elevator system including two lifting portions.

FIG. 76D illustrates another elevator system including a movable rail platform lifting device.

FIG. 76E illustrates another elevator system including a two-tier movable rail platform lifting device.

FIG. 76F illustrates yet another elevator system including a two-tier movable rail platform lifting device.

FIG. 76G illustrates an example of rearranging a plurality of unmanned transport vehicles boarded in an elevator carriage that moves up and down.

FIG. 76H illustrates an example of extending the wheels of an unmanned transport vehicle.

FIG. 76I illustrates unmanned transport vehicles according to rail width.

FIG. 76J illustrates a height-adjustable rail.

### DESCRIPTION OF EMBODIMENTS

An elevator according to a first aspect of the present disclosure is provided in a building, and includes: an elevator carriage that moves up and down; a partition that divides a space within the elevator carriage into a first space for a person to board and a second space for an unmanned transport vehicle to board; an elevator rail that includes a movable rail and is arranged in the second space; and an actuator that moves the movable rail. The unmanned transport vehicle travels along the elevator rail. The movable rail is switched between a first rail state and a second rail state by actuation of the actuator. In the first rail state, a first end of the movable rail is connected to a second end of a story rail provided on a predetermined story of the building. In the second rail state, the first end is not connected to the second end.

After the unmanned transport vehicle that travels along an elevator rail moves up and/or down with the elevator carriage and arrives at a predetermined story, in order for the unmanned transport vehicle to exit from the elevator carriage, it is necessary to connect the elevator rail with a story rail, which is a rail provided on that predetermined story for the unmanned transport vehicle to travel along. Here, if a movable rail and an actuator for driving the movable rail were to be installed for each of the story rails provided on each story, a quantity of movable rails and actuators corresponding to the number of stories in the building would be required, resulting in an increase in the number of parts related to the elevator, maintenance and inspection effort, and cost.

However, in the first aspect, the movable rail of the elevator rail is switched between a first rail state and a second rail state by actuation of the actuator, as described above. Stated differently, the configuration of the elevator rail and the operation of the actuator allow the elevator rail to be either coupled to or separated from the story rail.

Accordingly, in the first aspect, it is not necessary to prepare movable rails and actuators in a quantity corresponding to the number of stories in the building. As a result, it is possible to realize an elevator capable of simultaneously transporting people and an unmanned transport vehicle while preventing an increase in the number of parts and the like related to the elevator.

In a second aspect, the elevator may further include: a first carriage door that opens and closes an opening that is provided in the elevator carriage and leads to the first space; and a second carriage door that opens and closes an opening that is provided in the elevator carriage and leads to the second space. The second aspect depends from the first aspect.

This allows, for example, if the first carriage door and the second carriage door are configured separately, each of them to be opened and closed independently.

In a third aspect, the first carriage door and the second carriage door may be integrated as a single unit. The third aspect depends from the second aspect.

Since the first carriage door and the second carriage door are integrated as a single unit, this allows there to be no need to separately provide an actuator required for actuating the first carriage door and an actuator required for actuating the second carriage door. Accordingly, since the first carriage door and the second carriage door can be actuated by the same actuator, the number of parts of the elevator can be reduced.

In a fourth aspect, the second space may be positioned above the first space, and the elevator rail may be provided on a ceiling of the second space. The fourth aspect may depend from any one of the first to third aspects.

As a result, in buildings such as office buildings and apartments, story spaces where people are active can be made to correspond to the first space. Furthermore, in that building, a space that is a ceiling cavity area can be made to correspond to the second space. It is therefore possible to realize an elevator that allows both people and unmanned transport vehicles to smoothly enter and exit.

In a fifth aspect, the unmanned transport vehicle may include: a package carriage connected to a wire; and a winch capable of reeling out and reeling in the wire. The fifth aspect may depend from any one of the first to fourth aspects.

This allows, for example, the unmanned transport vehicle to lower the package carriage into the delivery box by reeling out the wire downward after the unmanned transport vehicle arrives above the delivery box located in the meter box of the corridor. This allows packages to be delivered or collected without lowering the unmanned transport vehicle itself into rooms or the like.

In a sixth aspect, the elevator rail may further include a fixed rail, and the movable rail may be switched from the second rail state to the first rail state by sliding relative to the fixed rail and stopping at a predetermined position. The sixth aspect may depend from any one of the first to fifth aspects.

This allows the elevator rail to be easily extended to a space outside the elevator.

In a seventh aspect, the elevator may further include: a second partition arranged below a first partition, within the elevator carriage, the first partition being the partition; and a second elevator rail that includes a movable rail and is different from a first elevator rail, the first elevator rail being the elevator rail. The space within the elevator carriage may be divided by the first partition and the second partition into the first space, the second space, and a third space for the unmanned transport vehicle to board. The second elevator rail may be arranged in the third space. The movable rail of the second elevator rail may be switched between a third rail state and a fourth rail state by actuation of an actuator. In the third rail state, a third end of the movable rail of the second elevator rail may be connected to a fourth end of a story rail provided on a story one below the predetermined story of the building. In the fourth rail state, the third end may be not connected to the fourth end. The seventh aspect may depend from any one of the first to sixth aspects.

As a result, because not only the second space but also the third space is used as a space for unmanned transport vehicles to board, the transport volume of packages transported by unmanned transport vehicles can be significantly increased.

In an eighth aspect, the elevator further includes a rail lifting device that raises and lowers the elevator rail. The eighth aspect may depend from any one of the first to seventh aspects.

With this, even if the story heights of stories of the building vary, the rail lifting device can appropriately align the height of the elevator rail with the height of the story rail.

In a ninth aspect, the rail lifting device is configured to change a distance between the elevator rail and a ceiling of the second space according to a story height of each of stories of the building. The ninth aspect may depend from the eighth aspect.

With this, the height of the elevator rail can be more appropriately aligned with the height of the story rail.

In a tenth aspect, a first story height of a first predetermined story of the building is different from a second story height of a second predetermined story of the building, the elevator rail is in a first first rail state in the first predetermined story of the building, and in a second first rail state in the second predetermined story of the building, and a first distance between the elevator rail and the ceiling of the second space in the first first rail state is different from a second distance between the elevator rail and the ceiling of the second space in the second first rail state. The tenth aspect may depend from the ninth aspect.

With this, even if the first story height differs from the second story height, the height of the elevator rail can be more appropriately aligned with the height of the story rail.

In the eleventh aspect, an absolute value of a difference between the first story height and the second story height is equal to an absolute value of a difference between the first distance and the second distance. The eleventh aspect may depend from the tenth aspect.

With this, the height of the elevator rail can be effectively matched with the height of the story rail.

An elevator according to a twelfth aspect is provided in a building, and includes: an elevator carriage that moves up and down; a partition that divides a space within the elevator carriage into a first space for a person to board and a second space for an unmanned transport vehicle to board; an elevator rail arranged in the second space; and a rail lifting device that raises and lowers the elevator rail. The unmanned transport vehicle travels along the elevator rail. The rail lifting device is configured to change a distance between the elevator rail and a ceiling of the second space according to a story height of each of stories of the building.

With this, even if the story heights of stories of the building vary, the rail lifting device can appropriately align the height of the elevator rail with the height of the story rail.

An elevator according to a thirteenth aspect is provided in a building, and includes: an elevator carriage that moves up and down; a first partition and a second partition that divide a space within the elevator carriage, the space within the elevator carriage including, sequentially from top to bottom vertically, a first second space for an unmanned transport vehicle to board, the first partition, a first space for a person to board, the second partition, and a second second space for the unmanned transport vehicle to board; a first elevator rail arranged in the first second space for the unmanned transport vehicle to travel; and a second elevator rail arranged in the second second space for the unmanned transport vehicle to travel.

With this, the first elevator rail and the second elevator rail allow many unmanned transport vehicles to travel.

In a fourteenth aspect, the first elevator rail includes a first movable rail. The second elevator rail includes a second movable rail. The elevator further includes: a first actuator that moves the first movable rail; and a second actuator that moves the second movable rail. The first movable rail is switched between a first first rail state and a first second rail state by actuation of the first actuator. In the first first rail state, a first first end of the first movable rail is connected to a first second end of a story rail provided on a predetermined story of the building. In the first second rail state, the first first end is not connected to the first second end. The second movable rail is switched between a second first rail state and a second second rail state by actuation of the second actuator. In the second first rail state, a second first end of the second movable rail is connected to a second second end of a story rail provided on a predetermined story of the building. In the second second rail state, the second first end is not connected to the second second end. The fourteenth aspect may depend from the thirteenth aspect.

With this, connection and non-connection between (i) the first elevator rail and the second elevator rail and (ii) the story rail can be appropriately switched.

In the fifteenth aspect, the elevator further includes: a first rail lifting device that raises and lowers the first elevator rail; and a second rail lifting device that raises and lowers the second elevator rail. The fifteenth aspect depends from the thirteenth aspect or the fourteenth aspect.

With this, the height of each of the first elevator rail and the second elevator rail can be matched with the height of the story rail to achieve effective connection.

A delivery system according to a sixteenth aspect of the present disclosure includes: an elevator provided in a building; a story rail that includes a movable rail and is provided on a predetermined story of the building; and an actuator that moves the movable rail. The elevator includes: an elevator carriage that moves up and down; a partition that divides a space within the elevator carriage into a first space for a person to board and a second space for an unmanned transport vehicle to board; and an elevator rail arranged in the second space. The unmanned transport vehicle travels along the elevator rail. The movable rail is switched between a first rail state and a second rail state by actuation of the actuator. In the first rail state, a first end of the movable rail is connected to a second end of the elevator rail. In the second rail state, the first end is not connected to the second end.

As a result, even if the elevator rail does not include a movable rail, because the story rail includes a movable rail, the elevator rail and the story rail can be coupled. As a result, the unmanned transport vehicle can easily enter and exit from the elevator carriage.

A transport vehicle according to a seventeenth aspect of the present disclosure includes an enclosure, a front wheel provided on the enclosure, and a rear wheel provided on the enclosure.

With this configuration, the unmanned transport vehicle can travel along the rail with the front wheel and the rear wheel.

In an eighteenth aspect of the present disclosure, the front wheel is configured to have an adjustable steering angle.

With this configuration, the steering angle of the front wheel can be automatically adjusted, allowing the unmanned transport vehicle to automatically turn right or left.

In a nineteenth aspect of the present disclosure, the rear wheel is configured to have a non-adjustable steering angle.

With this configuration, the unmanned transport vehicle can turn right or left simply by adjusting the steering angle of the front wheel, so there is no need to mount a mechanism for adjusting the steering angle of the rear wheel on the unmanned transport vehicle. Therefore, this can prevent a surge in the manufacturing cost of the unmanned transport vehicle.

In a twentieth aspect of the present disclosure, a steering device for changing the steering angle of the front wheel is further provided.

With this configuration, the unmanned transport vehicle can turn right or left simply by adjusting the steering angle of the front wheel.

In a twenty-first aspect of the present disclosure, a radius of the front wheel is smaller than a radius of the rear wheel.

With this configuration, the diameter of the front wheel can be made smaller than the diameter of the rear wheel, making it easier for the unmanned transport vehicle to turn right and left. Therefore, this can inhibit a decrease in the maneuverability of the unmanned transport vehicle (i.e., can improve its ability to make tight turns).

In a twenty-second aspect of the present disclosure, the transport vehicle further includes: an arm connected to the enclosure; and a wheel connected to a leading end side of the arm.

With this configuration, the wheel of the first arm and the wheel of the second arm can be connected to the rail. Therefore, the unmanned transport vehicle can travel along the rail with the first arm and the second arm.

In a twenty-third aspect of the present disclosure, the transport vehicle further includes: at least one actuator that actuates the arm. The arm is switched between a first arm state and a second arm state by actuation of the at least one actuator. In the first arm state, the wheel is positioned at a first position above the front wheel and the rear wheel. In the second arm state, the wheel is positioned at a second position below the first position.

With this configuration, the first arm and the second arm can be switched between the first arm state and the second arm state. Therefore, the unmanned transport vehicle can travel in the first arm state, and the unmanned transport vehicle can travel in the second arm state.

In a twenty-fourth aspect of the present disclosure, the transport vehicle further includes a controller. In a case in which the front wheel and the rear wheel are traveling on the first rail from a first section toward a second section, where no second rail is present above the first rail in the first section and the second rail is present above the first rail in the second section, when the front wheel and the rear wheel are in the first section, the controller controls the at least one actuator to change the arm from the second arm state to the first arm state to cause the wheel to travel on the second rail when the second rail is positioned below the wheel.

With this configuration, when the first arm and the second arm are in the first arm state, the unmanned transport vehicle can transfer from the rail to the elevated rail. When the unmanned transport vehicle transfers from the elevated rail to the rail, the first arm and the second arm can be in the second arm state. Therefore, by the unmanned transport vehicle being displaced between the first arm state and the second arm state, it can travel mutually between the rail and the elevated rail.

Because the unmanned transport vehicle is displaced between the first arm state and the second arm state while traveling, it can travel mutually between the rail and the elevated rail smoothly without stopping.

In a twenty-fifth aspect of the present disclosure, the arm is further switched to a third arm state by actuation of the at least one actuator. In the third arm state, the wheel is positioned at a third position that is below the first position and above the second position.

With this configuration, the first arm and the second arm can be switched to the third arm state, allowing the vehicle main body of the unmanned transport vehicle to be lifted. Therefore, the unmanned transport vehicle can travel along the elevated rail with the vehicle main body and the elevated rail positioned as close together as possible. With this, the height (width) from the bottom end of the unmanned transport vehicle to the top end of the elevated rail during travel can be prevented from becoming excessively high, making it possible to inhibit enlargement of the operating area of the system including the unmanned transport vehicle and the elevated rail.

In particular, the unmanned transport vehicle is useful when the unmanned transport vehicle travels in areas with height restrictions.

Because the unmanned transport vehicle is displaced to the third arm state while traveling, the unmanned transport vehicle can travel on the elevated rail smoothly without stopping.

In a twenty-sixth aspect of the present disclosure, the controller controls the at least one actuator to change the arm from the first arm state to the second arm state after the front wheel and the rear wheel are traveling on the first rail, respectively, and the wheel has separated from the second rail.

Accordingly, when the unmanned transport vehicle transfers from the elevated rail to the rail, the first arm and the second arm can be in the second arm state. Therefore, the unmanned transport vehicle can inhibit the first arm and second arm from interfering with other objects when traveling along the rail.

In particular, the unmanned transport vehicle is useful when the unmanned transport vehicle travels in areas with height restrictions.

Because the unmanned transport vehicle is displaced between the first arm state and the second arm state while traveling, it can travel mutually between the rail and the elevated rail smoothly without stopping.

In a twenty-seventh aspect of the present disclosure, when the enclosure, the front wheel, and a first rail on which the front wheel travels are viewed along a direction in which axles of the front wheel and the rear wheel are arranged, the bottom surface of the enclosure is positioned between the front wheel and the position of a contact point where the front wheel contacts the first rail.

With this configuration, the front wheel can be disposed on the side surface of the vehicle main body, making it possible to prevent the height from the bottom end to the top end of the unmanned transport vehicle from becoming excessively high, thereby making it possible to inhibit enlargement of the operating area of the system including the unmanned transport vehicle and the rail.

In a twenty-eighth aspect of the present disclosure, when the enclosure, the front wheel, and the first rail are viewed along the direction in which the axles of the front wheel and the rear wheel are arranged, the distance between the bottom surface of the enclosure and the position of the contact point is greater than or equal to 5 mm and less than or equal to 15 mm.

With this configuration, the height between the position of the coupling point and the bottom surface of the vehicle main body can be prevented from becoming excessively high, thereby making it possible to make the unmanned transport vehicle thinner and to inhibit enlargement of the operating area of the system including the unmanned transport vehicle and the rail.

In a twenty-ninth aspect of the present disclosure, the front wheel includes a first front wheel and a second front wheel. The front wheel is configured to allow adjustment of the distance between the first front wheel and the second front wheel. The rear wheel includes a first rear wheel and a second rear wheel. The rear wheel is configured to allow adjustment of the distance between the first rear wheel and the second rear wheel.

With this configuration, the widths of the front wheel and rear wheel can be adjusted, allowing for adjustment according to the width of a pair of rails consisting of two rails when the unmanned transport vehicle travels on the pair of rails. Therefore, the unmanned transport vehicle can move between a plurality of pairs of rails having different widths.

A groove structure according to a thirtieth aspect of the present disclosure includes: at least one of (i) a pair of grooves for right turn or (ii) a pair of grooves for left turn; and a pair of grooves for straight travel. The width of the pair of grooves for right turn and the width of the pair of grooves for left turn are different from the width of the pair of grooves for straight travel.

With this configuration, because the grooves have different widths, different types of rail pairs can be arranged together. Therefore, enlargement of the groove structure can be inhibited.

In a thirty-first aspect of the present disclosure, at least one of the depth of the pair of grooves for right turn or the depth of the pair of grooves for left turn is different from the depth of the pair of grooves for straight travel.

With this configuration, by having different groove depths, when an unmanned transport vehicle travels on the groove structure, it can travel without interference between the pair of grooves for right turn (pair of rails) and the pair of grooves for straight travel (pair of rails), and between the pair of grooves for left turn (pair of rails) and the pair of grooves for straight travel (pair of rails).

Hereinafter, embodiments are specifically described with reference to the drawings.

Each embodiment described below shows a general or specific example. The numerical values, shapes, materials, elements, the arrangement and connection of the elements, steps, order of the steps, etc., indicated in the following embodiments are mere examples, and therefore do not intend to limit the present disclosure. Therefore, among elements in the following embodiments, those not recited in any of the independent claims defining the broadest concept are described as optional elements.

Note that the figures are schematic illustrations and are not necessarily precise depictions. In the figures, elements that are the same share the same reference signs.

### Embodiment 1

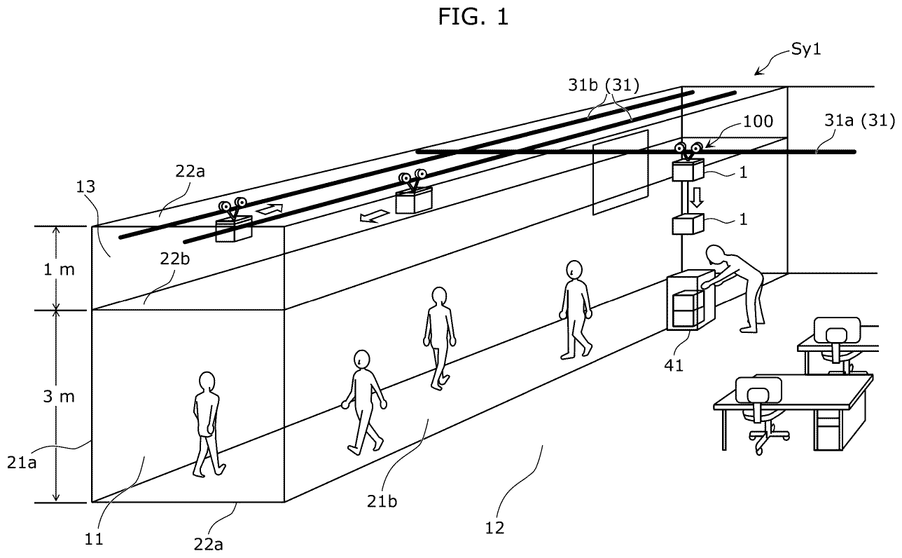

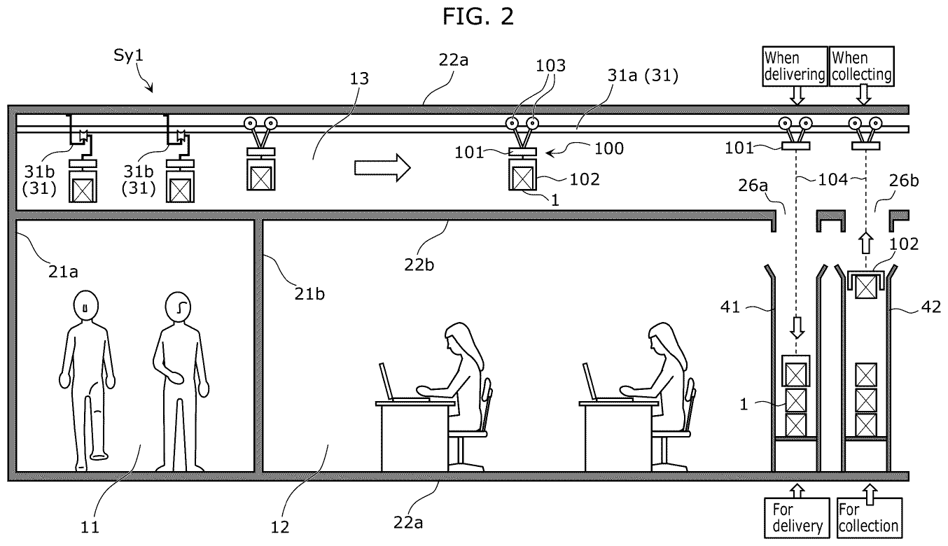

FIG. 1 and FIG. 2 illustrate examples of a configuration of an office building delivery system according to the present embodiment. Note that FIG. 1 illustrates a bird's-eye view of one story (hereinafter also referred to as a story area) among a plurality of stories in an office building in which the office building delivery system is installed. FIG. 2 illustrates a side view of the story area.

The story area includes a space surrounded by first vertical wall 21a extending vertically and two first horizontal walls 22a each extending horizontally. First vertical wall 21a is a wall that separates the inside and outside of the office building. The two first horizontal walls 22a are stacked vertically. The lower first horizontal wall 22a is used as the floor of a given story area, and the upper first horizontal wall 22a is used as the floor of the story area one level above that given story area.

The above-mentioned space of the story area is divided into three story spaces by second vertical wall 21b and second horizontal wall 22b. The three story spaces are first story space 11, second story space 12, and third story space 13. First story space 11 is a space for people to walk, i.e., a corridor, or an elevator lobby where people briefly wait before boarding an elevator. Second story space 12 is a space for people to perform desk work. Third story space 13 is a space for installing, for example, piping, power lines, etc., and is located above first story space 11 and second story space 12. Such third story space 13 is also called a ceiling space or ceiling cavity. In one example of dimensions, the height of first story space 11, that is, the height from the lower first horizontal wall 22a to second horizontal wall 22b is three meters. The height of third story space 13, that is, the height from second horizontal wall 22b to the upper first horizontal wall 22a is one meter. Note that these heights are merely examples and are not limited thereto.

Office building delivery system Sy1 according to the present embodiment includes a plurality of story rails 31, unmanned transport vehicle 100, delivery box 41, and collection box 42, as illustrated in FIG. 2. Note that the number of unmanned transport vehicles 100, the number of delivery boxes 41, and the number of collection boxes 42 included in office building delivery system Sy1 may be one or more than one.

Each of the plurality of story rails 31 is a rail for unmanned transport vehicle 100 to travel along, and is installed extending horizontally in third story space 13. More specifically, the plurality of story rails 31 include one or more first story rails 31a and one or more second story rails 31b. First story rail 31a extends along the arrangement direction of first story space 11 and second story space 12. Second story rail 31b extends along a direction perpendicular to the arrangement direction, that is, along the lengthwise direction of first story space 11.

Each of delivery box 41 and collection box 42 is a box having an opening at its upper portion, and is arranged in second story space 12. Delivery box 41 accommodates package 1 that is delivered from outside to second story space 12. Collection box 42 accommodates package 1 that is collected from second story space 12 to be transported to the outside. Second horizontal wall 22b includes two transport openings 26a and 26b. Transport opening 26a is provided at a position facing the opening of delivery box 41, and transport opening 26b is provided at a position facing the opening of collection box 42.

Unmanned transport vehicle 100 includes main body 101, one or more wheels 103, and package carriage 102. The one or more wheels 103 are attached to the upper part of main body 101 and are placed on story rail 31. As a result, unmanned transport vehicle 100 hangs from story rail 31. The one or more wheels 103 are rotated by a motor included in main body 101. As a result, unmanned transport vehicle 100 travels along story rail 31. Note that unmanned transport vehicle 100 may travel along only one of first story rail 31a or second story rail 31b. Alternatively, unmanned transport vehicle 100 may travel along these rails by transferring from one of first story rail 31a or second story rail 31b to the other.

Package carriage 102 is attached to the leading end of wire 104 included in a winch that is included in main body 101. Such package carriage 102 ascends and descends by the reeling in and out of wire 104 by the winch, and engages (holds) and disengages package 1. Stated differently, package carriage 102 engages package 1 and disengages package 1. Note that any method may be used for the engagement and disengagement.

Such unmanned transport vehicle 100 travels along story rail 31 in third story space 13 while package carriage 102 is holding package 1. Unmanned transport vehicle 100 stops above transport opening 26a of second horizontal wall 22b, and lowers package carriage 102 into delivery box 41 through transport opening 26a by causing the winch to reel out wire 104. Package carriage 102 then disengages package 1 and places package 1 in delivery box 41. Thereafter, by causing the winch to reel in wire 104, unmanned transport vehicle 100 raises package carriage 102 to pull up package carriage 102 from delivery box 41 through transport opening 26a.

Unmanned transport vehicle 100, in a state where package carriage 102 is not holding package 1, travels along story rail 31 in third story space 13 and stops above transport opening 26b of second horizontal wall 22b. Unmanned transport vehicle 100 lowers package carriage 102 into collection box 42 through transport opening 26b by causing the winch to reel out wire 104. Package carriage 102 then engages so as to hold package 1 that is inside collection box 42. Thereafter, by causing the winch to reel in wire 104, unmanned transport vehicle 100 raises package carriage 102 that is holding package 1 to pull up package carriage 102 from collection box 42 through transport opening 26b.

Thus, unmanned transport vehicle 100 according to the present embodiment includes package carriage 102 connected to wire 104, and a winch capable of reeling out and reeling in wire 104. With this, unmanned transport vehicle 100 can lift package 1 or place package 1 down by raising and lowering package carriage 102.

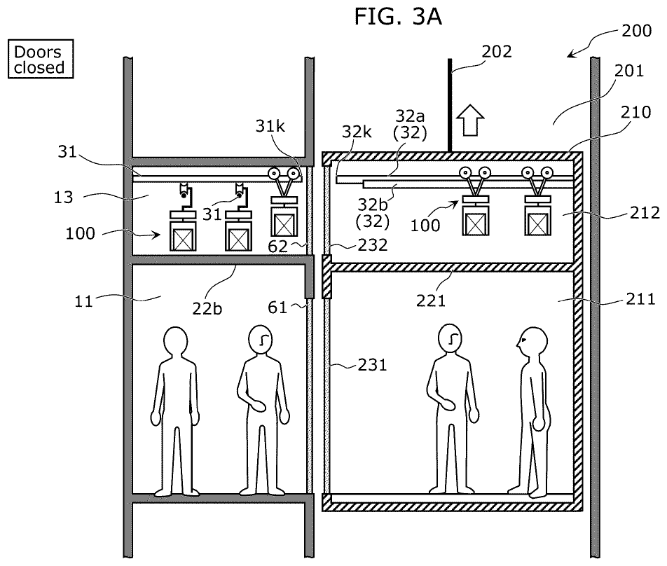

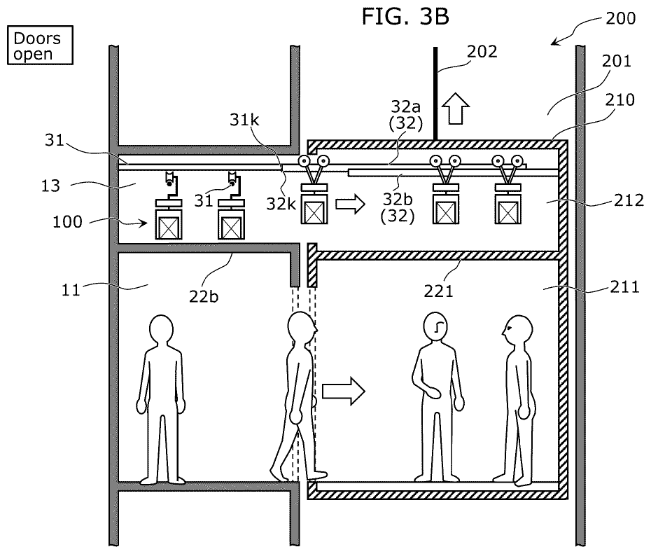

FIG. 3A and FIG. 3B illustrate an example of elevator 200 according to the present embodiment. FIG. 3A illustrates elevator 200 with its door closed, and FIG. 3B illustrates elevator 200 with its door open.

Office building delivery system Sy1 may include elevator 200, as illustrated in FIG. 3A and FIG. 3B. Elevator 200 is an elevator installed in the office building of FIG. 1 and FIG. 2, and includes elevator carriage 210. Elevator carriage 210 is suspended by carriage wire 202 within elevator path 201 that extends in the vertical direction. Mechanical equipment for elevator 200, such as air conditioning equipment, is arranged above elevator carriage 210. Elevator carriage 210 rises when carriage wire 202 is reeled in by the elevator winch, and elevator carriage 210 descends when carriage wire 202 is reeled out from the elevator winch. In this manner, elevator carriage 210 moves up and down.

Elevator carriage 210 includes partition 221 that divides the space within elevator carriage 210 into first elevator space 211 and second elevator space 212. First elevator space 211 is a space for people to board, and second elevator space 212 is a space for unmanned transport vehicle 100 to board. This second elevator space 212 is positioned above first elevator space 211. Stated differently, elevator carriage 210 is a two-story or two-level carriage. Second elevator space 212 includes elevator rail 32 arranged along the horizontal direction.

Elevator rail 32 is installed on the ceiling of second elevator space 212. More specifically, elevator rail 32 includes movable rail 32a and fixed rail 32b, and elevator 200 includes an actuator for moving movable rail 32a. Movable rail 32a is switched between a first rail state and a second rail state by actuation of the actuator. Stated differently, movable rail 32a is switched from the second rail state to the first rail state by sliding relative to fixed rail 32b and stopping at a predetermined position, as illustrated in FIG. 3A and FIG. 3B.

Elevator carriage 210 includes first carriage door 231 that opens and closes an opening leading from outside elevator carriage 210 to first elevator space 211, and second carriage door 232 that opens and closes an opening leading from outside elevator carriage 210 to second elevator space 212. These openings are formed in elevator carriage 210. First landing door 61 that opens and closes in conjunction with first carriage door 231 is arranged at a position opposite to first carriage door 231. Similarly, second landing door 62 that opens and closes in conjunction with second carriage door 232 is arranged at a position opposite to second carriage door 232. When first landing door 61 and first carriage door 231 open in conjunction with each other, first story space 11 and first elevator space 211 are in communication with each other. In this state, a person can move between first story space 11 and first elevator space 211. When first landing door 61 and first carriage door 231 close in conjunction with each other, first story space 11 and first elevator space 211 are partitioned from each other. In this state, a person cannot move between first story space 11 and first elevator space 211.

Similarly, when second landing door 62 and second carriage door 232 open in conjunction with each other, third story space 13 and second elevator space 212 are in communication with each other. In this state, unmanned transport vehicle 100 can move between third story space 13 and second elevator space 212 depending on the state of elevator rail 32. When second landing door 62 and second carriage door 232 close in conjunction with each other, third story space 13 and second elevator space 212 are partitioned from each other. In this state, unmanned transport vehicle 100 cannot move between third story space 13 and second elevator space 212.

Note that first carriage door 231 and second carriage door 232 may be integrated as a single unit. This makes it possible to reduce the number of actuators for opening and closing those doors. Alternatively, first carriage door 231 and second carriage door 232 may be configured as separate units, or may be configured independently of each other. This allows first carriage door 231 and second carriage door 232 to be opened and closed individually.

Unmanned transport vehicle 100 travels along that elevator rail 32. As illustrated in FIG. 3A, when first landing door 61 and first carriage door 231 are closed and second landing door 62 and second carriage door 232 are closed, unmanned transport vehicle 100 stops while suspended from elevator rail 32. Here, movable rail 32a of elevator rail 32 is in the second rail state. In the second rail state, as illustrated in FIG. 3A, first end 32k of movable rail 32a is not connected to second end 31k of story rail 31. Stated differently, elevator rail 32 and story rail 31 are not coupled. Therefore, in this case, movement of unmanned transport vehicle 100 between third story space 13 and second elevator space 212 is prohibited.

However, as illustrated in FIG. 3B, when first landing door 61 and first carriage door 231 open and second landing door 62 and second carriage door 232 open, elevator rail 32 couples to story rail 31 arranged in third story space 13. Stated differently, movable rail 32a of elevator rail 32 is in the first rail state. In the first rail state, as illustrated in FIG. 3B, first end 32k of movable rail 32a is connected to second end 31k of story rail 31. As a result, unmanned transport vehicle 100 in second elevator space 212 can travel along elevator rail 32 and story rail 31 to move from second elevator space 212 to third story space 13. Conversely, unmanned transport vehicle 100 in third story space 13 can also travel along story rail 31 and elevator rail 32 to move from third story space 13 to second elevator space 212.

Such office building delivery system Sy1 may be applied to an apartment (i.e., a housing complex) as apartment delivery system Sy2.

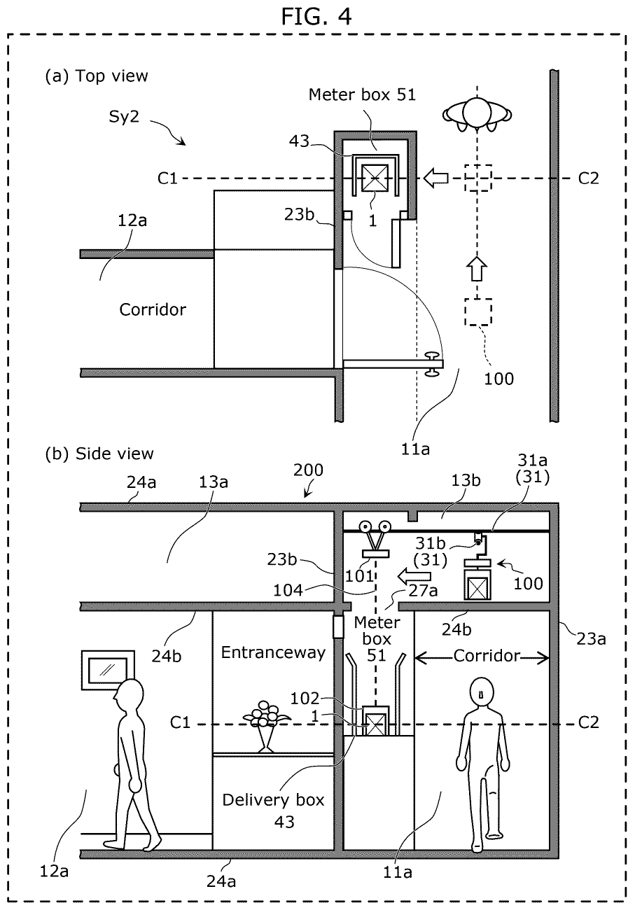

FIG. 4 illustrates an example of a configuration of an apartment delivery system according to the present embodiment. Note that (a) in FIG. 4 illustrates a top view of a portion of one story area among a plurality of story areas included in the apartment, and (b) in FIG. 4 illustrates a side view of that portion.

As illustrated in (b) in FIG. 4, the story area includes a space surrounded by first vertical wall 23a extending vertically and two first horizontal walls 24a each extending horizontally. First vertical wall 23a is a wall that separates the inside and outside of the apartment. The two first horizontal walls 24a are stacked vertically. The lower first horizontal wall 24a is used as the floor of a given story area, and the upper first horizontal wall 24a is used as the floor of the story area one level above that given story area.

The above-mentioned space of the story area is divided into four story spaces by second vertical wall 23b and second horizontal wall 24b. The four story spaces are first story space 11a, second story space 12a, third story space 13a, and fourth story space 13b. First story space 11a is a space for people to walk, i.e., a corridor of an apartment. Second story space 12a is a space for people to reside, essentially what would be considered a room. Third story space 13a is a space for installing, for example, piping, power lines, etc., and is located above second story space 12a. Such third story space 13a is also called a ceiling space or ceiling cavity of a room. Fourth story space 13b is a space for unmanned transport vehicle 100 to travel, and is located above first story space 11a. Such fourth story space 13b is also called a ceiling space or ceiling cavity of a corridor. Fourth story space 13b includes a plurality of story rails 31 arranged along the horizontal direction.

First story space 11a includes meter box 51 on the second vertical wall 23b side. Meter box 51 includes a meter that measures the amount of gas or water used in second story space 12a. In the present embodiment, delivery box 43 having an opening at its upper portion is further arranged in meter box 51. Second horizontal wall 24b includes transport opening 27a at a portion opposite to the opening of delivery box 43. Delivery box 43 may be protected by a transparent panel.

Unmanned transport vehicle 100 travels along story rail 31 within fourth story space 13b. For example, unmanned transport vehicle 100 travels in a direction along the corridor until reaching line segment C1-C2, as illustrated in (a) in FIG. 4. Unmanned transport vehicle 100, upon reaching line segment C1-C2, travels in the direction of extension of line segment C1-C2, as illustrated in (a) and (b) in FIG. 4. Unmanned transport vehicle 100 stops above transport opening 27a and, similar to the example illustrated in FIG. 1 and FIG. 2, raises and lowers package carriage 102 by reeling in and reeling out wire 104 by the winch. With this, unmanned transport vehicle 100 places package 1 in delivery box 43 through transport opening 27a. Alternatively, unmanned transport vehicle 100 removes package 1 from delivery box 43 and pulls up that package 1 to main body 101 side through transport opening 27a.

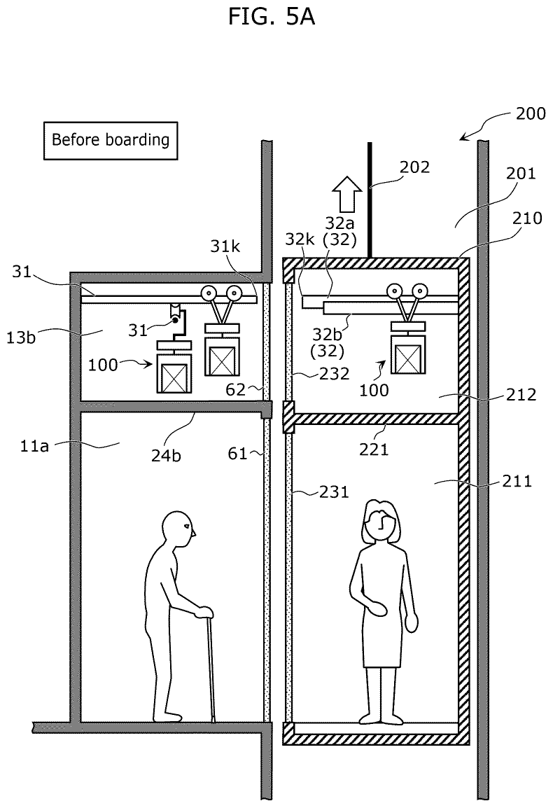

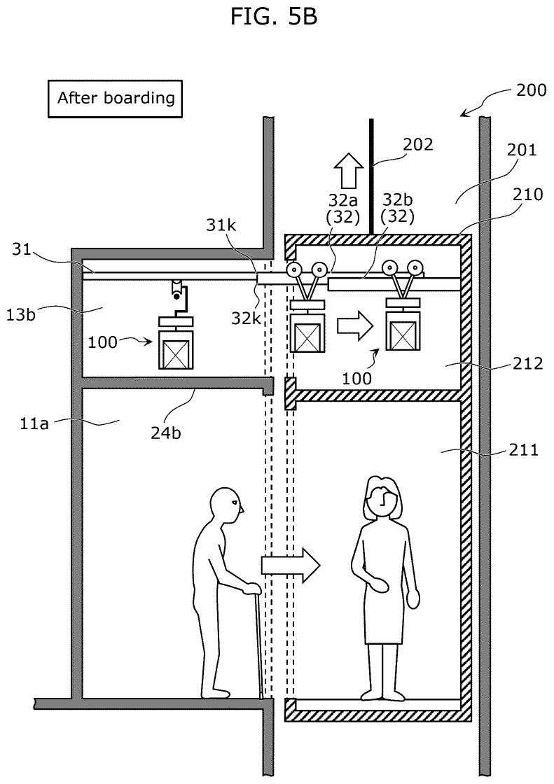

FIG. 5A and FIG. 5B illustrate an example of elevator 200 according to the present embodiment. FIG. 5A, similar to FIG. 3A, illustrates elevator 200 with first carriage door 231 and second carriage door 232 closed, and FIG. 5B, similar to FIG. 3B, illustrates elevator 200 with first carriage door 231 and second carriage door 232 open.

Apartment delivery system Sy2 may include elevator 200, similar to office building delivery system Sy1. Elevator 200 is disposed in the apartment of FIG. 4, for example. In the example illustrated in FIG. 5A and FIG. 5B, elevator carriage 210 is suspended by carriage wire 202 within elevator path 201 that extends in the vertical direction, and moves up and down by reeling out and reeling in of carriage wire 202 by an elevator winch.

In such apartment delivery system Sy2, unmanned transport vehicle 100 travels along elevator rail 32. As illustrated in FIG. 5A, when first landing door 61 and first carriage door 231 are closed and second landing door 62 and second carriage door 232 are closed, unmanned transport vehicle 100 stops while suspended from elevator rail 32. In this case, movable rail 32a of elevator rail 32 is in the second rail state. Stated differently, first end 32k of movable rail 32a is not connected to second end 31k of story rail 31. Therefore, in this case, movement of unmanned transport vehicle 100 between fourth story space 13b and second elevator space 212 is prohibited. However, as illustrated in FIG. 5B, when first landing door 61 and first carriage door 231 open and second landing door 62 and second carriage door 232 open, elevator rail 32 couples to story rail 31 arranged in third story space 13. More specifically, movable rail 32a is switched from the second rail state to the first rail state by sliding relative to fixed rail 32b and stopping at a predetermined position through actuation of an actuator. As a result, as illustrated in FIG. 5B, first end 32k of movable rail 32a is connected to second end 31k of story rail 31. Therefore, unmanned transport vehicle 100 in second elevator space 212 can travel along elevator rail 32 and story rail 31 to move from second elevator space 212 to fourth story space 13b. Conversely, unmanned transport vehicle 100 in fourth story space 13b can also travel along story rail 31 and elevator rail 32 to move from fourth story space 13b to second elevator space 212.

As described above, elevator 200 according to the present embodiment is an elevator provided in a building such as an office building or an apartment. Elevator 200 includes: elevator carriage 210 that moves up and down; partition 221 that divides a space within elevator carriage 210 into first elevator space 211 for a person to board and second elevator space 212 for unmanned transport vehicle 100 to board; elevator rail 32 that includes movable rail 32a and is arranged in second elevator space 212; and an actuator that moves movable rail 32a. Unmanned transport vehicle 100 travels along elevator rail 32. Movable rail 32a is switched between a first rail state and a second rail state by actuation of the actuator. In the first rail state, first end 32k of movable rail 32a is connected to second end 31k of story rail 31 provided on a predetermined story of the building. In the second rail state, first end 32k is not connected to second end 31k.

After unmanned transport vehicle 100 that travels along elevator rail 32 moves up and/or down with elevator carriage 210 and arrives at a predetermined story, in order for unmanned transport vehicle 100 to exit from elevator carriage 210, it is necessary to connect elevator rail 32 with story rail 31, which is a rail provided on that predetermined story for unmanned transport vehicle 100 to travel along. Here, if a movable rail and an actuator for driving the movable rail were to be installed for each of story rails 31 provided on each story, a quantity of movable rails and actuators corresponding to the number of stories in the building would be required, resulting in an increase in the number of parts for elevator 200 as a whole, maintenance and inspection effort, and cost.

However, in the present embodiment, movable rail 32a of elevator rail 32 is switched between a first rail state and a second rail state by actuation of the actuator, as described above. Stated differently, the configuration of elevator rail 32 and the operation of the actuator allow elevator rail 32 to be either coupled to or separated from story rail 31.

Accordingly, in the present embodiment, it is not necessary to prepare movable rails and actuators in a quantity corresponding to the number of stories in the building. As a result, it is possible to realize elevator 200 capable of simultaneously transporting people and unmanned transport vehicle 100 while preventing an increase in the number of parts and the like related to elevator 200.

Note that first elevator space 211 may be provided with a carriage operation panel. The carriage operation panel may include one or more displays and one or more operation buttons. The one or more displays display, for example, the current position of elevator carriage 210, the direction of travel, etc. The one or more operation buttons include destination story buttons corresponding to each story of the building, a door open button, a door close button, etc. The one or more operation buttons may be implemented as a touch panel that detects contact, or as contactless buttons that detect when a user holds their hand or finger near the device.

Elevator 200 further includes first carriage door 231 that leads to first elevator space 211 and opens and closes an opening formed in elevator carriage 210, and second carriage door 232 that leads to second elevator space 212 and opens and closes an opening formed in elevator carriage 210.

This allows, for example, if first carriage door 231 and second carriage door 232 are configured separately, each of them to be opened and closed independently.

First carriage door 231 and second carriage door 232 are integrated as a single unit.

Since first carriage door 231 and second carriage door 232 are integrated as a single unit, this allows there to be no need to separately provide an actuator required for actuating first carriage door 231 and an actuator required for actuating second carriage door 232. Accordingly, since first carriage door 231 and second carriage door 232 can be actuated by the same actuator, the number of parts of elevator 200 can be reduced.

Second elevator space 212 is positioned above first elevator space 211, and elevator rail 32 is provided on the ceiling of second elevator space 212.

As a result, in buildings such as office buildings and apartments, first story spaces 11, 11a where people are active can be made to correspond to first elevator space 211. Furthermore, in that building, third story space 13 or fourth story space 13b, which is a ceiling cavity area, can be made to correspond to second elevator space 212. It is therefore possible to realize elevator 200 that allows both people and unmanned transport vehicle 100 to smoothly enter and exit.

Unmanned transport vehicle 100 includes package carriage 102 connected to wire 104, and a winch capable of reeling out and reeling in wire 104.

This allows, for example, unmanned transport vehicle 100 to lower package carriage 102 into delivery box 43 by reeling out wire 104 downward after unmanned transport vehicle 100 arrives above delivery box 43 located in meter box 51 of first story space 11a such as a corridor. This allows package 1 to be delivered or collected without lowering unmanned transport vehicle 100 itself into second story space 12a such as a room.

Elevator rail 32 further includes fixed rail 32b, and movable rail 32a is switched from the second rail state to the first rail state by sliding relative to fixed rail 32b and stopping at a predetermined position.

This allows elevator rail 32 to be easily extended to third story space 13 or fourth story space 13b. Note that movable rail 32a may be a rotating rail that rotates around a rotary shaft.

### Variation 1 of Embodiment 1

In office building delivery system Sy1 according to the above embodiment, unmanned transport vehicle 100 travels along story rail 31 within the office building, but unmanned transport vehicle 100 may travel between a plurality of buildings.

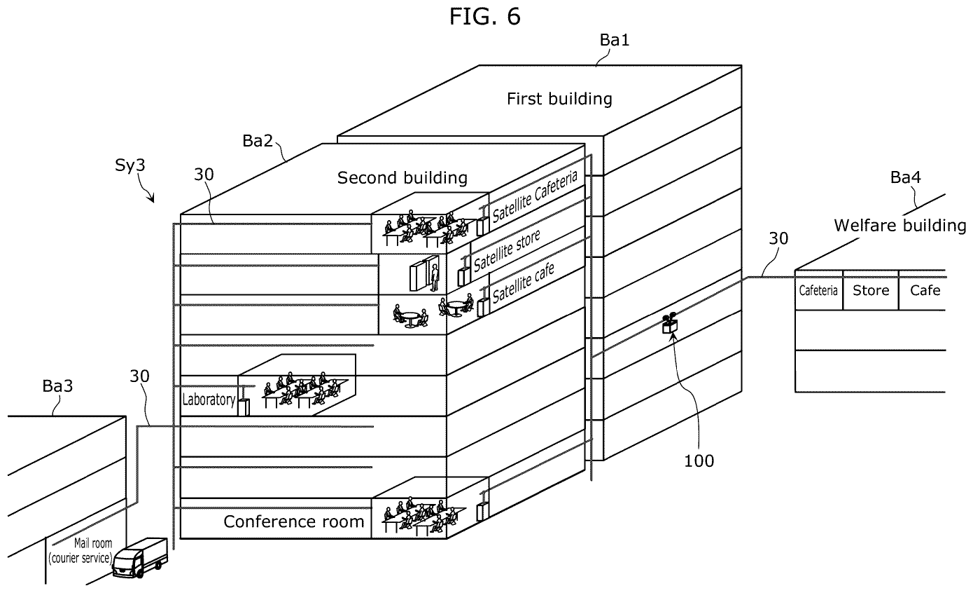

FIG. 6 illustrates an example of a configuration of a logistics system according to the present variation.

Logistics system Sy3 according to the present variation includes one or more unmanned transport vehicles 100 and transport rail 30. Transport rail 30 may include one or more story rails 31, and may include one or more elevator rails 32. Such transport rail 30 extends across a plurality of buildings. The plurality of buildings may be, for example, multi-story structures or office buildings. In the example of FIG. 6, transport rail 30 extends across a plurality of buildings including welfare building Ba4, second building Ba2, and mail room building Ba3. Second building Ba2 may be the office building of Embodiment 1. In such cases, it can also be said that office building delivery system Sy1 of Embodiment 1 is installed in second building Ba2. Alternatively, it can also be said that logistics system Sy3 includes office building delivery system Sy1 of Embodiment 1.

In logistics system Sy3 according to the present variation, since transport rail 30 is provided to connect a plurality of buildings, unmanned transport vehicle 100 can transport package 1 not only within buildings but also by traveling between buildings. Stated differently, network delivery can be realized. In the example of FIG. 6, transport rail 30 is not provided in first building Ba1. For example, when second building Ba2 was newly constructed as a new office building, first building Ba1 may have been a pre-existing office building. In such cases, transport rail 30 may be provided in second building Ba2 during the construction of second building Ba2 for the introduction of logistics system Sy3.

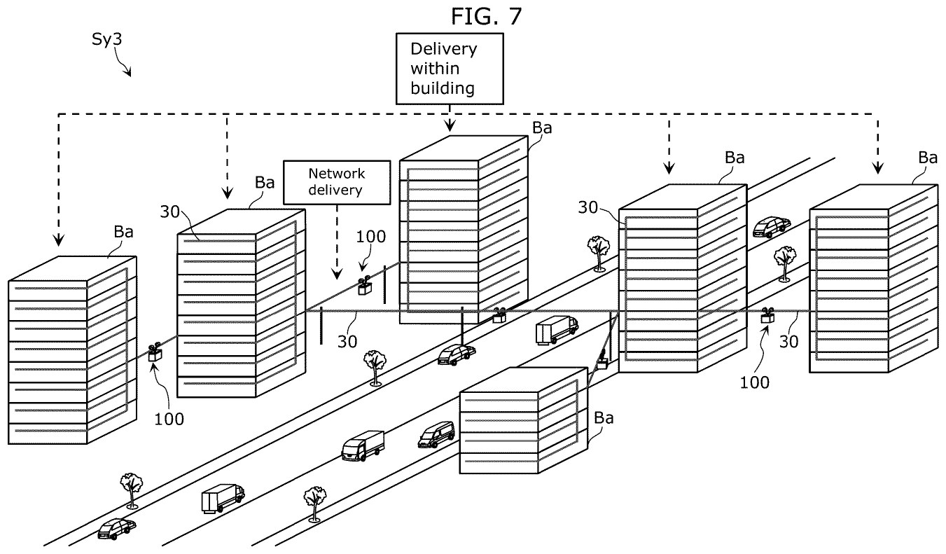

FIG. 7 illustrates another example of a configuration of logistics system Sy3 according to the present variation.

Logistics system Sy3 may be arranged over a wider area, as illustrated in FIG. 7. For example, transport rail 30 may be provided between many buildings Ba constructed in areas such as office building districts. Transport rail 30 may be provided so as to span across major arterial roads. In each building Ba, delivery of package 1 (that is, in-building delivery) is performed by office building delivery system Sy1 according to Embodiment 1. Between the plurality of buildings Ba, delivery of package 1 (that is, network delivery) is performed by unmanned transport vehicle 100 between those buildings Ba.

### Variation 2 of Embodiment 1

In office building delivery system Sy1 illustrated in FIG. 1 and FIG. 2, the height of the story area, that is, the height between the two first horizontal walls 22a is four meters. In this case, unmanned transport vehicle 100 travels in third story space 13 enclosed by upper first horizontal wall 22a and second horizontal wall 22b. However, when the height of the story area is low, it is difficult to secure enough vertical clearance in third story space 13 for unmanned transport vehicle 100 to travel. In this case, according to the present variation, at least a portion of unmanned transport vehicle 100 may protrude into first story space 11 or second story space 12 where people are present.

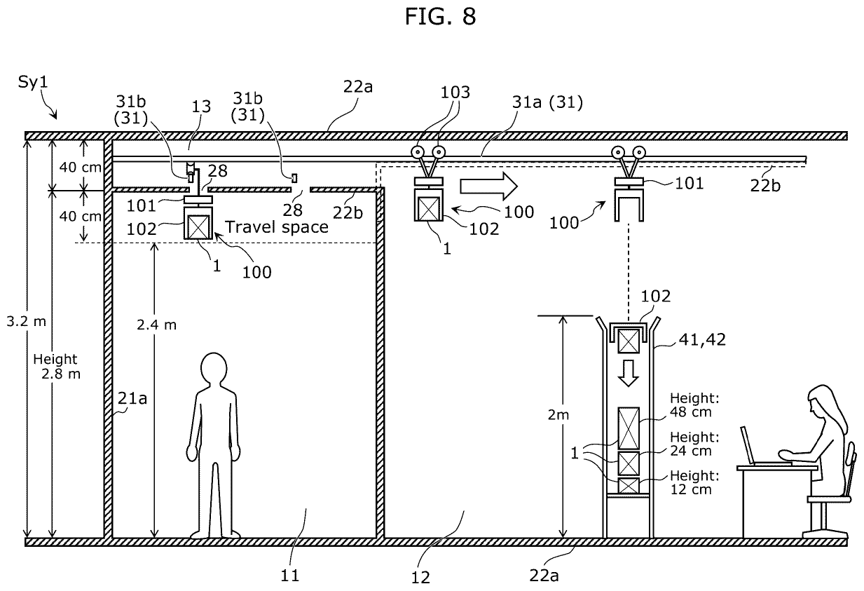

FIG. 8 illustrates an example of a configuration of office building delivery system Sy1 according to the present variation. In the example illustrated in FIG. 8, the height of the story area, that is, the height between the two first horizontal walls 22a is 3.2 meters. The height of first story space 11, that is, the height between the lower first horizontal wall 22a and second horizontal wall 22b is 2.8 meters. The height of third story space 13 above first story space 11, that is, the height between second horizontal wall 22b and the upper first horizontal wall 22a is 40 cm.

The plurality of story rails 31 are installed in third story space 13. However, main body 101 and package carriage 102 of unmanned transport vehicle 100 hanging from story rail 31 are located in first story space 11 or second story space 12. Stated differently, second horizontal wall 22b includes travel opening 28 that penetrates in the thickness direction at a portion opposite to story rail 31, and is formed to extend along story rail 31. Wheel 103 of unmanned transport vehicle 100 is placed on story rail 31 in third story space 13, and the member connecting wheel 103 and main body 101 is inserted through travel opening 28. As a result, from first story space 11 or second story space 12, main body 101 and package carriage 102 of unmanned transport vehicle 100 appear to travel along the lower surface of second horizontal wall 22b of the ceiling. Stated differently, main body 101 and package carriage 102 of unmanned transport vehicle 100 travel in a travel space located below second horizontal wall 22b. The height of the travel space in first story space 11 is 40 cm.

In the example illustrated in FIG. 8, unmanned transport vehicle 100 can raise and lower package carriage 102 at any position where unmanned transport vehicle 100 is capable of traveling. Accordingly, delivery boxes such as delivery box 41 or collection box 42 can be moved. Stated differently, the degree of freedom in the placement of delivery boxes can be increased.

Regarding apartment delivery system Sy2 as well, similar to office building delivery system Sy1, when the height of the story area is low, it is difficult to secure enough vertical clearance in fourth story space 13b for unmanned transport vehicle 100 to travel. In this case, according to the present variation, at least a portion of unmanned transport vehicle 100 may protrude into first story space 11a where people are present.

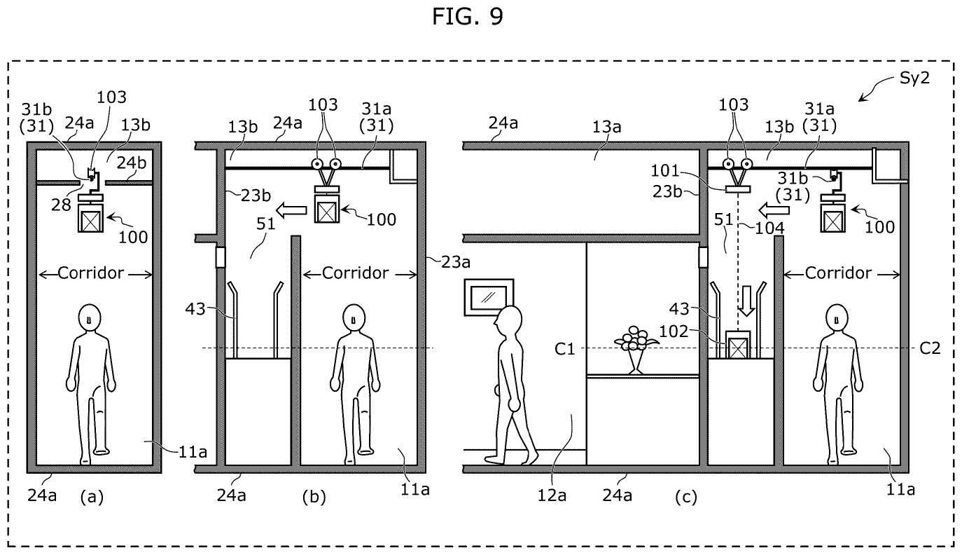

FIG. 9 illustrates an example of a configuration of apartment delivery system Sy2 according to the present variation. Note that (a) in FIG. 9 illustrates first story space 11a, which is a corridor not in front of an apartment room, and fourth story space 13b located above that first story space 11a, whereas (b) and (c) in FIG. 9 illustrate first story space 11a, which is a corridor in front of a room, and fourth story space 13b located above that first story space 11a.

For example, as illustrated in (a) in FIG. 9, story rail 31 is installed in fourth story space 13b. However, main body 101 and package carriage 102 of unmanned transport vehicle 100 hanging from story rail 31 are located in first story space 11a. Stated differently, second horizontal wall 24b includes travel opening 28 that penetrates in the thickness direction at a portion opposite to story rail 31, and is formed to extend along story rail 31. Wheel 103 of unmanned transport vehicle 100 is placed on story rail 31 in fourth story space 13b, and the member connecting wheel 103 and main body 101 is inserted through travel opening 28. As a result, from first story space 11a, main body 101 and package carriage 102 of unmanned transport vehicle 100 appear to travel along the lower surface of second horizontal wall 24b of the ceiling. Stated differently, main body 101 and package carriage 102 of unmanned transport vehicle 100 travel in a travel space located below second horizontal wall 24b.

As illustrated in (b) and (c) in FIG. 9, first story rail 31a is arranged in fourth story space 13b along the width direction of the corridor located below fourth story space 13b. Although not illustrated in (b) and (c) in FIG. 9, similar to (a) in FIG. 9, travel opening 28 is formed in second horizontal wall 24b at a portion opposite to first story rail 31a, so as to extend along first story rail 31a. Therefore, wheel 103 of unmanned transport vehicle 100 is placed on first story rail 31a in fourth story space 13b, and the member connecting wheel 103 and main body 101 is inserted through travel opening 28. As a result, from first story space 11a, main body 101 and package carriage 102 of unmanned transport vehicle 100 appear to travel along the lower surface of second horizontal wall 24b of the ceiling. Stated differently, main body 101 and package carriage 102 of unmanned transport vehicle 100 travel in a travel space located below second horizontal wall 24b.

Note that as illustrated in (b) and (c) in FIG. 9, second horizontal wall 24b need not be provided between first story space 11a in front of the room and fourth story space 13b. In this case, from first story space 11a, the entire unmanned transport vehicle 100 appears to travel along the lower surface of first horizontal wall 24a of the ceiling.

### Variation 3 of Embodiment 1

Elevator carriage 210 of elevator 200 according to Embodiment 1 has a two-story structure, as illustrated in FIG. 3A and FIG. 3B. The elevator carriage according to the present variation has a three-story structure.

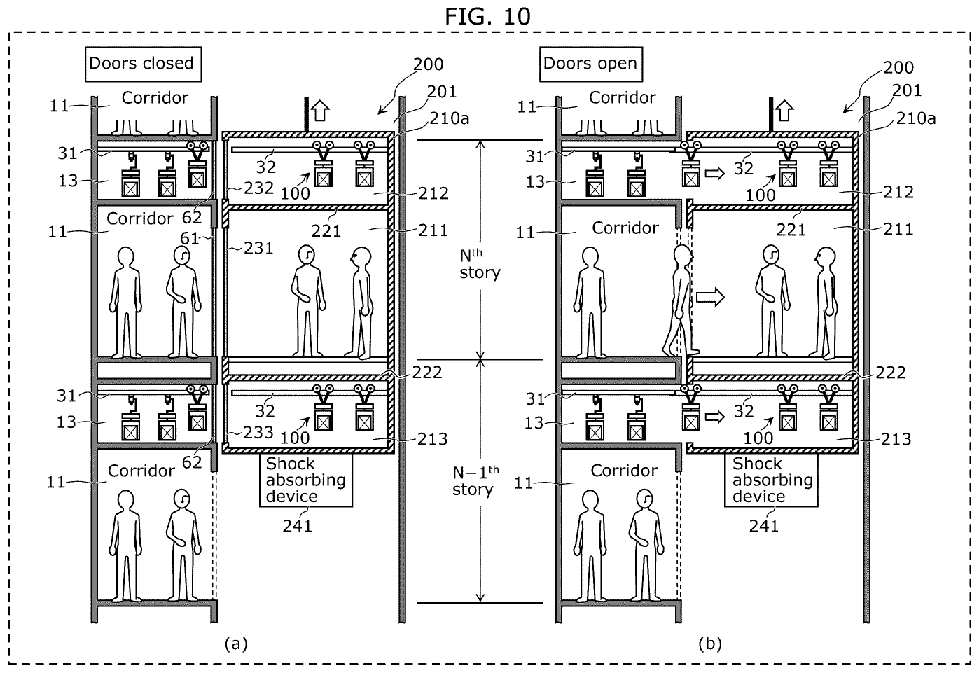

FIG. 10 illustrates an example of elevator 200 according to the present variation. In FIG. 10, (a) illustrates elevator 200 with its door closed, and (b) illustrates elevator 200 with its door open.

Elevator 200 according to the present variation includes elevator carriage 210a having a three-story structure, as illustrated in (a) and (b) in FIG. 10. More specifically, elevator carriage 210a includes two plate-shaped partitions 221 and 222. The two partitions 221 and 222 are arranged in the height direction of elevator carriage 210a. More specifically, partition 222 is disposed below partition 221. Each of the two partitions 221 and 222 is disposed parallel to the horizontal direction. The space within elevator carriage 210a is divided into first elevator space 211, second elevator space 212, and third elevator space 213 by these two partitions 221 and 222. Note that partition 221 is also called a first partition, and partition 222 is also called a second partition. Third elevator space 213 is a space for unmanned transport vehicle 100 to board, similar to second elevator space 212. This third elevator space 213 is positioned below first elevator space 211. Third elevator space 213 includes elevator rail 32 arranged along the horizontal direction. Note that elevator rail 32 arranged in second elevator space 212 is also called a first elevator rail, and elevator rail 32 arranged in third elevator space 213 is also called a second elevator rail.

Elevator carriage 210a further includes third carriage door 233 that opens and closes an opening leading from outside elevator carriage 210a to third elevator space 213, as illustrated in (a) in FIG. 10. This opening is formed in elevator carriage 210a. Here, for example, elevator carriage 210 stops at a position where first elevator space 211 and second elevator space 212 of elevator carriage 210a are respectively opposite to first story space 11 and third story space 13 located on story N (where N is an arbitrary integer). In this case, third elevator space 213 is opposite to third story space 13 located on the (N−1)th story. Stated differently, third carriage door 233 of third elevator space 213 is opposite to second landing door 62 on the (N−1)th story. Third carriage door 233 opens and closes in conjunction with second landing door 62.

When third carriage door 233 and second landing door 62 open in conjunction with each other, third story space 13 on the (N−1)th story and third elevator space 213 are in communication with each other. In this state, unmanned transport vehicle 100 can move between third story space 13 and third elevator space 213 depending on the state of elevator rail 32. When third carriage door 233 and second landing door 62 close in conjunction with each other, third story space 13 and third elevator space 213 are partitioned from each other. In this state, unmanned transport vehicle 100 cannot move between third story space 13 and third elevator space 213.

Note that shock absorbing device 241 that functions as a buffer may be attached to the bottom of elevator carriage 210a. Shock absorbing device 241 may be a spring type or may be an oil-filled type.

A building such as an office building may include two or more elevators 200 including such elevator carriage 210a. When two elevators 200 are installed, elevator carriage 210a of one elevator 200 may be configured to stop only at odd-numbered stories among all stories in the building, for example, and elevator carriage 210a of the other elevator 200 may be configured to stop only at even-numbered stories among all stories in the building. The first story (i.e., the lowest story) among all stories in the building may, as an exception, be a story at which elevator carriage 210a of each of the two elevators 200 is able to stop.

Thus, elevator 200 according to the present embodiment includes, within elevator carriage 210a, a second partition arranged below the first partition (partition 221), and a second elevator rail that includes a movable rail and is different from the first elevator rail. Note that the first elevator rail is elevator rail 32 arranged in second elevator space 212, and the second elevator rail is elevator rail 32 arranged in third elevator space 213. Moreover, the second partition is partition 222. The space within elevator carriage 210a is divided by the first partition and the second partition into first elevator space 211, second elevator space 212, and third elevator space 213 for unmanned transport vehicle 100 to board. Second elevator rail is disposed in third elevator space 213. Here, the movable rail of the second elevator rail, similar to the movable rail of the first elevator rail, is switched between a third rail state and a fourth rail state by actuation of an actuator. In the third rail state, the third end of the movable rail of the second elevator rail is connected to the fourth end of story rail 31 provided on a story (i.e., (N−1)th story) one below the predetermined story (i.e., the Nth story) of the building, and in the fourth rail state, the third end is not connected to the fourth end. Stated differently, elevator rail 32 in third elevator space 213 also has a similar configuration to elevator rail 32 in second elevator space 212 and performs similar operations.

As a result, because not only second elevator space 212 but also third elevator space 213 is used as a space for unmanned transport vehicles 100 to board, the transport volume of packages 1 transported by unmanned transport vehicles 100 can be significantly increased.

Stated differently, the elevator according to the present embodiment is an elevator provided in a building, and includes: an elevator carriage that moves up and down; a first partition and a second partition that divide the space within the elevator carriage. The space within the elevator carriage includes, sequentially from top to bottom vertically, a first second space for an unmanned transport vehicle to board, the first partition, a first space for a person to board, the second partition, and a second second space for an unmanned transport vehicle to board. The elevator also includes a first elevator rail arranged in the first second space for the unmanned transport vehicle to travel, and a second elevator rail arranged in the second second space for the unmanned transport vehicle to travel.

The first elevator rail includes a first movable rail, and the second elevator rail includes a second movable rail. The elevator further includes a first actuator that moves the first movable rail, and a second actuator that moves the second movable rail. The first movable rail is switched between a first first rail state and a first second rail state by actuation of the first actuator. In the first first rail state, a first first end of the first movable rail is connected to a first second end of a story rail provided on a predetermined story of the building. In the first second rail state, the first first end is not connected to the first second end. The second movable rail is switched between a second first rail state and a second second rail state by actuation of the second actuator. In the second first rail state, a second first end of the second movable rail is connected to a second second end of a story rail provided on a predetermined story of the building. In the second second rail state, the second first end is not connected to the second second end.

The elevator further includes a first rail lifting device that raises and lowers the first elevator rail, and a second rail lifting device that raises and lowers the second elevator rail.

In the above embodiment, elevator rail 32 includes a movable rail, but story rail 31 may also include a movable rail. Stated differently, the delivery system according to the present embodiment includes: elevator 200 installed in a building; story rail 31 that includes a movable rail and is provided on a predetermined story of the building; and an actuator that moves the movable rail. Elevator 200 includes: elevator carriage 210 that moves up and down; partition 221 that divides a space within elevator carriage 210 into a first space for a person to board and a second space for unmanned transport vehicle 100 to board; and elevator rail 32 that is arranged in second elevator space 212. Unmanned transport vehicle 100 travels along elevator rail 32. The movable rail of story rail 31 is switched between a first rail state and a second rail state by actuation of the actuator. In the first rail state, the first end of the movable rail is connected to the second end of elevator rail 32, and in the second rail state, the first end is not connected to the second end. Note that the delivery system may be office building delivery system Sy1 or apartment delivery system Sy2.

As a result, even if elevator rail 32 does not include a movable rail, because story rail 31 includes a movable rail, elevator rail 32 and story rail 31 can be coupled. As a result, unmanned transport vehicle 100 can easily enter and exit from elevator carriage 210.

### Embodiment 2

For example, it is conceivable to install a movable rail and an actuator for driving the movable rail at each intersection where story rails 31 installed on each story cross each other, to allow unmanned transport vehicle 100 to turn right or left. In such cases, a quantity of movable rails and actuators corresponding to the number of intersections would be required, resulting in an increase in the number of parts for the building as a whole, maintenance and inspection effort, and cost. However, in the present embodiment, movable rails and the like are not installed at intersections. At intersections, transferring from one rail to another rail is achieved by controlling unmanned transport vehicle 100 and/or an arm of unmanned transport vehicle 100. This prevents an increase in the number of parts and the like for the building. Note that the package transport device in Embodiments 2 to 4 corresponds to unmanned transport vehicle 100 of Embodiment 1. Hereinafter, the package transport device will be described in detail.

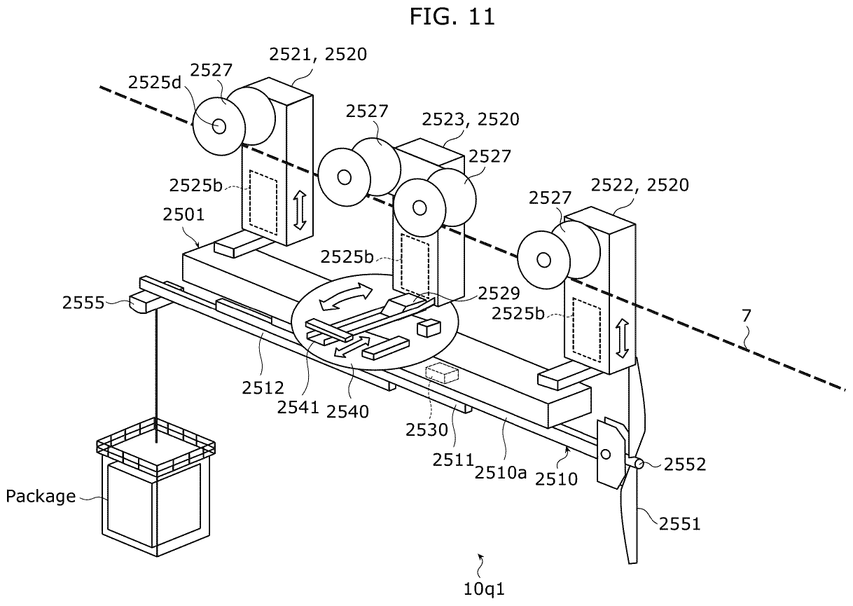

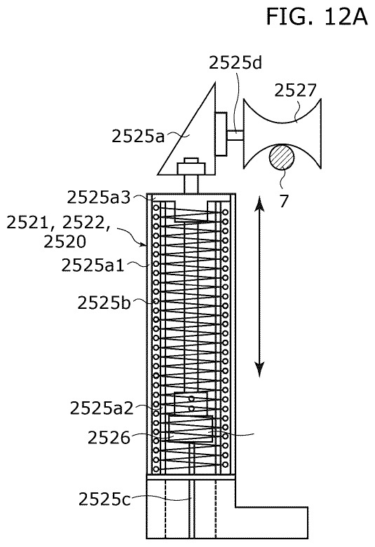

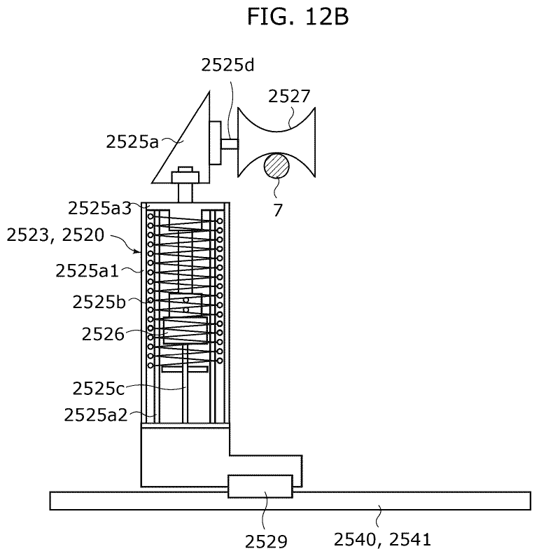

FIG. 11 is a perspective view illustrating an example of package transport device 10q1 according to Embodiment 2. FIG. 12A illustrates the internal structure of first connector 2521 and second connector 2522 of package transport device 10q1 according to Embodiment 2. FIG. 12B illustrates the internal structure of third connector 2523 of package transport device 10q1 according to Embodiment 2.

Package transport device 10q1 is an unmanned mobile body or the like that travels on rail 7. In other words, package transport device 10q1 can move along rail 7 provided above the ground that it is attached to. For example, package transport device 10q1 can carry a package from the delivery origin to the delivery destination while a plurality of connectors 2520 are connected to rail 7.

Package transport device 10q1 includes vehicle main body 2501, rail slider portion 2510, control processor 2530, a plurality of connectors 2520, turntable 2540, side propeller 2551, and propeller actuation motor 2552.

Vehicle main body 2501 is a rectangular enclosure elongated in the lengthwise direction of rail 7. The plurality of connectors 2520, turntable 2540, etc., are provided on the top of vehicle main body 2501. Rail slider portion 2510, etc., is provided on the bottom of vehicle main body 2501. Package transport device 10q1 may include a plurality of propellers that can fly vehicle main body 2501 by being rotationally driven by a propeller actuation motor.

Rail slider portion 2510 is extendable with respect to vehicle main body 2501. Rail slider portion 2510 includes slider main body 2510a, package holder 2555, and a motor actuator.

Slider main body 2510a is coupled to vehicle main body 2501. Slider main body 2510a is elongated in the lengthwise direction of vehicle main body 2501. In the present embodiment, slider main body 2510a is exemplified as coupled to the lower surface of vehicle main body 2501, but slider main body 2510a may be configured to extend in the lengthwise direction of vehicle main body 2501 and retract to the original position.

Slider main body 2510a includes first slider 2511 and second slider 2512. Although slider main body 2510a is exemplified as including two sliders, slider main body 2510a may include one or three or more sliders. Note that first slider 2511 and second slider 2512 and the like may be collectively referred to simply as “sliders”. Although not illustrated, a balancer may be provided on the side propeller 2551 side of the sliders to balance the weight with the package.

First slider 2511 and second slider 2512 are arranged on one side of vehicle main body 2501 and are configured to extend from the one side of vehicle main body 2501 further along the lengthwise direction of vehicle main body 2501 and retract to their original positions. First slider 2511, second slider 2512, and slider main body 2510a are aligned in listed order when first slider 2511 and second slider 2512 are extended away from vehicle main body 2501.

More specifically, first slider 2511 is arranged vertically below vehicle main body 2501, and can extend from the one side of vehicle main body 2501 along the lengthwise direction of vehicle main body 2501 so as to move away from vehicle main body 2501, and can retract to a position vertically below vehicle main body 2501. Second slider 2512 is coupled to the vertical lower surface of first slider 2511 and can extend from the one side of first slider 2511 along the lengthwise direction of vehicle main body 2501 so as to move away from vehicle main body 2501, and can retract to a position vertically below vehicle main body 2501.

Package holder 2555 is provided at the leading end of rail slider portion 2510. In the present embodiment, package holder 2555 is provided at the leading end of second slider 2512.

Package holder 2555 is arranged at one end of rail slider portion 2510 and can hold attached packages. Note that package holder 2555 is exemplified as provided at the leading end of second slider 2512, but there may be one or three or more sliders. In such cases, package holder 2555 is provided at the leading end of the slider farthest from vehicle main body 2501 when all sliders are extended.

Once package transport device 10q1 has arrived at rail 7 located in front of the delivery destination, control processor 2530 controls a motor capable of rotating turntable 2540 so as to rotate turntable 2540 and thus rotate third connector 2523.

After turntable 2540 rotates vehicle main body 2501, control processor 2530 controls the motor actuator so as to extend each of the sliders with respect to vehicle main body 2501. More specifically, control processor 2530 controls the motor actuator so as to extend first slider 2511 and second slider 2512 from vehicle main body 2501.

Control processor 2530 controls the rear propeller actuation motor 2552 for rotating side propeller 2551 to control the traveling speed of package transport device 10q1 (rotation speed of side propeller 2551) or stop the traveling of package transport device 10q1.

The motor actuator extends each of the sliders with respect to vehicle main body 2501. More specifically, in response to a control instruction from control processor 2530, the motor actuator extends first slider 2511 and second slider 2512 along the lengthwise direction of vehicle main body 2501 so as to move away from vehicle main body 2501.

Connector 2520 is held by (connected to) rail 7 located above vehicle main body 2501. More specifically, connector 2520 can be connected to rail 7 located at a position spaced apart from the ground surface with vehicle main body 2501 hanging from the connector. In the present embodiment, vehicle main body 2501 includes a plurality of connectors 2520. The plurality of connectors 2520 include first connector 2521, second connector 2522, and third connector 2523. In the present embodiment, three connectors 2520—namely first connector 2521, second connector 2522, and third connector 2523—are provided as the plurality of connectors 2520. However, the plurality of connectors 2520 may include two or four or more.

First connector 2521 is located on one side in the lengthwise direction of vehicle main body 2501. Second connector 2522 is located on the other side in the lengthwise direction of vehicle main body 2501. Third connector 2523 is located in the central region of vehicle main body 2501 between the one side and the other side in the lengthwise direction of vehicle main body 2501. Connectors 2520 are one example of the rail holder. First connector 2521 is one example of the first rail holder. Second connector 2522 is one example of the second rail holder. Third connector 2523 is one example of the third rail holder.

As illustrated in FIG. 12A and FIG. 12B, each of first connector 2521, second connector 2522, and third connector 2523 includes roller support portion 2525a, spring 2525b, shaft 2525c, slide motor 2526, roller 2527, and roller axle support 2525d.

Roller support portion 2525a can extend and retract along the vertical direction with respect to vehicle main body 2501.

More specifically, roller support portion 2525a includes outer enclosure 2525a1 and spring guide portion 2525a2.

Outer enclosure 2525a1 is an elongated, bottomed, cylindrical shape with a vertical upper opening, and houses spring 2525b and spring guide portion 2525a2 therein. Spring guide portion 2525a2 is an elongated, bottomed, cylindrical shape with a vertical downward opening, and houses slide motor 2526 and part of shaft 2525c therein. Flange 2525a3 for supporting one end of spring 2525b is formed at the vertical upper end portion of spring guide portion 2525a2. Spring 2525b is provided around the outer circumference of spring guide portion 2525a2.

Spring guide portion 2525a2 can move vertically upward with respect to outer enclosure 2525a1 by being driven by slide motor 2526. At this time, spring guide portion 2525a2 slides while being guided by outer enclosure 2525a1.

Spring 2525b is a coil spring and is provided around the outer circumference of spring guide portion 2525a2 while inserted into spring guide portion 2525a2. One end of spring 2525b is supported by flange 2525a3 of spring guide portion 2525a2, and the other end of spring 2525b is supported by the bottom of outer enclosure 2525a1.

When the driving by slide motor 2526 stops, the elastic force of spring 2525b causes spring 2525b to pull spring guide portion 2525a2, thereby moving spring guide portion 2525a2 vertically downward and housing spring guide portion 2525a2 inside outer enclosure 2525a1.

Shaft 2525c is inserted through outer enclosure 2525a1, and includes one end coupled to vehicle main body 2501 and another end provided with roller 2527 and roller axle support 2525d. Slide motor 2526 is attached to shaft 2525c. Part of shaft 2525c can move vertically upward by being driven by slide motor 2526.

More specifically, shaft 2525c extends in the vertical direction and includes a cylindrical first shaft and a cylindrical second shaft with a portion of the first shaft inserted inside. One end of the first shaft is a free end that is inserted inside the second shaft and can move vertically, and the other end of the first shaft is coupled to vehicle main body 2501. One end of the second shaft is coupled to the top end of spring guide portion 2525a2, and the other end of the second shaft is coupled to slide motor 2526. Therefore, when slide motor 2526 is driven, the second shaft moves vertically while being guided by the first shaft.

For example, slide motor 2526 is a stepping motor, and is housed inside spring guide portion 2525a2. Slide motor 2526 is controlled by control processor 2530 to apply a vertical upward force from outer enclosure 2525a1 to spring guide portion 2525a2 via shaft 2525c so that spring guide portion 2525a2 extends from outer enclosure 2525a1. Stated differently, slide motor 2526 can slide spring guide portion 2525a2 vertically upward with respect to outer enclosure 2525a1. Slide motor 2526 is one example of the motor.

Roller 2527 can travel on rail 7 by rotatably contacting rail 7. Roller 2527 is rotatably supported by roller axle support 2525d at the vertical upper end of roller support portion 2525a. A recess that can engage rail 7 is formed in roller 2527. This makes it difficult for this roller 2527 to derail from rail 7.

Roller axle support 2525d is fixed to the vertical upper end of roller support portion 2525a and extends in a direction orthogonal to the lengthwise direction of roller support portion 2525a. Roller axle support 2525d rotatably supports roller 2527 with respect to rail 7. Roller axle support 2525d may include an electric motor. In such cases, roller 2527 rotates by being coupled to the rotary shaft of the electric motor.

As illustrated in FIG. 12B, third connector 2523 further includes slide block 2529 that slides on slide rail 2541 provided on turntable 2540. Slide block 2529 is coupled to the vertical lower end of third connector 2523.

In the present embodiment, third connector 2523 is exemplified as including two rollers 2527 and two roller axle supports 2525d, but third connector 2523 may include three or more of each or one of each. Similarly, first connector 2521 and second connector 2522 are each exemplified as including one roller 2527 and one roller axle support 2525d, but first connector 2521 and second connector 2522 each may include two or more of each of these.

Here, roller 2527 of first connector 2521 is one example of the first rotating roller. Roller 2527 of second connector 2522 is one example of the second rotating roller. The two rollers 2527 of third connector 2523 are one example of the third rotating roller and the fourth rotating roller.

Turntable 2540 is provided on the upper surface of vehicle main body 2501, between vehicle main body 2501 and third connector 2523. Third connector 2523 is coupled to turntable 2540. In response to a control instruction from control processor 2530, turntable 2540 applies stress to rotate vehicle main body 2501. Accordingly, when third connector 2523 is connected to rail 7, turntable 2540 can rotate vehicle main body 2501 around center point O. With this, turntable 2540 rotates vehicle main body 2501 until the lengthwise direction of the frame approximately perpendicularly intersects the extending direction of rail 7.

Turntable 2540 includes a straight slide rail 2541 that includes the center of rotation. Slide block 2529 provided on third connector 2523 slides on slide rail 2541. Stoppers are arranged at both ends of slide rail 2541 to prevent slide block 2529 from coming off slide rail 2541.

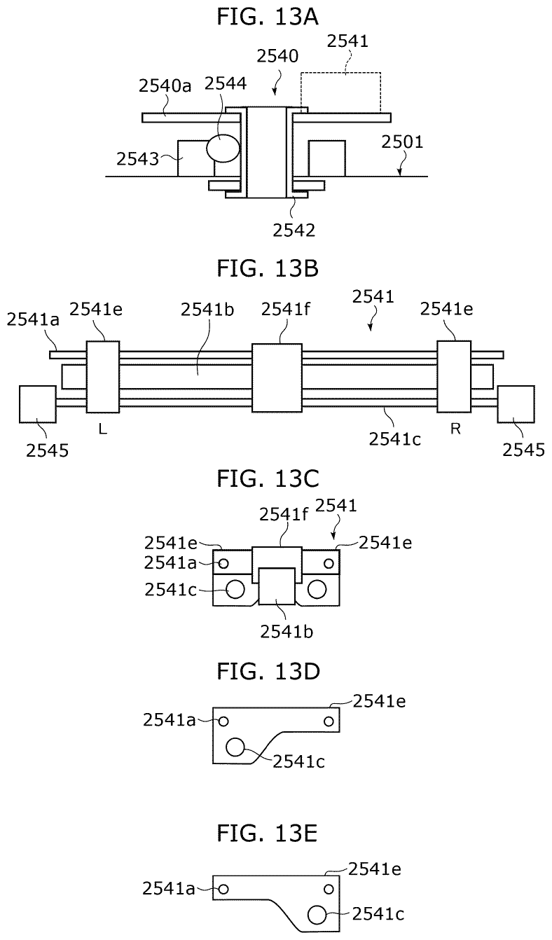

FIG. 13A illustrates an example of the internal structure of turntable 2540 of the package transport device according to Embodiment 2.

As illustrated in FIG. 13A, turntable 2540 includes rotary shaft 2542 and platform 2540a that is rotated by rotary shaft 2542. Rotary shaft 2542 extends in the vertical direction, orthogonal to the upper surface of vehicle main body 2501. Rotary shaft 2542 is driven by motor 2543 provided in vehicle main body 2501 being controlled by control processor 2530, which rotates via motor 2543 and worm 2544. Platform 2540a is coupled vertically above rotary shaft 2542. Platform 2540a is disc-shaped. Rotary shaft 2542 is coupled to the central region of platform 2540a. As illustrated in FIG. 11, slide rail 2541 is arranged on the upper surface of platform 2540a.

FIG. 13B is a side view illustrating an example of slide rail 2541 of package transport device 10q1 according to Embodiment 2. FIG. 13C is a front view illustrating an example of slide block 2529 of package transport device 10q1 according to Embodiment 2. Note that illustration of motor 2545 is omitted in FIG. 13C. FIG. 13D is a front view illustrating an example of the left side components, ball screw 2541c, and guide 2541a of slide block 2529 of package transport device 10q1 according to Embodiment 2. FIG. 13E is a front view illustrating an example of the right side components, ball screw 2541c, and guide 2541a of a slider of package transport device 10q1 according to Embodiment 2.

As illustrated in FIG. 13B through FIG. 13E, slide rail 2541 is, for example, a linear guide. Slide rail 2541 includes, for example, two guides 2541a, guide rail 2541b, two ball screws 2541c, and motor 2545. The two motors 2541d rotate the two ball screws 2541c in a one-to-one synchronized manner while the two guides 2541a maintain the attitude of slide block 2529, allowing slide block 2529 to move along the lengthwise direction of guide rail 2541b. Slide block 2529 includes, for example, two clutch blocks 2541e and linear block 2541f. Slide block 2529 can move along slide rail 2541 by motor 2545 provided in turntable 2540 being controlled by control processor 2530.

As illustrated in FIG. 11, side propeller 2551 is provided on the other side of vehicle main body 2501 (the side opposite the side in the traveling direction). Side propeller 2551 provides propulsion force to vehicle main body 2501 in a direction parallel to rail 7. More specifically, side propeller 2551 is rotated by propeller actuation motor 2552 attached to propeller support portion 22a9 to provide propulsion force to vehicle main body 2501.

Propeller actuation motor 2552 controls the rotation rate of side propeller 2551 in response to a control instruction from control processor 2530.

With package transport device 10q1 configured in this manner, roller 2527 can be separated from rail 7 by extending connector 2520. Similarly, roller 2527 can be placed on rail 7 by retracting connector 2520. Although all connectors 2520 are arranged on the right side in a view along the traveling direction in the example in FIG. 11, third connector 2523 can be arranged on the left side in a view along the traveling direction by rotating turntable 2540. By rotating turntable 2540 in a state in which only third connector 2523 is coupled to rail 7, vehicle main body 2501 rotates, which makes it possible to reverse the traveling direction of package transport device 10q1. Third connector 2523 can be transferred horizontally by moving slide block 2529 provided on slide rail 2541 of turntable 2540. Stated differently, rollers 2527 of third connector 2523 can be moved horizontally away from or closer to rail 7. First slider 2511 and second slider 2512 can also be extended to deliver the package to a location spaced horizontally away from package transport device 10q1.

### Variation of Embodiment 2

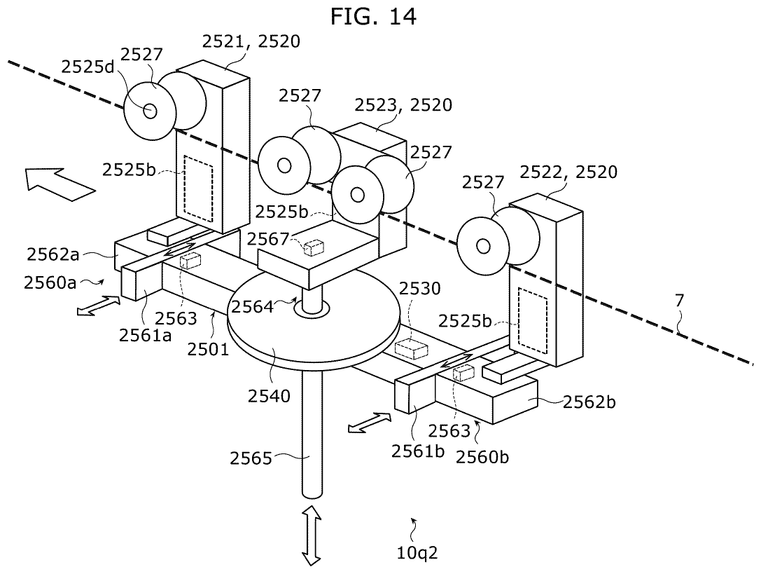

FIG. 14 is a perspective view illustrating an example of package transport device 10q2 according to a variation of Embodiment 2.

Hereinafter, as illustrated in FIG. 14, since the basic configuration of package transport device 10q2 according to the present variation is the same as the basic configuration of the package transport device according to Embodiment 2 and the like, regarding the basic configuration of package transport device 10q2 in the present variation, the same reference signs as above will be used and repeated description will be omitted where appropriate. Package transport device 10q2 according to the present variation differs from the package transport device according to Embodiment 2 in that first connector 2521, second connector 2522, turntable 2540, and third connector 2523 move with respect to vehicle main body 2501. Package transport device 10q2 according to the present variation does not include the slide rail of Embodiment 2, but may include a slide rail. Third connector 2523 of package transport device 10q2 does not include a lifting mechanism achieved by spring 2525b, slide motor 2526, etc.

Package transport device 10q2 according to the present variation includes first sliding mechanisms 2560a and 2560b that move first connector 2521 and second connector 2522.

First sliding mechanism 2560a is arranged between first connector 2521 and vehicle main body 2501 and extends with respect to vehicle main body 2501. First sliding mechanism 2560b is also arranged between first connector 2521 and vehicle main body 2501 and extends with respect to vehicle main body 2501. First sliding mechanism 2560a is one example of the second slider portion. First sliding mechanism 2560b is one example of the third slider portion.

More specifically, first sliding mechanism 2560a includes connector support portion 2562a that slides in a direction that is horizontal and orthogonal to the lengthwise direction of vehicle main body 2501, and slide main body portion 2561a that slidably supports connector support portion 2562a. First sliding mechanism 2560b includes connector support portion 2562b that slides in a direction orthogonal to the lengthwise direction of vehicle main body 2501 and in the horizontal direction, and slide main body portion 2561b that slidably supports connector support portion 2562b.

Connector support portion 2562a is provided on the front (the side in the traveling direction) and on the rear (the side opposite the traveling direction side) of vehicle main body 2501, and connector support portion 2562b is provided on the front (the side in the traveling direction) and on the rear (the side opposite the traveling direction side) of vehicle main body 2501. Connector support portions 2562a and 2562b slide in the lengthwise direction of slide main body portions 2561a and 2561b, which is a horizontal direction. More specifically, connector support portions 2562a and 2562b slide in a direction that is orthogonal to the lengthwise direction of vehicle main body 2501 and approximately parallel to the horizontal direction.

Slide main body portions 2561a and 2561b are elongated in a predetermined direction with respect to vehicle main body 2501 and are connected to vehicle main body 2501. More specifically, slide main body portions 2561a and 2561b are provided horizontally relative to the lengthwise direction of vehicle main body 2501 by slide motor 2563 provided in vehicle main body 2501. Accordingly, slide main body portions 2561a and 2561b guide connector support portions 2562a and 2562b in a direction orthogonal to the lengthwise direction of vehicle main body 2501.

Slide motor 2563 is provided on vehicle main body 2501 and controlled by control processor 2530 so as to move slide main body portions 2561a and 2561b vertically with respect to vehicle main body 2501.

Package transport device 10q2 according to the present variation further includes second sliding mechanism 2564 that moves turntable 2540 and third connector 2523 vertically.

Second sliding mechanism 2564 includes turntable 2540, shaft motor 2567, and shaft 2565 that is inserted through turntable 2540 and coupled to third connector 2523.

Turntable 2540 is disposed between third connector 2523 and vehicle main body 2501. After extending first sliding mechanism 2560a and first sliding mechanism 2560b and separating first connector 2521 and second connector 2522 from the rail, turntable 2540 rotates vehicle main body 2501 under control by control processor 2530.

Shaft motor 2567 is controlled by control processor 2530 so as to move shaft 2565 vertically with respect to vehicle main body 2501 and turntable 2540.

Shaft 2565 inserts through the center of turntable 2540, and third connector 2523 is coupled to the vertical upper end of shaft 2565. Shaft motor 2567 can be controlled by control processor 2530 to move shaft 2565 vertically.

### Embodiment 3

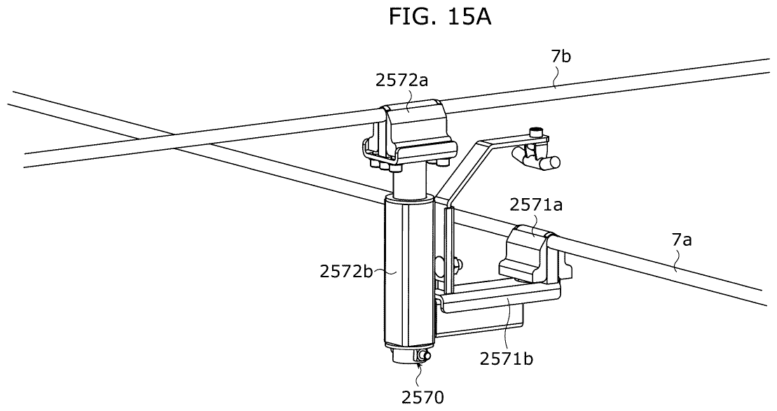

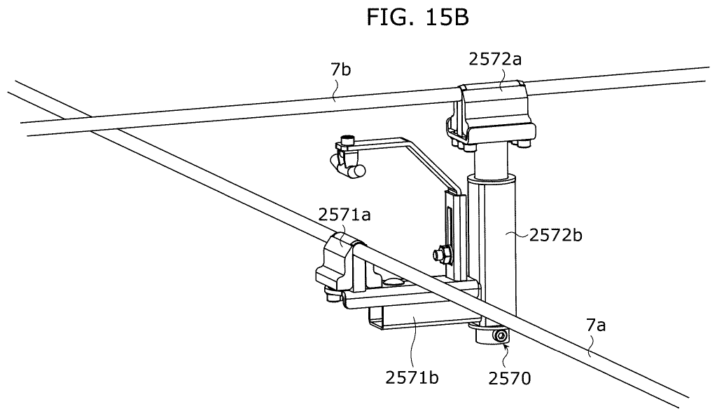

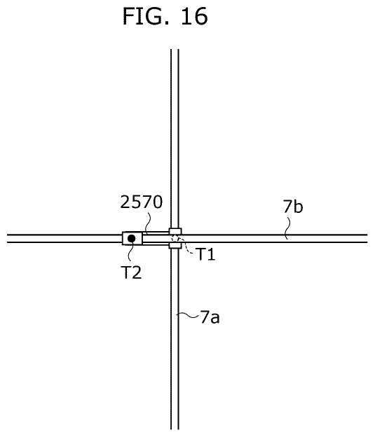

FIG. 15A is a perspective view illustrating an example of rail 7 and rail coupling 2570 according to Embodiment 3. FIG. 15B is another perspective view illustrating an example of rail 7 and rail coupling 2570 according to Embodiment 3. FIG. 16 is a perspective view illustrating first coupling point T1 of first rail 7a and second coupling point T2 of second rail 7b according to Embodiment 3.

The present embodiment gives an example in which first rail 7a and second rail 7b are coupled by rail coupling 2570.

Rail coupling 2570 has an L-shape or inverted L-shape and can couple first rail 7a and second rail 7b at the point where first rail 7a and second rail 7b intersect three-dimensionally. FIG. 15A illustrates rail coupling 2570 that is L-shaped in a view along the lengthwise direction of first rail 7a, i.e., positioned on the left side in a view along the traveling direction. FIG. 15B illustrates rail coupling 2570 that is inverted L-shaped in a view along the lengthwise direction of first rail 7a, i.e., positioned on the right side in a view along the traveling direction.

Rail coupling 2570 can also couple first rail 7a to second rail 7b so that first rail 7a is inverted L-shaped in a view along the lengthwise direction of first rail 7a.

Rail coupling 2570 includes first rail coupler 2571a, first rail extension 2571b, second rail coupler 2572a, and second rail extension 2572b.

First rail coupler 2571a couples to first rail 7a. More specifically, first rail 7a is inserted into a first insertion hole of first rail coupler 2571a to couple first rail coupler 2571a to first rail 7a. The vertical lower surface of first rail coupler 2571a is connected to first rail extension 2571b.

One end of first rail extension 2571b is connected to first rail coupler 2571a, and the other end of first rail extension 2571b is connected to the other end of second rail coupler 2572a. First rail extension 2571b extends from first rail coupler 2571a in a direction that is orthogonal to the lengthwise direction of first rail 7a and horizontal.

Second rail coupler 2572a couples to second rail 7b. More specifically, second rail 7b is inserted into a second insertion hole of second rail coupler 2572a to couple second rail coupler 2572a to second rail 7b. The vertical lower surface of second rail coupler 2572a is connected to second rail extension 2572b.

One end of second rail extension 2572b is connected to second rail coupler 2572a, and the other end of second rail extension 2572b is connected to the other end of first rail coupler 2571a. Second rail extension 2572b extends from second rail coupler 2572a in a direction that is orthogonal to the lengthwise direction of second rail 7b and vertical.

Thus, as illustrated in FIG. 15A through FIG. 16, rail coupling 2570 is coupled to second rail 7b at a position farther from a position on second rail 7b vertically above first coupling point T1 where rail coupling 2570 is coupled to first rail 7a. Stated differently, second rail coupler 2572a and second rail extension 2572b are positioned away from first rail 7a. In other words, in a view of first rail 7a and second rail 7b in the vertical direction, first coupling point T1 of rail coupling 2570 and first rail 7a and second coupling point T2 of rail coupling 2570 and second rail 7b do not overlap, but are spaced apart from each other. Thus, a space is formed between first rail 7a and second rail coupler 2572a for rollers 2527 of package transport device 10q2 to pass through.

Therefore, in FIG. 15A, it is easy for package transport device 10q2 to turn right from first rail 7a to second rail 7b. In FIG. 15B, it is easy for package transport device 10q2 to turn left from first rail 7a to second rail 7b.

Note that package transport device 10q2 is capable of turning left in FIG. 15A and capable of turning right in FIG. 15B.

### Embodiment 4

Hereinafter, since the basic configuration of package transport device 10q1 according to the present embodiment is the same as the basic configuration of the package transport device according to Embodiment 2 and the like, regarding the basic configuration of package transport device 10q1 in the present embodiment, the same reference signs as above will be used and repeated description will be omitted where appropriate. The present embodiment may also be used with lifting systems, unmanned aerial vehicles, and delivery boxes according to embodiments other than Embodiment 1.

### Operation Example 1

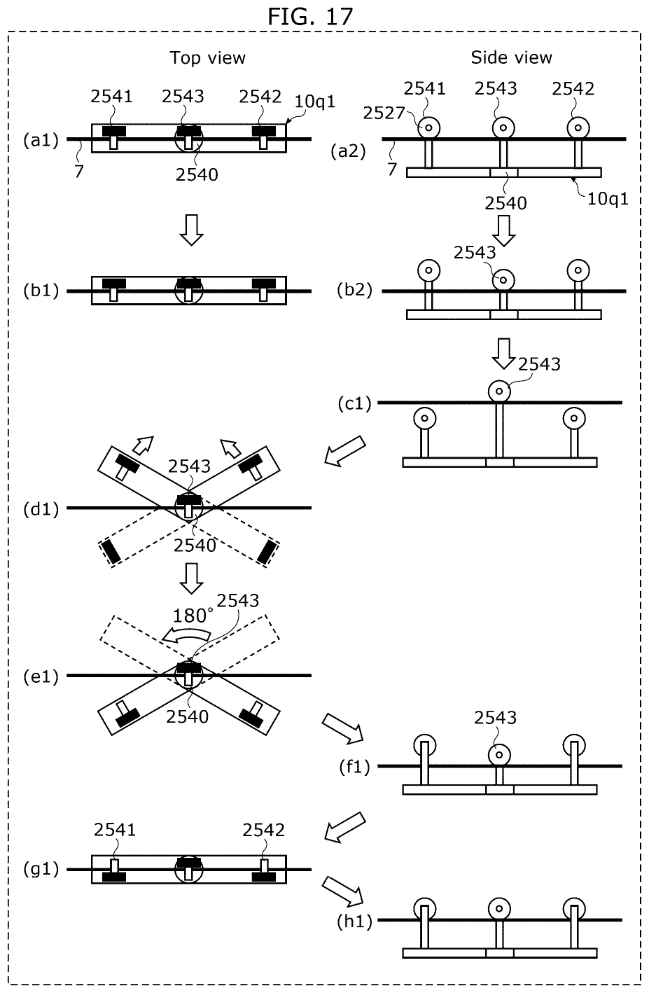

FIG. 17 is a top view and a side view illustrating an operation of package transport device 10q1 according to Embodiment 4. This operation example illustrates a case in which package transport device 10q1 rotates vehicle main body 180° on rail 7. This example assumes that package transport device 10q1 is stopped on rail 7 and first connector 2521, second connector 2522, and third connector 2523 of package transport device 10q1 are coupled to rail 7.

First, as illustrated in (a1) and (a2) in FIG. 17, the control processor of package transport device 10q1 controls the slide motor of third connector 2523 so as to retract third connector 2523 of package transport device 10q1.

As illustrated in (b1) and (b2) in FIG. 17, this lifts the vehicle main body of package transport device 10q1, and rollers 2527 of first connector 2521 and second connector 2522 separate from rail 7. At this time, since first connector 2521, second connector 2522, and third connector 2523 are coupled offset from the center of the vehicle main body toward one side of the vehicle main body, the vehicle main body is tilted with respect to the horizontal plane. The control processor may control, for example, the slide rail of turntable 2540 so as to tilt the vehicle main body and shift the position of third connector 2523 with respect to the vehicle main body.

Next, as illustrated in (c1) in FIG. 17, the control processor of package transport device 10q1 controls the slide motor of third connector 2523 so as to extend third connector 2523 of package transport device 10q1. Thus, rollers 2527 of first connector 2521 and second connector 2522 are positioned vertically below rail 7, without first connector 2521 and second connector 2522 contacting rail 7.

Next, as illustrated in (d1) and (e1) in FIG. 17, the control processor of package transport device 10q1 controls turntable 2540 so as to rotate it 180°. This will reverse the orientation of package transport device 10q1.

Next, as illustrated in (f1) in FIG. 17, the control processor of package transport device 10q1 controls the slide motor of third connector 2523 so as to retract third connector 2523 of package transport device 10q1. This lifts the vehicle main body of package transport device 10q1 and places rollers 2527 of first connector 2521 and second connector 2522 vertically above rail 7. This also places first connector 2521 and second connector 2522 on the opposite side of rail 7 that third connector 2523 is on. At this time, since third connector 2523 is offset from the center of the vehicle main body toward one side of the vehicle main body, and first connector 2521 and second connector 2522 are offset from the center of the vehicle main body toward the other side of the vehicle main body, the vehicle main body is approximately parallel to the horizontal plane or slightly inclined to the other side of the vehicle main body.

Next, as illustrated in (g1) and (h1) in FIG. 17, the control processor of package transport device 10q1 controls the slide motor of third connector 2523 so as to return third connector 2523 of package transport device 10q1 to its original length. This places rollers 2527 of first connector 2521 and second connector 2522 on rail 7. Package transport device 10q1 then begins traveling.

The control processor of package transport device 10q1 may also control the slide motor of third connector 2523 so as to extend third connector 2523 of package transport device 10q1 and separate roller 2527 of third connector 2523 from rail 7. The control processor of package transport device 10q1 controls the slide motor of third connector 2523 so as to retract third connector 2523 of package transport device 10q1 and place roller 2527 of third connector 2523 vertically below rail 7. Next, the control processor of package transport device 10q1 controls turntable 2540 so as to rotate it 180°. This places third connector 2523 on the other side of the vehicle main body along with first connector 2521 and second connector 2522. Package transport device 10q1 then begins traveling.

### Operation Example 2

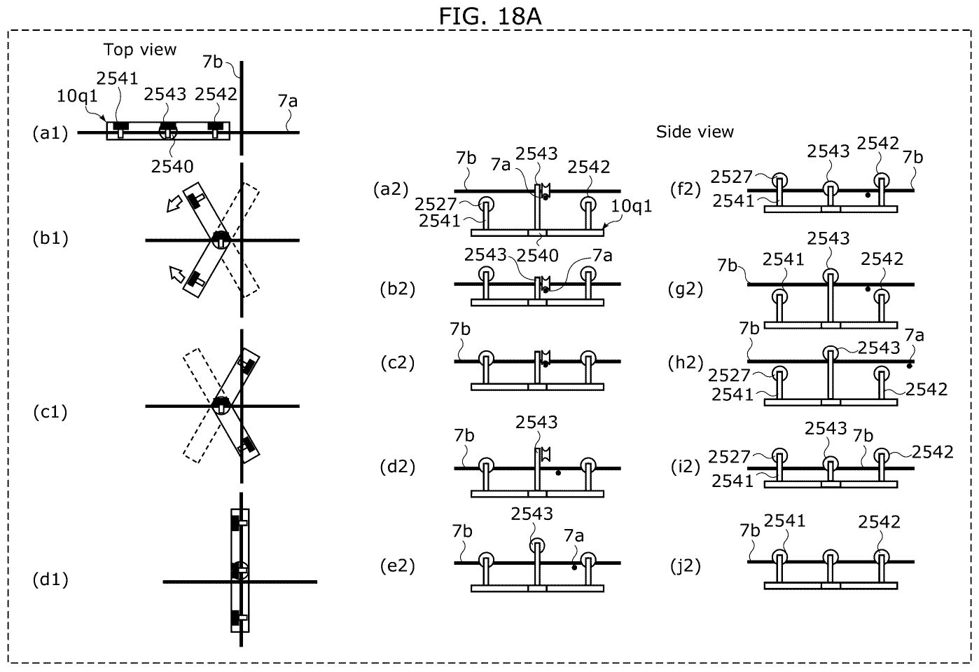

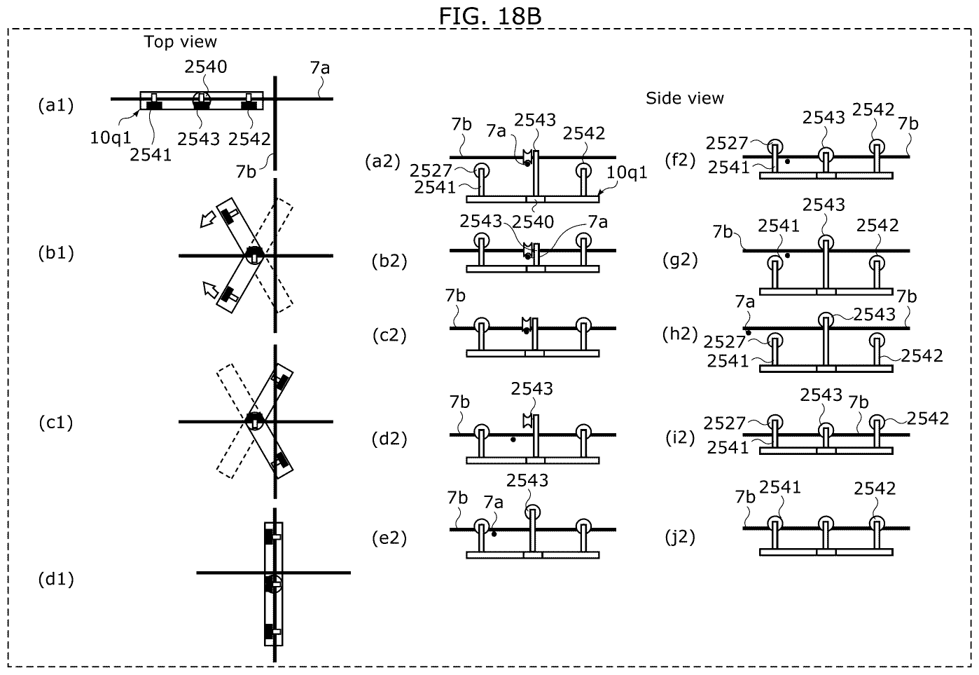

FIG. 18A is a top view and a side view illustrating an operation in which package transport device 10q1 according to Embodiment 4 turns left at the intersection of first rail 7a and second rail 7b.

FIG. 18A assumes a left turn is made from first rail 7a to second rail 7b. Moreover, it is assumed that first rail 7a and second rail 7b are coupled by the rail coupling of FIG. 15B, i.e., a rail coupling located on the right side when viewed along first rail 7a. First connector 2521, second connector 2522, and third connector 2523 of package transport device 10q1 are assumed to be located on the opposite side of first rail 7a from the side where the rail coupling is located. This example assumes that package transport device 10q1 is stopped on first rail 7a and first connector 2521, second connector 2522, and third connector 2523 of package transport device 10q1 are coupled to first rail 7a.

First, as illustrated in (a1) in FIG. 18A, the control processor of package transport device 10q1 controls the slide motor of third connector 2523 so as to retract third connector 2523 of package transport device 10q1. This lifts the vehicle main body of package transport device 10q1 and separates rollers 2527 of first connector 2521 and second connector 2522 from first rail 7a. Next, the control processor of package transport device 10q1 controls the slide motor of third connector 2523 so as to extend third connector 2523 of package transport device 10q1. Thus, rollers 2527 of first connector 2521 and second connector 2522 are positioned vertically below first rail 7a, without first connector 2521 and second connector 2522 contacting first rail 7a or second rail 7b.

Next, as illustrated in (b1) and (c1) in FIG. 18A, the control processor of package transport device 10q1 controls turntable 2540 so as to rotate it 90° counterclockwise.

This places package transport device 10q1 in an attitude where the lengthwise direction of package transport device 10q1 is parallel to the lengthwise direction of the second rail, as illustrated in (a2) in FIG. 18A. In other words, this places rollers 2527 of first connector 2521 and second connector 2522 vertically below second rail 7b.

Next, as illustrated in (b2) in FIG. 18A, the control processor of package transport device 10q1 controls the slide motor of third connector 2523 so as to retract third connector 2523 of package transport device 10q1. This lifts the vehicle main body of package transport device 10q1 and places rollers 2527 of first connector 2521 and second connector 2522 vertically above second rail 7b.

Next, as illustrated in (c2) in FIG. 18A, the control processor of package transport device 10q1 controls the slide motor of third connector 2523 so as to return third connector 2523 of package transport device 10q1 to its original length. This places rollers 2527 of first connector 2521 and second connector 2522 on second rail 7b.

Next, as illustrated in (d2) in FIG. 18A, the control processor of package transport device 10q1 controls the slide motor of third connector 2523 so as to extend third connector 2523 of package transport device 10q1 and move roller 2527 of third connector 2523 away from first rail 7a. At this time, roller 2527 of third connector 2523 is vertically above first rail 7a and second rail 7b.

Next, as illustrated in (e2) in FIG. 18A, the control processor of package transport device 10q1 controls turntable 2540 so as to rotate it 90° clockwise. This places roller 2527 of third connector 2523 vertically above second rail 7b. The control processor of package transport device 10q1 controls the motor of first connector 2521 and the motor of second connector 2522 so as to rotate rollers 2527 to slightly advance second connector 2522 closer to first rail 7a.

Next, as illustrated in (f2) in FIG. 18A, the control processor of package transport device 10q1 controls the slide motor of third connector 2523 so as to retract third connector 2523 of package transport device 10q1. This lifts the vehicle main body of package transport device 10q1 and separates rollers 2527 of first connector 2521 and second connector 2522 from second rail 7b.

Next, as illustrated in (g2) in FIG. 18A, the control processor of package transport device 10q1 controls the slide motor of third connector 2523 so as to extend third connector 2523 of package transport device 10q1. Thus, rollers 2527 of first connector 2521 and second connector 2522 are positioned vertically below second rail 7b, without first connector 2521 and second connector 2522 contacting first rail 7a or second rail 7b.

Next, as illustrated in (h2) in FIG. 18A, the control processor of package transport device 10q1 controls the motor of third connector 2523 so as to move second connector 2522 forward until it passes first rail 7a.

Next, as illustrated in (i2) in FIG. 18A, the control processor of package transport device 10q1 controls the slide motor of third connector 2523 so as to retract third connector 2523 of package transport device 10q1 and place rollers 2527 of first connector 2521 and second connector 2522 vertically above second rail 7b.

Next, as illustrated in (j2) in FIG. 18A, the control processor of package transport device 10q1 controls the slide motor of third connector 2523 so as to return third connector 2523 of package transport device 10q1 to its original length. This places rollers 2527 of first connector 2521 and second connector 2522 on second rail 7b.

Package transport device 10q1 then begins traveling.

While FIG. 18A illustrates a case in which a left turn is made, FIG. 18B illustrates a case in which a right turn is made.

FIG. 18B is a top view and a side view illustrating an operation in which the package transport device according to Embodiment 4 turns right at the intersection of the first rail and the second rail. Since the operation in the case of a right turn is the same as the operation in the case of a left turn as illustrated in FIG. 18A, repeated description will be omitted where appropriate.

FIG. 18B assumes a right turn is made from first rail 7a to second rail 7b. Moreover, it is assumed that first rail 7a and second rail 7b are coupled by the rail coupling of FIG. 15A, i.e., a rail coupling located on the left side when viewed along first rail 7a. First connector 2521, second connector 2522, and third connector 2523 of package transport device 10q1 are assumed to be located on the opposite side of first rail 7a from the side where the rail coupling is located. This example assumes that package transport device 10q1 is stopped on first rail 7a and first connector 2521, second connector 2522, and third connector 2523 of package transport device 10q1 are coupled to first rail 7a.

First, as illustrated in (a1) in FIG. 18B, the control processor of package transport device 10q1 controls the slide motor of third connector 2523 so as to retract third connector 2523 of package transport device 10q1. This lifts the vehicle main body of package transport device 10q1 and separates rollers 2527 of first connector 2521 and second connector 2522 from first rail 7a. Next, the control processor of package transport device 10q1 controls the slide motor of third connector 2523 so as to extend third connector 2523 of package transport device 10q1. Thus, rollers 2527 of first connector 2521 and second connector 2522 are positioned vertically below first rail 7a, without first connector 2521 and second connector 2522 contacting first rail 7a or second rail 7b.

Next, as illustrated in (b1) and (c1) in FIG. 18B, the control processor of package transport device 10q1 controls turntable 2540 so as to rotate it 90° clockwise.

This places package transport device 10q1 in an attitude where the lengthwise direction of package transport device 10q1 is parallel to the lengthwise direction of the second rail, as illustrated in (a2) in FIG. 18B. In other words, this places rollers 2527 of first connector 2521 and second connector 2522 vertically below second rail 7b.

Next, as illustrated in (b2) in FIG. 18B, the control processor of package transport device 10q1 controls the slide motor of third connector 2523 so as to retract third connector 2523 of package transport device 10q1. This lifts the vehicle main body of package transport device 10q1 and places rollers 2527 of first connector 2521 and second connector 2522 vertically above second rail 7b.

Next, as illustrated in (c2) in FIG. 18B, the control processor of package transport device 10q1 controls the slide motor of third connector 2523 so as to return third connector 2523 of package transport device 10q1 to its original length. This places rollers 2527 of first connector 2521 and second connector 2522 on second rail 7b.

Next, as illustrated in (d2) in FIG. 18B, the control processor of package transport device 10q1 controls the slide motor of third connector 2523 so as to extend third connector 2523 of package transport device 10q1 and move roller 2527 of third connector 2523 away from first rail 7a. At this time, roller 2527 of third connector 2523 is vertically above first rail 7a and second rail 7b.

Next, as illustrated in (e2) in FIG. 18B, the control processor of package transport device 10q1 controls turntable 2540 so as to rotate it 90° counterclockwise. This places roller 2527 of third connector 2523 vertically above second rail 7b. The control processor of package transport device 10q1 controls the motor of first connector 2521 and the motor of second connector 2522 so as to rotate rollers 2527 to slightly advance first connector 2521 closer to first rail 7a.

Next, as illustrated in (f2) in FIG. 18B, the control processor of package transport device 10q1 controls the slide motor of third connector 2523 so as to retract third connector 2523 of package transport device 10q1. This lifts the vehicle main body of package transport device 10q1 and separates rollers 2527 of first connector 2521 and second connector 2522 from second rail 7b.

Next, as illustrated in (g2) in FIG. 18B, the control processor of package transport device 10q1 controls the slide motor of third connector 2523 so as to extend third connector 2523 of package transport device 10q1. Thus, rollers 2527 of first connector 2521 and second connector 2522 are positioned vertically below second rail 7b, without first connector 2521 and second connector 2522 contacting first rail 7a or second rail 7b.

Next, as illustrated in (h2) in FIG. 18B, the control processor of package transport device 10q1 controls the motor of third connector 2523 so as to move first connector 2521 forward until it passes first rail 7a.

Next, as illustrated in (i2) in FIG. 18B, the control processor of package transport device 10q1 controls the slide motor of third connector 2523 so as to retract third connector 2523 of package transport device 10q1 and place rollers 2527 of first connector 2521 and second connector 2522 vertically above second rail 7b.

Next, as illustrated in (j2) in FIG. 18B, the control processor of package transport device 10q1 controls the slide motor of third connector 2523 so as to return third connector 2523 of package transport device 10q1 to its original length. This places rollers 2527 of first connector 2521 and second connector 2522 on second rail 7b.

Package transport device 10q1 then begins traveling.

Note that even in the case of the rail coupling of FIG. 15A, package transport device 10q1 can still turn left, and even in the case of the rail coupling of FIG. 15B, package transport device 10q1 can still turn right.

### Embodiment 5

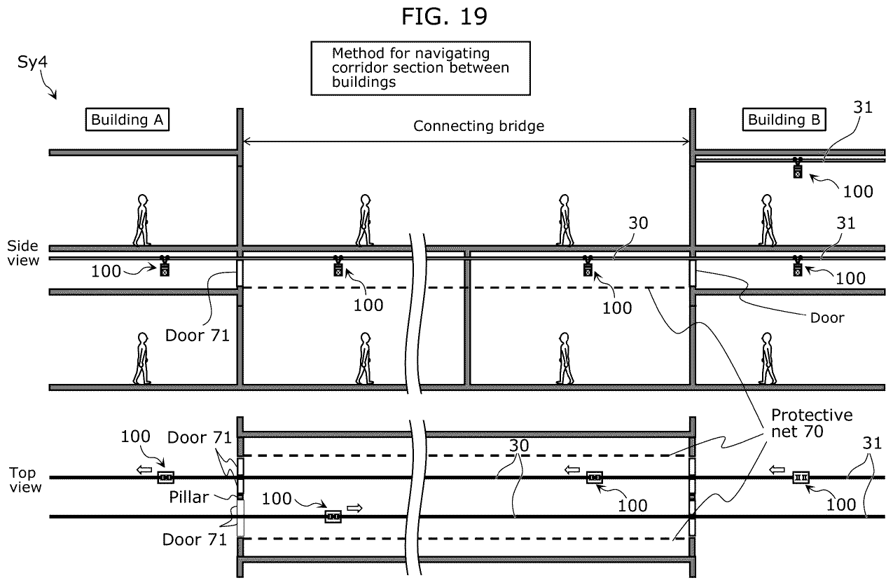

FIG. 19 illustrates an example of a configuration of a logistics system according to the present embodiment.

Logistics system Sy4 according to the present embodiment includes, for example, office building delivery system Sy1 installed in Building A, office building delivery system Sy1 installed in Building B, and a connection mechanism that connects these office building delivery systems Sy1. The connection mechanism is installed on a connecting bridge that connects Building A and Building B, and includes transport rail 30 provided along the connecting bridge, protective net 70, and a plurality of doors 71. Protective net 70 is disposed below transport rail 30. Therefore, even if unmanned transport vehicle 100 traveling on transport rail 30 drops package 1, the protective net can prevent package 1 from falling to the floor, or prevent package 1 from falling onto the head of a person walking on the connecting bridge. Since doors 71 are provided at the boundaries between the connecting bridge and Building A and Building B, it is possible to inhibit, for example, birds from entering Building A and Building B.

### Embodiment 6

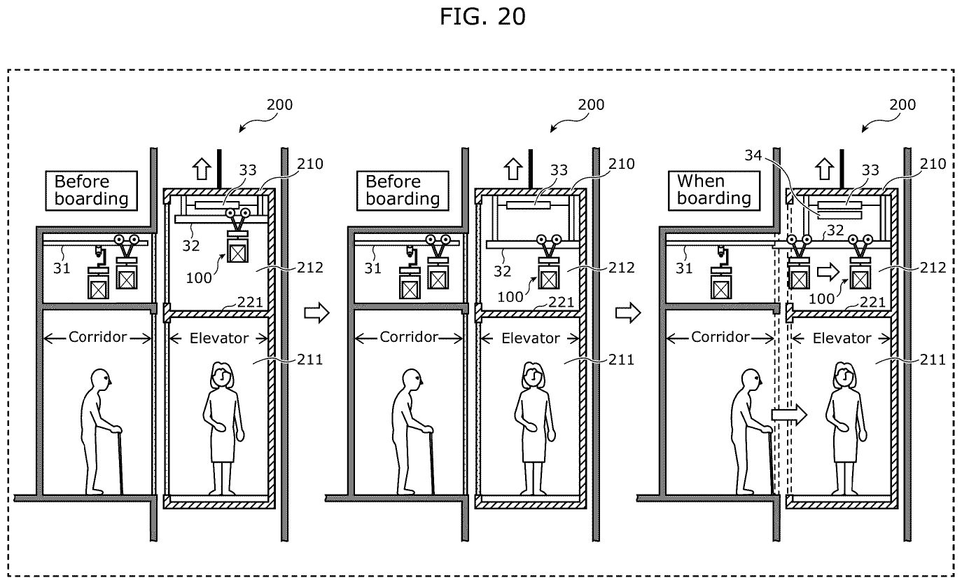

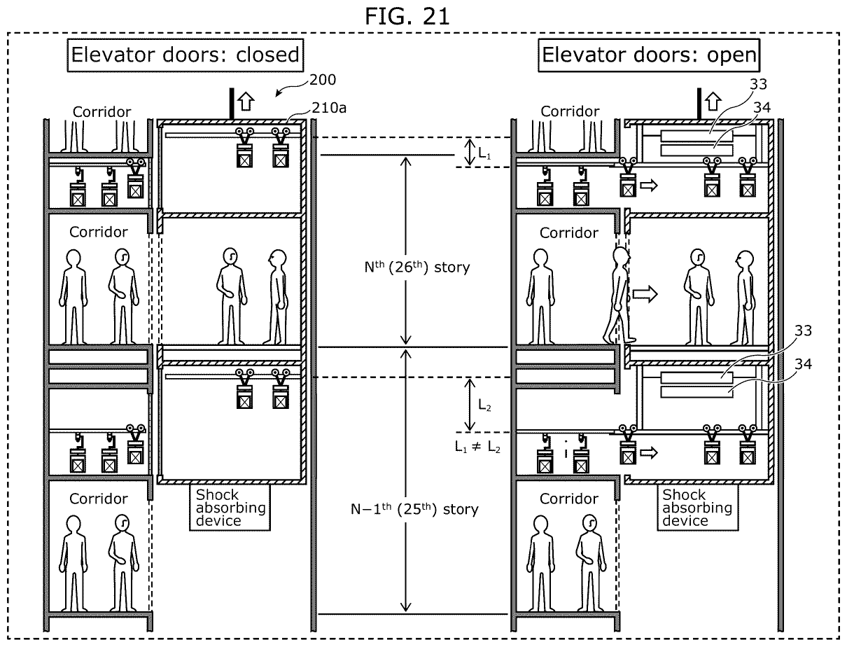

FIG. 20 illustrates an example of an elevator of apartment delivery system Sy2 according to the present embodiment.

In the example illustrated in FIG. 20, elevator 200 includes rail lifting device 33 and rail extension-contraction device 34. Note that rail extension-contraction device 34 is a device that includes an actuator for extending and contracting elevator rail 32 by moving the above-mentioned movable rail 32a included in elevator rail 32 in the horizontal direction. Rail extension-contraction device 34 may be called a rail horizontal movement device.

When the stories of the building have varying story heights, a mechanism for adjusting the height of elevator rail 32 is necessary each time elevator carriage 210 arrives at a story. Therefore, in the present embodiment, as illustrated in FIG. 20, rail lifting device 33 aligns the height of elevator rail 32 with the height of story rail 31.

Stated differently, elevator carriage 210 includes rail lifting device 33 that raises and lowers elevator rail 32. According to the above aspect, even if the story heights of stories of the building vary, rail lifting device 33 can appropriately align the height of elevator rail 32 with the height of story rail 31. Rail lifting device 33 is configured to change the distance between elevator rail 32 and the ceiling of second elevator space 212 according to the story height of each story of the building. The first story height of a first predetermined story of the building is different from the second story height of a second predetermined story of the building. In such cases, elevator rail 32 is in a first first rail state in the first predetermined story of the building, and in a second first rail state in the second predetermined story of the building. Here, a first distance between elevator rail 32 and the ceiling of second elevator space 212 in the first first rail state is different from a second distance between elevator rail 32 and the ceiling of second elevator space 212 in the second first rail state. The absolute value of the difference between the first story height and the second story height is equal to the absolute value of the difference between the first distance and the second distance.

Thus, elevator 200 according to the present embodiment is an elevator provided in a building, and includes: elevator carriage 210 that moves up and down; partition 221 that divides a space within elevator carriage 210 into first elevator space 211 for a person to board and second elevator space 212 for unmanned transport vehicle 100 to board; elevator rail 32 that is arranged in second elevator space 212; and rail lifting device 33 that raises and lowers elevator rail 32. Unmanned transport vehicle 100 travels along elevator rail 32. Rail lifting device 33 is configured to change the distance between elevator rail 32 and the ceiling of second elevator space 212 according to the story height of each story of that building.

FIG. 21 illustrates an example of elevator 200 of office building delivery system Sy1 according to the present embodiment. As illustrated in FIG. 21, elevator 200 of office building delivery system Sy1 may also include rail lifting device 33 and rail extension-contraction device 34, similar to the example in FIG. 20.

The first story height of an Nth story (where N is an arbitrary natural number) of the building is different from the second story height of an (N−1)th story of the building. In such cases, elevator rail 32 is in a first first rail state in the Nth story of the building, and in a second first rail state in the (N−1)th story of the building. Here, a first distance between elevator rail 32 and the ceiling of second elevator space 212 in the first first rail state is different from a second distance between elevator rail 32 and the ceiling of second elevator space 212 in the second first rail state. Stated differently, first distance L1 between elevator rail 32 and a reference position in the first first rail state is different from second distance L2 between elevator rail 32 and a reference position in the second first rail state.

### Embodiment 7

Unmanned transport vehicle 100 according to Embodiments 1 to 6 travels along one rail. On the other hand, unmanned transport vehicle 110 according to the present embodiment travels along two rails.

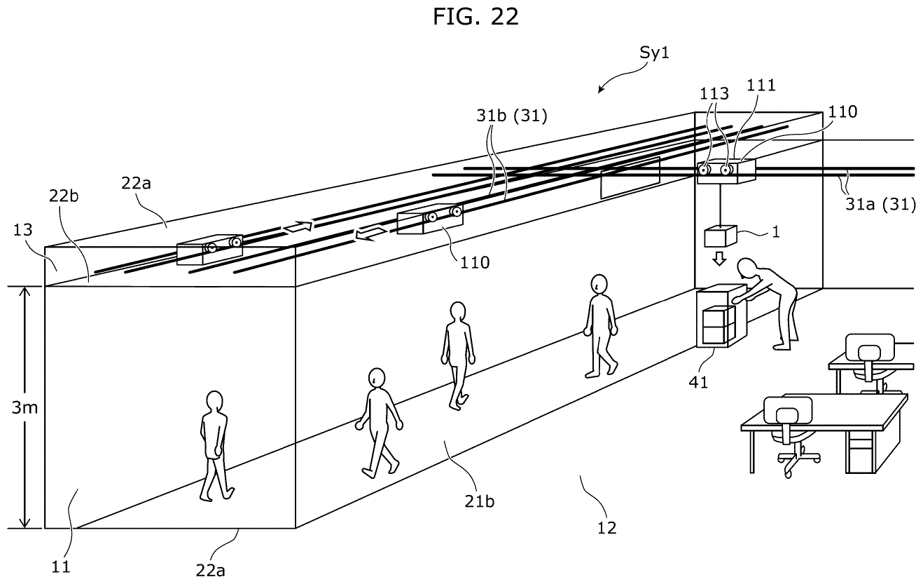

FIG. 22 illustrates an example of a configuration of office building delivery system Sy1 according to the present embodiment. Note that FIG. 22 illustrates, similar to FIG. 1, a bird's-eye view of one story among a plurality of stories in an office building in which office building delivery system Sy1 is installed.

Office building delivery system Sy1 according to the present embodiment is installed in a story area of the office building. Third story space 13 in the story area illustrated in FIG. 22 is, for example, narrower in the height direction than third story space 13 illustrated in FIG. 1. Therefore, in the present embodiment, unmanned transport vehicle 110 is configured to be shorter than unmanned transport vehicle 100 so that it can travel even within the narrow third story space 13, and travels along a pair of story rails 31 arranged parallel to each other on a horizontal plane. Note that a plurality of pairs of story rails 31 are installed in third story space 13, and a pair of first story rails 31a and a pair of second story rails 31b included in the plurality of pairs of story rails 31 are perpendicular to each other.

For example, unmanned transport vehicle 110 includes four wheels 113 arranged on a virtual plane (for example, a horizontal plane), two of the four wheels 113 are placed on one rail in the pair of story rails 31, and the remaining two wheels 113 are placed on the other rail in the pair of story rails 31. Enclosure 111 of unmanned transport vehicle 110 is arranged so as to be sandwiched between the pair of story rails 31. Note that in the following description, the left-right direction of unmanned transport vehicle 110 is a direction extending along the axle of each of the four wheels 113, and the anteroposterior direction of unmanned transport vehicle 110 is a direction that extends along the above-mentioned plane on which the four wheels 113 are arranged and is perpendicular to the left-right direction.

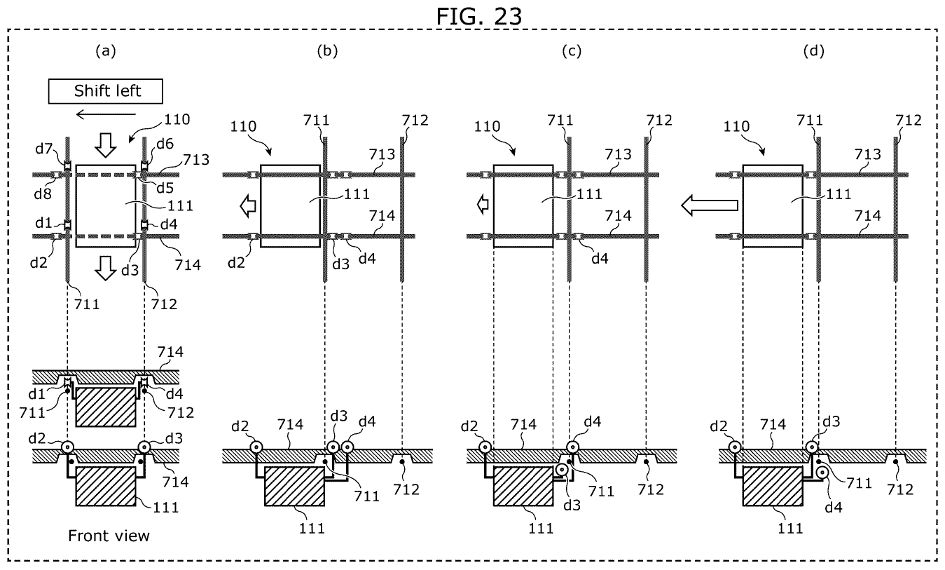

FIG. 23 illustrates an example of an operation in which unmanned transport vehicle 110 transfers from one pair of rails to another pair of rails.

For example, rails 711 and 712 forming one pair of rails and rails 713 and 714 forming another pair of rails intersect perpendicularly. Note that rails 711 and 712 may be a pair of story rails 31 or a pair of first story rails 31a. Similarly, rails 713 and 714 may be a pair of story rails 31 or a pair of second story rails 31b. Rails 711 and 712 are disposed below rails 713 and 714.

For example, unmanned transport vehicle 110 having eight wheels 113 travels along rails 711 and 712, and transfers from rails 711 and 712 to rails 713 and 714. Note that in FIG. 23, the eight wheels 113 are illustrated as wheels d1 to d8.

First, as illustrated in (a) in FIG. 23, unmanned transport vehicle 110 travels along rails 711 and 712 in a state where wheels d1 and d7 are placed on rail 711, and wheels d4 and d6 are placed on rail 712. As wheels d1 and d4 approach rail 714 and wheels d7 and d6 approach rail 713, unmanned transport vehicle 110 places wheels d2 and d3 on rail 714 and places wheels d8 and d5 on rail 713. Thereafter, unmanned transport vehicle 110 disengages wheels d1 and d7 from rail 711 and disengages wheels d4 and d6 from rail 712.

Next, as illustrated in (b) in FIG. 23, unmanned transport vehicle 110 places wheel d4 on rail 714 and places wheel d6 on rail 713. Unmanned transport vehicle 110 travels along rails 713 and 714 with the rotation of wheels d2, d3, d4, d8, d5, and d6. Unmanned transport vehicle 110 moves wheels d3 and d5 closer to rail 711.

Next, as illustrated in (c) in FIG. 23, unmanned transport vehicle 110 passes wheels d3 and d5 under rail 711, and then, as illustrated in (d) in FIG. 23, passes wheels d4 and d6 under rail 711. As a result, unmanned transport vehicle 110 travels along rails 713 and 714 with the rotation of wheels d2, d3, d8, and d5.

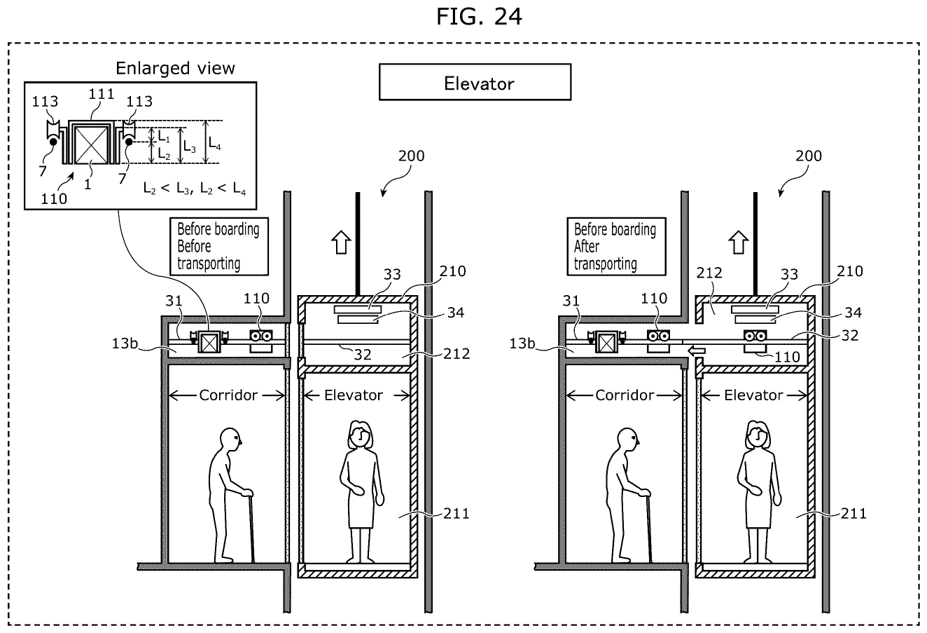

FIG. 24 illustrates an example in which unmanned transport vehicle 110 is applied to elevator 200.

Elevator 200 includes, similar to the example illustrated in FIG. 20, rail lifting device 33 and rail extension-contraction device 34. In the present embodiment, a pair of story rails 31 is arranged in fourth story space 13b, and a pair of elevator rails 32 is arranged in second elevator space 212. Unmanned transport vehicle 110 travels along that pair of story rails 31 and travels along the pair of elevator rails 32.

As illustrated in FIG. 24, at least one wheel 113 of unmanned transport vehicle 110 is placed on one rail of the pair of rails 7, and at least one remaining wheel 113 of unmanned transport vehicle 110 is placed on the other rail of the pair of rails 7. Note that the pair of rails 7 is a pair of story rails 31 or a pair of elevator rails 32. Enclosure 111 of unmanned transport vehicle 110 is arranged so as to be sandwiched between that pair of rails 7. Here, thickness L4 of unmanned transport vehicle 110 is greater than height L2 from the lowermost surface of unmanned transport vehicle 110 to the pair of rails 7, and thickness L3 of package 1 is greater than that height L2.

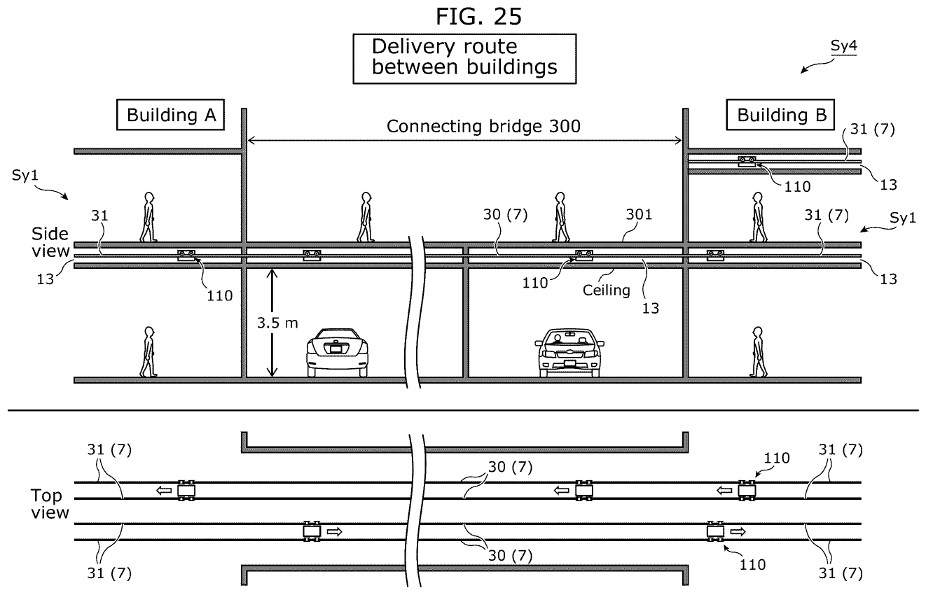

FIG. 25 illustrates an example of a configuration of logistics system Sy4 according to the present embodiment.

Logistics system Sy4 according to the present embodiment includes, for example, office building delivery system Sy1 installed in Building A, office building delivery system Sy1 installed in Building B, and a plurality of pairs of transport rails 30 that connect these office building delivery systems Sy1. The plurality of pairs of transport rails 30 are arranged in third story space 13 of connecting bridge 300 that connects Building A and Building B. Transport rail 30 is connected to one end of story rails 31 of both of Building A and Building B. Therefore, it can also be said that one rail 7 is configured by serially connecting story rail 31 of Building A, transport rail 30, and story rail 31 of Building B. Note that in the example of FIG. 25, a plurality of pairs of transport rails 30 are provided, but a single pair of transport rails 30 may be provided.

Unmanned transport vehicle 110 travels along a pair of rails 7 in third story space 13 of each of Building A, Building B, and connecting bridge 300.

Thus, the structure according to the present embodiment includes a first building, a second building, connecting bridge 300 that connects the first building and the second building, and rail 7 for unmanned transport vehicle 110 to travel on. The rail extends from the inside of the first building, across connecting bridge 300, and to the inside of the second building. Note that the first building is, for example, Building A, and the second building is, for example, Building B. The first building includes a first predetermined story and a second predetermined story, and a first space for unmanned transport vehicle 110 to travel on is provided between the ceiling of the first predetermined story and the floor of the second predetermined story of the first building. The second building includes a first predetermined story and a second predetermined story, and a second space for unmanned transport vehicle 110 to travel on is provided between the ceiling of the first predetermined story and the floor of the second predetermined story of the second building. The first space is, for example, third story space 13 of Building A, and the second space is, for example, third story space 13 of Building B. Connecting bridge 300 further includes walkway 301 that connects the floor of the second predetermined story of the first building and the floor of the second predetermined story of the second building. Below walkway 301, a third space for unmanned transport vehicle 110 to travel in is provided. The third space connects to the first space and the second space. Note that the third space is, for example, third story space 13 of connecting bridge 300. Rail 7 is disposed across the first space, the third space, and the second space.

This allows unmanned transport vehicle 110 to travel between the first building and the second building via connecting bridge 300.

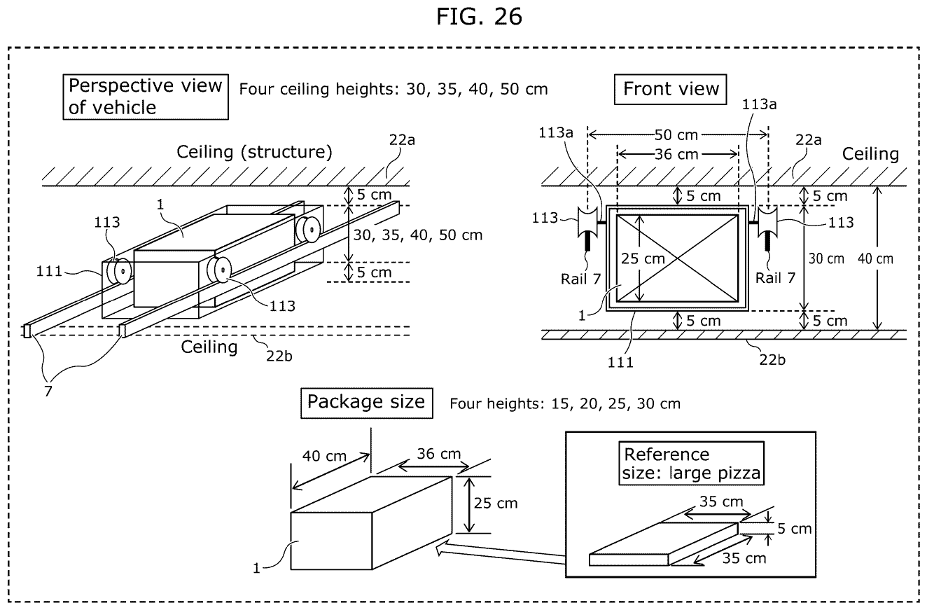

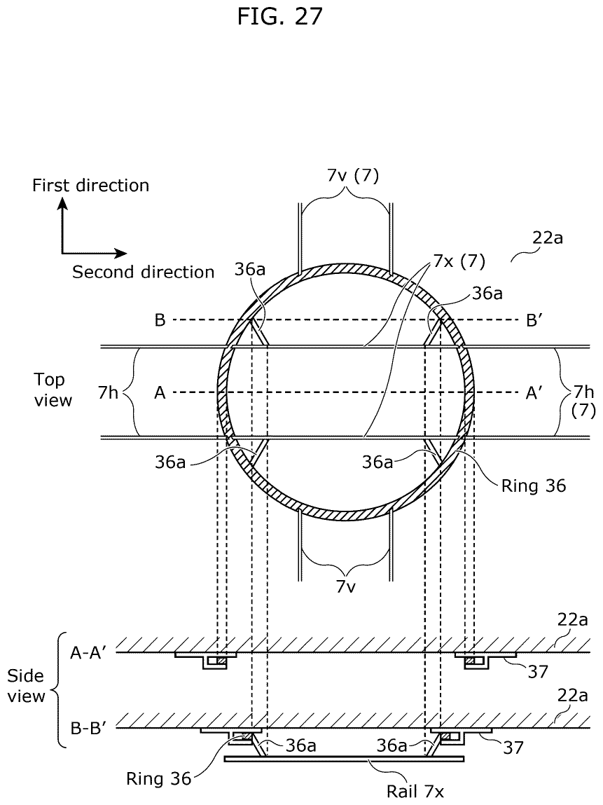

FIG. 26 illustrates an example of the size of unmanned transport vehicle 110.

Unmanned transport vehicle 110 travels in third story space 13, which is a space between first horizontal wall 22a and second horizontal wall 22b. The height of third story space 13, that is, the distance between first horizontal wall 22a and second horizontal wall 22b is, for example, 40 cm. The thickness (that is, the height) of unmanned transport vehicle 110 is, for example, 30 cm. In such cases, the gap between unmanned transport vehicle 110 and first horizontal wall 22a or second horizontal wall 22b is, for example, 5 cm. Note that the thickness of unmanned transport vehicle 110 may be greater than or equal to 30 cm depending on the height of third story space 13. For example, the thickness may be 35 cm, 40 cm, or 50 cm. The distance between the pair of rails 7 is, for example, 50 cm. Package 1 stored in enclosure 111 is, for example, 25×36×40 cm. 25 cm is the thickness (that is, the height) of package 1, 36 cm is the width of package 1 (that is, the length in the arrangement direction of the pair of rails 7), and 40 cm is the overall length of package 1 (that is, the length in the direction along the pair of rails 7). Note that the thickness of package 1 may be greater than or equal to 25 cm, and may be less than or equal to 25 cm. For example, the thickness of package 1 may be 15 cm, 20 cm, 30 cm, etc.

FIG. 27 illustrates an example of a configuration (turntable) for changing the orientation of unmanned transport vehicle 110.

The top view in FIG. 27 is a view from below of a plurality of rails 7 installed on, for example, first horizontal wall 22a. The plurality of rails 7 include two pairs of rails 7v, two pairs of rails 7h, and a pair of rails 7x. Note that rail 7v is rail 7 that extends along the first direction, and rail 7h is rail 7 that extends along the second direction perpendicular to the first direction. The first direction and the second direction are directions perpendicular to the vertical direction. The pair of rails 7v consists of two parallel rails 7v, and the pair of rails 7h consists of two parallel rails 7x.

One pair of the two pairs of rails 7v is disposed spaced apart from the other pair along the first direction. Stated differently, the pair of rails 7v and the other pair of rails 7v different from that pair of rails 7v are disposed spaced apart from each other along the first direction.

One pair of the two pairs of rails 7h is disposed spaced apart from the other pair along the second direction. Stated differently, the pair of rails 7h and the other pair of rails 7h different from that pair of rails 7h are disposed spaced apart from each other along the second direction.

As illustrated in the side view of FIG. 27, an annular base 37 is attached to the lower surface of first horizontal wall 22a. A rotating member is attached to base 37. The rotating member includes ring 36 and four support pillars 36a erected extending from ring 36 downward and toward the center. More specifically, base 37 includes a groove having an opening facing the center, and ring 36 is fitted into that groove. Two of the four support pillars 36a support rail 7x, and the remaining two support pillars 36a support another rail 7x different from that rail 7x.

Ring 36 rotates while sliding along the groove of base 37 with respect to base 37. Here, the pair of rails 7x connected to that ring 36 via the four support pillars 36a also rotates. Through the rotation of the pair of rails 7x, the two pairs of rails 7v become interconnected via this pair of rails 7x. Stated differently, a pair of rails 7v is connected to a pair of rails 7x, and furthermore, that pair of rails 7x is connected to another pair of rails 7v. At this time, unmanned transport vehicle 110 can travel along the pair of rails 7v, the pair of rails 7x, and the other pair of rails 7v. Alternatively, through the rotation of the pair of rails 7x, the two pairs of rails 7h become interconnected via this pair of rails 7x. Stated differently, a pair of rails 7h is connected to a pair of rails 7x, and furthermore, that pair of rails 7x is connected to another pair of rails 7h. At this time, unmanned transport vehicle 110 can travel along the pair of rails 7h, the pair of rails 7x, and the other pair of rails 7h.

When the four wheels 113 of unmanned transport vehicle 110 are placed on the pair of rails 7x, the orientation of unmanned transport vehicle 110 can be changed when the rotating member pivots.

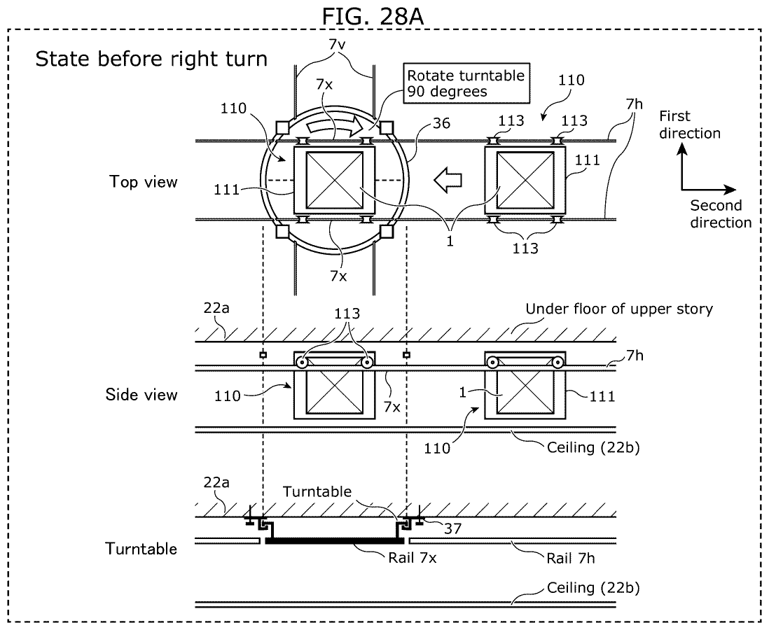

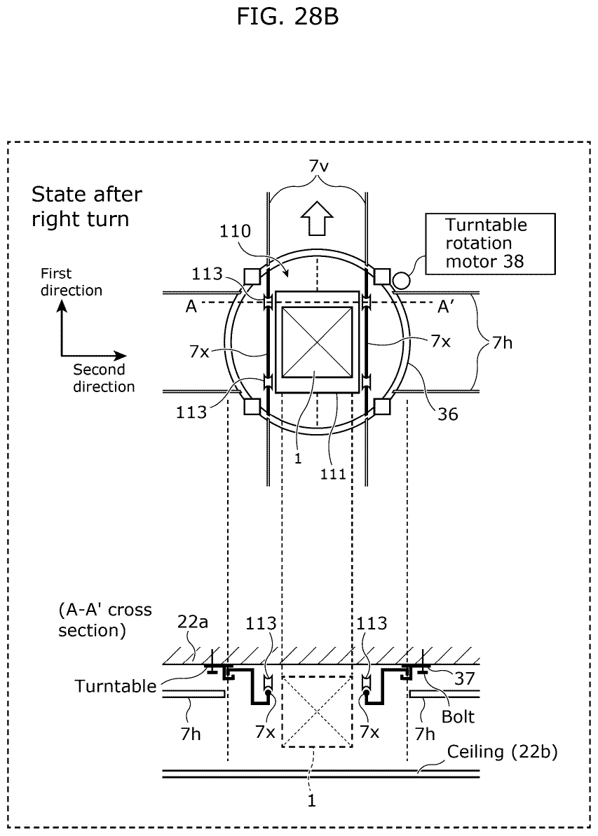

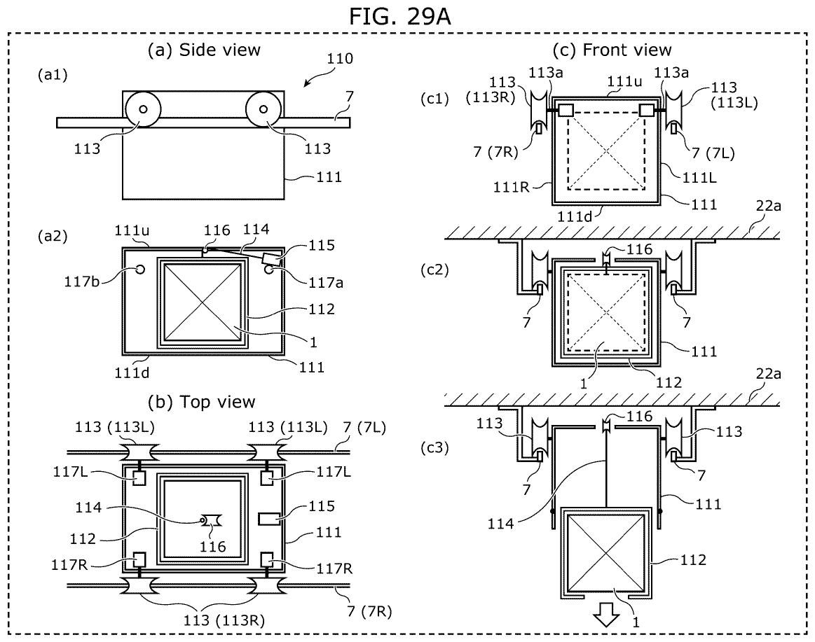

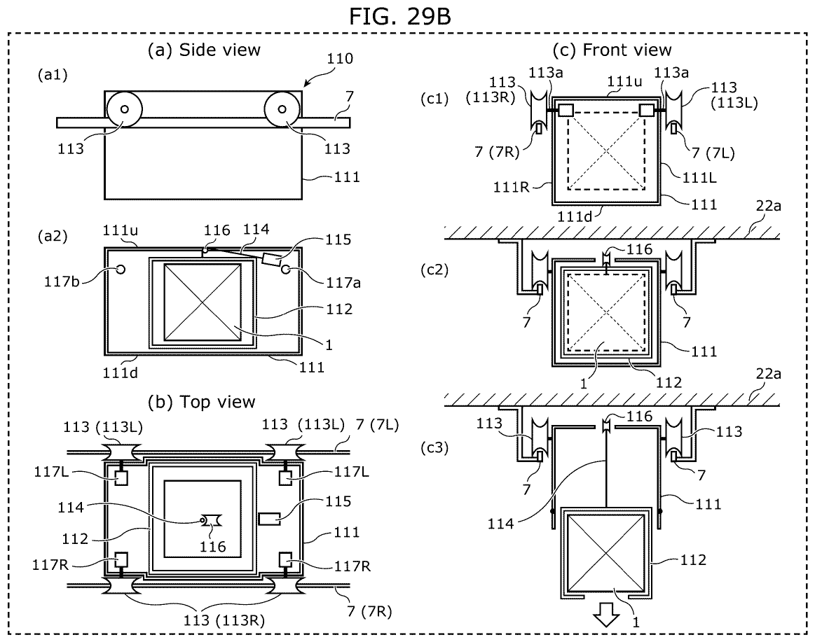

FIG. 28A and FIG. 28B illustrate an example of an operation for changing the orientation of unmanned transport vehicle 110.

For example, as illustrated in FIG. 28A, unmanned transport vehicle 110 travels along the pair of rails 7h toward ring 36. Here, the pair of rails 7h is connected to the pair of rails 7x. Unmanned transport vehicle 110 stops at the center of ring 36. Stated differently, unmanned transport vehicle 110 stops when the four wheels 113 of unmanned transport vehicle 110 are placed on the pair of rails 7x.

Next, as illustrated in FIG. 28B, the rotating member pivots. Stated differently, ring 36 pivots by the actuation of turntable rotation motor 38. This causes the lengthwise direction of the pair of rails 7x to be switched from a direction parallel to the pair of rails 7h (i.e., the second direction) to a direction parallel to the pair of rails 7v (i.e., the first direction). As a result, the pair of rails 7x is connected to the pair of rails 7v. This allows unmanned transport vehicle 110 to travel along the pair of rails 7x to the pair of rails 7v. Therefore, the orientation of unmanned transport vehicle 110, that is, the travel direction, is changed from the second direction to the first direction.

Thus, the turntable according to the present embodiment includes base 37, a rotating member rotatably attached to base 37 around a rotary shaft extending in the vertical direction, a first movable rail connected to the rotating member, and a second movable rail connected to the rotating member. Note that the rotating member includes, for example, ring 36 and four support pillars 36a, as illustrated in FIG. 27 through FIG. 28B. The first movable rail and the second movable rail are, for example, the pair of rails 7x. This allows the orientation of unmanned transport vehicle 110 to be appropriately changed.

The turntable according to the present embodiment includes an actuator for rotating the rotating member. The actuator is, for example, turntable rotation motor 38 illustrated in FIG. 28B. The rotating member is switched between a first rotation state and a second rotation state by actuation of the actuator. In the first rotation state, the first movable rail, which is one rail in the pair of rails 7x, is connected to a first-direction first fixed rail extending in the first direction, and the second movable rail, which is the other rail in the pair of rails 7x, is connected to a first-direction second fixed rail extending in the first direction. The first-direction first fixed rail and the first-direction second fixed rail are, for example, the pair of rails 7v illustrated in FIG. 27 through FIG. 28B. In the second rotation state, the first movable rail is connected to a second-direction first fixed rail extending in the second direction, and the second movable rail is connected to a second-direction second fixed rail extending in the second direction. The second-direction first fixed rail and the second-direction second fixed rail are, for example, the pair of rails 7h illustrated in FIG. 27 through FIG. 28B.

This allows the orientation of unmanned transport vehicle 110 to be switched between the first direction and the second direction. This allows unmanned transport vehicle 110 to travel along the first-direction first fixed rail and the first-direction second fixed rail, as well as along the second-direction first fixed rail and the second-direction second fixed rail.

FIG. 29A and FIG. 29B illustrate an example of a detailed configuration of unmanned transport vehicle 110. Note that (a1) and (a2) in FIG. 29A and FIG. 29B are views of unmanned transport vehicle 110 from the left-right direction, that is, from a direction perpendicular to the pair of rails 7 in the plane where the pair of rails 7 is disposed. (a1) illustrates the external appearance of unmanned transport vehicle 110, and (a2) illustrates the internal configuration of unmanned transport vehicle 110. (b) in FIG. 29A and FIG. 29B is a view of unmanned transport vehicle 110 from above, that is, from a direction perpendicular to the plane where the pair of rails 7 is disposed. (c1), (c2), and (c3) in FIG. 29A and FIG. 29B are views of unmanned transport vehicle 110 from the anteroposterior direction, that is, from a direction along the pair of rails 7. (c1) illustrates a cross-section at a predetermined depth position of unmanned transport vehicle 110, (c2) illustrates a cross-section at another depth position of unmanned transport vehicle 110, and (c3) illustrates a state where unmanned transport vehicle 110 is unloading package 1. Note that a depth position refers to a position in a direction along the pair of rails 7.

As illustrated in FIG. 29A and FIG. 29B, unmanned transport vehicle 110 includes enclosure 111, package carriage 112, winch 115, motors 117a and 117b, and pulley 116.

Enclosure 111 is rectangular box-shaped and configured to accommodate package carriage 112. Package carriage 112 stores package 1. Pulley 116 is positioned at approximately the center of the upper surface of enclosure 111, and wire 114 is hung on pulley 116. One end of wire 114 is connected to approximately the center of the upper surface of package carriage 112, and the other end is wound around winch 115. Winch 115 reels wire 114 in and out by being driven by motor 117a or 117b.

Here, winch 115 is positioned at a location offset from package carriage 112 in a direction along the pair of rails 7, as illustrated in (a2) and (b) in FIG. 29A and FIG. 29B. Stated differently, as illustrated in (b) in FIG. 29A and FIG. 29B, when unmanned transport vehicle 110 is viewed from above, winch 115 is positioned at a location that does not overlap with package carriage 112. As a result, because there is no need to provide space for placing winch 115 above package carriage 112 within enclosure 111, the thickness of unmanned transport vehicle 110 can be reduced.

Unmanned transport vehicle 110 includes two first motors 117L and two second motors 117R for rotating the four wheels 113, as illustrated in (b) in FIG. 29A and FIG. 29B. These first motors 117L and second motors 117R are also, like winch 115, positioned at locations that do not overlap with package carriage 112 when unmanned transport vehicle 110 is viewed from above. As illustrated in (b) in FIG. 29B, the width in the left-right direction at the central portion in the anteroposterior direction of enclosure 111 may be configured to be wider than the example illustrated in (a) in FIG. 29A. Unmanned transport vehicle 110, when lowering package 1, opens the bottom of enclosure 111 and causes winch 115 to reel out wire 114 by being driven by motor 117a or 117b, as illustrated in (c3) in FIG. 29A and FIG. 29B. With this, package carriage 112 descends in a state of being suspended by wire 114 from pulley 116.

Unmanned transport vehicle 110 according to the present embodiment includes, as illustrated in (c1) in FIG. 29A, enclosure 111 having first side surface 111L and second side surface 111R opposite each other, first wheels 113L provided on first side surface 111L, and second wheels 113R provided on second side surface 111R. First wheel 113L is wheel 113 for traveling on first rail 7L, and second wheel 113R is wheel 113 for traveling on second rail 7R parallel to first rail 7L. In this example, first rail 7L and second rail 7R constitute a pair of rails 7. As illustrated in (c1) in FIG. 29A, when viewed from the direction in which first rail 7L and second rail 7R extend, axle 113a of each of first wheel 113L and second wheel 113R is lower than upper surface 111u of enclosure 111 and higher than lower surface 111d of enclosure 111. Note that unmanned transport vehicle 110 is also called a transport vehicle.

This allows the thickness of unmanned transport vehicle 110 to be reduced, making it possible to realize a transport vehicle suitable for traveling through third story space 13 (i.e., ceiling cavity, etc.) where height is limited.

As illustrated in (b) in FIG. 29A, when unmanned transport vehicle 110 is viewed from vertically above, enclosure 111 does not overlap with first wheel 113L, and enclosure 111 does not overlap with second wheel 113R.

With this, first wheel 113L and second wheel 113R can effectively be positioned lower than upper surface 111u of enclosure 111 and higher than lower surface 111d of enclosure 111, allowing unmanned transport vehicle 110 to be appropriately made thinner.

Here, the configuration of unmanned transport vehicle 110 according to the present embodiment can also be expressed as follows.

When enclosure 111, first wheel 113L, and second wheel 113R are viewed from the direction in which first rail 7L and second rail 7R extend, enclosure 111 is positioned between first rail 7L and second rail 7R.

When unmanned transport vehicle 110 is viewed from above in the vertical direction, the width of enclosure 111 in a direction perpendicular to the direction along first rail 7L and second rail 7R is shorter than the distance between first rail 7L and second rail 7R.

As illustrated in (b) in FIG. 29A, when unmanned transport vehicle 110 is viewed from above in the vertical direction, the width of enclosure 111 in a direction perpendicular to the direction along first rail 7L and second rail 7R is shorter than the distance between first wheel 113L and second wheel 113R.

Even in such a case, unmanned transport vehicle 110 can be appropriately made thinner.

In the present embodiment, as illustrated in (a2) in FIG. 29A, unmanned transport vehicle 110 includes package carriage 112 connected to wire 114, winch 115 capable of reeling out and reeling in wire 114, and pulley 116. Package carriage 112 is suspended by wire 114 being passed over pulley 116. As illustrated in (b) in FIG. 29A, when unmanned transport vehicle 110 is viewed from vertically above, package carriage 112 does not overlap with winch 115.

This configuration inhibits winch 115 from adding excessive thickness to unmanned transport vehicle 110, enabling unmanned transport vehicle 110 to maintain a suitably low profile. Typically, winch 115 is large in size. Therefore, when unmanned transport vehicle 110 is viewed from vertically above, if winch 115 and package carriage 112 overlap within enclosure 111, it becomes difficult to fit both winch 115 and package carriage 112 inside enclosure 111 which has a narrow width in the height direction. As a result, it is difficult to achieve a thin unmanned transport vehicle 110 in the vertical direction (i.e., the height direction). In contrast, according to the present embodiment, when unmanned transport vehicle 110 is viewed from vertically above, winch 115 and package carriage 112 do not overlap within enclosure 111, making it possible to realize a thin unmanned transport vehicle 110 in the vertical direction.

In the present embodiment, as illustrated in (a2) and (b) in FIG. 29A, winch 115 is positioned at a corner within enclosure 111. For example, winch 115 is positioned closer to upper surface 111u than to lower surface 111d within enclosure 111. Winch 115 is positioned either in front of or behind the center in the anteroposterior direction within enclosure 111. As illustrated in (b) in FIG. 29A, when unmanned transport vehicle 110 is viewed from vertically above, winch 115 is positioned between first wheel 113L and second wheel 113R, or between first motor 117L and second motor 117R.

With this, when unmanned transport vehicle 110 is viewed from vertically above, package carriage 112 and winch 115 can be effectively prevented from overlapping.

In the present embodiment, as illustrated in (b) in FIG. 29A, unmanned transport vehicle 110 includes first motor 117L positioned within enclosure 111 that rotates first wheel 113L, and second motor 117R positioned within enclosure 111 that rotates second wheel 113R. When unmanned transport vehicle 110 is viewed from vertically above, first motor 117L does not overlap with package carriage 112, and second motor 117R does not overlap with package carriage 112.

This configuration inhibits first motor 117L and second motor 117R from adding excessive thickness to unmanned transport vehicle 110, enabling unmanned transport vehicle 110 to maintain a suitably low profile. Stated differently, when unmanned transport vehicle 110 is viewed from vertically above, first motor 117L and second motor 117R do not overlap with package carriage 112, making it possible to realize a thin unmanned transport vehicle 110 in the vertical direction.

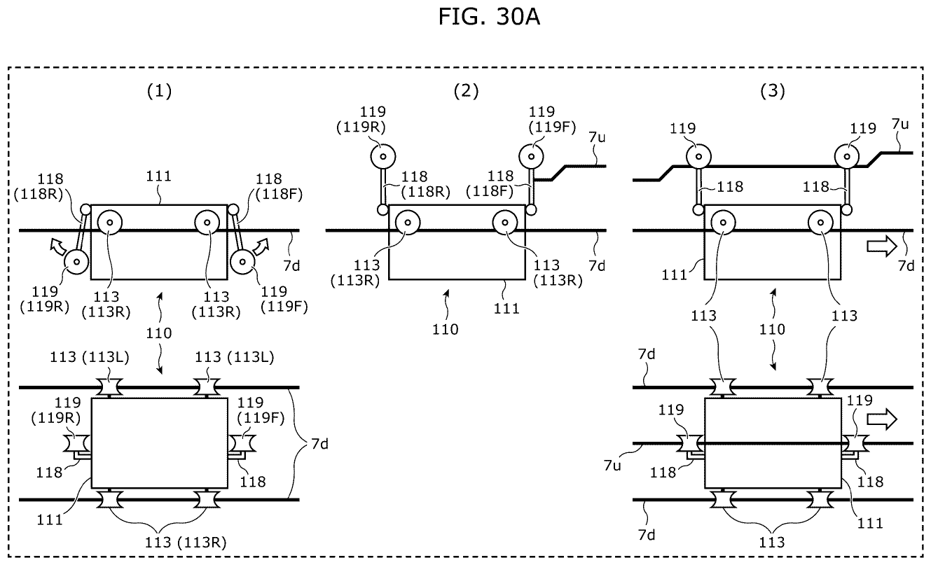

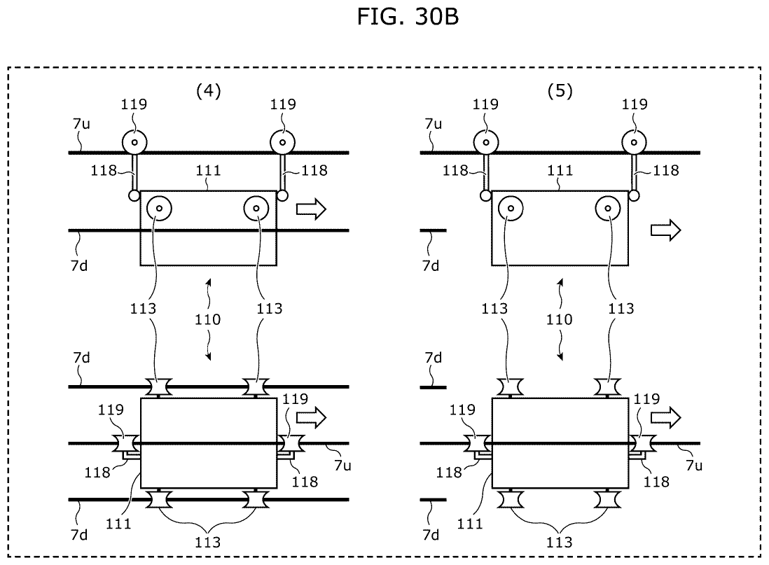

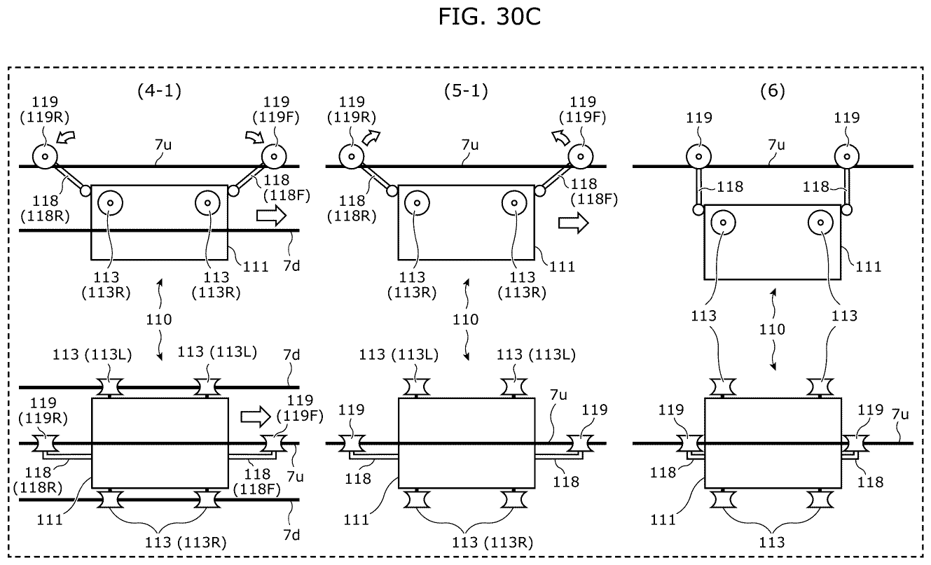

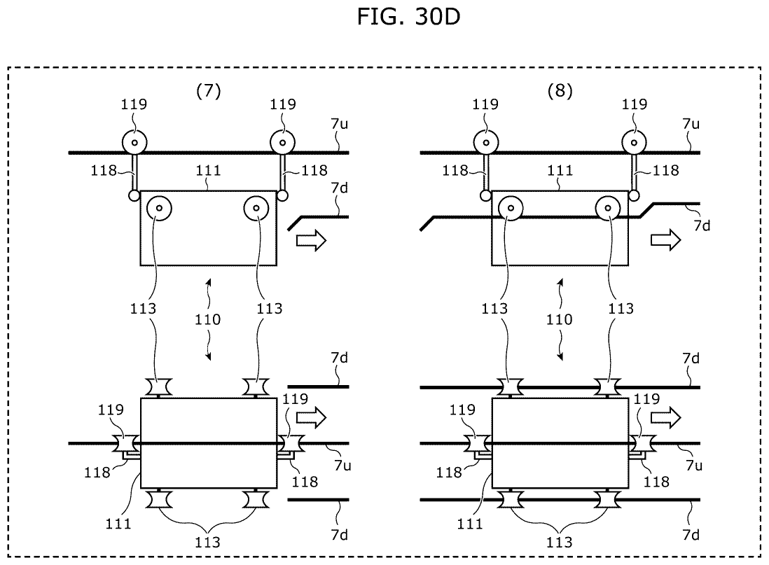

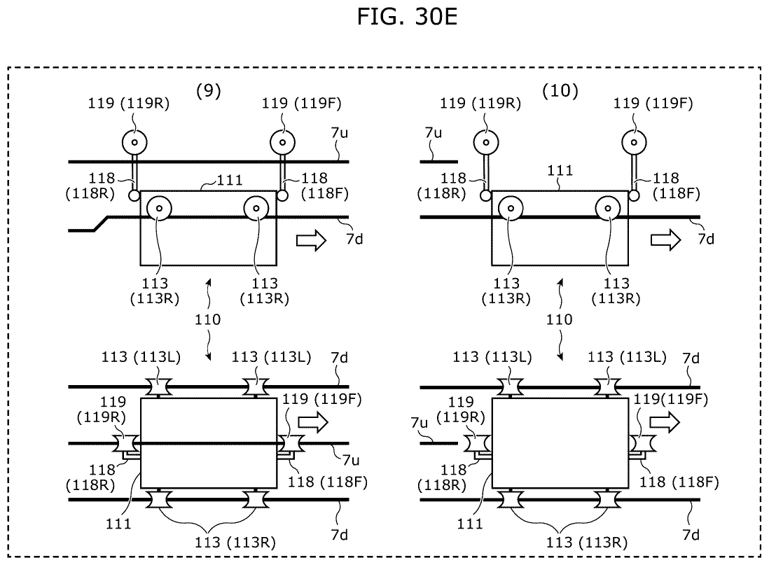

FIG. 30A to FIG. 30E are diagrams for explaining an example of an operation in which unmanned transport vehicle 110 changes rails. Note that in each of FIG. 30A through FIG. 30E, the upper portion illustrates unmanned transport vehicle 110 as viewed from the left-right direction, and the lower portion illustrates unmanned transport vehicle 110 as viewed from above.

Unmanned transport vehicle 110, for example, travels along a pair of rails 7d, then transfers to a single rail 7u and travels along that rail 7u, and subsequently transfers to a pair of rails 7d and travels along that pair of rails 7d. Note that rails 7d and 7u are examples of rail 7. Unmanned transport vehicle 110 includes four wheels 113 for traveling along the pair of rails 7d, and two arms 118 and two wheels 119 for traveling along rail 7u.

The base portions of the two arms 118 are attached to the upper surface side of enclosure 111 of unmanned transport vehicle 110, at the approximately central portion in the left-right direction of unmanned transport vehicle 110, so as to be arranged along the traveling direction (i.e., anteroposterior direction) of unmanned transport vehicle 110. Each of the two wheels 119 is attached to the leading end of its arm 118. Each of the two arms 118 is, for example, rod-shaped, and unmanned transport vehicle 110 rotates arms 118 about the base portions of those arms 118. Note that the pivot axle of arm 118 is parallel to the left-right direction of unmanned transport vehicle 110.

First, as illustrated in (1) in FIG. 30A, unmanned transport vehicle 110 travels along the pair of rails 7d in a state where the two wheels 113 on the right side are placed on the right rail 7d of the pair of rails 7d, and the two wheels 113 on the left side are placed on the left rail 7d of the pair of rails 7d. Here, unmanned transport vehicle 110 has the two wheels 119 lowered, but when transferring from the pair of rails 7d to rail 7u, unmanned transport vehicle 110 raises those two wheels 119 by rotating the two arms 118 in advance.

Next, as illustrated in (2) in FIG. 30A, unmanned transport vehicle 110 approaches rail 7u that is disposed above the pair of rails 7d. Note that rail 7u is parallel to the pair of rails 7d when rail 7u and the pair of rails 7d are illustrated as viewed from above. At this time, the end of rail 7u is positioned lower than the two wheels 119. A first rail portion including the end of rail 7u is positioned at the lowest position in rail 7u, a second rail portion following the first rail portion is positioned higher than the first rail portion, and a third rail portion following the second rail portion is positioned higher than the second rail portion. Stated differently, rail 7u is configured such that three rail portions at different heights from each other are connected via inclined portions in order of height, starting from the lowest rail portion.

Next, as illustrated in (3) in FIG. 30A, as unmanned transport vehicle 110 travels as the four wheels 113 rotate, the two wheels 119 are placed on rail 7u. Here, for example, the two wheels 119 are placed on the second rail portion of rail 7u described above. Unmanned transport vehicle 110 travels by rotation of the two wheels 119 and the four wheels 113.

Next, as illustrated in (4) in FIG. 30B, as unmanned transport vehicle 110 travels further, when the two wheels 119 are placed on the third rail portion via the inclined portion of rail 7u, the four wheels 113 separate from the pair of rails 7d. Furthermore, as unmanned transport vehicle 110 travels as the two wheels 119 rotate, as illustrated in (5) in FIG. 30B, unmanned transport vehicle 110 passes beyond the end of the pair of rails 7d. This completes the transfer of unmanned transport vehicle 110 from the pair of rails 7d to rail 7u.

Here, rail 7u includes first rail portion, second rail portion, and third rail portion as described above, but rail 7u need not include the third rail portion. Stated differently, rail 7u is configured such that a rail portion positioned at a lower position and a rail portion positioned higher than that are connected via an inclined portion. In such cases, unmanned transport vehicle 110 may carry out the operations illustrated in (4-1) and (5-1) in FIG. 30C instead of the operations illustrated in (4) and (5) in FIG. 30A. Stated differently, after the state illustrated in (3) in FIG. 30A, unmanned transport vehicle 110 lowers the two wheels 119 by driving the two arms 118 such that the two wheels 119 move away from each other, as illustrated in (4-1) in FIG. 30C. For example, unmanned transport vehicle 110 lowers the two wheels 119 such that the two arms 118 are inclined in the anteroposterior direction by 45 degrees from the vertical direction. As a result, the four wheels 113 of unmanned transport vehicle 110 lift off from the pair of rails 7d. As illustrated in (5-1) in FIG. 30C, when unmanned transport vehicle 110 travels as the two wheels 119 rotate, unmanned transport vehicle 110 passes beyond the end of the pair of rails 7d. Thereafter, unmanned transport vehicle 110 raises the two wheels 119 by rotation of the two arms 118, as illustrated in (6) in FIG. 30C. Stated differently, unmanned transport vehicle 110 raises the leading ends of the two arms 118 by aligning them in the vertical direction. As a result, enclosure 111 of unmanned transport vehicle 110 separates from rail 7u by the length of arm 118.

Next, unmanned transport vehicle 110 transfers from rail 7u to the pair of rails 7d. For example, at this time, as illustrated in (7) in FIG. 30D, unmanned transport vehicle 110 approaches the pair of rails 7d while traveling by rotation of the two wheels 119. Each of the pair of rails 7d includes a first rail portion including a starting end, a second rail portion connected to the first portion, and a third rail portion connected to the second portion via an inclined portion. The first rail portion is inclined. Stated differently, the first rail portion is formed to become higher toward the terminal end from the starting end.

As unmanned transport vehicle 110 travels as the two wheels 119 rotate, when wheel 113 contacts the first rail portion of rail 7d, wheel 113, as illustrated in (8) in FIG. 30D, is pushed up by the incline of the first rail portion of rail 7d and placed on the second rail portion. Furthermore, as unmanned transport vehicle 110 travels as the four wheels 113 rotate, as illustrated in (9) in FIG. 30E, the four wheels 113 are pushed up by the inclined portion of rail 7d and placed on the third rail portion. Here, the two wheels 119 lift off from rail 7u.

Next, as illustrated in (10) in FIG. 30E, when unmanned transport vehicle 110 travels as the four wheels 113 rotate, unmanned transport vehicle 110 passes beyond the end of rail 7u. This completes the transfer of unmanned transport vehicle 110 from rail 7u to the pair of rails 7d.

Unmanned transport vehicle 110 according to the present embodiment includes, as illustrated in (1) and (2) in FIG. 30A, first arm 118F and second arm 118R each connected to enclosure 111, third wheel 119F connected to the leading end side of first arm 118F, fourth wheel 119R connected to the leading end side of second arm 118R, and at least one actuator that drives first arm 118F and second arm 118R. First arm 118F is one of the two arms 118, and second arm 118R is the other of the two arms 118. Similarly, third wheel 119F is one of the two wheels 119, and fourth wheel 119R is the other of the two wheels 119. The number of first wheels 113L provided on enclosure 111 is two or more, and the number of second wheels 113R provided on enclosure 111 is two or more. First arm 118F and second arm 118R are switched between a first arm state and a second arm state by actuation of the at least one actuator. As illustrated in (2) in FIG. 30A, in the first arm state, third wheel 119F and fourth wheel 119R are positioned at a first position above first wheel 113L and second wheel 113R. As illustrated in (1) in FIG. 30A, in the second arm state, third wheel 119F and fourth wheel 119R are positioned at a second position below the first position.

This allows unmanned transport vehicle 110 traveling along first rail 7L and second rail 7R to be transferred to rail 7u, which is a third rail, by switching the state of first arm 118F and second arm 118R. In this example, first rail 7L and second rail 7R constitute a pair of rails 7d in FIG. 30A. Stated differently, the system can switch from a state where first wheels 113L travel on first rail 7L and second wheels 113R travel on second rail 7R, to a state where third wheel 119F and fourth wheel 119R travel on rail 7u.

Unmanned transport vehicle 110 according to the present embodiment includes a controller. This controller may be configured as a processor or central processing unit (CPU), and may perform the following operations by reading and executing a computer program stored in a recording medium such as memory. For example, first wheels 113L and second wheels 113R travel on first rail 7L and second rail 7R (that is, on the pair of rails 7d), respectively, from a first section toward a second section. Here, as illustrated in (1) in FIG. 30A, no rail 7u exists above first rail 7L and second rail 7R in the first section. As illustrated in (3) in FIG. 30A, rail 7u exists above first rail 7L and second rail 7R in the second section. In this case, as illustrated in (1) in FIG. 30A, when first wheels 113L and second wheels 113R are in the first section, the controller controls at least one actuator to change first arm 118F and second arm 118R from the second arm state to the first arm state. As illustrated in (2) and (3) in FIG. 30A, this enables the controller to cause third wheel 119F and fourth wheel 119R to travel on rail 7u when rail 7u is positioned below third wheel 119F and fourth wheel 119R.

This enables unmanned transport vehicle 110 to be appropriately transferred from first rail 7L and second rail 7R, which are a pair of rails 7d, to the third rail, which is rail 7u, positioned above those rails.

In the present embodiment, as illustrated in (4-1) and (5-1) in FIG. 30C, first arm 118F and second arm 118R are further switched to a third arm state by actuation of at least one actuator. In the third arm state, third wheel 119F and fourth wheel 119R are positioned at a third position that is below the first position and above the second position. For example, the controller changes first arm 118F and second arm 118R from the second arm state to the first arm state, and after third wheel 119F and fourth wheel 119R have traveled on rail 7u, the controller controls at least one actuator to change first arm 118F and second arm 118R from the first arm state to the third arm state.

With this, first wheels 113L and second wheels 113R can be lifted from first rail 7L and second rail 7R, which are a pair of rails 7d. Stated differently, unmanned transport vehicle 110 can be appropriately transferred from first rail 7L and second rail 7R, which are a pair of rails 7d, to the third rail, which is rail 7u.

In the present embodiment, as illustrated in (9) and (10) in FIG. 30E, first wheels 113L and second wheels 113R travel on first rail 7L and second rail 7R (that is, on the pair of rails 7d), respectively, and third wheel 119F and fourth wheel 119R separate from rail 7u. After this, the controller controls at least one actuator to change first arm 118F and second arm 118R from the first arm state to the second arm state, as illustrated in (1) in FIG. 30A.

This allows unmanned transport vehicle 110 to be appropriately transferred from rail 7u, which is the third rail, to first rail 7L and second rail 7R, which are a pair of rails 7d.

Unmanned transport vehicle 110 according to the present embodiment, as illustrated in FIG. 30A through FIG. 30E, is a transport vehicle that includes at least one wheel 119 and at least two wheels 113. Note that wheel 119 may be called a first wheel, and wheel 113 may be called a second wheel. The at least one wheel 119 is for traveling on rail 7u. Rail 7u is positioned outside the first building and is used for the transport vehicle to travel outdoors. Note that rail 7u may be called a first rail. The at least two wheels 113 are for traveling on a pair of rails 7d. The pair of rails 7d are arranged inside the first building and are used for the transport vehicle to travel indoors. Note that rail 7d is also called a second rail.

By including at least one wheel 119 and at least two wheels 113, unmanned transport vehicle 110 can travel along rail 7u and also travel along the pair of rails 7d. Stated differently, unmanned transport vehicle 110 can freely travel both indoors and outdoors of the first building.

Unmanned transport vehicle 110 according to the present embodiment is configured to be changeable between a first travel mode in which the at least one wheel 119 travels along rail 7u and a second travel mode in which the at least two wheels 113 travel along the pair of rails 7d.

This allows unmanned transport vehicle 110 to be transferred between rail 7u and the pair of rails 7d by switching between the first travel mode and the second travel mode.

Here, the rail structure according to the present embodiment includes a pair of rails 7d disposed inside the first building for unmanned transport vehicle 110 to travel indoors, and rail 7u positioned outside the first building for unmanned transport vehicle 110 to travel outdoors. The rail structure includes a first region where unmanned transport vehicle 110 can transfer from rail 7u to the pair of rails 7d, or from the pair of rails 7d to first rail 7u. Note that the first region is, for example, the region shown in (3) in FIG. 30A, or the region shown in (8) in FIG. 30D.

This allows unmanned transport vehicle 110 to easily switch between rails.

In the present embodiment, when the first region is viewed from vertically above, rail 7u is positioned between the pair of rails 7d.

This allows unmanned transport vehicle 110 to stably transfer onto rail 7u.

In the present embodiment, as illustrated in (3) in FIG. 30A, when the first region is viewed from a horizontal direction, rail 7u is positioned above the pair of rails 7d. When the first region is viewed from the horizontal direction, there is a first part where the distance between rail 7u and the pair of rails 7d increases as it extends in the first direction. Here, the first direction is the direction in which unmanned transport vehicle 110 moves from inside the first building to outside the first building. In the example in (3) in FIG. 30A, the first direction is the direction indicated by the arrow.

This allows unmanned transport vehicle 110 to be appropriately transferred from the pair of rails 7d to rail 7u while inhibiting active operation by unmanned transport vehicle 110.

In the present embodiment, as illustrated in (3) in FIG. 30A, in the first part, the height of rail 7u from the ground increases as it extends in the first direction.

This allows unmanned transport vehicle 110 to be appropriately transferred from the pair of rails 7d to rail 7u with a simple configuration.

In the present embodiment, as illustrated in (8) in FIG. 30D, in the first part, the height of the pair of rails 7d from the ground increases as they extend in the second direction. Here, the second direction is the direction in which unmanned transport vehicle 110 moves from outside the first building to inside the first building. In the example in (8) in FIG. 30D, the second direction is the direction indicated by the arrow.

This allows unmanned transport vehicle 110 to be appropriately transferred from rail 7u to the pair of rails 7d while inhibiting active operation by unmanned transport vehicle 110.

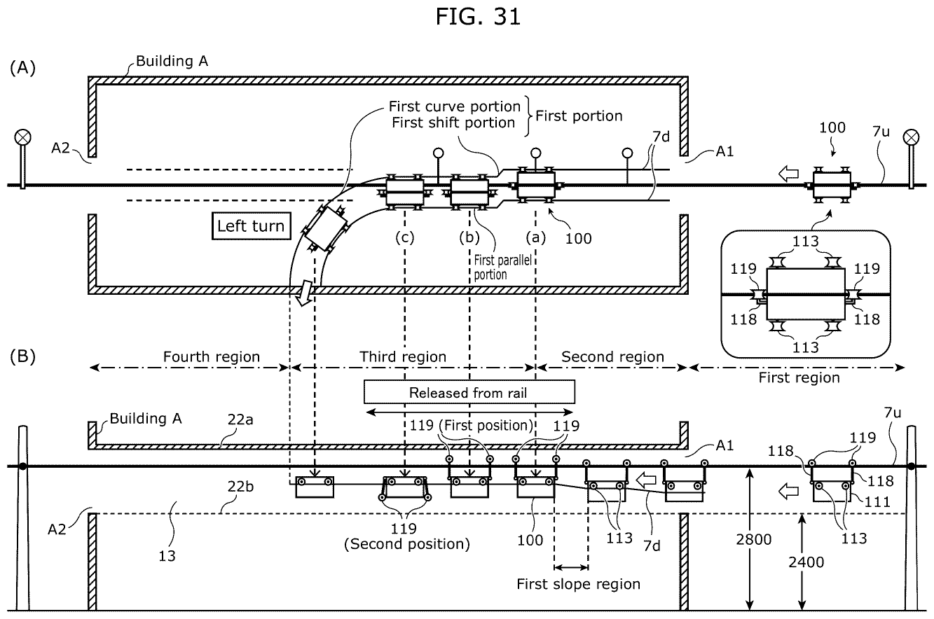

FIG. 31 illustrates an example of unmanned transport vehicle 110 entering Building A from outside. In FIG. 31, (A) illustrates Building A and unmanned transport vehicle 110 as viewed from above, and (B) illustrates Building A and unmanned transport vehicle 110 as viewed from a horizontal direction. Note that in FIG. 31, a cross-section of Building A is illustrated. FIG. 31 illustrates an example in which unmanned transport vehicle 110 sequentially passes through position (a), position (b), and position (c).

In the example of FIG. 31, rail 7u is installed in third story space 13 inside Building A so as to penetrate through Building A in the horizontal direction, and a pair of rails 7d are installed in third story space 13 inside Building A below rail 7u. More specifically, rail 7u is installed in a straight line so as to pass through opening A1 and opening A2 of Building A. However, as illustrated in (A) in FIG. 31, the pair of rails 7d are arranged along rail 7u from opening A1 to position (c) inside Building A; however, when viewed from the orientation facing from opening A1 toward opening A2, the pair of rails 7d curve to the left in the horizontal direction inside Building A.

Unmanned transport vehicle 110 enters from outside Building A into Building A through opening A1, traveling along rail 7u. Here, unmanned transport vehicle 110 raises the leading end of each of the two arms 118 such that each of the two arms 118 aligns with the vertical direction, with the two wheels 119 placed on rail 7u. Unmanned transport vehicle 110 travels in this state by rotating its two wheels 119.

When unmanned transport vehicle 110 enters Building A and travels, the four wheels 113 of unmanned transport vehicle 110 are positioned above the pair of rails 7d. As unmanned transport vehicle 110 travels, the height of the pair of rails 7d located below its four wheels 113 increases. As a result, as illustrated in (B) in FIG. 31, at position (a), the four wheels 113 are placed on the pair of rails 7d, and the two wheels 119 move upward and away from the pair of rails 7d. This allows unmanned transport vehicle 110 to travel along the pair of rails 7d by rotation of the four wheels 113.

Here, as illustrated in (A) in FIG. 31, the portion at position (b) in the pair of rails 7d is shifted to the left by approximately 10 cm, for example, compared to the portion at position (a) in the pair of rails 7d, when viewed from the traveling direction of unmanned transport vehicle 110. Therefore, as unmanned transport vehicle 110 passes through position (a) and moves toward position (b), the position of unmanned transport vehicle 110 shifts to the left. As a result, when unmanned transport vehicle 110 passes through position (b), rail 7u is not arranged below the two wheels 119. Therefore, unmanned transport vehicle 110, when passing through position (b) and moving toward position (c), can rotate the two arms 118 such that the leading ends of the two arms 118 lower, thereby lowering the two wheels 119.

Thereafter, unmanned transport vehicle 110 travels along the pair of rails 7d while curving to the left, as illustrated in (A) in FIG. 31.

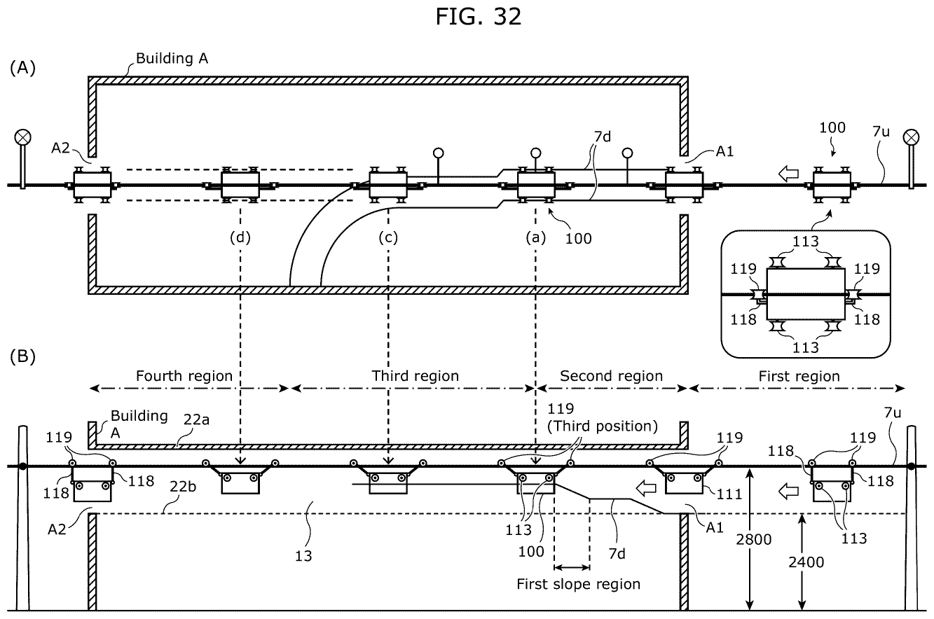

FIG. 32 illustrates another example of unmanned transport vehicle 110 entering Building A from outside. In FIG. 32, (A) illustrates Building A and unmanned transport vehicle 110 as viewed from above, and (B) illustrates Building A and unmanned transport vehicle 110 as viewed from a horizontal direction. Note that in FIG. 32, a cross-section of Building A is illustrated. In the example of FIG. 32, rail 7u and the pair of rails 7d are installed in the same manner as in the example of FIG. 31. FIG. 32 illustrates an example in which unmanned transport vehicle 110 sequentially passes through position (a), position (c), and position (d).

Outside Building A, unmanned transport vehicle 110 raises the leading end of each of the two arms 118 such that each of the two arms 118 aligns with the vertical direction, with the two wheels 119 placed on rail 7u. Unmanned transport vehicle 110 travels in this state by rotating its two wheels 119. Here, unmanned transport vehicle 110 enters from outside Building A into Building A through opening A1, traveling along rail 7u. Here, unmanned transport vehicle 110 rotates the two arms 118 such that each of the two arms 118 is inclined in the anteroposterior direction by approximately 45 degrees from the vertical direction. As a result, enclosure 111 of unmanned transport vehicle 110 moves closer to rail 7u and is elevated from the ground.

When unmanned transport vehicle 110 enters Building A and travels, the four wheels 113 of unmanned transport vehicle 110 are positioned above the pair of rails 7d. Furthermore, as unmanned transport vehicle 110 travels, the height of the pair of rails 7d located below its four wheels 113 increases. However, in the example of FIG. 32, unlike the example of FIG. 31, enclosure 111 of unmanned transport vehicle 110 is positioned closer to rail 7u and is at a high position from the ground surface. Therefore, even when unmanned transport vehicle 110 passes through positions (a) and (c), the four wheels 113 do not ride on the pair of rails 7d. In other words, unmanned transport vehicle 110 does not transfer from rail 7u to the pair of rails 7d. As a result, unmanned transport vehicle 110 continues to travel along rail 7u and passes through position (d). At this time, there is no pair of rails 7d beneath unmanned transport vehicle 110. Therefore, unmanned transport vehicle 110, after passing through position (d), rotates the two arms 118 such that each of the two arms 118 rises at its leading end along the vertical direction. Unmanned transport vehicle 110 continues to travel along rail 7u and exits Building A.

Thus, the rail structure according to the present embodiment includes rail 7d and rail 7u positioned above rail 7d. Note that rail 7d is also called a first rail, and rail 7u is also called a second rail. As illustrated in FIG. 31 and FIG. 32, when regions that exist sequentially along the direction in which rail 7u extends are defined as a first region, a second region, a third region, and a fourth region, rail 7d exists in the second region and the third region. The second region includes a first slope region in which the distance in the height direction between rail 7d and rail 7u narrows with increasing distance from the first region. In the third region, rail 7d includes a first portion in which the distance between rail 7d and rail 7u increases with increasing distance from the second region when viewed from above in the vertical direction.

As a result, since the second region includes the first slope region, unmanned transport vehicle 110 can easily transfer from rail 7u to rail 7d as illustrated in FIG. 31. Furthermore, since rail 7d includes the first portion, unmanned transport vehicle 110 can easily move away from rail 7u in the horizontal direction by traveling along rail 7d.

In the first slope region, rail 7d is inclined relative to the horizontal direction, while rail 7u extends along the horizontal direction.

As a result, unmanned transport vehicle 110 can bring the four wheels 113 close to rail 7d as illustrated in FIG. 31 while traveling along rail 7u, and can easily transfer from rail 7u to rail 7d.

The first portion includes a first shift portion that, as illustrated in FIG. 31, connects to a first parallel portion of rail 7d while shifting so as to move away from rail 7u in the horizontal direction with increasing distance from the second region. In the third region, the first parallel portion and rail 7u are parallel.

As a result, since the first portion of rail 7d includes the first shift portion, unmanned transport vehicle 110 traveling along rail 7d can easily move away from rail 7u in the horizontal direction.

As illustrated in FIG. 31, the first portion includes a first curve portion that has a shape that curves in the horizontal direction and changes the traveling direction of rail 7d.

As a result, since the first portion of rail 7d includes the first curve portion, unmanned transport vehicle 110 traveling along the first curve portion can easily change its traveling direction without stopping.

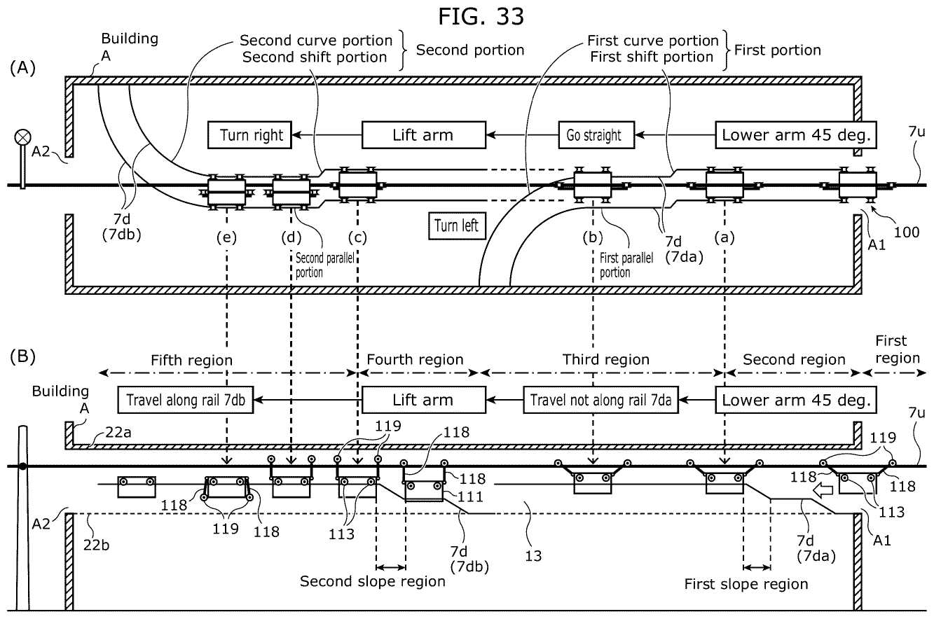

FIG. 33 illustrates another example of unmanned transport vehicle 110 entering Building A from outside. In FIG. 33, (A) illustrates Building A and unmanned transport vehicle 110 as viewed from above, and (B) illustrates Building A and unmanned transport vehicle 110 as viewed from a horizontal direction. Note that in FIG. 33, a cross-section of Building A is illustrated. FIG. 33 illustrates an example in which unmanned transport vehicle 110 sequentially passes through position (a), position (b), position (c), position (d), and position (e).

In the example of FIG. 33, rail 7u is installed in third story space 13 inside Building A so as to penetrate through Building A in the horizontal direction, similar to the examples of FIG. 31 and FIG. 32. In the example of FIG. 33, a pair of rails 7da and a pair of rails 7db are installed in third story space 13 inside Building A, each as a pair of rails 7d. The pair of rails 7da are provided on the opening A1 side in third story space 13, and the pair of rails 7db are provided on the opening A2 side in third story space 13. As illustrated in (A) in FIG. 33, the pair of rails 7da are arranged along rail 7u from opening A1 to position (b) inside Building A; however, when viewed from the orientation facing from opening A1 toward opening A2, the pair of rails 7da curve to the left in the horizontal direction inside Building A. However, the pair of rails 7db are arranged along rail 7u from the center of Building A to position (e) inside Building A; however, when viewed from the orientation facing from opening A1 toward opening A2, the pair of rails 7db curve to the right in the horizontal direction inside Building A. The portions of the pair of rails 7da and the pair of rails 7db on the opening A1 side are positioned lower than the other portions.

Unmanned transport vehicle 110 enters from outside Building A into Building A through opening A1, traveling along rail 7u. Here, unmanned transport vehicle 110 places the two wheels 119 on rail 7u while inclining each of the two arms 118 in the anteroposterior direction by approximately 45 degrees from the vertical direction. As a result, enclosure 111 of unmanned transport vehicle 110 is close to rail 7u and is at a high position from the ground. As a result, even after entering Building A, unmanned transport vehicle 110 travels along rail 7u, and even when passing through positions (a) and (b), the four wheels 113 do not ride on the pair of rails 7d. In other words, unmanned transport vehicle 110 does not transfer from rail 7u to the pair of rails 7d.

When unmanned transport vehicle 110 travels through the center of Building A, the pair of rails 7db is positioned below the four wheels 113. Here, unmanned transport vehicle 110 rotates the two arms 118 such that each of the two arms 118 rises at its leading end along the vertical direction. As a result, the distance between rail 7u and enclosure 111 of unmanned transport vehicle 110 increases, and the height of enclosure 111 from the ground surface decreases. As a result, when unmanned transport vehicle 110 passes through position (c), the four wheels 113 of unmanned transport vehicle 110 are placed on the pair of rails 7db, and the two wheels 119 move upward and away from rail 7u. Furthermore, unmanned transport vehicle 110 begins traveling along the pair of rails 7db by rotation of the four wheels 113, and shifts to the left while moving from position (c) toward position (d). As a result, when unmanned transport vehicle 110 passes through position (d), rail 7u is not arranged below the two wheels 119. Therefore, unmanned transport vehicle 110, when passing through position (d) and moving toward position (e), can lower the two wheels 119 by rotating arms 118.

Thereafter, unmanned transport vehicle 110 travels along the pair of rails 7db while curving to the right, as illustrated in (A) in FIG. 33.

Thus, the rail structure according to the present embodiment includes rail 7da, rail 7db, and rail 7u positioned above rail 7da and rail 7db. Rail 7da, rail 7db, and rail 7u are also respectively called a first lower rail, a second lower rail, and an upper rail. When regions that exist sequentially along the direction in which rail 7u extends are defined as a first region, a second region, a third region, a fourth region, and a fifth region, rail 7da exists in the second region and the third region, and rail 7db exists in the fourth region and the fifth region. The second region includes a first slope region in which the distance in the height direction between rail 7da and rail 7u narrows with increasing distance from the first region. In the third region, rail 7da includes a first portion in which the distance between rail 7da and rail 7u increases with increasing distance from the second region when viewed from above in the vertical direction. The fourth region includes a second slope region in which the distance in the height direction between rail 7db and rail 7u narrows with increasing distance from the third region. In the fifth region, rail 7db includes a second portion in which the distance between rail 7db and rail 7u increases with increasing distance from the fourth region when viewed from above in the vertical direction.

As a result, since the second region includes the first slope region, unmanned transport vehicle 110 can easily transfer from rail 7u to rail 7da as illustrated in FIG. 33. Furthermore, since rail 7da includes the first portion, unmanned transport vehicle 110 can easily move away from rail 7u in the horizontal direction by traveling along rail 7da. Similarly, since the fourth region includes the second slope region, unmanned transport vehicle 110 can easily transfer from rail 7u to rail 7db as illustrated in FIG. 33. Furthermore, since rail 7db includes the second portion, unmanned transport vehicle 110 can easily move away from rail 7u in the horizontal direction by traveling along rail 7db.

In the first slope region, rail 7da is inclined relative to the horizontal direction, while rail 7u extends along the horizontal direction. In the second slope region, rail 7db is inclined relative to the horizontal direction, while rail 7u extends along the horizontal direction.

As a result, unmanned transport vehicle 110 can bring the four wheels 113 close to rail 7da as illustrated in FIG. 33 while traveling along rail 7u, and can easily transfer from rail 7u to rail 7da. Similarly, unmanned transport vehicle 110 can bring the four wheels 113 close to rail 7db as illustrated in FIG. 33 while traveling along rail 7u, and can easily transfer from rail 7u to rail 7db.

The first portion includes a first shift portion that connects to a first parallel portion of rail 7da while shifting so as to move away from rail 7u in the horizontal direction with increasing distance from the second region. In the third region, the first parallel portion and rail 7u are parallel. The second portion includes a second shift portion that connects to a second parallel portion of rail 7db while shifting so as to move away from rail 7u in the horizontal direction with increasing distance from the fourth region. In the fifth region, the second parallel portion and rail 7u are parallel.

As a result, since the first portion of rail 7da includes the first shift portion, unmanned transport vehicle 110 traveling along rail 7da can easily move away from rail 7u in the horizontal direction. Similarly, since the second portion of rail 7db includes the second shift portion, unmanned transport vehicle 110 traveling along rail 7db can easily move away from rail 7u in the horizontal direction.

The first portion includes a first curve portion that has a shape that curves in the horizontal direction and changes the traveling direction of rail 7da. The second portion includes a second curve portion that has a shape that curves in the horizontal direction and changes the traveling direction of rail 7db.

As a result, since the first portion of rail 7da includes the first curve portion, unmanned transport vehicle 110 traveling along the first curve portion can easily change its traveling direction without stopping. Similarly, since the second portion of rail 7db includes the second curve portion, unmanned transport vehicle 110 traveling along the second curve portion can easily change its traveling direction without stopping.

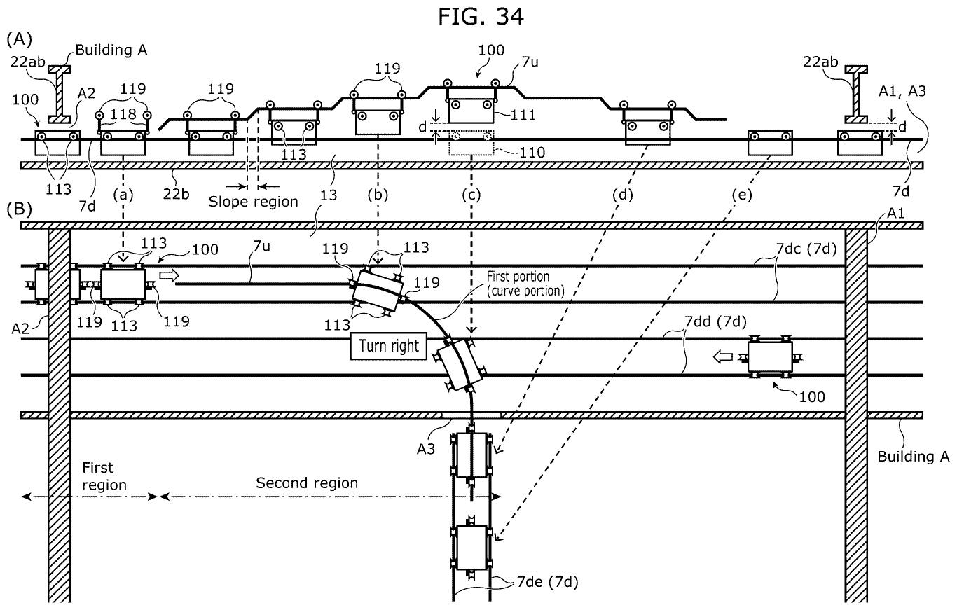

FIG. 34 illustrates another example of unmanned transport vehicle 110 entering Building A from outside. In FIG. 34, (A) illustrates Building A and unmanned transport vehicle 110 as viewed from a horizontal direction, and (B) illustrates Building A and unmanned transport vehicle 110 as viewed from above. Note that in FIG. 34, a cross-section of Building A is illustrated. FIG. 34 illustrates an example in which unmanned transport vehicle 110 sequentially passes through position (a), position (b), position (c), position (d), and position (e).

In the example of FIG. 34, a pair of rails 7dc and a pair of rails 7dd are installed in third story space 13 inside Building A so as to penetrate through Building A in the horizontal direction, and a pair of rails 7de are installed outside Building A. Note that each of the pair of rails 7dc, the pair of rails 7dd, and the pair of rails 7de is a pair of rails 7d on which wheels 113 are placed. Stated differently, three pairs of rails 7d are provided. Rail 7u is disposed above the three pairs of rails 7d.

More specifically, each rail 7d included in the pair of rails 7dc and the pair of rails 7dd is disposed so as to pass through opening A1 and opening A2 of Building A, approximately parallel to each other, and in a straight line. The pair of rails 7de is disposed so as to extend outward from opening A3 of Building A, as illustrated in (B) in FIG. 34. Note that ceiling beam 22ab is located above opening A1, opening A2, and opening A3.

Rail 7u, as illustrated in (B) in FIG. 34, includes a first side end portion along the pair of rails 7dc, a central portion straddling the pair of rails 7dd, and a second side end portion penetrating through opening A3. The first side end portion is formed such that its height from the ground increases as it extends from the end on the opening A1 side toward the central portion. The second side end portion is formed such that its height from the ground decreases as it extends from the central portion toward the end on the opening A3 side. Note that the pair of rails 7de are provided below the portion of the second side end portion that is outside Building A. The central portion side of the first side end portion and the central portion are formed to curve to the right in the horizontal direction when viewed from the orientation from opening A2 toward opening A1.

Unmanned transport vehicle 110 enters Building A through opening A2 by traveling along the pair of rails 7dc by rotation of the four wheels 113. Unmanned transport vehicle 110, upon reaching position (a), raises the leading end of each of the two arms 118 such that each of the two arms 118 aligns with the vertical direction. Unmanned transport vehicle 110, by rotation of the four wheels 113, places the two wheels 119 onto the first side end portion of rail 7u located above the pair of rails 7dc. As a result, unmanned transport vehicle 110 travels along the first side end portion of rail 7u by rotation of the two wheels 119. Stated differently, unmanned transport vehicle 110 transfers from the pair of rails 7dc to the first side end portion of rail 7u. Here, the first side end portion is formed, as described above, such that its height from the ground increases as it extends from the end on the opening A1 side toward the central portion. Therefore, the four wheels 113 of unmanned transport vehicle 110 move upward and away from the pair of rails 7dc. Unmanned transport vehicle 110 travels from position (b) along rail 7u while turning to the right, and passes through position (c), which is the central portion of rail 7u. Here, the central portion of rail 7u is positioned at a high position from the ground. Stated differently, the central portion of rail 7u is sufficiently separated in the height direction from the pair of rails 7dd located directly below it. Therefore, when one unmanned transport vehicle 110 passes through position (c), even if another unmanned transport vehicle 110 travels along the pair of rails 7dd and comes directly below the one unmanned transport vehicle 110, a vertical spacing of distance d between the one unmanned transport vehicle 110 and the other unmanned transport vehicle 110 can be secured (where d is, for example, greater than or equal to 1 cm).

Unmanned transport vehicle 110 travels along rail 7u while descending from the central portion toward the second side end portion, and reaches the second side end portion (for example, position (d)). Here, a pair of rails 7de is arranged below the four wheels 113 of unmanned transport vehicle 110. Due to the descent accompanying the travel of unmanned transport vehicle 110 along rail 7u, at position (e), the four wheels 113 are placed on the pair of rails 7de. Thereafter, unmanned transport vehicle 110 travels along the pair of rails 7de by rotation of the four wheels 113. As a result, unmanned transport vehicle 110 transfers from rail 7u to a pair of rails 7de.

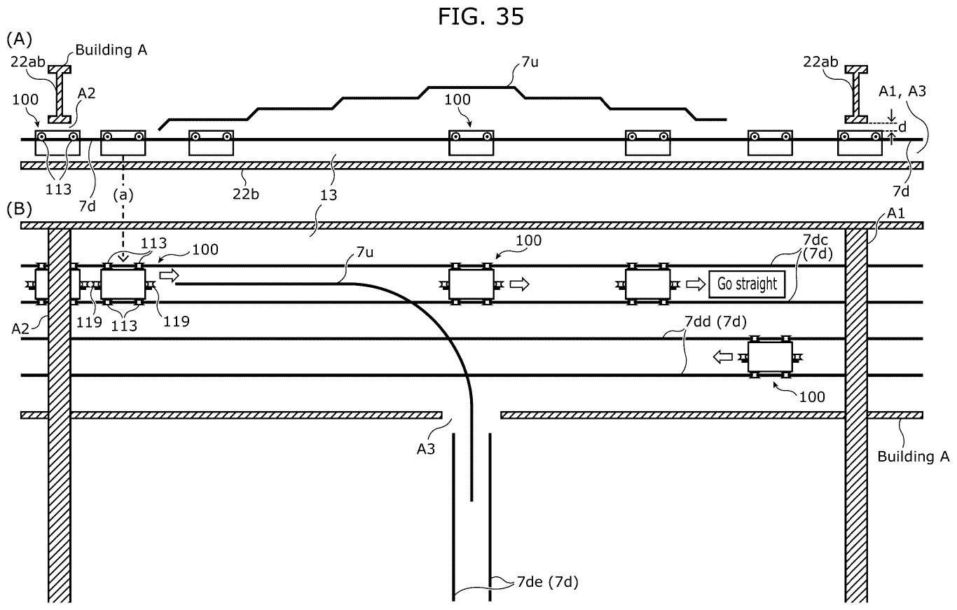

FIG. 35 illustrates another example of unmanned transport vehicle 110 entering Building A from outside. In FIG. 35, (A) illustrates Building A and unmanned transport vehicle 110 as viewed from a horizontal direction, and (B) illustrates Building A and unmanned transport vehicle 110 as viewed from above. Note that in FIG. 35, a cross-section of Building A is illustrated. In the example of FIG. 35, rail 7u, the pair of rails 7dc, the pair of rails 7dd, and the pair of rails 7de are installed in the same manner as in the example of FIG. 34.

Unmanned transport vehicle 110 enters Building A through opening A2 by traveling along the pair of rails 7dc by rotation of the four wheels 113. In the example of FIG. 34, unmanned transport vehicle 110 raises the leading end of each of the two arms 118. However, in the example of FIG. 35, unmanned transport vehicle 110 does not raise the leading end of each of the two arms 118. As a result, unmanned transport vehicle 110 continues to travel along the pair of rails 7dc in third story space 13 of Building A. Stated differently, unmanned transport vehicle 110 continues to travel along the pair of rails 7dc without transferring between rails.

Thus, the rail structure according to the present embodiment includes rail 7d and rail 7u positioned above rail 7d. Note that rail 7d is also called a first rail, and rail 7u is also called a second rail. As illustrated in FIG. 34, when regions that exist sequentially along the direction in which rail 7d extends are defined as a first region and a second region, rail 7u exists in the second region. The second region includes a slope region in which the distance in the height direction between rail 7d and rail 7u widens with increasing distance from the first region. In the second region, rail 7u includes a first portion in which the distance between rail 7u and rail 7d increases with increasing distance from the first region when viewed from above in the vertical direction.

As a result, since the second region includes the slope region, unmanned transport vehicle 110 can easily transfer from rail 7d to rail 7u as illustrated in FIG. 34. Furthermore, since rail 7u includes the first portion, unmanned transport vehicle 110 can easily move away from rail 7d in the horizontal direction by traveling along rail 7u.

In the slope region, rail 7d extends along the horizontal direction, while rail 7u is inclined relative to the horizontal direction.

As a result, unmanned transport vehicle 110 can separate the four wheels 113 from rail 7d by placing and rotating the two wheels 119 on rail 7u as illustrated in FIG. 34 while traveling along rail 7d. As a result, unmanned transport vehicle 110 can easily transfer from rail 7u to rail 7d.

The first portion includes a curve portion that has a shape that curves in the horizontal direction and changes the traveling direction of rail 7u.

As a result, since the first portion of rail 7u includes the curve portion, unmanned transport vehicle 110 traveling along the curve portion can easily change its traveling direction without stopping.

Unmanned transport vehicle 110 according to the present embodiment includes enclosure 111, wheels 113 provided on enclosure 111, arm 118 having a first end connected to enclosure 111, at least one actuator that drives arm 118, and wheel 119 connected to a second end of arm 118. Note that arm 118 is called a first arm, the first end of arm 118 is also called a base portion, and the second end of arm 118 may be called a leading end. Wheel 113 and wheel 119 may be respectively called a first wheel and a second wheel. Wheels 113 are for traveling on rail 7d, and wheel 119 is for traveling on rail 7u positioned above rail 7d. Arm 118 is switched between a first arm state and a second arm state by actuation of the at least one actuator. As illustrated in (B) in FIG. 31, in the first arm state, wheels 119 are positioned at a first position above wheels 113. In the second arm state, wheels 119 are positioned at a second position below the first position.

As a result, by switching arm 118 between the first arm state and the second arm state, unmanned transport vehicle 110 can transfer from rails 7d to rail 7u, and conversely, can transfer from rail 7u to rails 7d.

Arm 118 is further switched to a third arm state by actuation of the at least one actuator. As illustrated in (B) in FIG. 32, in the third arm state, wheels 119 are positioned at a third position that is below the first position and above the second position. Note that the first position, the second position, and the third position are vertical positions referenced from wheels 113.

As a result, unmanned transport vehicle 110 can, as illustrated in FIG. 32, lift wheels 113 from rails 7d by positioning wheels 119 at the third position, and can avoid transferring from rail 7u to rails 7d.

As illustrated in FIG. 31, when arm 118 is in the first arm state and wheels 119 are traveling on rail 7u, when wheels 113 travel on rails 7d causing wheels 119 to separate from rail 7u, arm 118 changes from the first arm state to the second arm state by actuation of the at least one actuator.

This allows unmanned transport vehicle 110 to stow wheels 119 that are not in use and perform stable travel using wheels 113.

As illustrated in FIG. 32 and FIG. 33, when arm 118 is in the first arm state and wheels 119 are traveling on rail 7u, arm 118 changes from the first arm state to the third arm state by actuation of the at least one actuator so that wheels 113 do not contact the structure.

This allows unmanned transport vehicle 110 to travel appropriately along rail 7u while avoiding contact of wheels 113 with a structure (for example, rail 7d).

As illustrated in FIG. 32, when arm 118 is in the first arm state and wheels 119 are traveling on rail 7u, arm 118 changes from the first arm state to the third arm state by actuation of the at least one actuator so that wheels 113 do not contact the structure, and then changes from the third arm state to the first arm state by actuation of the at least one actuator.

This allows unmanned transport vehicle 110 to travel along rail 7u so as to jump over the structure.

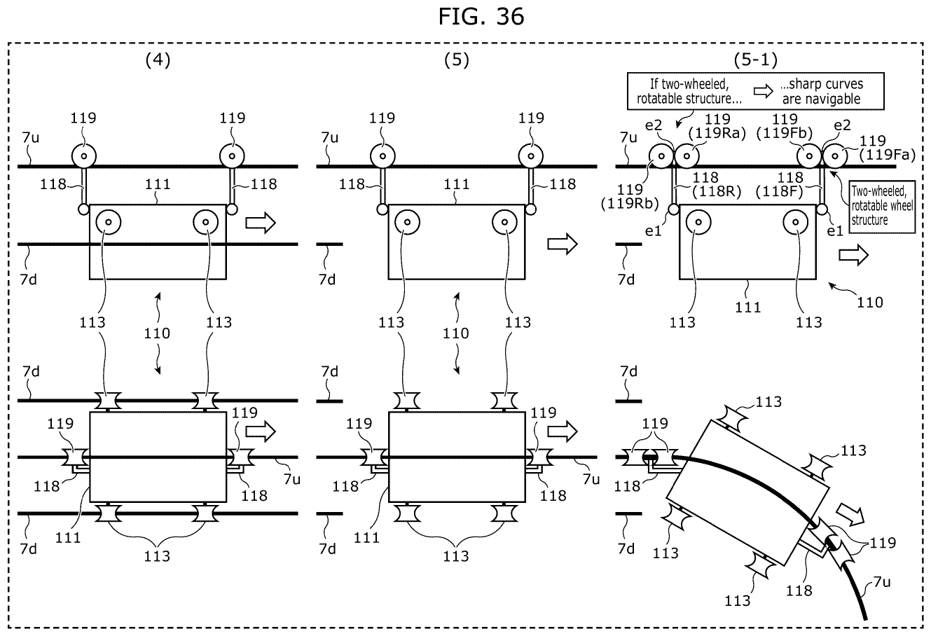

FIG. 36 illustrates another example of unmanned transport vehicle 110.

Previously, there was a possibility that wheels 119 would derail when unmanned transport vehicle 110 traveled on curved sections of rail 7u, particularly on curved sections with large angles. In the example of FIG. 36, as illustrated in (5-1), a rotation structure is provided that allows wheels 119 to rotate in a direction along rail 7u. The rotation structure may be any structure as long as it allows wheels 119 to rotate in a direction along rail 7u. The rotation structure may be provided at the connection point between arm 118 and enclosure 111, or may be provided at the connection point between arm 118 and wheel 119. The rotation structure may be provided for each arm 118. The rotation structure allows the direction in which enclosure 111 extends and the orientation of front wheels 119Fa and 119Fb to be different from each other. The rotation structure allows the direction in which enclosure 111 extends and the orientation of rear wheels 119Ra and 119Rb to be different from each other. The rotation structure allows the direction in which front wheels 119Fa and 119Fb extend along rail 7u and the direction in which rear wheels 119Ra and 119Rb extend along rail 7u to be different from each other. Stated differently, the rotation structure allows an angle to be formed between the direction in which front wheels 119Fa and 119Fb extend along rail 7u and the direction in which rear wheels 119Ra and 119Rb extend along rail 7u. As a result, when unmanned transport vehicle 110 travels on curved sections of rail 7u, the direction in which front wheels 119Fa and 119Fb extend along rail 7u, and/or the direction in which rear wheels 119Ra and 119Rb extend along rail 7u, can be changed to follow the curve, thereby reducing the possibility that wheels 119 will derail when unmanned transport vehicle 110 travels on curved sections of rail 7u. The number of wheels 119 connected to one arm 118 may be two, as in the example of (5-1) in FIG. 36. By providing two wheels 119, contact between wheels 119 and rail 7u can be stabilized compared to when there is only one wheel 119. This further reduces the possibility that wheels 119 will derail.

Unmanned transport vehicle 110 according to the present embodiment includes, as illustrated in (5-1) in FIG. 36, enclosure 111, first arm 118F having first end e1 connected to enclosure 111, one or more wheels 119 connected to second end e2 of first arm 118F, second arm 118R having first end e1 connected to enclosure 111, and one or more wheels 119 connected to second end e2 of second arm 118R. Note that first arm 118F and second arm 118R are also called arm 118. One or more wheels 119 of first arm 118F are also called one or more first wheels, and one or more wheels 119 of second arm 118R are also called one or more second wheels. Unmanned transport vehicle 110 also includes a rotation structure that changes the orientation of one or more first wheels and the orientation of one or more second wheels, and at least one actuator that drives first arm 118F, second arm 118R, and the rotation structure. One or more first wheels of first arm 118F are for traveling on rail 7u, and one or more second wheels of second arm 118R are for traveling on rail 7u.

This allows the orientation of the one or more first wheels and the orientation of the one or more second wheels to be changed by the rotation structure so as to correspond to curves in rail 7u on which unmanned transport vehicle 110 travels. Therefore, stability can be increased when unmanned transport vehicle 110 travels around curves.

The one or more first wheels include wheel 119Fa and wheel 119Fb. Note that wheel 119Fa and wheel 119Fb are also respectively called a first first wheel and a second first wheel. The one or more second wheels include wheel 119Ra and wheel 119Rb. Note that wheel 119Ra and wheel 119Rb are also respectively called a first second wheel and a second second wheel.

This allows further enhancement of stability when unmanned transport vehicle 110 travels around curves, because a plurality of wheels 119 are attached to single arm 118.

The rotation structure varies the degree of change in the orientation of the one or more first wheels and the orientation of the one or more second wheels according to the curvature of curves in rail 7u.

This further inhibits the possibility that the one or more first wheels and the one or more second wheels will derail from rail 7u.

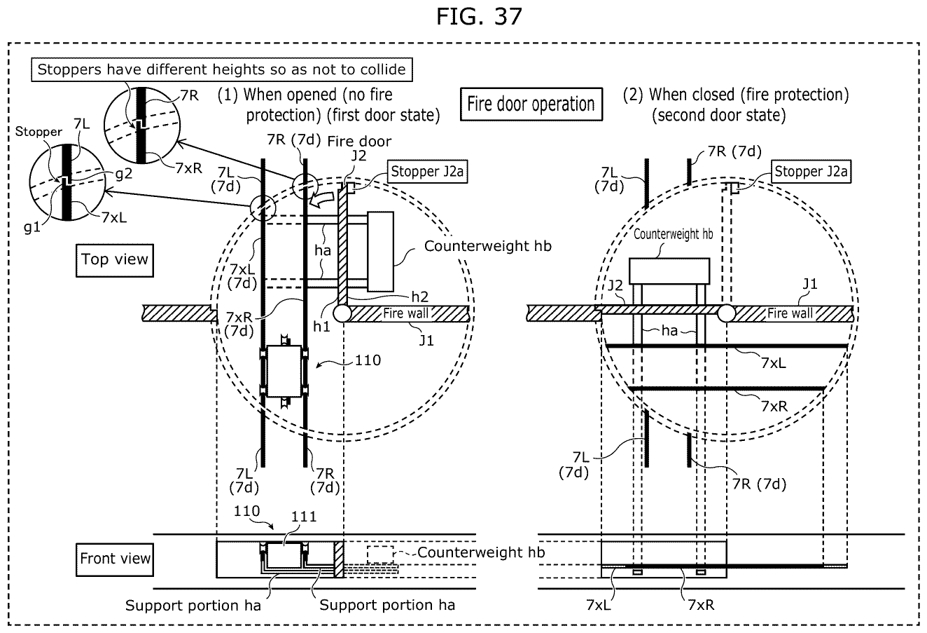

FIG. 37 illustrates an example of a structure including rail 7d according to the present embodiment. More specifically, FIG. 37 relates to a structure including fire door J2 and rail 7d.

In FIG. 37, a pair of rails 7d, namely movable rail 7xL and movable rail 7xR, are integrally provided on fire door J2 and rotate together with fire door J2. Accordingly, even when it becomes necessary to close fire door J2, such as in the event of a fire, this prevents situations where rail 7d becomes an obstacle and fire door J2 cannot be closed.

Hereinafter, the configuration of FIG. 37 will be described. Fire door J2 is pivotably connected to fire wall J1. Movable rail 7xL and movable rail 7xR are connected to fire door J2 via respective support portions ha. Furthermore, in FIG. 37, counterweight hb for offsetting the weight of movable rail 7xL, movable rail 7xR, and the two support portions ha is provided on the side opposite to the side where movable rail 7xL and movable rail 7xR are located. Therefore, when fire door J2 pivots with respect to fire wall J1, movable rail 7xL, movable rail 7xR, the two support portions ha, and counterweight hb pivot together with fire door J2.

Fire door J2 can transition between an open state and a closed state. In the open state, movable rail 7xL is coupled to rail 7L of the fixed pair of rails 7d, and movable rail 7xR is coupled to rail 7R of the fixed pair of rails 7d. Note that rail 7L and rail 7R are each also called a fixed rail. This allows unmanned transport vehicle 110 to travel along rails 7d and pass through the frame where fire door J2 is provided. Here, movable rail 7xL and rail 7L are coupled by engagement of first protrusion g1 provided on movable rail 7xL with second protrusion g2 provided on rail 7L.

Fire door J2 is maintained in an open state by stopper J2a. When stopper J2a is removed, fire door J2 may automatically close. A spring or other elastic body may be used as a means for automatically closing fire door J2. For example, when stopper J2a is removed, a compressed spring may extend and push fire door J2, thereby closing fire door J2. When stopper J2a is removed and fire door J2 starts pivoting, the connection between movable rail 7xL and rail 7L becomes disengaged. Note that movable rail 7xR and rail 7R also change in the same manner as movable rail 7xL and rail 7L.

Thus, the structure according to the present embodiment includes fire wall J1 which is a wall, fire door J2 which is a door pivotably connected to fire wall J1, support portion ha connected to fire door J2, and movable rail 7xL or 7xR that is connected to support portion ha for unmanned transport vehicle 110 to travel on and pivots together with fire door J2.

With this, since movable rail 7xL or 7xR pivots together with fire door J2, movable rail 7xL or 7xR can be set to an appropriate state according to the state of fire door J2.

The structure is capable of transitioning between a first door state in which fire door J2 is in an open state and a second door state in which fire door J2 is in a closed state. In the first door state, movable rail 7xL or 7xR is coupled to the fixed rail, and in the second door state, movable rail 7xL or 7xR is not coupled to the fixed rail. Note that the fixed rail is rail 7L or 7R.

With this, by opening fire door J2 and coupling movable rail 7xL or 7xR with the fixed rail, unmanned transport vehicle 110 can travel along rails 7d, and fire door J2 can be properly closed by moving movable rail 7xL or 7xR together with fire door J2.

Furthermore, the structure includes stopper J2a that prevents movement of fire door J2 to maintain the first door state.

With this, since the first door state of fire door J2 is maintained, unmanned transport vehicle 110 can safely travel along rails 7d.

Movable rail 7xL includes first protrusion g1, and rail 7L, which is a fixed rail, includes second protrusion g2. In the first door state, movable rail 7xL is coupled to rail 7L by first protrusion g1 and second protrusion g2 contacting each other.

This makes it possible to stabilize the coupled state between movable rail 7xL and rail 7L.

Fire door J2 includes first surface h1 and second surface h2. Movable rails 7xL and 7xR and two support portions ha are provided on first surface h1. The structure includes counterweight hb provided on second surface h2.

With this, the balance between the weight applied to first surface h1 of fire door J2 and the weight applied to second surface h2 of fire door J2 can be maintained, and the movement or state of fire door J2 can be stabilized.

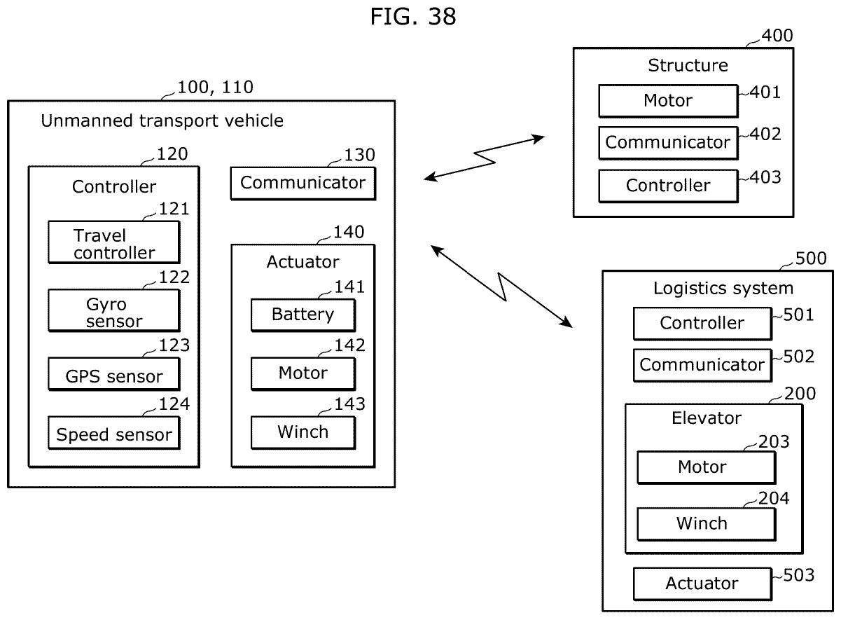

FIG. 38 illustrates an example of a schematic configuration of an unmanned transport vehicle, a structure, and a logistics system according to the above embodiments.

As illustrated in FIG. 38, the unmanned transport vehicle includes, for example, controller 120, communicator 130, and actuator 140. Note that the unmanned transport vehicle may be unmanned transport vehicle 100 or may be unmanned transport vehicle 110. For example, controller 120 includes a CPU or processor, and controls each processing operation of the unmanned transport vehicle by reading and executing a program stored in memory. Controller 120 includes travel controller 121, gyro sensor 122, GPS 123, and speed sensor 124. Travel controller 121 performs processing operations to cause the unmanned transport vehicle to travel by rotating wheels 103, 113, 119, and the like. Gyro sensor 122 detects acceleration, inclination, and the like of the unmanned transport vehicle, global positioning system (GPS) sensor 123 detects the position of the unmanned transport vehicle, and speed sensor 124 detects the speed of the unmanned transport vehicle. Travel controller 121 may control the travel of the unmanned transport vehicle based on the detection results from these sensors. Communicator 130 communicates with devices or equipment external to the unmanned transport vehicle via wired or wireless connection. Wireless communication may be performed via Wi-Fi (registered trademark), Bluetooth (registered trademark), ZigBee (registered trademark), or specified low power radio, but is not limited thereto. Actuator 140 includes battery 141, motor 142, and winch 143. Battery 141 supplies power for the unmanned transport vehicle to travel, or power for communicator 130 to perform communication. Motor 142 is an actuator for driving, for example, arm 118, wheel 119, wheel 113, and rotation structure. The unmanned transport vehicle may include a plurality of motors 142. Winch 143 may be used as winch 115.

Structure 400 is the rail structure or the structure described above, and includes, for example, motor 401, communicator 402, and controller 403. Motor 401 may be turntable rotation motor 38, or it may be an actuator for opening and closing fire door J2 described above. Communicator 402, similar to communicator 130 of the unmanned transport vehicle, communicates with devices or equipment external to structure 400 via wired or wireless connection. For example, communicator 402 may communicate with the unmanned transport vehicle.

Logistics system 500 may be, for example, office building delivery system Sy1, apartment delivery system Sy2, logistics system Sy3, logistics system Sy4, etc. Such logistics system 500 includes, for example, controller 501, communicator 502, elevator 200, and actuator 503. Elevator 200 includes motor 203 and winch 204. Motor 203 may be an actuator such as rail lifting device 33, rail extension-contraction device 34, etc., arranged on elevator 200. Winch 204 raises and lowers elevator carriage 210 by reeling out or reeling in carriage wire 202. Actuator 503 may be an actuator for moving rails disposed in each building, etc. Communicator 502, similar to communicator 130 of the unmanned transport vehicle, communicates with devices or equipment external to logistics system 500 via wired or wireless connection. For example, communicator 502 may communicate with the unmanned transport vehicle. Logistics system 500 may include structure 400.

### Embodiment 8

Unmanned transport vehicle 100 according to Embodiments 1 to 6 travels along one rail 7. However, unmanned transport vehicle 110 according to Embodiment 7 travels along two rails 7, similar to unmanned transport vehicle 110a according to the present embodiment. Unmanned transport vehicles 100 and 110 according to Embodiments 1 to 7 travel with enclosure 111 positioned below rail 7 or between two rails 7. Unmanned transport vehicle 110a according to the present embodiment travels with enclosure 111 positioned on two rails 7.

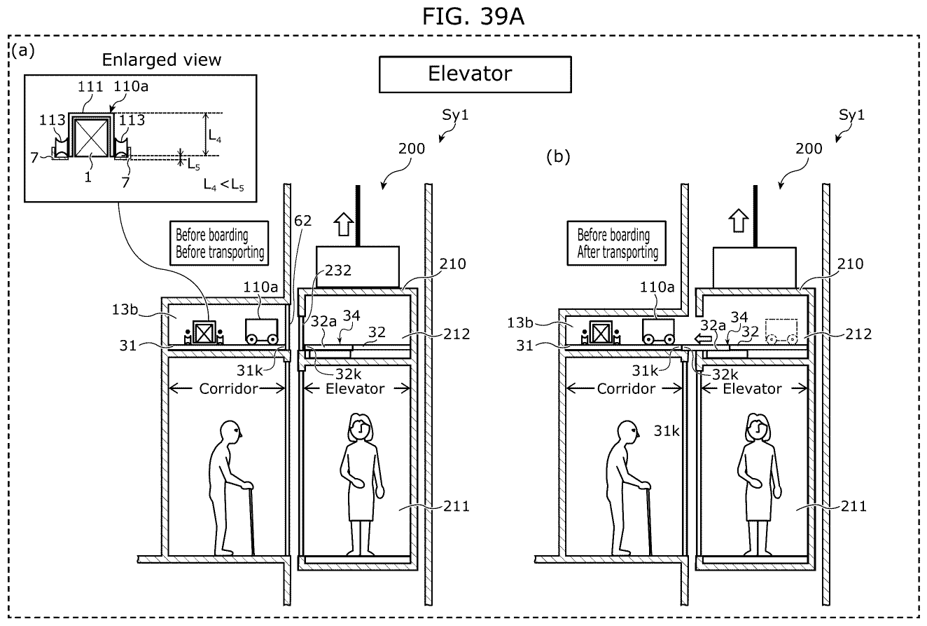

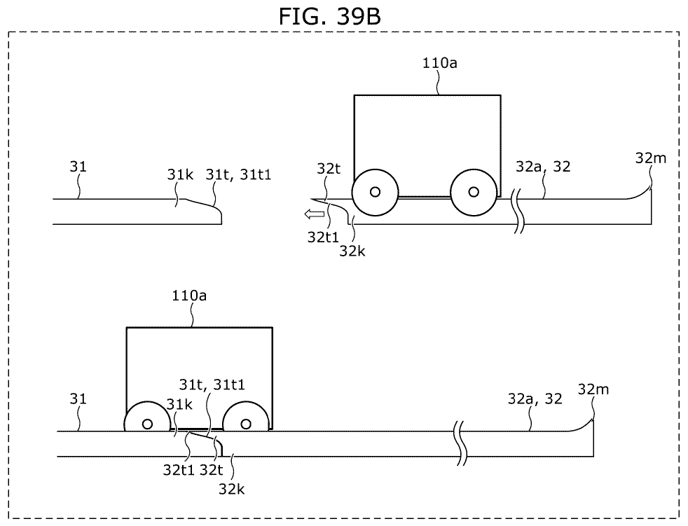

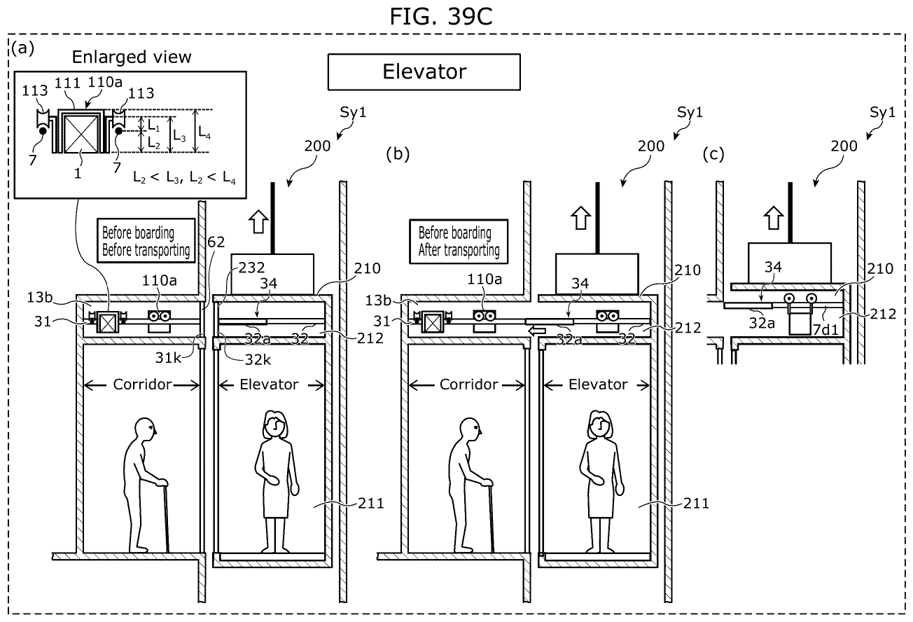

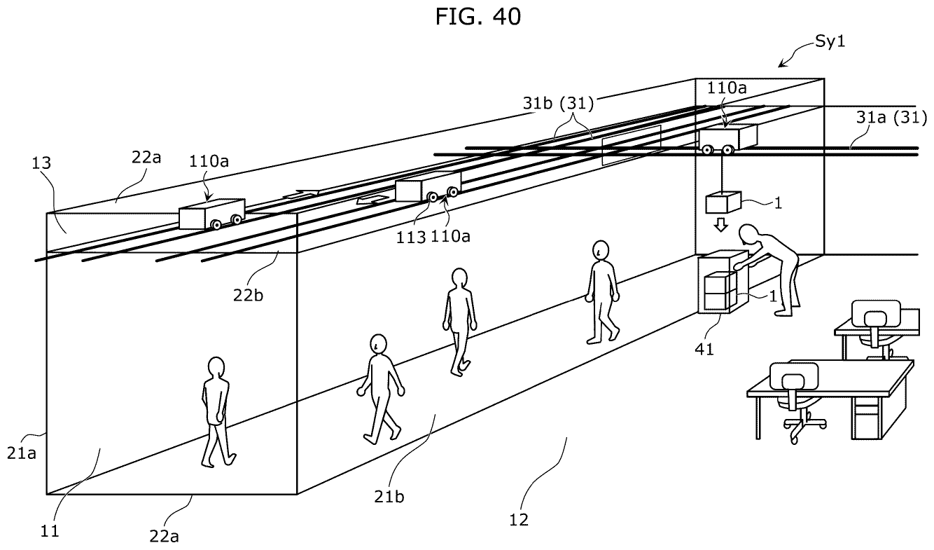

FIG. 39A illustrates an example in which unmanned transport vehicle 110a according to Embodiment 8 is applied to elevator 200. In (a) in FIG. 39A, a state in which a pair of story rails 31 and a pair of elevator rails 32 are not connected is illustrated. In (b) in FIG. 39A, a state in which a pair of story rails 31 and a pair of elevator rails 32 are connected is illustrated.

Office building delivery system Sy1 according to the present embodiment is installed in a story area of the office building. Office building delivery system Sy1 includes unmanned transport vehicle 110a and elevator 200.

In the present embodiment, unmanned transport vehicle 110a is configured to be slimmer in the up-down direction than unmanned transport vehicles 100, 110 so that it can travel even in narrow spaces such as within third story space 13, and travels along a pair of story rails 31 arranged parallel to each other on a horizontal plane. Unmanned transport vehicles 100, 110, and 110a are examples of a transport vehicle.

Note that a pair of story rails 31 is arranged in fourth story space 13b, and a pair of elevator rails 32 is arranged in second elevator space 212. Unmanned transport vehicle 110a can travel along the pair of story rails 31 and can travel along the pair of elevator rails 32.

Second elevator space 212 includes second carriage door 232 formed at a position opposite to the pair of story rails 31. Fourth story space 13b includes second landing door 62 formed at a position opposite to the pair of story rails 31. When elevator carriage 210 in elevator 200 arrives at a predetermined story, second carriage door 232 is arranged so as to be opposite to second landing door 62. Here, the height of the pair of elevator rails 32 and the height of the pair of story rails 31 are aligned.

When the stories of the building have varying story heights, each time elevator carriage 210 arrives at a predetermined story, the height of the pair of elevator rails 32 is adjusted to match the height of the pair of story rails 31. The height of the pair of elevator rails 32 may be aligned with the height of the pair of story rails 31 by rail lifting device 33 described above, or the height of the pair of elevator rails 32 may be aligned with the height of the pair of story rails 31 by elevator carriage 210 being controlled by controller 501.

For example, unmanned transport vehicle 110a includes four wheels 113 arranged on a virtual plane (for example, a horizontal plane), two of the four wheels 113 are placed on one story rail 31 in the pair of story rails 31, and the remaining two wheels 113 are placed on the other story rail 31 in the pair of story rails 31. Since the four wheels 113 are arranged on the lower side of enclosure 111 of unmanned transport vehicle 110a, enclosure 111 of unmanned transport vehicle 110a is positioned above the pair of story rails 31. Here, in the system including unmanned transport vehicle 110a and rail 7, the sum of thickness (height) L4 of unmanned transport vehicle 110a and thickness (height) L5 of a portion of rail 7 that the four wheels 113 of unmanned transport vehicle 110a contact becomes the height of the system.

Note that in the following description, the left-right direction of unmanned transport vehicle 110a is a direction extending along the axle of each of the four wheels 113, and the anteroposterior direction of unmanned transport vehicle 110a is a direction that extends along the above-mentioned plane on which the four wheels 113 are arranged and is perpendicular to the left-right direction.

In the present embodiment, elevator 200 includes rail extension-contraction device 34, similar to the example illustrated in FIG. 20 and FIG. 24.

Rail extension-contraction device 34 couples the pair of movable rails 32a to the pair of story rails 31 by moving the above-mentioned pair of movable rails 32a included in the pair of elevator rails 32 in the horizontal direction.

When the height of the pair of elevator rails 32 is aligned with the height of the pair of story rails 31, rail extension-contraction device 34 is controlled by controller 501 to move the pair of movable rails 32a in the horizontal direction so as to couple them to the pair of story rails 31. First ends 32k of the pair of movable rails 32a in the pair of elevator rails 32 are connected to second ends 31k of the pair of story rails 31. This causes the pair of movable rails 32a to be coupled to the pair of story rails 31.

FIG. 39B illustrates connection between the pair of movable rails 32a and the pair of story rails 31.

Here, first ends 32k of the pair of movable rails 32a in the pair of elevator rails 32 and second ends 31k of the pair of story rails 31 are processed to be easily connected.

More specifically, first end 32k includes protrusion 32t that protrudes so as to approach second ends 31k of the pair of story rails 31. Protrusion 32t is part of first end 32k and is a top end edge portion of first end 32k. Protrusion 32t includes protruding inclined portion 32t1. In protrusion 32t, protruding inclined portion 32t1, which is a portion that meshes with second end 31k, is inclined upward as it approaches second end 31k. Protruding inclined portion 32t1 includes a linear surface or arcuate curved surface that faces second end 31k. Second end 31k includes notch 31t that is cut out so as to mesh with first end 32k. Notch 31t is shaped such that a top end edge portion of second end 31k is cut out so as to mesh with protrusion 32t of first end 32k when the pair of movable rails 32a and the pair of story rails 31 are coupled. Notch 31t includes notch inclined portion 31t1. In notch 31t, notch inclined portion 31t1, which is a portion that meshes with first end 32k, is inclined downward as it approaches second end 31k. Notch inclined portion 31t1 includes a linear surface or arcuate curved surface that faces first end 32k.

When first ends 32k of the pair of movable rails 32a and second ends 31k of the pair of story rails 31 are connected, first ends 32k and second ends 31k are meshed together, whereby first ends 32k and second ends 31k are coupled with protrusions 32t of first ends 32k positioned above notches 31t of second ends 31k. Therefore, when unmanned transport vehicle 110a travels on the pair of movable rails 32a and the pair of story rails 31 that are coupled at first ends 32k and second ends 31k, the weight of unmanned transport vehicle 110a can be supported by the pair of movable rails 32a and the pair of story rails 31. Therefore, when unmanned transport vehicle 110a travels along the pair of movable rails 32a and the pair of story rails 31, it becomes difficult for the unmanned transport vehicle to derail from these pair of movable rails 32a and pair of story rails 31.

End portions on the opposite side from first ends 32k of the pair of movable rails 32a include protrusions 32m, a portion of which protrudes upward. Protrusion 32m includes a linear surface or arcuate curved surface on first end 32k side. Therefore, when first ends 32k and second ends 31k are coupled, even when unmanned transport vehicle 110a traveling from the pair of story rails 31 toward the pair of movable rails 32a reaches the end portions of the pair of movable rails 32a, the force of the traveling unmanned transport vehicle 110a can be diverted in the tangential direction of the linear surface or arcuate curved surface of protrusions 32m, which, compared to a case where a protrusion simply protrudes vertically from the end portion, can inhibit sudden collision of unmanned transport vehicle 110a with the end portions of the pair of movable rails 32a.

In this way, unmanned transport vehicle 110a in second elevator space 212 can travel along the pair of elevator rails 32 and the pair of story rails 31 to move from second elevator space 212 to fourth story space 13b. Conversely, unmanned transport vehicle 110a in fourth story space 13b can also travel along the pair of story rails 31 and the pair of elevator rails 32 to move from fourth story space 13b to second elevator space 212.

In the present embodiment, a pair of story rails 31 is arranged in fourth story space 13b, and a pair of elevator rails 32 is arranged in second elevator space 212. Unmanned transport vehicle 110a travels along that pair of story rails 31 and travels along the pair of elevator rails 32.

FIG. 39C illustrates another example in which unmanned transport vehicle 110 is applied to elevator 200. In (a) in FIG. 39C, a state in which a pair of story rails 31 and a pair of elevator rails 32 are not connected is illustrated. In (b) in FIG. 39C, a state in which a pair of story rails 31 and a pair of elevator rails 32 are connected is illustrated. In (c) in FIG. 39C, a state in which unmanned transport vehicle 110 is suspended from elevated rail 7d1 by the first arm and the second arm is illustrated.

In FIG. 39C, although an example of office building delivery system Sy1 using unmanned transport vehicle 110 is illustrated, unmanned transport vehicles 100, 110a, and 110b may be used.

Elevator 200 includes, similar to the example illustrated in FIG. 39B, etc., rail lifting device 33 and rail extension-contraction device 34. In the present embodiment, a pair of story rails 31 is arranged in fourth story space 13b, and a pair of elevator rails 32 is arranged in second elevator space 212. The heights of fourth story space 13b and second elevator space 212 are set lower than in the case of FIG. 39B.

At least one wheel 113 of enclosure 111 is placed on one rail of the pair of rails 7, and at least one remaining wheel 113 of unmanned transport vehicle 110 is placed on the other rail of the pair of rails 7. Enclosure 111 of unmanned transport vehicle 110 is arranged so as to be sandwiched between that pair of rails 7.

Here, thickness L4 of unmanned transport vehicle 110 is greater than height L2 from the lowermost surface of unmanned transport vehicle 110 to the pair of rails 7, and thickness L3 of package 1 is greater than that height L2.

In this case, the wheel of the first arm and the wheel of the second arm of unmanned transport vehicle 110 are moved to a position (second position) lower than wheels 113 of enclosure 111 (the first arm and the second arm are in the second arm state). Unmanned transport vehicle 110 travels along that pair of story rails 31 and pair of elevator rails 32.

When the height of second elevator space 212 is set high, elevated rail 7d1 may be positioned in second elevator space 212. In this case, the wheel of the first arm and the wheel of the second arm of unmanned transport vehicle 110 are moved to a position (first position) higher than wheels 113 of enclosure 111 (the first arm and the second arm are in the first arm state). Unmanned transport vehicle 110 travels along that pair of story rails 31 and pair of elevator rails 32.

FIG. 40 illustrates an example of a configuration of office building delivery system Sy1 according to Embodiment 8. Note that FIG. 40 illustrates, similar to FIG. 1 and FIG. 22, a bird's-eye view of one story among a plurality of stories in an office building in which office building delivery system Sy1 is installed.

Office building delivery system Sy1 according to the present embodiment is installed in a story area of the office building. Third story space 13 in the story area illustrated in FIG. 40 is, for example, narrower in the height direction than third story space 13 illustrated in FIG. 22. Therefore, in the present embodiment, unmanned transport vehicle 110a is configured to be shorter than unmanned transport vehicles 100, 110 so that it can travel even within the narrow third story space 13, and can travel along a pair of story rails 31 arranged parallel to each other on a horizontal plane. Note that a plurality of pairs of story rails 31 are installed in third story space 13, and a pair of first story rails 31a and a pair of second story rails 31b included in the plurality of pairs of story rails 31 are perpendicular to each other.

For example, unmanned transport vehicle 110a includes four wheels 113 arranged on a virtual plane (for example, a horizontal plane), two of the four wheels 113 are placed on one rail in the pair of story rails 31, and the remaining two wheels 113 are placed on the other rail in the pair of story rails 31. Enclosure 111 of unmanned transport vehicle 110a is arranged so as to be sandwiched between the pair of story rails 31. Note that in the following description, the left-right direction of unmanned transport vehicle 110a is a direction extending along the axle of each of the four wheels 113, and the anteroposterior direction of unmanned transport vehicle 110a is a direction that extends along the above-mentioned plane on which the four wheels 113 are arranged and is perpendicular to the left-right direction.

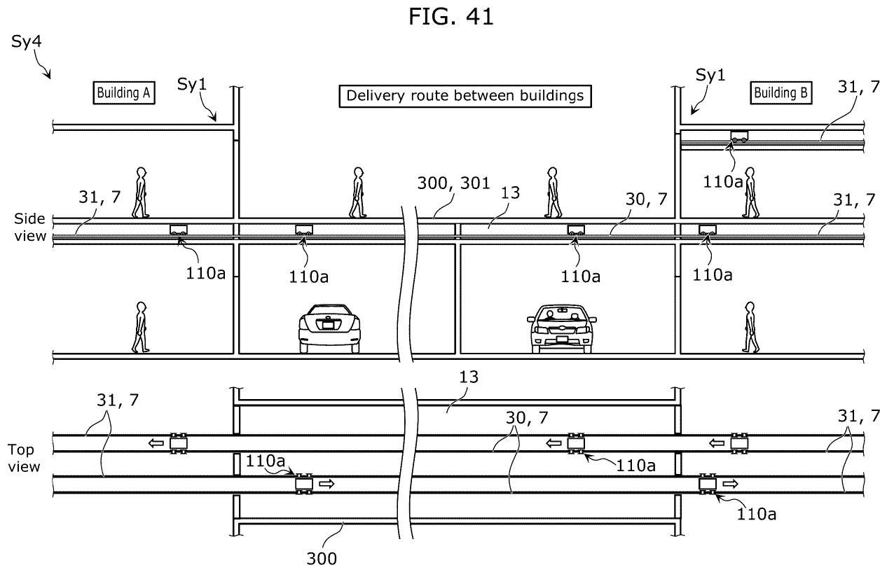

FIG. 41 illustrates an example of a configuration of logistics system Sy4 according to Embodiment 8.

Logistics system Sy4 according to the present embodiment includes, for example, office building delivery system Sy1 installed in Building A, office building delivery system Sy1 installed in Building B, and a plurality of pairs of transport rails 30 that connect these office building delivery systems Sy1. The plurality of pairs of transport rails 30 are arranged in third story space 13 of connecting bridge 300 that connects Building A and Building B. Transport rail 30 is connected to one end of pairs of story rails 31 of both of Building A and Building B. Therefore, it can also be said that one rail 7 is configured by serially connecting the pair of story rails 31 of Building A, transport rail 30, and the pair of story rails 31 of Building B. Note that in the example of FIG. 41, a plurality of pairs of transport rails 30 are provided, but a single pair of transport rails 30 may be provided.

Unmanned transport vehicle 110a travels along a pair of rails 7 in third story space 13 of each of Building A, Building B, and connecting bridge 300.

Thus, the structure according to the present embodiment includes a first building, a second building, connecting bridge 300 that connects the first building and the second building, and rail 7 for unmanned transport vehicle 110a to travel on. The rail extends from the inside of the first building, across connecting bridge 300, and to the inside of the second building. Note that the first building is, for example, Building A, and the second building is, for example, Building B. The first building includes a first predetermined story and a second predetermined story, and a first space for unmanned transport vehicle 110a to travel on is provided between the ceiling of the first predetermined story and the floor of the second predetermined story of the first building. The second building includes a first predetermined story and a second predetermined story, and a second space for unmanned transport vehicle 110a to travel on is provided between the ceiling of the first predetermined story and the floor of the second predetermined story of the second building. The first space is, for example, third story space 13 of Building A, and the second space is, for example, third story space 13 of Building B. Connecting bridge 300 further includes walkway 301 that connects the floor of the second predetermined story of the first building and the floor of the second predetermined story of the second building. Below walkway 301, a third space for unmanned transport vehicle 110a to travel in is provided. The third space connects to the first space and the second space. Note that the third space is, for example, third story space 13 of connecting bridge 300. Rail 7 is disposed across the first space, the third space, and the second space.

This allows unmanned transport vehicle 110a to travel between the first building and the second building via connecting bridge 300.

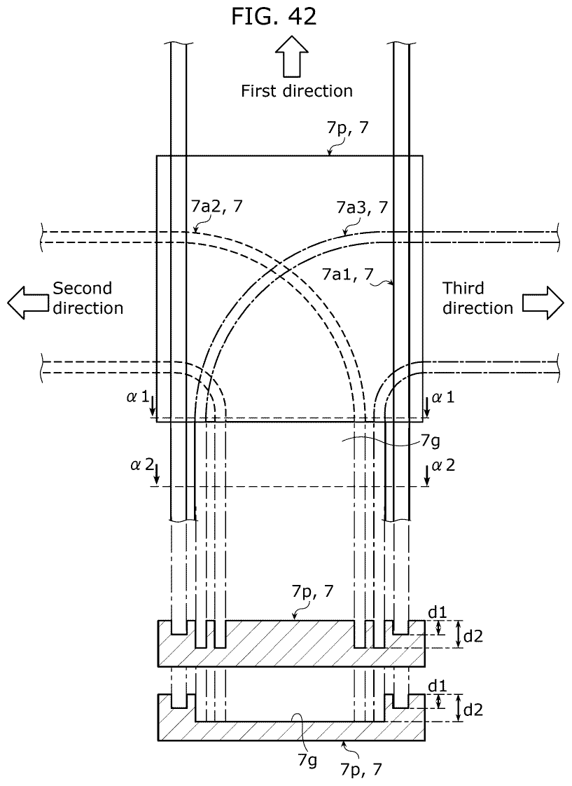

FIG. 42 illustrates groove structure 7p of rail 7 according to Embodiment 8. FIG. 42 illustrates a cross-sectional view of rail 7 at line α1-α1 and a cross-sectional view of rail 7 at line α2-α2. Rail 7 is one example of the first rail.

In the present embodiment, office building delivery system Sy1 includes groove structure 7p.

Groove structure 7p is applied to the pair of transport rails 30, the pair of story rails 31, and the pair of elevator rails 32 described above. In groove structure 7p, three pairs of rails 7 extending from the first direction to the third direction are connected.

The pair of rails 7a1 extending in the first direction indicated by solid lines is straight. The pair of rails 7a1 is one example of a pair of grooves for straight travel. The pair of rails 7a2 extending in the second direction indicated by dashed lines turns left from transfer section 7g of groove structure 7p. The pair of rails 7a2 is one example of a pair of grooves for left turn. The pair of rails 7a3 extending in the third direction indicated by single-dotted lines turns right from transfer section 7g. The pair of rails 7a3 is one example of a pair of grooves for right turn. The pair of rails 7 is a comprehensive term for the pairs of rails 7a1 to 7a3.

The pairs of rails 7a1 to 7a3 provided in groove structure 7p may be groove-shaped. In such cases, the depths of the pairs of rails 7a1 to 7a3 are different. In the present embodiment, depths d2 of the pairs of rails 7a2 and 7a3 are deeper than depth d1 of the pair of rails 7a1. Note that the depth of the pair of rails 7a1 may be deeper than the depth of the pairs of rails 7a2 and 7a3. Depths d2 of the pair of rails 7a2 and 7a3 are the same. Note that the depths of the pair of rails 7a2 and the pair of rails 7a3 may be different from each other.

The widths of the pairs of rails 7a1 to 7a3 are different. The width of the pair of rails 7a1 is larger than the width of the pair of rails 7a2 and 7a3. The width of the pair of rails 7a3 is larger than the width of the pair of rails 7a2.

Groove structure 7p includes transfer section 7g which is a junction point where a plurality of pairs of rails 7 are formed. In transfer section 7g, the depth is the same as depth d2 of the pairs of rails 7a2 and 7a3, and the bottom surface forms a uniform plane.

There may be cases where unmanned transport vehicle 110a wants to mutually transfer between the pair of rails 7a2 and the pair of rails 7a3. In such cases, unmanned transport vehicle 110a may adjust the width of the pair of front wheels 113a1 and the width of the pair of rear wheels 113b1 at transfer section 7g.

More specifically, unmanned transport vehicle 110a further includes a wheel width adjuster that adjusts the width of wheels 113. Controller 120 of unmanned transport vehicle 110a controls the wheel width adjuster to adjust the wheel width of the pair of front wheels 3514a and the pair of rear wheels 3514b to match the pair of rails 7a2 or to match the pair of rails 7a3. The wheel width adjuster can simultaneously adjust the width of the pair of front wheels 3514a and the width of the pair of rear wheels 3514b along the axial direction of wheels 113. Thus, front wheels 113a1 are configured to allow adjustment of the distance between the left and right first front wheel and second front wheel, and rear wheels 113b1 are similarly configured to allow adjustment of the distance between the left and right first rear wheel and second rear wheel.

Note that in the present embodiment, groove structure 7p may be configured to allow mutual transfer between the pair of rails 7a2, 7a3 and the pair of rails 7a1. In such cases, since the depths of the pair of rails 7a1 and the pair of rails 7a2, 7a3 are different, groove structure 7p may include an inclined portion that allows unmanned transport vehicle 110a to transfer between rails while adjusting for the depth difference between the pair of rails 7a1 and the pair of rails 7a2, 7a3, and a flat portion for adjusting the wheel width.

In the present embodiment, unmanned transport vehicle 110b can be used. In the above embodiment as well, unmanned transport vehicle 110b can be used. Unmanned transport vehicle 110b is one example of a transport vehicle.

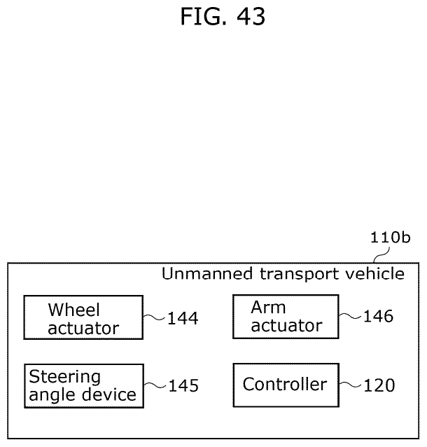

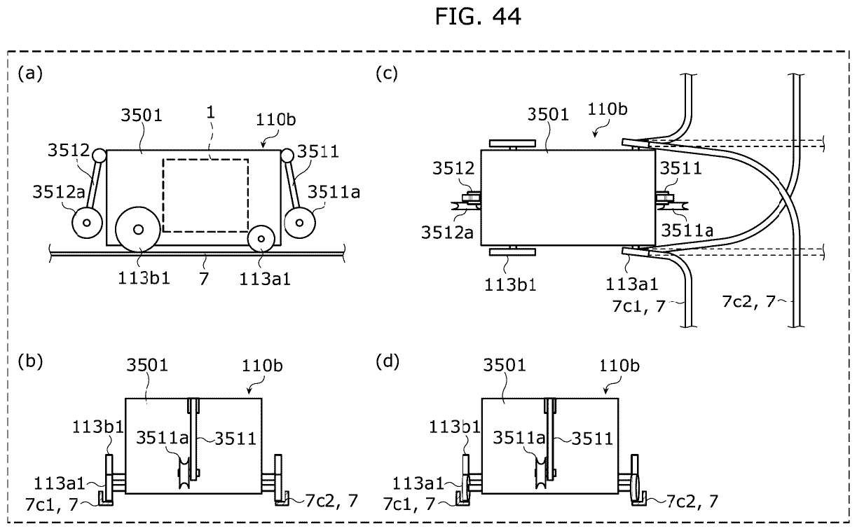

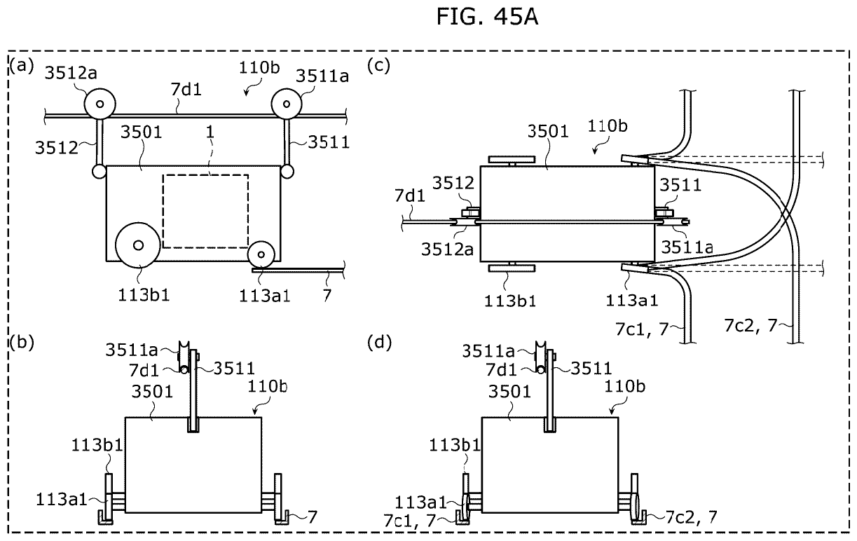

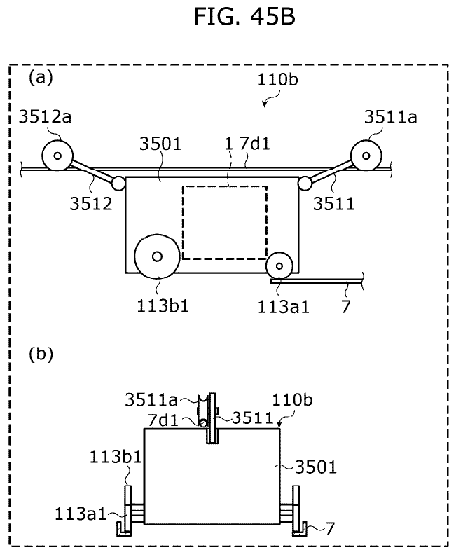

FIG. 43 is a block diagram illustrating an example of unmanned transport vehicle 110b according to Embodiment 8. FIG. 44 illustrates an example of first arm 3511 and second arm 3512 of unmanned transport vehicle 110b according to Embodiment 8 traveling on rails 7 in a second arm state. In FIG. 44, (a) illustrates a side view of unmanned transport vehicle 110b traveling on rails 7. In FIG. 44, (b) illustrates a front view of unmanned transport vehicle 110b traveling on rails 7. In FIG. 44, (c) illustrates a top view of unmanned transport vehicle 110b when the steering angle of front wheel 113a1 is adjusted while traveling on rails 7. In FIG. 44, (d) illustrates a front view of unmanned transport vehicle 110b when the steering angle of front wheel 113a1 is adjusted while traveling on rails 7. FIG. 45A illustrates an example of first arm 3511 and second arm 3512 of unmanned transport vehicle 110b according to Embodiment 8 traveling on elevated rail 7d1 in a first arm state. In FIG. 45A, (a) illustrates a side view of unmanned transport vehicle 110b traveling on elevated rail 7d1. In FIG. 45A, (b) illustrates a front view of unmanned transport vehicle 110b traveling on elevated rail 7d1. In FIG. 45A, (c) illustrates a top view of unmanned transport vehicle 110b when the steering angle of front wheel 113a1 is adjusted while traveling on elevated rail 7d1. In FIG. 45A, (d) illustrates a front view of unmanned transport vehicle 110b when the steering angle of front wheel 113a1 is adjusted while traveling on elevated rail 7d1. FIG. 45B illustrates an example of first arm 3511 and second arm 3512 of unmanned transport vehicle 110b according to Embodiment 8 traveling on elevated rail 7d1 in a third arm state. In FIG. 45B, (a) illustrates a side view of unmanned transport vehicle 110b traveling on elevated rail 7d1. In FIG. 45B, (b) illustrates a front view of unmanned transport vehicle 110b traveling on elevated rail 7d1.

As illustrated in FIG. 43 through FIG. 45B, unmanned transport vehicle 110b can deliver packages to structures such as homes, apartment buildings, and office buildings. The structure includes rail 7 that is laid out. Rail 7 is a pair of rails consisting of first rail 7c1 and second rail 7c2. In the present embodiment, first rail 7c1 and second rail 7c2 are collectively referred to simply as rails 7. Rails 7 are laid out, for example, on each story and in each room inside the structure. Rails 7 are also laid out to connect between two adjacent structures, and are laid out in residential areas, roads, bridges, etc. Unmanned transport vehicle 110b can deliver a package from the delivery origin to the delivery destination by traveling along rails 7.

More specifically, unmanned transport vehicle 110b includes vehicle main body 3501, wheels 113a1, 113b1, first arm 3511, second arm 3512, wheel actuators 144, steering angle device 145, arm actuators 146, and controller 120.

A storage space for accommodating one or more packages is formed inside vehicle main body 3501. For example, a package is accommodated in the storage space of vehicle main body 3501 by the sender. The package carriage described above may be provided in the storage space. Vehicle main body 3501 is one example of enclosure 111.

Vehicle main body 3501 is provided with a plurality of wheels 113a1, 113b1. In the present embodiment, since vehicle main body 3501 has a cubic shape, vehicle main body 3501 includes two front wheels 113a1 positioned on the left and right sides respectively at the front in the traveling direction of vehicle main body 3501, and two rear wheels 113b1 positioned on the left and right sides respectively at the rear in the traveling direction of vehicle main body 3501. When unmanned transport vehicle 110b travels along rails 7, front wheel 113a1 on the right side at the front in the traveling direction and rear wheel 113b1 on the right side at the rear in the traveling direction are placed on first rail 7c1 so that they travel on first rail 7c1, and front wheel 113a1 on the left side at the front in the traveling direction and rear wheel 113b1 on the left side at the rear in the traveling direction are placed on second rail 7c2 so that they travel on second rail 7c2.

First arm 3511 is positioned at the front side of vehicle main body 3501 and at the central portion in the width direction of vehicle main body 3501. Second arm 3512 is positioned at the rear side of vehicle main body 3501 and at the central portion in the width direction. The width direction of vehicle main body 3501 is, when rails 7 is viewed in a plan view, a direction perpendicular to the direction in which rails 7 extend.

Arm actuator 146 is provided on first arm 3511 and second arm 3512. Each arm actuator 146 is an actuator that can rotate (actuate) first arm 3511 and second arm 3512 under control by controller 120. First arm 3511 and second arm 3512 are switched between a first arm state and a second arm state by actuation of the at least one arm actuator 146. As illustrated in (a) in FIG. 45A, in the first arm state, wheel 3511a of first arm 3511 and wheel 3512a of second arm 3512 are positioned at a first position above front wheel 113a1 and rear wheel 113b1. As illustrated in (a) in FIG. 44, in the second arm state, wheel 3511a of first arm 3511 and wheel 3512a of second arm 3512 are positioned at a second position below the first position.

Wheel actuator 144 is provided on each of vehicle main body 3501, first arm 3511, and second arm 3512. Each wheel actuator 144 can rotate (actuate) the plurality of wheels 113a1, 113b1 of vehicle main body 3501, wheel 3511a connected to the leading end side of first arm 3511, and wheel 3512a connected to the leading end side of second arm 3512 under control by controller 120.

Steering angle device 145, under control by controller 120, can adjust (change) the steering angle of front wheel 113a1 of vehicle main body 3501. Steering angle device 145 cannot adjust (change) the steering angle of rear wheel 113b1 of vehicle main body 3501. Stated differently, front wheel 113a1 is configured to allow adjustment of the steering angle, while rear wheel 113b1 is configured to prevent adjustment of the steering angle. Steering angle device 145 is one example of the steering device.

The radius of front wheel 113a1 is smaller than the radius of rear wheel 113b1. Stated differently, because front wheel 113a1 has a smaller diameter than rear wheel 113b1, it is easier for steering angle device 145 to adjust the steering angle of front wheel 113a1.

If the steering angle cannot be adjusted, it becomes difficult for unmanned transport vehicle 110b to make right or left turns as illustrated in FIG. 42. While it is possible for unmanned transport vehicle 110b to travel along rails 7, if the traveling speed of unmanned transport vehicle 110b is high, it is conceivable that unmanned transport vehicle 110b may ride up and off rails 7 when making left and right turns. Therefore, in unmanned transport vehicle 110b, steering angle device 145 can adjust the steering angle of front wheels 113a1 to smoothly make right and left turns. As a result, compared to adjusting the traveling direction of vehicle main body 3501 using, for example, a turntable that can change the orientation of unmanned transport vehicle 110b, the manufacturing cost of unmanned transport vehicle 110b is less likely to surge.

Controller 120 can control each arm actuator 146 that drives first arm 3511 and second arm 3512. Controller 120 can also control each wheel actuator 144 that drives the plurality of wheels 113a1, 113b1 of vehicle main body 3501, wheel 3511a of first arm 3511, and wheel 3512a of second arm 3512. Controller 120 can control steering angle device 145 that adjusts the steering angle of front wheels 113a1 of vehicle main body 3501. Controller 120 is one example of the controller.

The timing at which controller 120 controls wheel actuators 144, steering angle device 145, and arm actuators 146 may be based on image data obtained from an imaging unit mounted on unmanned transport vehicle 110b, or may be based on map information related to rails 7 and elevated rail 7d1 obtained from the management server. When configured to obtain map information, unmanned transport vehicle 110b includes a wireless communicator capable of communicating with the management server. Elevated rail 7d1 is one example of the second rail.

Here, the management server sets a travel route for unmanned transport vehicle 110b based on position information of the delivery destination and position information of the delivery origin. The management server obtains position information of unmanned transport vehicle 110b and changes the route according to the status of the set travel route for unmanned transport vehicle 110b. The management server sets the travel route for unmanned transport vehicle 110b according to other unmanned transport vehicles 110b that are moving or scheduled to move. The management server sends a departure instruction to unmanned transport vehicle 110b based on the set travel route. The management server also manages the traveling state of unmanned transport vehicle 110b. The management server is implemented as a computer, a cloud server, or the like. The travel route is a route for unmanned transport vehicle 110b to travel through areas where rails 7 are present and structures where rails 7 are present, and is shown in map information.

Such unmanned transport vehicle 110b can perform the following operations.

As illustrated in FIG. 44 and FIG. 45A, the bottom ends of first arm 3511 and second arm 3512 are provided on vehicle main body 3501 so as to be pivotable by respective arm actuators 146 about an axis extending in the width direction of vehicle main body 3501. Each arm actuator 146 is an electric motor or the like. Each arm actuator 146, under control by controller 120, extends first arm 3511 and second arm 3512 upward from vehicle main body 3501 so that wheel 3511a of first arm 3511 and wheel 3512a of second arm 3512 are positioned above vehicle main body 3501. When unmanned transport vehicle 110b transfers to elevated rail 7d1 positioned higher than rails 7, first arm 3511 and second arm 3512 pivot so that wheel 3511a of first arm 3511 and wheel 3512a of second arm 3512 are placed on elevated rail 7d1. Wheel actuators 144, under control by controller 120, rotate wheel 3511a of first arm 3511 and wheel 3512a of second arm 3512, enabling travel on elevated rail 7d1.

More specifically, in a case in which front wheels 113a1 and rear wheels 113b1 are traveling on rails 7 from a first section toward a second section, where no elevated rail 7d1 exists above rails 7 in the first section and elevated rail 7d1 exists above rails 7 in the second section, when front wheels 113a1 and rear wheels 113b1 are in the first section, controller 120 controls at least one arm actuator 146 to change first arm 3511 and second arm 3512 from the second arm state to the first arm state to travel with wheel 3511a of first arm 3511 and wheel 3512a of second arm 3512 on elevated rail 7d1 when elevated rail 7d1 is positioned below wheel 3511a of first arm 3511 and wheel 3512a of second arm 3512.

Stated differently, unmanned transport vehicle 110b can transfer from rails 7 positioned below vehicle main body 3501 to elevated rail 7d1 positioned higher than vehicle main body 3501, and can continuously travel from rails 7 to elevated rail 7d1.

As illustrated in FIG. 45B, first arm 3511 and second arm 3512 may also be further switched to a third arm state by actuation of the at least one arm actuator 146. In the third arm state, wheel 3511a of first arm 3511 and wheel 3512a of second arm 3512 are positioned at a third position that is below the first position and above the second position. In the third arm state, vehicle main body 3501 can be raised compared to the first arm state.

For example, when first arm 3511 and second arm 3512 are in the first arm state and unmanned transport vehicle 3500 is traveling on elevated rail 7d1, by switching first arm 3511 and second arm 3512 to the third arm state, vehicle main body 3501 of unmanned transport vehicle 3500 can be brought closer to elevated rail 7d1.

As illustrated in FIG. 44 and FIG. 45A, unmanned transport vehicle 110b can transfer from elevated rail 7d1 to rails 7 by means opposite to those described above.

When vehicle main body 3501 travels on rails 7, wheel 3511a of first arm 3511 and wheel 3512a of second arm 3512 are positioned below rails 7.

More specifically, when front wheels 113a1 and rear wheels 113b1 are traveling on rails 7, after wheel 3511a of first arm 3511 and wheel 3512a of second arm 3512 have separated from elevated rail 7d1, controller 120 controls at least one arm actuator 146 to change first arm 3511 and second arm 3512 from the first arm state to the second arm state. This allows unmanned transport vehicle 110b to continue traveling on rails 7.

When unmanned transport vehicle 110b travels on rails 7, controller 120 controls wheel actuators 144 so that the plurality of wheels 113a1 and 113b1 arranged below vehicle main body 3501 of unmanned transport vehicle 110b rotate. For example, when unmanned transport vehicle 110b transfers from elevated rail 7d1 at a high position to rails 7, wheel actuators 144, under control by controller 120, rotate the plurality of wheels 113a1 and 113b1 of vehicle main body 3501. As a result, unmanned transport vehicle 110b can transfer from elevated rail 7d1 positioned higher than vehicle main body 3501 to rails 7 positioned below vehicle main body 3501, and can continuously travel from elevated rail 7d1 to rails 7.

When wheel 3511a of first arm 3511 and wheel 3512a of second arm 3512 separate from elevated rail 7d1, wheel actuators 144, under control by controller 120, stop the rotation of wheel 3511a of first arm 3511 and wheel 3512a of second arm 3512. Each arm actuator 146, under control by controller 120, rotates first arm 3511 and second arm 3512 so that wheel 3511a of first arm 3511 and wheel 3512a of second arm 3512 are placed below vehicle main body 3501.

When vehicle main body 3501, front wheel 113a1, and rail 7 on which front wheel 113a1 travels are viewed along the direction in which the axles of front wheel 113a1 and rear wheel 113b1 extend, the bottom surface of vehicle main body 3501 is positioned between front wheel 113a1 and the position of the contact point where front wheel 113a1 contacts rail 7 (the position where they are in contact).

When vehicle main body 3501, front wheel 113a1, and rail 7 are viewed along the direction in which the axles of front wheel 113a1 and rear wheel 113b1 extend, the distance between the bottom surface of vehicle main body 3501 and the position of the contact point is greater than or equal to 5 mm and less than or equal to 15 mm.

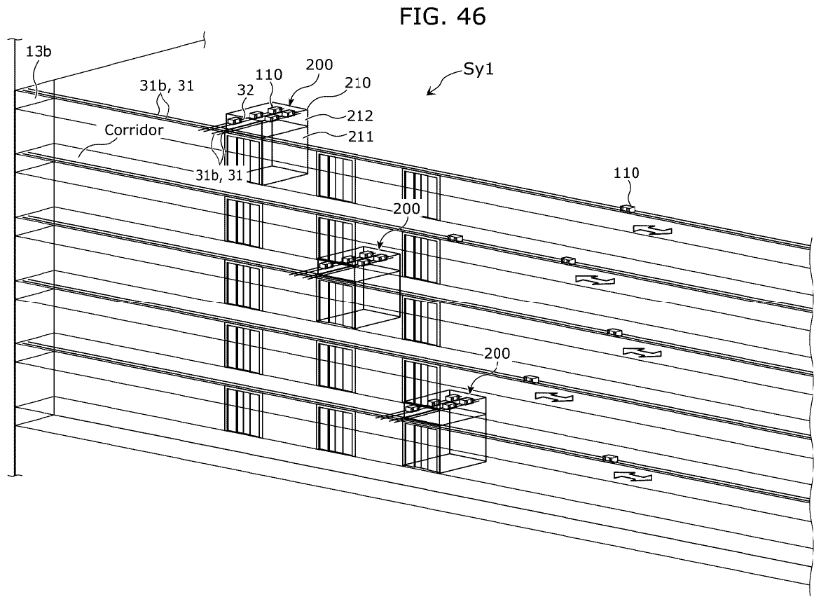

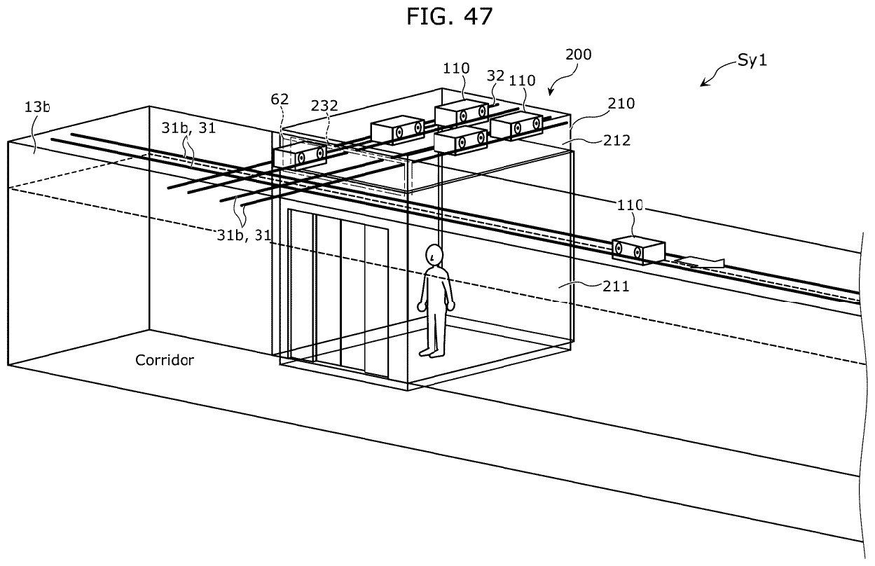

FIG. 46 illustrates an example of office building delivery system Sy1 applied to an office building. FIG. 47 illustrates an example of elevator 200 of office building delivery system Sy1 on a story of an office building. In FIG. 46 and FIG. 47, although an example of unmanned transport vehicle 110 is illustrated, unmanned transport vehicles 100, 110a, and 110b may be used.

Office building delivery system Sy1 includes elevator 200. In the present embodiment as well, elevator carriage 210 of elevator 200 is suspended by a carriage wire within an elevator path that extends in the vertical direction, and moves up and down by reeling out and reeling in of a carriage wire by an elevator winch.

In such office building delivery system Sy1, unmanned transport vehicle 110 travels along a pair of elevator rails 32. In the present embodiment, a plurality of pairs of elevator rails 32 are provided in second elevator space 212.

When first landing door in the corridor and first carriage door of first elevator space 211 for a person to board are closed and second landing door 62 of fourth story space 13b above the corridor and second carriage door 232 of second elevator space 212 for unmanned transport vehicle 110 to board are closed, unmanned transport vehicle 110 stops while suspended from the pair of elevator rails 32. In this case, because the movable rails of the pair of elevator rails 32 are not coupled to the pair of story rails 31, movement of unmanned transport vehicle 110 between fourth story space 13b and second elevator space 212 is prohibited.

When first landing door and first carriage door open and second landing door 62 and second carriage door 232 open, a pair of elevator rails 32 couple to a pair of story rails 31 arranged in the third story space. As a result, unmanned transport vehicle 110 in second elevator space 212 can travel along the pair of elevator rails 32 and the pair of story rails 31 to move from second elevator space 212 to fourth story space 13b. Conversely, unmanned transport vehicle 110 in fourth story space 13b can also travel along the pair of story rails 31 and the pair of elevator rails 32 to move from fourth story space 13b to second elevator space 212.

The plurality of pairs of story rails 31 include a pair of first story rails 31a and a pair of second story rails 31b. The pair of first story rails 31a and the pair of second story rails 31b are perpendicular to each other. Therefore, unmanned transport vehicle 110 can switch its traveling direction at the intersection of the pair of first story rails 31a and the pair of second story rails 31b.

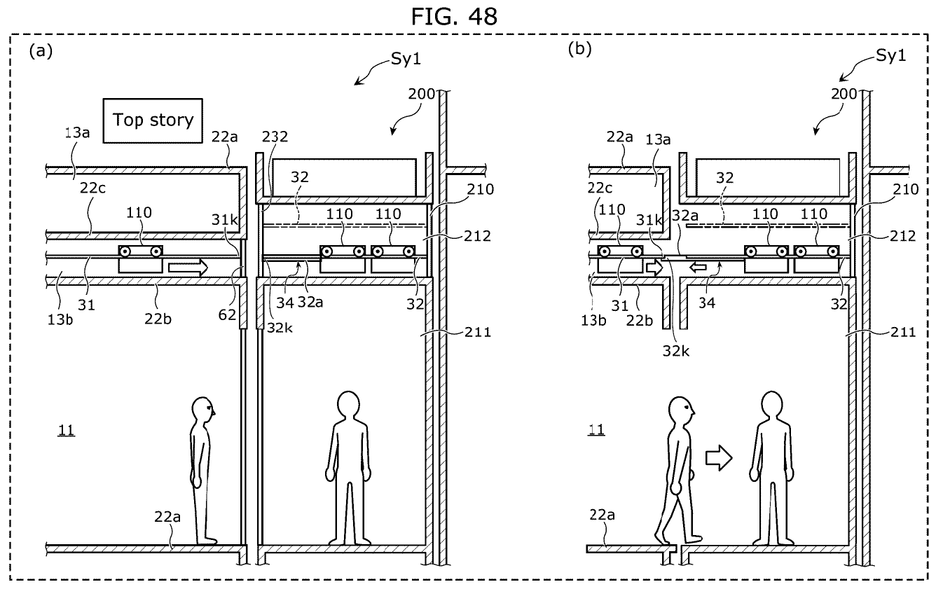

FIG. 48 illustrates an example of applying office building delivery system Sy1 to an office building with a story height of 4.5 m. In (a) in FIG. 48, a state in which a pair of story rails 31 and a pair of elevator rails 32 are not connected is illustrated. In (b) in FIG. 48, a state in which a pair of story rails 31 and a pair of elevator rails 32 are connected is illustrated. In FIG. 48, an example is illustrated in which unmanned transport vehicle 110 is used. Note that the above-described unmanned transport vehicles 110a and 110b may be used.

In the example illustrated in FIG. 48, third story space 13 of the above-mentioned space of the story area is divided into two story spaces. More specifically, third story space 13 includes third story space 13a, which is a space for installing, for example, piping, power lines, etc., and fourth story space 13b in which a plurality of pairs of story rails 31 are arranged along the horizontal direction. Third story space 13a is positioned above fourth story space 13b, and is separated from the story above it by the upper first horizontal wall 22a. Third story space 13a and fourth story space 13b are separated by third horizontal wall 22c.

The height of the story area, that is, the height between the two first horizontal walls 22a is 4.5 meters. The height of first story space 11, that is, the height between the lower first horizontal wall 22a and second horizontal wall 22b is three meters. The height of fourth story space 13b above first story space 11, that is, the height between second horizontal wall 22b and the upper first horizontal wall 22a is 40 cm to 50 cm. The height of unmanned transport vehicle 110, that is, the height between the bottom surface and upper surface of unmanned transport vehicle 110 is 30 cm. Therefore, the gap between the bottom surface of unmanned transport vehicle 110 and second horizontal wall 22b, and the gap between the upper surface of unmanned transport vehicle 110 and second horizontal wall 22b is 5 cm to 10 cm. The height between the ceiling of first elevator space 211 (the floor of second elevator space 212) and the ceiling of second elevator space 212 is one meter. Note that these heights are merely examples and are not limited thereto.

Second landing door 62 that opens and closes in conjunction with second carriage door 232 is arranged at a position opposite to second carriage door 232. When second landing door 62 and second carriage door 232 open in conjunction with each other, fourth story space 13b and second elevator space 212 are in communication with each other.

Elevator 200 includes rail lifting device 33 and rail extension-contraction device 34.

Rail lifting device 33 aligns the height of the pair of elevator rails 32 with the height of the pair of story rails 31. Stated differently, when second landing door 62 and second carriage door 232 open in conjunction with each other, rail lifting device 33 is controlled by controller 501 to adjust the position (height) of the pair of elevator rails 32 so as to align the height of the pair of elevator rails 32 with the height of the pair of story rails 31.

Rail extension-contraction device 34 is controlled by controller 501 to move the pair of movable rails 32a in the horizontal direction so as to couple them to the pair of story rails 31. First end 32k of movable rail 32a in the pair of elevator rails 32 is connected to second end 31k of the pair of story rails 31. This causes the pair of story rails 31 and the pair of elevator rails 32 to be coupled.

Unmanned transport vehicle 110 in second elevator space 212 can travel along the pair of elevator rails 32 and the pair of story rails 31 to move from second elevator space 212 to fourth story space 13b. Conversely, unmanned transport vehicle 110 in fourth story space 13b can also travel along the pair of story rails 31 and the pair of elevator rails 32 to move from fourth story space 13b to second elevator space 212.

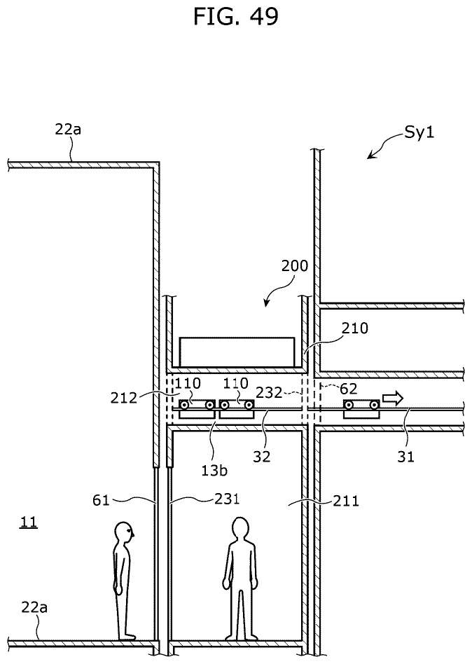

FIG. 49 illustrates an example of office building delivery system Sy1 in which first carriage door 231 and first landing door 61, and second landing door 62 and second carriage door 232 through which unmanned transport vehicle 110 passes are arranged.

The height between the upper first horizontal wall 22a and the lower first horizontal wall 22a in first story space 11 is seven meters. In such cases, even when a pair of story rails 31 is arranged above first story space 11, it is difficult to align the position of the pair of story rails 31 with the position of a pair of elevator rails 32 arranged in second elevator space 212. Note that these heights are merely examples and are not limited thereto.

In view of this, in FIG. 49, first landing door 61 of first story space 11 that opens and closes in conjunction with first carriage door 231 of first elevator space 211 is arranged at a position opposing first carriage door 231. Second carriage door 232 of second elevator space 212 is arranged on the opposite side of first carriage door 231. Second landing door 62 that opens and closes in conjunction with second carriage door 232 is arranged at a position opposite to second carriage door 232. Stated differently, first carriage door 231 and first landing door 61 through which people pass are on the opposite side from second landing door 62 and second carriage door 232 through which unmanned transport vehicle 110 passes.

In this case as well, unmanned transport vehicle 110 can travel between the pair of elevator rails 32 and the pair of story rails 31.

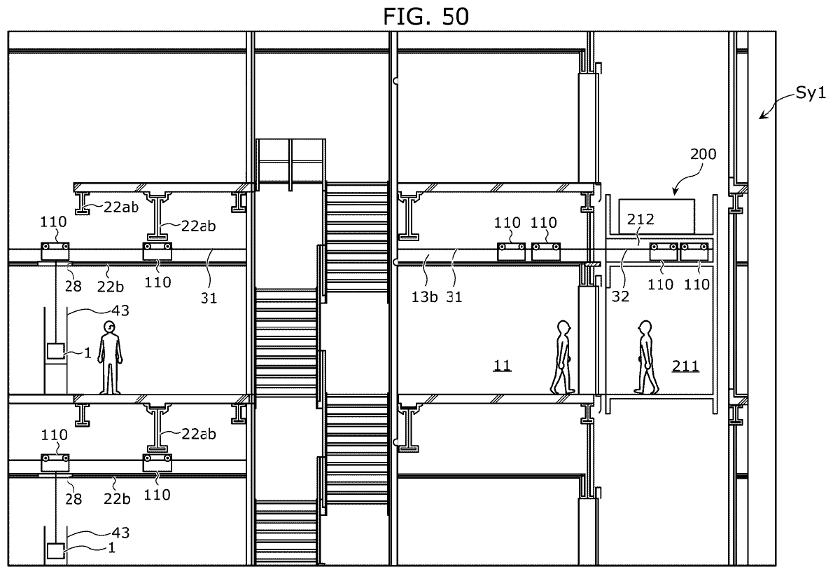

FIG. 50 illustrates an example of office building delivery system Sy1 applied to an office building.

The pair of story rails 31 are arranged below beam 22ab that supports the office building. The height between second horizontal wall 22b of the ceiling and beam 22ab within fourth story space 13b is at least 70 cm. The pair of story rails 31 are laid out between this second horizontal wall 22b and beam 22ab so as to be parallel to second horizontal wall 22b. Note that these heights are merely examples and are not limited thereto.

For example, when elevator 200 arrives at a predetermined story of the office building, the pair of elevator rails 32 arranged in second elevator space 212 of elevator 200 and the pair of story rails 31 in fourth story space 13b are coupled. Unmanned transport vehicle 110 can travel along the pair of elevator rails 32 to the pair of story rails 31 to move from second elevator space 212 to fourth story space 13b.

Unmanned transport vehicle 110 travels along the pair of story rails 31 in fourth story space 13b and stops above delivery box 43. Travel opening 28 is formed in second horizontal wall 22b of the ceiling, above delivery box 43. Unmanned transport vehicle 110 lowers the package carriage through travel opening 28 and stores the package in delivery box 43. When the package is stored in delivery box 43, the package carriage is raised to retrieve the package carriage. In this way, the package can be delivered to a predetermined delivery box 43.

Here, a case where unmanned transport vehicle 110 collects a package is exemplified, but unmanned transport vehicle 110 can also lower the package carriage through travel opening 28 and collect the package stored in delivery box 43.

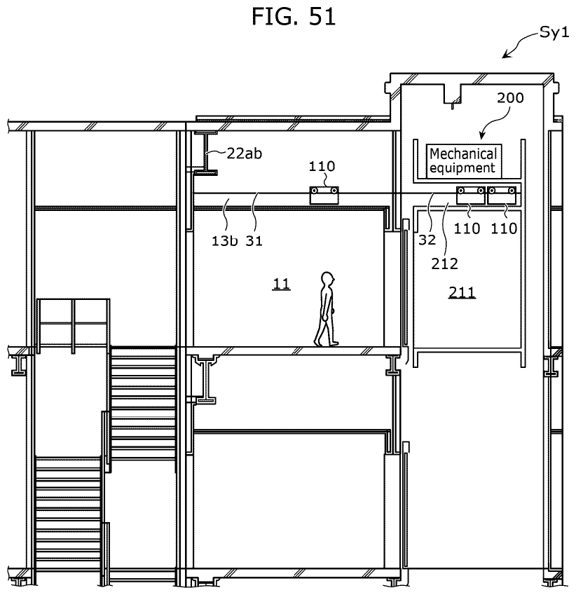

FIG. 51 illustrates an example of office building delivery system Sy1 on the top story of an office building.

The height between the ceiling of first elevator space 211 and the ceiling of second elevator space 212 is 60 cm. In such cases, on the top story, since it is difficult to increase the height of second elevator space 212 and fourth story space 13b, it is preferable to reduce the thickness of the mechanical equipment for elevator 200 installed in elevator 200. It is preferable to arrange the pair of story rails 31 and the pair of elevator rails 32 in a single layer. Note that these heights are merely examples and are not limited thereto.

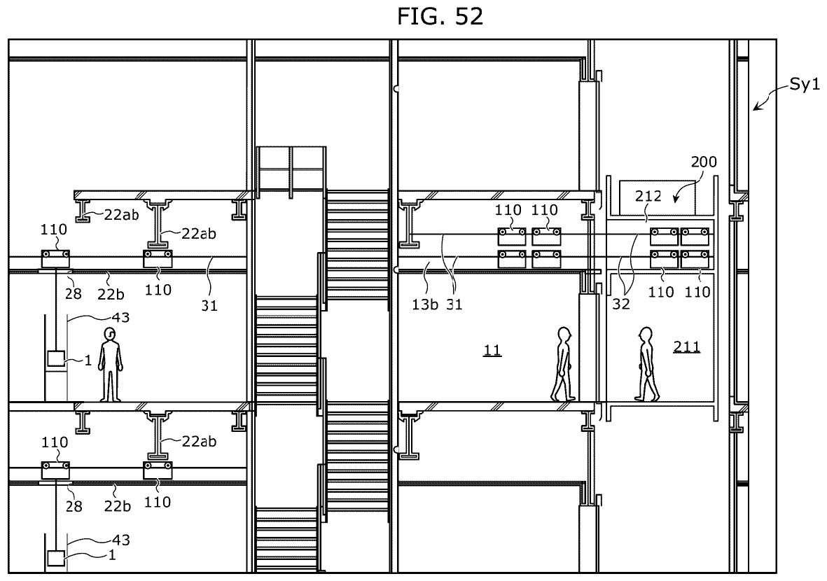

FIG. 52 is another view illustrating an example of office building delivery system Sy1.

FIG. 50 illustrates a case where the pair of elevator rails 32 arranged in second elevator space 212 of elevator 200 and the pair of story rails 31 arranged in fourth story space 13b are in a single layer, whereas FIG. 52 illustrates a case where the pair of elevator rails 32 arranged in second elevator space 212 of elevator 200 and the pair of story rails 31 in fourth story space 13b are arranged in two layers in the up-down direction.

Stated differently, a pair of elevator rails 32 arranged in second elevator space 212 of elevator 200 are arranged in the up-down direction, respectively. The upper pair of elevator rails 32 and the lower pair of elevator rails 32 are laid out so as to be parallel to second horizontal wall 22b, at a height where unmanned transport vehicles 110 do not contact each other even when unmanned transport vehicles 110 travel on each pair.

The pair of story rails 31 of fourth story space 13b are disposed above and below each other. The upper pair of story rails 31 and the lower pair of story rails 31 are laid out so as to be parallel to second horizontal wall 22b, at a height where unmanned transport vehicles 110 do not contact each other even when unmanned transport vehicles 110 travel on each pair.

When coupling the upper pair of story rails 31 and the upper pair of elevator rails 32, rail lifting device 33 is controlled by controller 501 to adjust the position (height) of the upper pair of elevator rails 32 so as to align with the height of the upper pair of story rails 31. Rail extension-contraction device 34 is controlled by controller 501 to move the pair of movable rails in the horizontal direction so as to couple them to the upper pair of story rails 31. This causes the upper pair of story rails 31 and the upper pair of elevator rails 32 to be coupled. Unmanned transport vehicle 110 can travel between the upper pair of elevator rails 32 and the upper pair of story rails 31 along the upper pair of elevator rails 32 and the upper pair of story rails 31.

When coupling the lower pair of story rails 31 and the lower pair of elevator rails 32, rail lifting device 33 is controlled by controller 501 to adjust the position (height) of the lower pair of elevator rails 32 so as to align with the height of the lower pair of story rails 31. Rail extension-contraction device 34 is controlled by controller 501 to move the pair of movable rails in the horizontal direction so as to couple them to the lower pair of story rails 31. This causes the lower pair of story rails 31 and the lower pair of elevator rails 32 to be coupled. Unmanned transport vehicle 110 can travel between the lower pair of elevator rails 32 and the lower pair of story rails 31 along the lower pair of elevator rails 32 and the lower pair of story rails 31.

The pair of story rails 31 are arranged below beam 22ab that supports the office. The height between second horizontal wall 22b of the ceiling and beam 22ab within fourth story space 13b is at least 70 cm. For this reason, in locations where the height between second horizontal wall 22b of the ceiling and beam 22ab within fourth story space 13b is low, the pair of story rails 31 in fourth story space 13b form a single layer. Note that these heights are merely examples and are not limited thereto.

For example, when elevator 200 arrives at a predetermined story of the office, the pair of elevator rails 32 arranged in second elevator space 212 of elevator 200 and the pair of story rails 31 in fourth story space 13b are coupled. Unmanned transport vehicle 110 can travel along from the pair of elevator rails 32 to the pair of story rails 31 to move from second elevator space 212 to fourth story space 13b.

Unmanned transport vehicle 110 travels along the pair of story rails 31 in fourth story space 13b and stops above delivery box 43. Travel opening 28 is formed in second horizontal wall 22b of the ceiling, above delivery box 43. Unmanned transport vehicle 110 lowers the package carriage and stores the package in delivery box 43. When the package is stored in delivery box 43, the package carriage is raised to retrieve the package carriage. In this way, the package can be delivered to a predetermined delivery box 43. Unmanned transport vehicle 110 can also collect packages from delivery box 43.

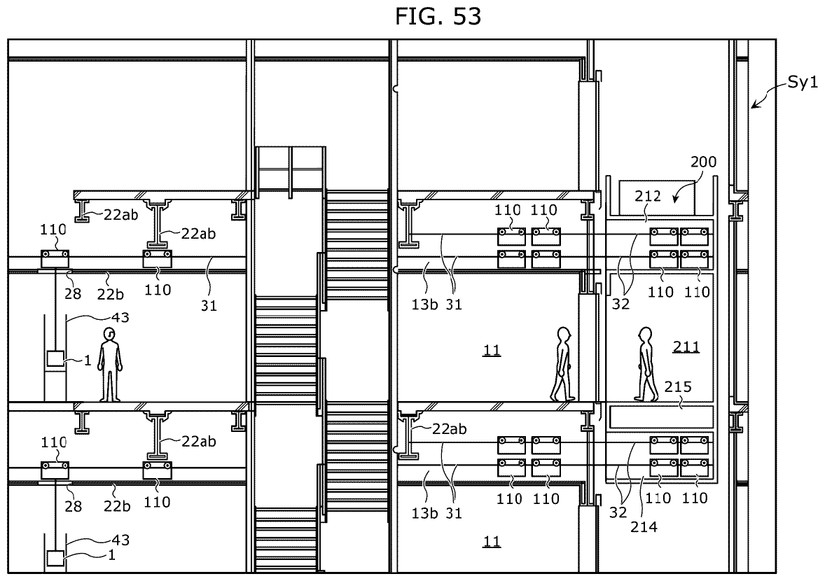

FIG. 53 illustrates an example of elevator 200 including second elevator space 212 and fourth elevator space 214 in office building delivery system Sy1.

FIG. 53 also illustrates, similarly to FIG. 52, a case where the pair of elevator rails 32 arranged in second elevator space 212 of elevator 200 and the pair of story rails 31 in fourth story space 13b are each arranged in two layers in the up-down direction.

FIG. 52 illustrates a case where the pair of elevator rails 32 arranged in second elevator space 212 of elevator 200 and the pair of story rails 31 in fourth story space 13b are arranged in two layers in the up-down direction, whereas in FIG. 53, fourth elevator space 214 is formed below first elevator space 211 of elevator 200. In fourth elevator space 214 as well, similar to second elevator space 212, a pair of story rails 31 that connect to a pair of elevator rails 32 arranged in fourth story space 13b on the (N−1)th story, which is one story below first story space 11, are provided in two layers in the up-down direction, respectively.

A pair of elevator rails 32 arranged in fourth elevator space 214 are also arranged in the up-down direction, respectively. The upper pair of elevator rails 32 and the lower pair of elevator rails 32 are laid out so as to be parallel to second horizontal wall 22b, at a height where unmanned transport vehicles 110 do not contact each other even when unmanned transport vehicles 110 travel on each pair.

Since beam 22ab is provided in fourth story space 13b between the story of first story space 11 (Nth story) and the (N−1)th story, which is one story below first story space 11, fifth elevator space 215 is formed between fourth elevator space 214 and first elevator space 211. Fifth elevator space 215 is set to a height similar to the height of beam 22ab.

Fourth elevator space 214 can be connected to fourth story space 13b between the story of first story space 11 (Nth story) and the (N−1)th story, which is one story below first story space 11, when it is possible for a person to move between first elevator space 211 and first story space 11. Stated differently, since second elevator space 212 and fourth elevator space 214 are formed in elevator 200, unmanned transport vehicles 110 can travel between the pair of story rails 31 and the pair of elevator rails 32 simultaneously in fourth story space 13b above the story of first story space 11 (Nth story) where elevator 200 has stopped and in fourth story space 13b on the (N−1)th story, which is one story below first story space 11. Note that when elevator 200 has arrived at the lowest story, since there may be cases where fourth story space 13b is formed below the floor, unmanned transport vehicle 110 in fourth elevator space 214 may wait in fourth elevator space 214.

Rail lifting device 33, when controlled by controller 501, adjusts the position (height) of this pair of elevator rails 32 by two layers so as to align with the height of the pair of elevator rails 32 arranged in second elevator space 212 and the pair of story rails 31 arranged in fourth story space 13b on the Nth story. Furthermore, rail lifting device 33, when controlled by controller 501, adjusts the position (height) of this pair of elevator rails 32 by two layers so as to align with the height of the pair of elevator rails 32 arranged in fourth elevator space 214 and the pair of story rails 31 arranged in fourth story space 13b on the (N−1)th story.

Rail extension-contraction device 34, when controlled by controller 501, moves the pair of movable rails arranged in second elevator space 212 in the horizontal direction by two layers so as to couple them to the pair of story rails 31 arranged in fourth story space 13b on the Nth story. Furthermore, rail extension-contraction device 34, when controlled by controller 501, moves the pair of movable rails arranged in fourth elevator space 214 in the horizontal direction by two layers so as to couple them to the pair of story rails 31 arranged in fourth story space 13b on the (N−1)th story.

As a result, a pair of story rails 31 above the story (Nth story) of first story space 11 and a pair of elevator rails 32 arranged in second elevator space 212 are coupled for two stories. Furthermore, a pair of story rails 31 at the story ((N−1)th story) one below the story (Nth story) of first story space 11 and a pair of elevator rails 32 arranged in fourth elevator space 214 are coupled for two stories.

Unmanned transport vehicle 110 can travel between a pair of story rails 31 above the story (Nth story) of first story space 11 and a pair of elevator rails 32 arranged in second elevator space 212. Unmanned transport vehicle 110 can also travel between a pair of story rails 31 in the story ((N−1)th story) one below the story of first story space 11 and a pair of elevator rails 32 arranged in fourth elevator space 214.

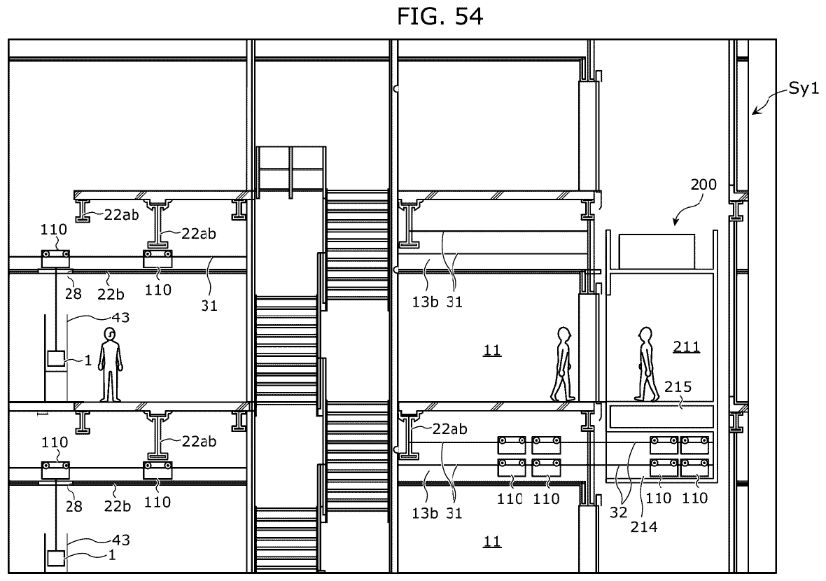

FIG. 54 illustrates an example of elevator 200 including fourth elevator space 214 in office building delivery system Sy1.

FIG. 54 also illustrates, similarly to FIG. 53, a case where fourth elevator space 214 is formed below first elevator space 211 of elevator 200, and a pair of story rails 31 at the story ((N−1)th story) one below the story of first story space 11 and a pair of elevator rails 32 arranged in fourth elevator space 214 are arranged in two layers in the up-down direction.

In FIG. 54, unlike FIG. 53, second elevator space 212 is not formed above first elevator space 211 of elevator 200.

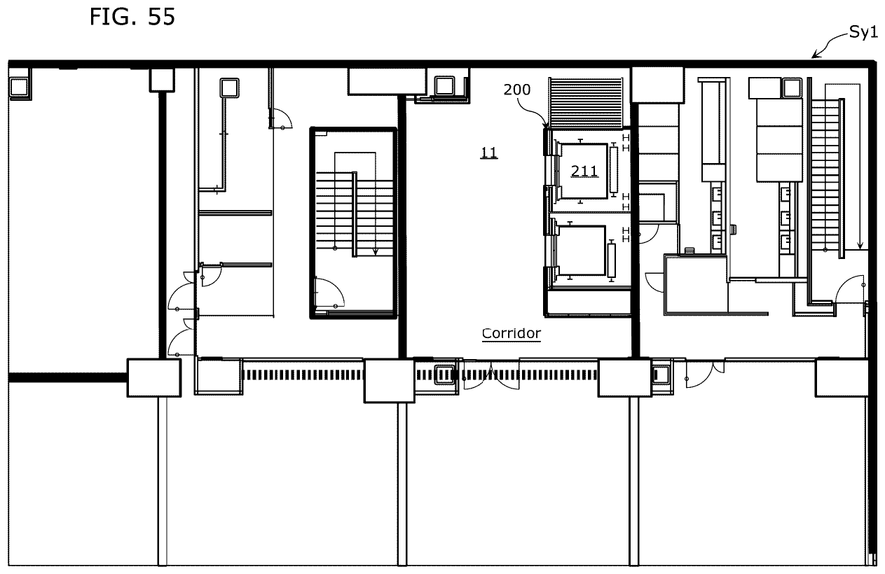

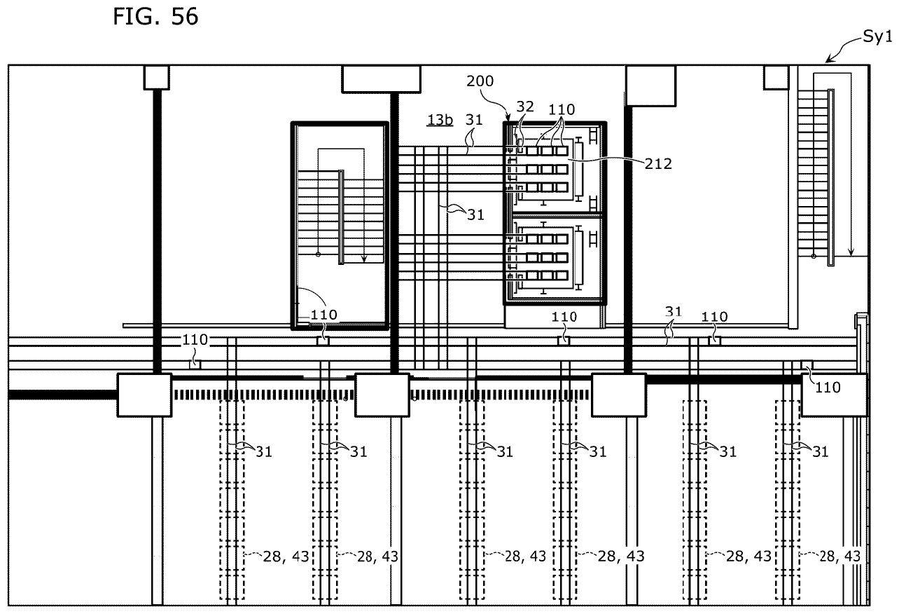

FIG. 55 illustrates an example of first elevator space 211 of elevator 200 and first story space 11 of an office building in office building delivery system Sy1 viewed from above. FIG. 56 illustrates an example of second elevator space 212 of elevator 200 and fourth story space 13b of an office building in office building delivery system Sy1 viewed from above.

Although a plurality of elevators 200 are installed in the office building, certain elevators 200 may be operated even when no people are boarded if unmanned transport vehicle 110 is boarded or waiting to board. In the office building, in fourth story space 13b positioned above the corridors and the like of first story space 11, space is secured for laying out a pair of story rails 31.

Fourth story space 13b is formed above first story space 11 of the office building. Second elevator space 212 is formed above first elevator space 211 of elevator 200.

Fourth story space 13b includes a pair of story rails 31 that are laid out. Since unmanned transport vehicle 110 can travel between the pair of story rails 31 and the pair of elevator rails 32, it can travel along the pair of story rails 31 and move to fourth story space 13b corresponding to the rooms. Unmanned transport vehicle 110 stops above delivery box 43 of the delivery destination, lowers the package carriage through travel opening 28 above delivery box 43, and stores the package in delivery box 43. When the package is stored in delivery box 43, the package carriage is raised to retrieve the package carriage. In this way, the package can be delivered to a predetermined delivery box 43. Unmanned transport vehicle 110 can also lower the package carriage through travel opening 28 and collect the package stored in delivery box 43.

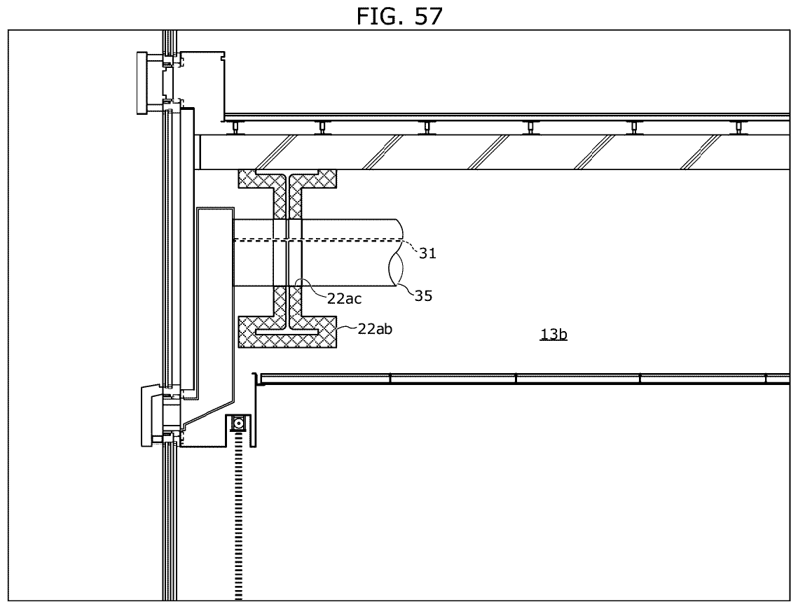

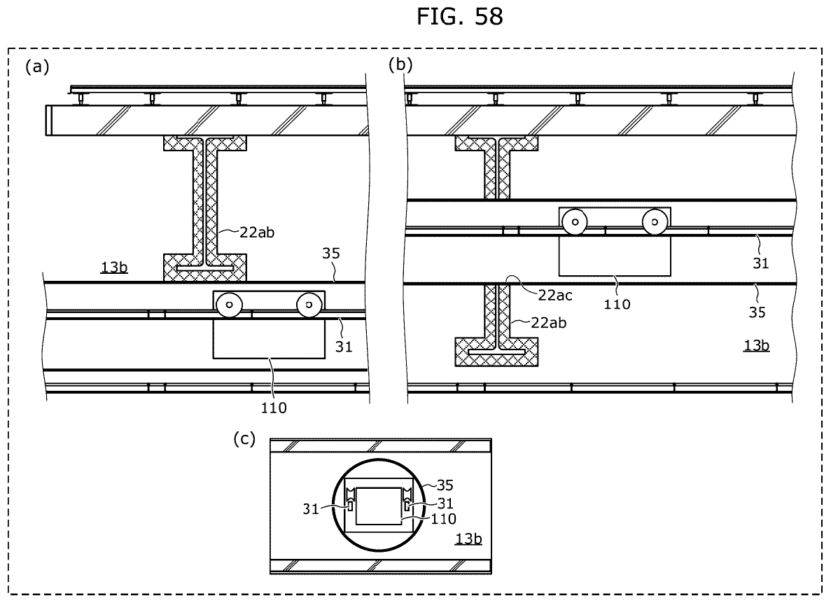

FIG. 57 illustrates an example of office building delivery system Sy1 including duct 35 in which unmanned transport vehicle 110 can travel. FIG. 58 illustrates an example of office building delivery system Sy1 including duct 35 in which unmanned transport vehicle 110 can travel and beam 22ab through which duct 35 passes. In FIG. 58, (b) illustrates duct 35 passing through through-hole 22ac of beam 22ab. In FIG. 58, (a) illustrates duct 35 disposed below beam 22ab. In FIG. 58, (c) illustrates duct 35 and unmanned transport vehicle 110 traveling along the pair of story rails 31 inside duct 35.

Duct 35 is laid out in fourth story space 13b. More specifically, duct 35 is laid out in fourth story space 13b above first story space 11, and is also connected to the second landing door provided in fourth story space 13b.

Duct 35 has a cylindrical shape, but may have a rectangular tubular shape. Rails 7 on which unmanned transport vehicle 110 can travel, i.e., a pair of story rails 31, are provided inside duct 35. Therefore, unmanned transport vehicle 110 can travel along the pair of story rails 31 inside duct 35.

In locations where beams 22ab that support the office building are positioned, it is difficult for unmanned transport vehicle 110 to travel. However, in the present embodiment, beam 22ab has a through-hole 22ac formed in it for the passage of duct 35. This makes it possible to lay out duct 35 in fourth story space 13b.

Since unmanned transport vehicle 110 carries packages into delivery box 43 of the delivery destination, duct 35 has a through-hole formed at a position corresponding to (facing) travel opening 28 above delivery box 43. With this, unmanned transport vehicle 110 stops above delivery box 43 of the delivery destination, lowers the package carriage through the through-hole and travel opening 28, and stores the package in delivery box 43. When the package is stored in delivery box 43, the package carriage is raised to retrieve the package carriage. In this way, the package can be delivered to a predetermined delivery box 43. Unmanned transport vehicle 110 can also lower the package carriage through travel opening 28 and collect the package stored in delivery box 43.

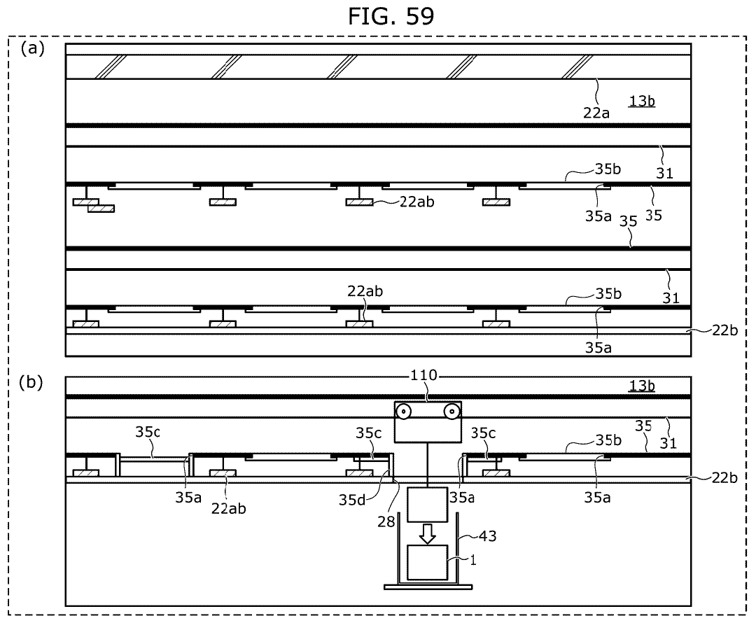

FIG. 59 illustrates an example of office building delivery system Sy1 including duct 35 applied to an office building. In FIG. 59, (a) illustrates a case in which two layers of ducts 35 are arranged in the up-down direction in fourth story space 13b between upper first horizontal wall 22a and second horizontal wall 22b. In the two layers of ducts 35, the upper duct 35 is not arranged vertically above the lower duct 35. In FIG. 59, (b) illustrates a case in which one layer of duct 35 is arranged in fourth story space 13b.

Duct 35 has through-hole 35a formed at a position corresponding to (facing) travel opening 28 above delivery box 43. Shutter 35c is arranged at through-hole 35a. When unmanned transport vehicle 110 arrives above shutter 35c, the shutter actuator, under control by the controller, opens shutter 35c. This allows unmanned transport vehicle 110 to lower the package carriage through through-hole 35a and travel opening 28.

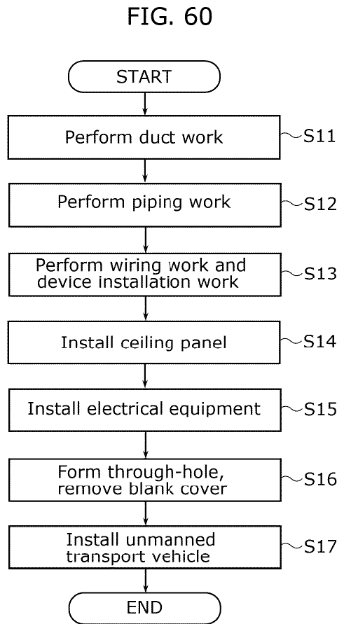

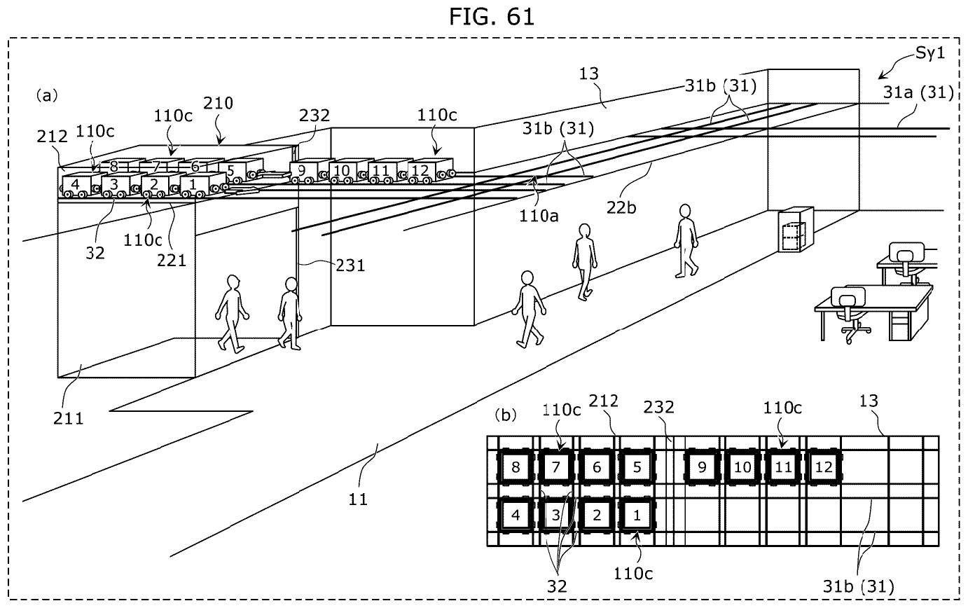

Next, a case in which duct 35 is installed in an office building will be described with reference to FIG. 60.

FIG. 60 illustrates a flowchart illustrating a case in which duct 35 is installed in an office building.

As illustrated in (a) in FIG. 59 and FIG. 60, the inner diameter of duct 35 is 50 cm. The height between the bottom end of beam 22ab and the bottom end of duct 35 is 20 cm. Note that these heights are merely examples and are not limited thereto.

First, a worker performs various duct work in the office building (S11). More specifically, duct 35 and a pair of story rails 31 are installed in fourth story space 13b. The worker also installs air conditioning ducts, ventilation ducts, and the like in the office building.

Next, the worker performs piping work such as installing water pipes, gas pipes, and fire suppression piping such as sprinklers in the office building (S12).

Next, the worker performs wiring work such as electrical wiring and communication wiring, and various device installation work for fire alarms, surveillance cameras, and the like in the office building (S13).

Next, the worker installs second horizontal wall 22b, which is a ceiling panel, in the office building (S14). This forms fourth story space 13b between upper first horizontal wall 22a and second horizontal wall 22b, while concealing the wiring, piping, duct 35, the pair of story rails 31, and the like.

Next, the worker installs lighting fixtures, air conditioning equipment, and the like on second horizontal wall 22b and the like in the office building (S15).

Next, the worker forms travel opening 28 in second horizontal wall 22b and removes blank cover 35b provided in advance to through-hole 35a of duct 35 at a position opposing travel opening 28 in the office building (S16). A plurality of through-holes 35a are formed in advance in duct 35, and blank covers 35b that cover through-holes 35a of duct 35 are also attached in advance. Blank covers 35b are removed only at locations corresponding to travel openings 28. Here, since a gap is formed between through-hole 35a and travel opening 28, the worker installs piping 35d that connects through-hole 35a and travel opening 28. The worker also installs shutter 35c that can open and close through-hole 35a. The worker also configures the controller that controls the shutter actuator and the shutter actuator so that shutter 35c is actuated by the shutter actuator.

Next, the worker installs unmanned transport vehicle 110 that can travel on the pair of story rails 31 and the like in the office building (S17). In this way, the construction work on the office building is completed.

With this, unmanned transport vehicle 110 stops above delivery box 43 of the delivery destination, and when shutter 35c opens through-hole 35a, can lower the package carriage through through-hole 35a above delivery box 43 and travel opening 28, and store the package in delivery box 43. In this way, the package can be delivered to a predetermined delivery box 43. Unmanned transport vehicle 110 can also lower the package carriage through travel opening 28 and collect the package stored in delivery box 43.

Although office building delivery system Sy1 has been described in the present embodiment, the present embodiment can also be applied to apartment delivery system Sy2, logistics system Sy3, and Sy4.

In the present embodiment, unmanned transport vehicles 110, 110a, and 110b may be equipped with the above-described package carriage.

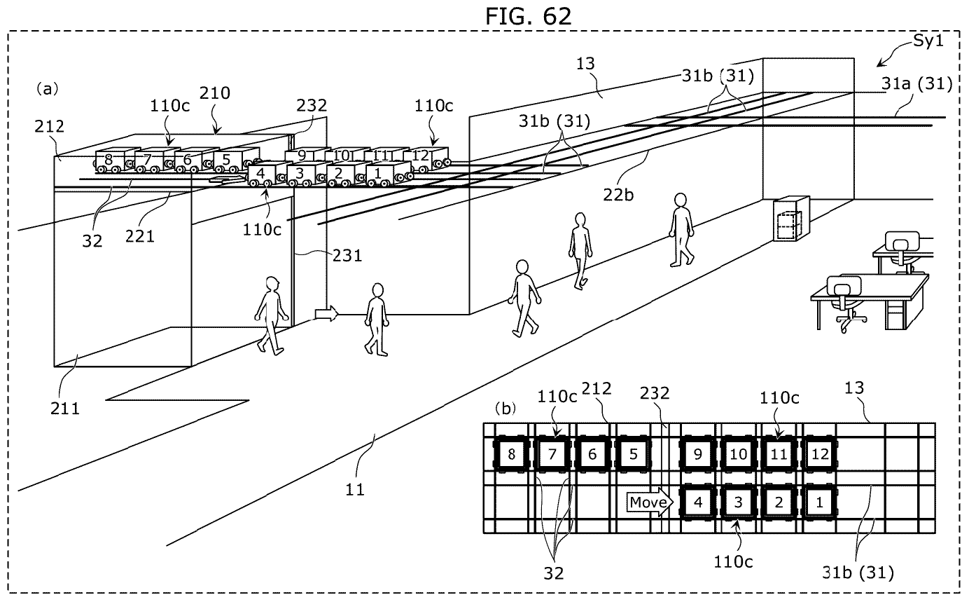

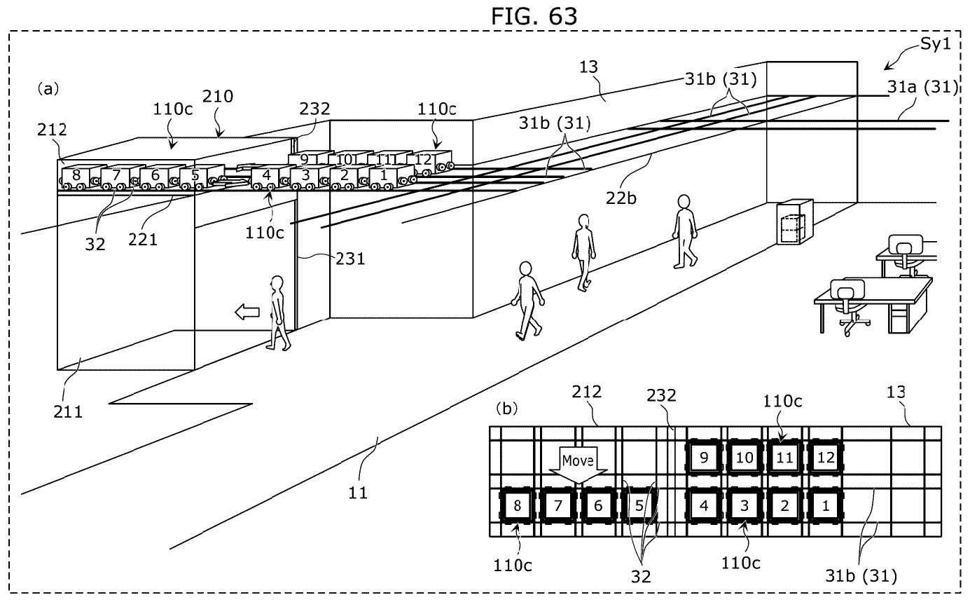

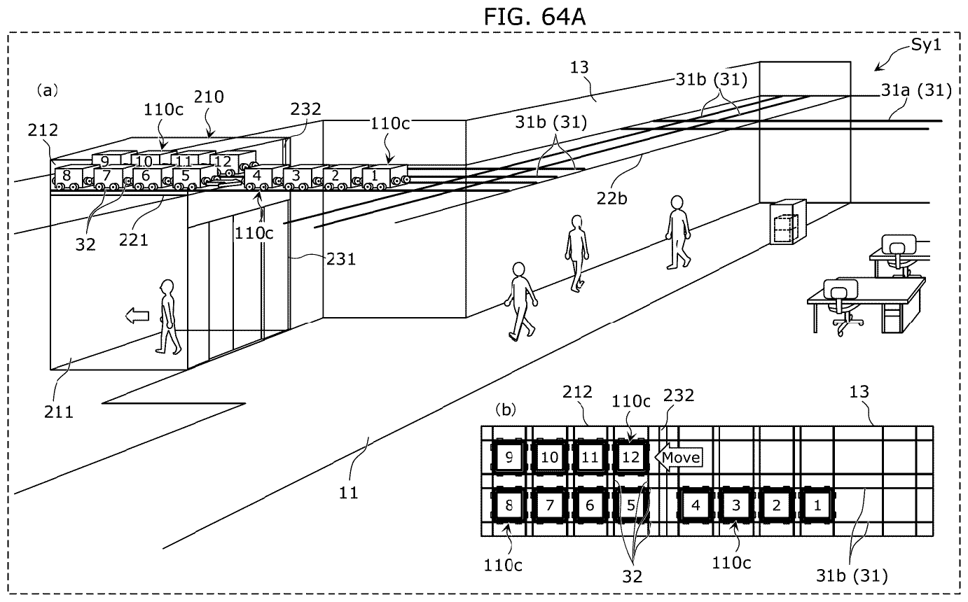

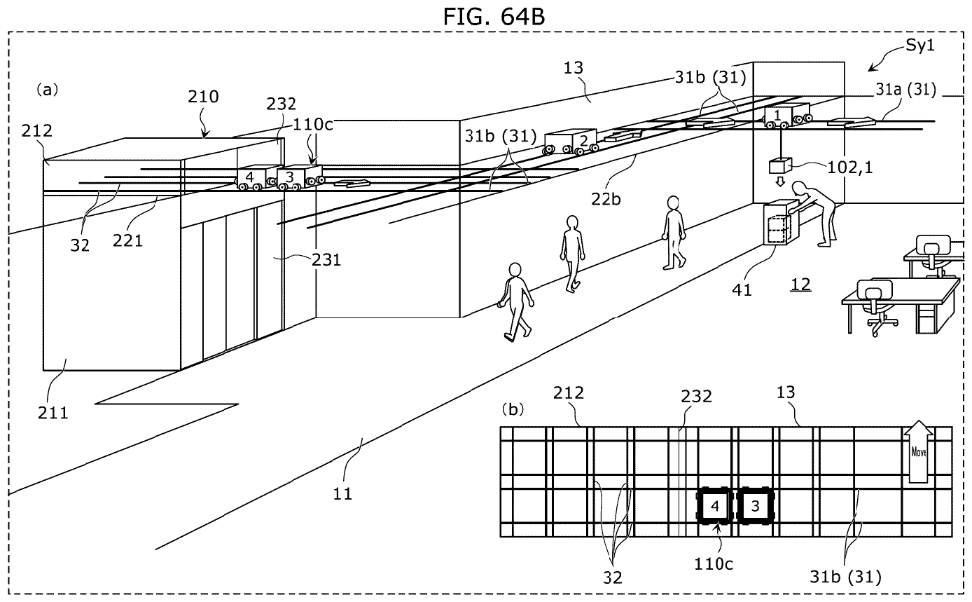

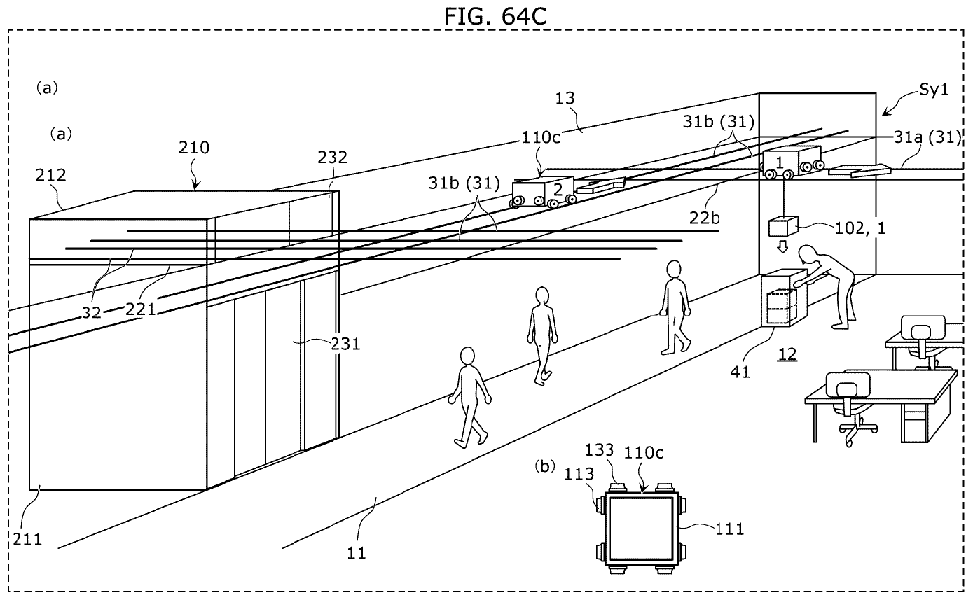

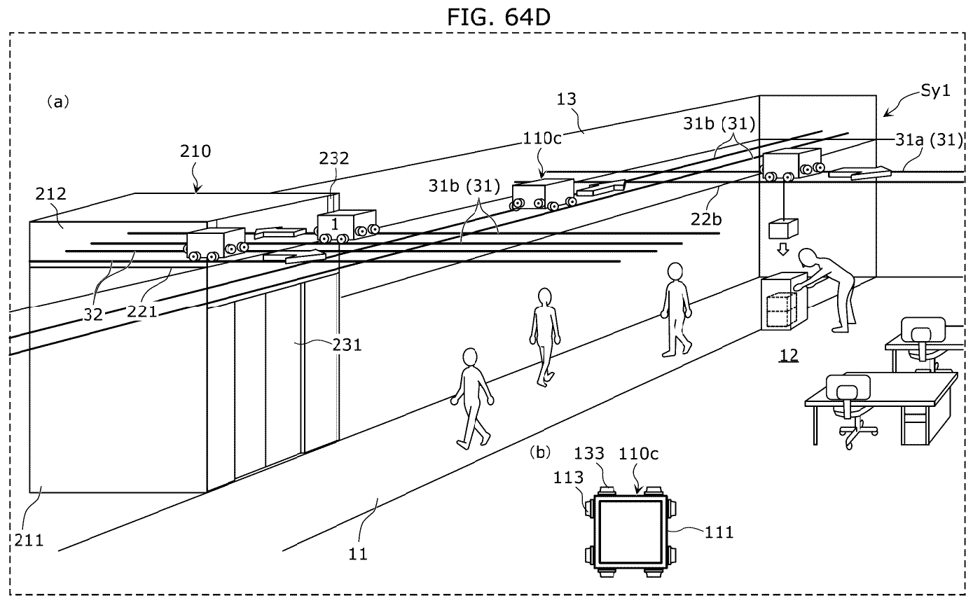

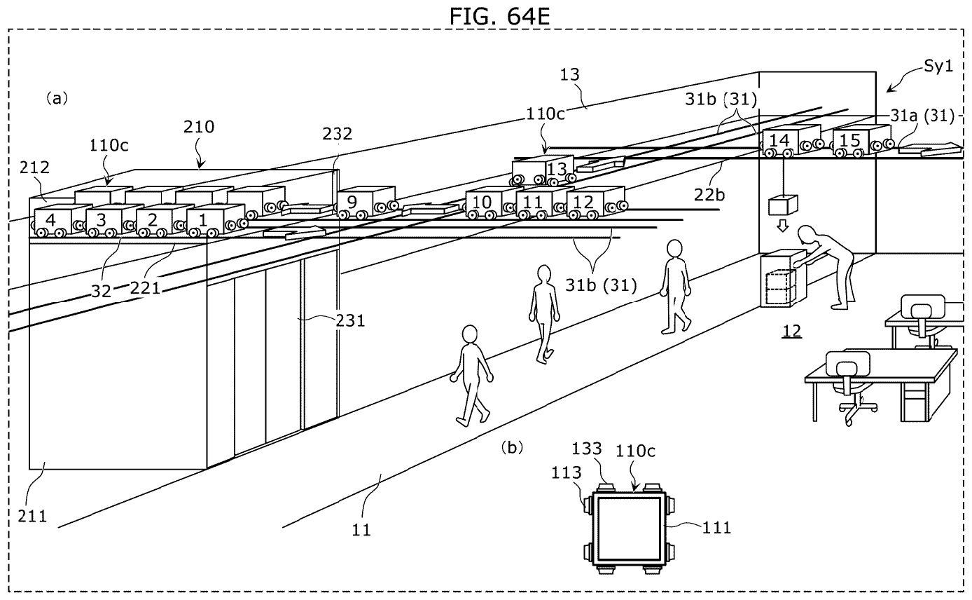

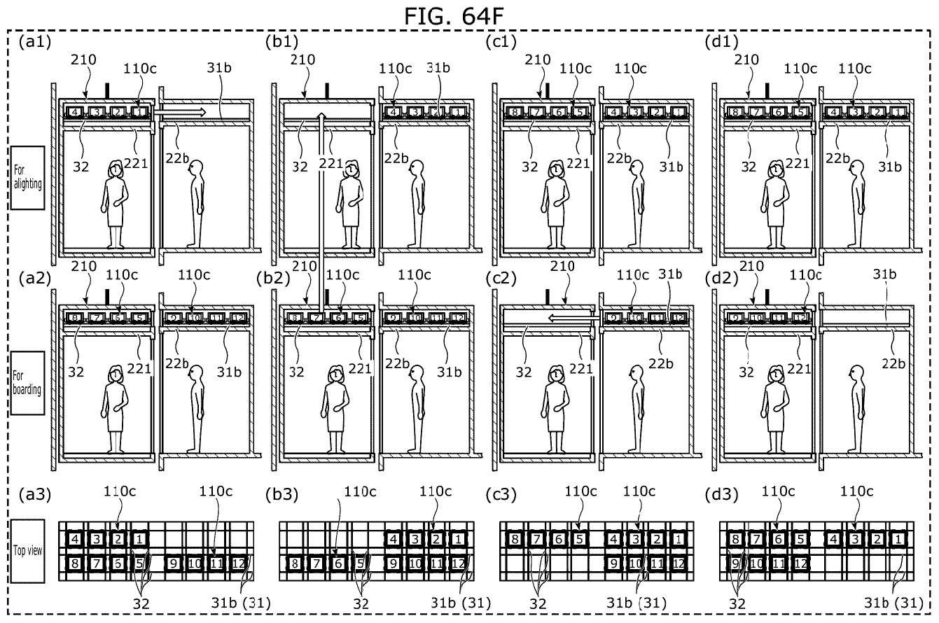

FIG. 61 to FIG. 64A illustrate examples of a configuration of office building delivery system Sy1 according to the present embodiment. (a) in FIG. 61, (a) in FIG. 62, (a) in FIG. 63, and (a) in FIG. 64A illustrate, similar to FIG. 1 and FIG. 22, a bird's-eye view of one story among a plurality of stories in an office building in which office building delivery system Sy1 is installed. In (b) in FIG. 61, (b) in FIG. 62, (b) in FIG. 63, and (b) in FIG. 64A, third story space 13, second elevator space 212, and unmanned transport vehicle 110c are illustrated as viewed from above.

Note that FIG. 61 illustrates a bird's-eye view of one story (also referred to as a story area) among a plurality of stories in an office building in which office building delivery system Sy1 is installed. FIG. 61 illustrates an elevator including elevator carriage 210 installed in an office building, and unmanned transport vehicle 110c. An elevator lobby and a corridor connected to the elevator lobby are formed in front of the entrance of elevator carriage 210. The elevator lobby and the corridor are included in first story space 11 included in the story area described above. Note that even when reference signs are not provided in this figure, the description will use the same reference signs as those described above.

Third story space 13 included in the story area includes story rails 31 (first story rails 31a, second story rails 31b), which are rails for unmanned transport vehicle 110c to travel along and extend horizontally.

The plurality of second story rails 31b are arranged along the horizontal direction in third story space 13, and include second story rails 31b for boarding and second story rails 31b for alighting that extend from second story rails 31b for boarding to the elevator lobby. At the portion where second story rail 31b for boarding and second story rail 31b for alighting intersect, they form a diamond crossing like railway rails. Stated differently, at the intersection portion (the portion forming a diamond crossing) between second story rail 31b for boarding and second story rail 31b for alighting, unmanned transport vehicle 110c is configured to be able to move between second story rails 31b for boarding and for alighting.

Note that second story rails 31b for boarding and for alighting do not mean second story rails 31b exclusively for boarding and exclusively for alighting. Second story rail 31b for boarding and second story rail 31b for alighting may be interchanged with each other.

The space within elevator carriage 210 is divided into first elevator space 211 and second elevator space 212 by partition 221. Stated differently, elevator carriage 210 is a two-story or two-level carriage.

First elevator space 211 is a space for a person to board. First elevator space 211 is one example of a first space. Second elevator space 212 is a space for unmanned transport vehicle 110c to board. Second elevator space 212 is one example of a second space. Second elevator space 212 is positioned above first elevator space 211.

Second elevator space 212 includes a plurality of elevator rails 32. The plurality of elevator rails 32 correspond one-to-one with the plurality of second story rails 31b. In the present embodiment, second elevator space 212 includes elevator rail 32 for boarding, which is for unmanned transport vehicle 110c to board elevator carriage 210, and elevator rail 32 for alighting, which is for unmanned transport vehicle 110c to alight from elevator carriage 210. Elevator rail 32 for boarding corresponds with second story rail 31b for boarding, and elevator rail 32 for alighting corresponds with second story rail 31b for alighting. Elevator rail 32 for boarding and elevator rail 32 for alighting are examples of the first elevator rail.

Note that elevator rails 32 for boarding and for alighting do not mean elevator rails 32 exclusively for boarding and exclusively for alighting. Elevator rail 32 for boarding and elevator rail 32 for alighting may be interchanged with each other.

The plurality of elevator rails 32 for boarding and the plurality of elevator rails 32 for alighting correspond one-to-one with the plurality of second story rails 31b for boarding and the plurality of second story rails 31b for alighting. Unmanned transport vehicle 110c is configured to be able to board from second story rail 31b for boarding to elevator rail 32 for boarding, and unmanned transport vehicle 110c is configured to be able to alight from elevator rail 32 for alighting to second story rail 31b for alighting. In such cases, when elevator carriage 210 arrives in front of the entrance/exit of the story area, elevator rails 32 for boarding and for alighting and second story rails 31b for boarding and for alighting are connected in a straight line so that unmanned transport vehicle 110c can board elevator carriage 210 and unmanned transport vehicle 110c can alight from elevator carriage 210.

The plurality of elevator rails 32 include elevator rail 32 for connection that connects elevator rail 32 for boarding and elevator rail 32 for alighting, and forms a diamond crossing with elevator rails 32 for boarding and for alighting. Stated differently, elevator rail 32 for connection intersects elevator rail 32 for boarding and elevator rail 32 for alighting. Elevator rail 32 for connection is an example of the second elevator rail.

With such rails, unmanned transport vehicle 110c can move from elevator rail 32 for boarding to elevator rail 32 for alighting via elevator rail 32 for connection.

In the present embodiment, controller 501 illustrated in FIG. 38 controls winch 204 illustrated in FIG. 38 so as not to stop elevator carriage 210 at stories where only unmanned transport vehicle 110c is scheduled to alight when a person is boarded in first elevator space 211 and unmanned transport vehicle 110c is boarded in second elevator space 212.

For example, when a person boarded in first elevator space 211 presses a destination button of elevator carriage 210 and wishes to alight at a desired story area, or when a person presses a call button in an elevator lobby and boards from the story area where that call button is, unmanned transport vehicle 110c can board from third story space 13 to second elevator space 212 or alight from second elevator space 212 to third story space 13. Stated differently, at story areas where people do not board and story areas where people do not alight from elevator carriage 210, elevator carriage 210 does not stop even if unmanned transport vehicle 110c is scheduled to board elevator carriage 210 or unmanned transport vehicle 110c is scheduled to alight from elevator carriage 210.

However, controller 501 controls winch 204 so as to stop elevator carriage 210 at stories where unmanned transport vehicle 110c is scheduled to alight when a person is not boarded in first elevator space 211 and unmanned transport vehicle 110c is boarded in second elevator space 212.

As a result, when no person is boarded in elevator carriage 210, unmanned transport vehicle 110c can board from third story space 13 to second elevator space 212 or alight from second elevator space 212 to third story space 13. Stated differently, when no person is boarded in elevator carriage 210, elevator carriage 210 can carry unmanned transport vehicle 110c to the stories of each story area.

As described above, elevator carriage 210 includes first carriage door 231 and second carriage door 232.

First carriage door 231 is a door that opens and closes an opening leading from outside elevator carriage 210 to first elevator space 211. Second carriage door 232 is a door that opens and closes an opening leading from outside elevator carriage 210 to second elevator space 212. Controller 501 can control opening and closing of first carriage door 231 and second carriage door 232.

More specifically, controller 501 controls the actuation mechanism of first carriage door 231 and the actuation mechanism of second carriage door 232 to open first carriage door 231 and open second carriage door 232 when a person and unmanned transport vehicle 110c alight at a predetermined story when a person is boarded in first elevator space 211 and an unmanned transport vehicle is boarded in second elevator space 212. However, controller 501 controls the actuation mechanism of first carriage door 231 to open first carriage door 231 and keep second carriage door 232 in a closed state when a person alights at a predetermined story when a person is boarded in first elevator space 211 and unmanned transport vehicle 110c is not boarded in second elevator space 212.

Note that controller 501 may keep first carriage door 231 in a closed state while opening second carriage door 232 when unmanned transport vehicle 110c alights at a predetermined story when a person is boarded in first elevator space 211 and unmanned transport vehicle 110c is boarded in second elevator space 212. In the above description, boarding and alighting of people with respect to elevator carriage 210 was prioritized over boarding and alighting of unmanned transport vehicle 110c, but the present invention is not limited to this example.

In such cases, it is conceivable that individuals riding in elevator carriage 210 may experience anxiety or confusion. Accordingly, controller 501 may keep first carriage door 231 closed and display on the display provided on elevator carriage 210 that the elevator is stopped for unmanned transport vehicle 110c when second carriage door 232 is open. This makes it possible to notify that the reason for elevator carriage 210 stopping is not due to a malfunction, which can be expected to alleviate the anxiety and confusion of people riding in elevator carriage 210.

Controller 501 may keep first carriage door 231 closed and output, from the loudspeaker provided on elevator carriage 210, an announcement that the elevator is stopped for unmanned transport vehicle 110c when second carriage door 232 is open. Controller 501 may keep first carriage door 231 closed and output from the loudspeaker and display provided on elevator carriage 210 that the elevator is stopped for unmanned transport vehicle 110c when second carriage door 232 is open. This makes it possible to notify that the reason for elevator carriage 210 stopping is not due to a malfunction, which can be expected to alleviate the anxiety and confusion of people riding in elevator carriage 210.

Elevator carriage 210 moves to the story area where the call button was pressed and stops. The call button is a button for summoning elevator carriage 210. A call button is installed in each story area. Stated differently, when a call button is pressed, elevator carriage 210 moves to the story area where the pressed call button is located.

For example, FIG. 61 illustrates eight unmanned transport vehicles 110c numbered 1 to 8 riding in elevator carriage 210.

In office building delivery system Sy1 illustrated in FIG. 61, when elevator carriage 210 stops at a story area and first carriage door 231 of first elevator space 211 where people are boarded opens, second carriage door 232 of second elevator space 212 is also configured to open. Here, four unmanned transport vehicles 110c numbered 1 to 4 obtain control instructions from controller 501, whereby controller 120 controls actuator 140, and start alighting from elevator carriage 210. Four unmanned transport vehicles 110c numbered 5 to 8 obtain control instructions from controller 501, whereby controller 120 controls actuator 140, and start moving inside elevator carriage 210 from elevator rails 32 for boarding to elevator rails 32 for alighting. Four unmanned transport vehicles 110c numbered 9 to 12 obtain control instructions from controller 501, whereby controller 120 controls actuator 140, and start boarding elevator carriage 210. Unmanned transport vehicles 110c may start moving in this order: numbered 1 to 4, numbered 5 to 8, and numbered 9 to 12. The control instruction is a signal instructing unmanned transport vehicle 110c to board elevator carriage 210, or a signal instructing unmanned transport vehicle 110c to alight from elevator carriage 210.

As illustrated in FIG. 62, four unmanned transport vehicles 110c numbered 1 to 4 move from elevator rails 32 for alighting to second story rails 31b for alighting, and alight from elevator carriage 210.

Next, as illustrated in FIG. 63, four unmanned transport vehicles 110c numbered 5 to 8 move from elevator rails 32 for boarding to elevator rails 32 for alighting via elevator rails 32 for connection.

Next, as illustrated in FIG. 64A, four unmanned transport vehicles 110c numbered 9 to 12 move from second story rails 31b for boarding to elevator rails 32 for boarding, and board elevator carriage 210.

In this way, since a plurality of unmanned transport vehicles 110c board and alight in groups, office building delivery system Sy1 can improve the transport efficiency of unmanned transport vehicles 110c with respect to elevator carriage 210. As a result, in the building delivery system, the transport efficiency of packages transported by unmanned transport vehicle 110c can be improved.

FIG. 64B through FIG. 64E illustrate unmanned transport vehicles 110c that have moved to second story rails 31b delivering packages to second story space 12. (a) in FIG. 64B, (a) in FIG. 64C, (a) in FIG. 64D, and (a) in FIG. 64E illustrate, similar to FIG. 1 and FIG. 22, a bird's-eye view of one story among a plurality of stories in an office building in which office building delivery system Sy1 is installed. In (a) in FIG. 64B, third story space 13, second elevator space 212, and unmanned transport vehicle 110c are illustrated as viewed from above. In (b) in FIG. 64C, (b) in FIG. 64D, and (b) in FIG. 64E, unmanned transport vehicle 110c is illustrated as viewed from above.

Second story space 12 is a space for people to perform desk work. Second story space 12 is included in the story area.

For example, as illustrated in (b) in FIG. 64C, etc., unmanned transport vehicle 110c includes four wheels 113 and four lifting wheels 133 arranged on a virtual plane (for example, a horizontal plane), two of the four wheels 113 are placed on one rail in the pair of story rails 31, and the remaining two wheels 113 are placed on the other rail in the pair of story rails 31. Note that in the present embodiment, the pair of story rails 31 may be referred to simply as story rail 31 or story rails 31.

Story rails 31 have a portion where story rails 31 extending in the first direction and story rails 31 extending in the second direction intersect to form a diamond crossing. When unmanned transport vehicle 110c travels on story rails 31 extending in the first direction with four wheels 113, unmanned transport vehicle 110c stops at the portion forming a diamond crossing and switches from story rails 31 extending in the first direction to story rails 31 extending in the second direction. More specifically, in unmanned transport vehicle 110c, from a state where four wheels 113 are placed on story rails 31 extending in the first direction (second state), four lifting wheels 133 lower and are placed on story rails 31 extending in the second direction, whereby the four wheels 113 rise and become separated from story rails 31 extending in the first direction (first state). This allows unmanned transport vehicle 110c to make right and left turns at the portion forming a diamond crossing.

For example, as illustrated in (a) in FIG. 64B, unmanned transport vehicles 110c numbered 1 to 4 travel toward predetermined delivery destinations. For example, as illustrated in (a) in FIG. 64B and (a) in FIG. 64C, unmanned transport vehicle 110c numbered 1 stops above delivery box 41 at the delivery destination, lowers package carriage 102 to house package 1 inside delivery box 41 and deliver package 1.

As illustrated in (a) in FIG. 64D, after delivering the package, unmanned transport vehicle 110c numbered 1 moves along story rails 31 and returns to second elevator space 212 of elevator carriage 210.

In this way, unmanned transport vehicle 110c delivers package 1 to the delivery destination and boards elevator carriage 210 after delivery.

For example, (a) in FIG. 64E illustrates unmanned transport vehicles 110c numbered 1 to 4 moving from second elevator space 212 to story rails 31, unmanned transport vehicles 110c numbered 9 to 12 boarding second elevator space 212 from story rails 31 after delivering packages or after collecting packages, unmanned transport vehicles 110c numbered 13 and 15 moving along story rails 31 toward delivery destinations, and unmanned transport vehicle 110c numbered 14 housing package 1 inside delivery box 41 at the delivery destination.

FIG. 64F illustrates an example of a plurality of unmanned transport vehicles 110c boarding and alighting from elevator carriage 210.

The “left column” illustrated in (a1) to (d1) in FIG. 64F illustrates four unmanned transport vehicles 110c numbered 1 to 4 moving from elevator rails 32 for alighting to second story rails 31b for alighting, and alighting from elevator carriage 210. The “right column” illustrated in (a2) to (d2) in FIG. 64F illustrates four unmanned transport vehicles 110c numbered 5 to 8 moving from elevator rails 32 for boarding to elevator rails 32 for alighting, and four unmanned transport vehicles 110c numbered 9 to 12 moving from second story rails 31b for boarding to elevator rails 32 for boarding, and boarding elevator carriage 210. In FIG. 64F, (a3) to (d3) illustrate top views of twelve unmanned transport vehicles 110c numbered 1 to 12. Note that FIG. 64F illustrates a case in which the positions of elevator rails 32 for alighting to second story rails 31b for alighting and second story rails 31b for boarding to elevator rails 32 for boarding illustrated in FIG. 61 through FIG. 64A are reversed.

As illustrated in (a1), (a2), (a3), (b1), (b2), and (b3) in FIG. 64F, four unmanned transport vehicles 110c numbered 1 to 4 obtain control instructions from controller 501, whereby controller 120 controls actuator 140, and move from elevator rails 32 for alighting to second story rails 31b for alighting, and alight from elevator carriage 210. With this, space for four unmanned transport vehicles 110c becomes available on elevator rails 32 for alighting.

As illustrated in (b1), (b2), (b3), (c1), (c2), and (c3) in FIG. 64F, four unmanned transport vehicles 110c numbered 5 to 8 obtain control instructions from controller 501, whereby controller 120 controls actuator 140, and move from elevator rails 32 for boarding to elevator rails 32 for alighting via elevator rails 32 for connection. With this, space on elevator rails 32 for alighting becomes filled, and space for four unmanned transport vehicles 110c becomes available on elevator rail 32 for boarding.

As illustrated in (c1), (c2), (c3), (d1), (d2), and (d3) in FIG. 64F, four unmanned transport vehicles 110c numbered 9 to 12 obtain control instructions from controller 501, whereby controller 120 controls actuator 140, and move from second story rails 31b for boarding to elevator rails 32 for boarding. With this, space on elevator rails 32 for boarding becomes filled.

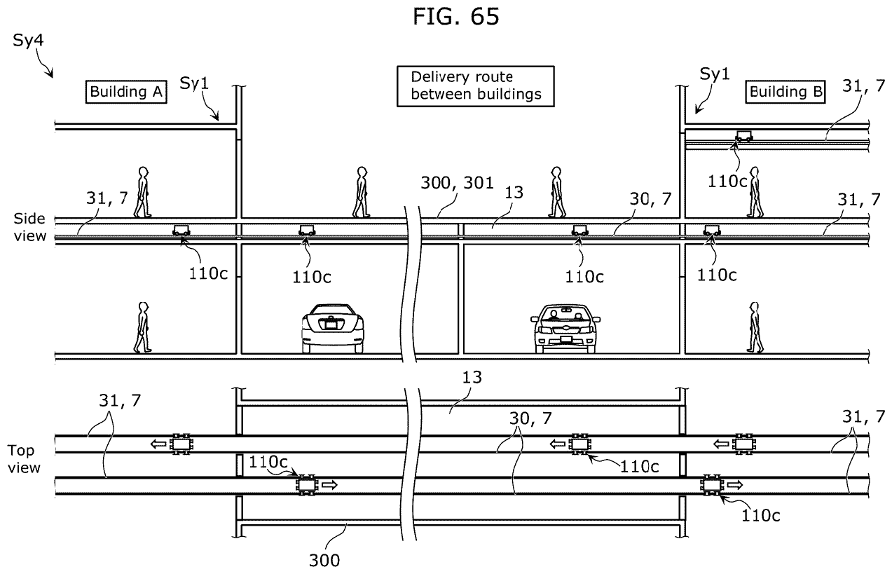

FIG. 65 illustrates an example of a configuration of logistics system Sy4 according to Embodiment 8.

Logistics system Sy4 according to the present embodiment includes, for example, office building delivery system Sy1 installed in Building A, office building delivery system Sy1 installed in Building B, and a plurality of pairs of transport rails 30 that connect these office building delivery systems Sy1. The plurality of pairs of transport rails 30 are arranged in third story space 13 of connecting bridge 300 that connects Building A and Building B. Transport rail 30 is connected to one end of pairs of story rails 31 of both of Building A and Building B. Therefore, it can also be said that one rail 7 is configured by serially connecting the pair of story rails 31 of Building A, transport rail 30, and the pair of story rails 31 of Building B. Note that in the example of FIG. 65, a plurality of pairs of transport rails 30 are provided, but a single pair of transport rails 30 may be provided.

Unmanned transport vehicle 110c travels along a pair of rails 7 in third story space 13 of each of Building A, Building B, and connecting bridge 300.

Thus, the structure according to the present embodiment includes a first building, a second building, connecting bridge 300 that connects the first building and the second building, and rail 7 for unmanned transport vehicle 110c to travel on. The rail extends from the inside of the first building, across connecting bridge 300, and to the inside of the second building. Note that the first building is, for example, Building A, and the second building is, for example, Building B. The first building includes a first predetermined story and a second predetermined story, and a first space for unmanned transport vehicle 110c to travel on is provided between the ceiling of the first predetermined story and the floor of the second predetermined story of the first building. The second building includes a first predetermined story and a second predetermined story, and a second space for unmanned transport vehicle 110c to travel on is provided between the ceiling of the predetermined first story and the floor of the second predetermined story of the second building. The first space is, for example, third story space 13 of Building A, and the second space is, for example, third story space 13 of Building B. Connecting bridge 300 further includes walkway 301 that connects the floor of the second predetermined story of the first building and the floor of the second predetermined story of the second building. Below walkway 301, a third space for unmanned transport vehicle 110c to travel in is provided. The third space connects to the first space and the second space. Note that the third space is, for example, third story space 13 of connecting bridge 300. Rail 7 is disposed across the first space, the third space, and the second space.

This allows unmanned transport vehicle 110c to travel between the first building and the second building via connecting bridge 300.

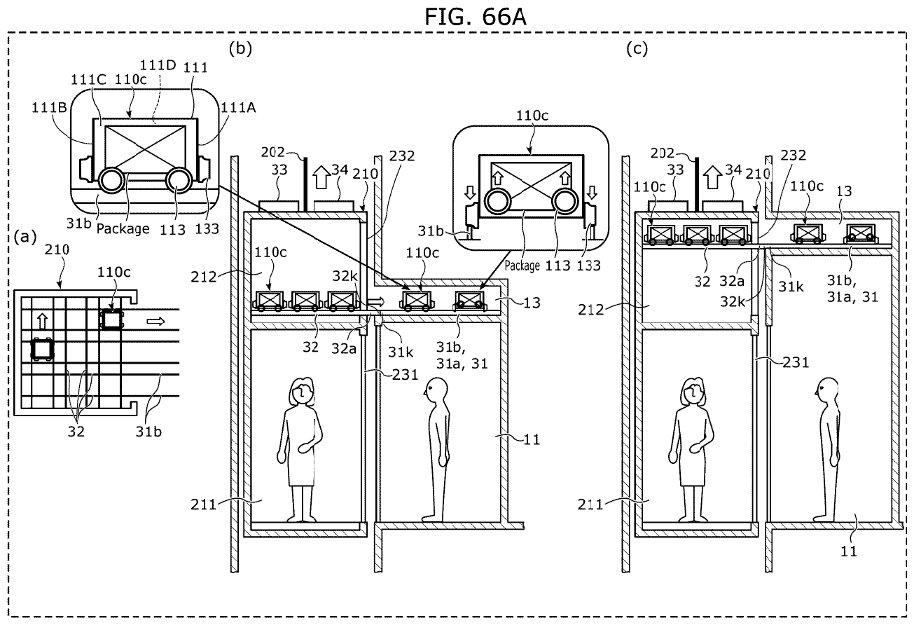

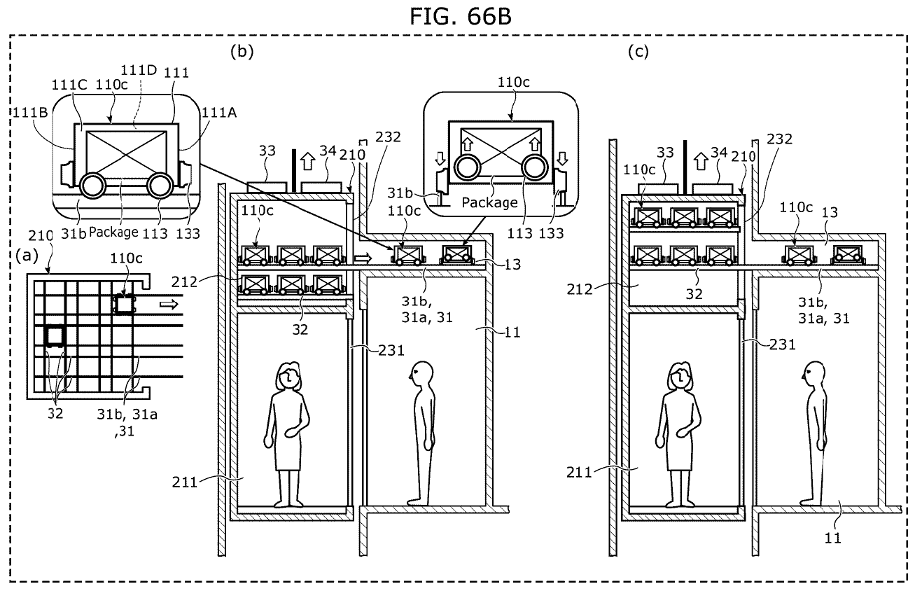

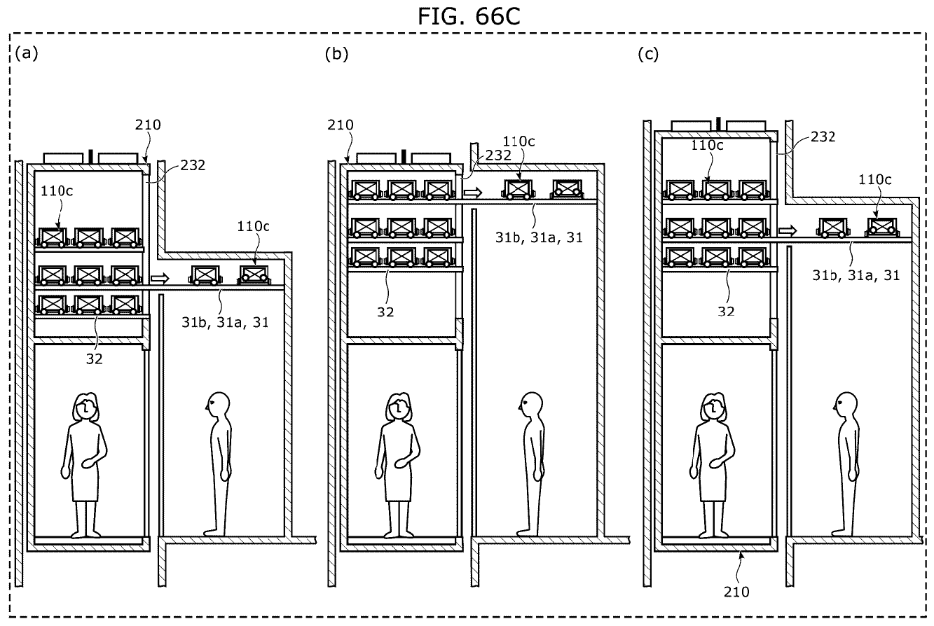

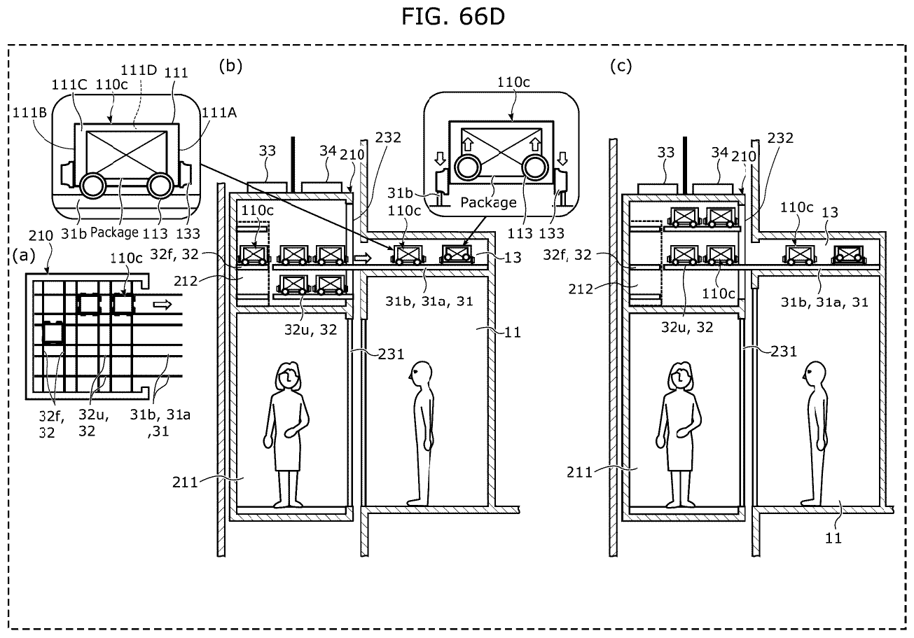

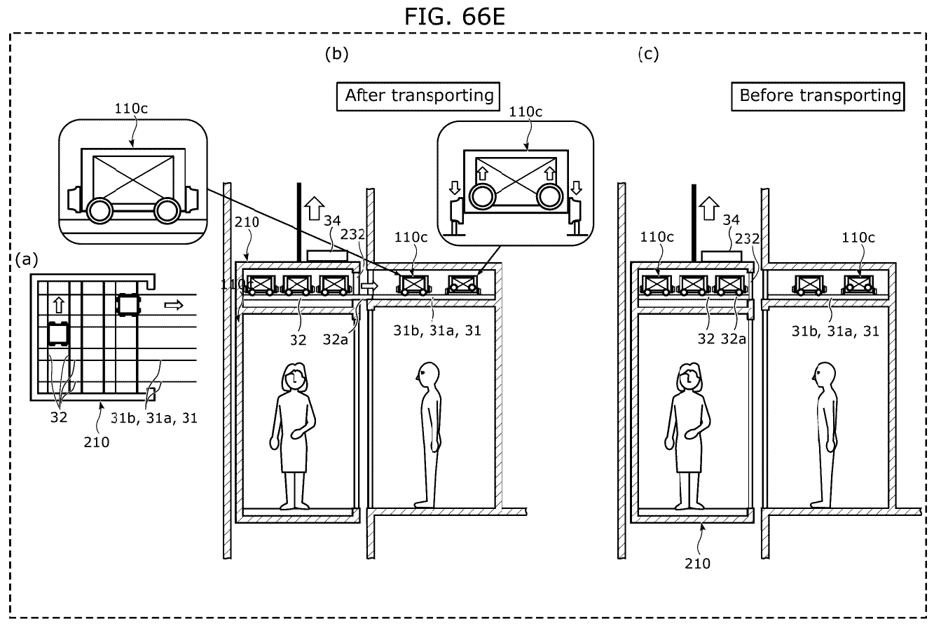

FIG. 66A illustrates an example of elevator carriage 210 according to the present embodiment. In (a) in FIG. 66A, a state in which second carriage door 232 of elevator carriage 210 is open and elevator rails 32 and second story rails 31b are connected is illustrated. In (b) in FIG. 66A, a state in which elevator rails 32 rise, second carriage door 232 of elevator carriage 210 is open, and elevator rails 32 and second story rails 31b are connected is illustrated. Note that even when reference signs are not provided in this figure, the description will use the same reference signs as those described above.

Unmanned transport vehicle 110c includes enclosure 111, four wheels 113 arranged on enclosure 111, four lifting wheels 133 arranged on enclosure 111, and at least one actuator 140.

Enclosure 111 includes first side surface 111A and second side surface 111B opposite each other, and third side surface 111C and fourth side surface 111D opposite each other.

The four lifting wheels 133 include two first wheels positioned on first side surface 111A and two second wheels positioned on second side surface 111B. Stated differently, the first wheel includes a first first wheel and a second first wheel. The second wheel includes a first second wheel and a second second wheel. The first wheel is for traveling on the first rail, and the second wheel is for traveling on the second rail parallel to the first rail. The first rail and the second rail are, for example, story rails 31, 31a, 31b consisting of two rails, elevator rails 32 consisting of two rails, or the like.

Each of the four lifting wheels 133 may include a flange portion with an enlarged diameter provided on the periphery of the wheel main body. Stated differently, each of the four lifting wheels 133 may be configured with a wheel main body that travels on the rail while contacting the rail, and the above-described flange portion. When lifting wheel 133 travels on the rail, the flange portion contacts and is guided by the side surface of the rail, which makes it difficult for unmanned transport vehicle 110c to derail.

The four wheels 113 include two third wheels positioned on third side surface 111C and two fourth wheels positioned on fourth side surface 111D. The third wheel includes a first third wheel and a second third wheel, and the fourth wheel includes a first fourth wheel and a second fourth wheel. The third wheel is for traveling on the third rail, and the fourth wheel is for traveling on the fourth rail parallel to the third rail. The third rail and the fourth rail are, for example, story rails 31, 31a, 31b consisting of two rails, elevator rails 32 consisting of two rails, or the like.

Each of the four wheels 113 may include a flange portion with an enlarged diameter provided on the periphery of the wheel main body. Stated differently, each of the four wheels 113 may be configured with a wheel main body that travels on the rail while contacting the rail, and the above-described flange portion. When the wheel travels on the rail, the flange portion contacts and is guided by the side surface of the rail, which makes it difficult for unmanned transport vehicle 110c to derail.

Actuator 140, under control by controller 120, moves the first wheel and the second wheel in the upward direction and downward direction, and moves the third wheel and the fourth wheel in the downward direction and upward direction. Actuator 140 is an example of the actuator.

Note that the number of the four wheels 113 and the number of the four lifting wheels 133 are merely examples. The number of wheels 113 and the number of lifting wheels 133 may be such that at least one of them is five or more.

Actuator 140, under control by controller 120, can change the four lifting wheels 133 between a first state and a second state. More specifically, actuator 140, under control by controller 120, can change between the second state in which the four lifting wheels 133 are separated from elevator rail 32 and the first state in which the four lifting wheels 133 are placed on elevator rail 32. In the first state, the four lifting wheels 133 are positioned below the four wheels 113. In the second state, the four wheels 113 are positioned below the four lifting wheels 133. Controller 120 is one example of the control device.

For example, actuator 140, under control by controller 120, lowers the four lifting wheels 133 and raises the four wheels 113, positioning them vertically below the four wheels 113. Stated differently, the bottom ends of the four lifting wheels 133 are positioned vertically below the bottom ends of the four wheels 113. When actuator 140 lowers the four lifting wheels 133, it also lowers the axle coupled to the four lifting wheels 133. In unmanned transport vehicle 110c, in the first state, an actuation mechanism including a plurality of gears, shafts, etc., connected to the axle is actuated such that the four lifting wheels 133 rotate and the four wheels 113 do not rotate. In unmanned transport vehicle 110c, in the second state, an actuation mechanism including a plurality of gears, shafts, etc., connected to the axle is actuated such that the four wheels 113 rotate and the four lifting wheels 133 do not rotate.

As illustrated in (a) and (b) in FIG. 66A, elevator carriage 210 is suspended by carriage wire 202 within elevator path 201 that extends in the vertical direction. Elevator carriage 210 rises when carriage wire 202 is reeled in by the elevator winch, and elevator carriage 210 descends when carriage wire 202 is reeled out from the elevator winch. In this manner, elevator carriage 210 moves up and down.

Elevator carriage 210 includes rail lifting device 33 and rail extension-contraction device 34.

For example, depending on the building, the story height of each story may differ. In such cases, it is considered that a mechanism for adjusting the height of elevator rail 32 is necessary each time elevator carriage 210 arrives at each story.

Therefore, rail lifting device 33 aligns the height of elevator rail 32 with the height of story rail 31. Stated differently, rail lifting device 33 raises and lowers elevator rail 32.

For example, the first story height of a first predetermined story of the building is different from the second story height of a second predetermined story of the building. In FIG. 66A, (a) illustrates a case with the first story height, which is high, and in (b) illustrates a case with the second story height, which is lower than in (a).

In such cases, elevator rail 32 is controlled by controller 501 controlling motor 203, and as illustrated in (a) in FIG. 66A, is in a first first rail state in the first predetermined story of the building, and as illustrated in (b) in FIG. 66A, is in a second first rail state in the second predetermined story of the building.

With this, even if the story heights of stories of the building vary, rail lifting device 33 can appropriately align the height of elevator rail 32 with the height of story rail 31. Since elevator rail 32 and story rail 31 are aligned linearly, unmanned transport vehicle 110c can travel.

Rail extension-contraction device 34 is a device that includes an actuator for extending and contracting elevator rail 32 by moving the above-mentioned movable rail 32a included in elevator rail 32 in the horizontal direction so as to connect with second story rail 31b.

Movable rail 32a is switched between a first rail state and a second rail state by actuation of rail extension-contraction device 34 controlled by controller 501.

In the first rail state, first end 32k of movable rail 32a is connected to second end 31k of story rail 31 provided on a predetermined story of the building. As a result, unmanned transport vehicle 110c in second elevator space 212 can travel along elevator rail 32 and story rail 31 to move from second elevator space 212 to third story space 13. Conversely, unmanned transport vehicle 110c in third story space 13 can also travel along story rail 31 and elevator rail 32 to move from third story space 13 to second elevator space 212.

In the second rail state, first end 32k is not connected to second end 31k. Stated differently, elevator rail 32 and story rail 31 are not coupled. Therefore, in this case, movement of unmanned transport vehicle 110c between third story space 13 and second elevator space 212 is prohibited.

Here, among the plurality of elevator rails 32 of elevator carriage 210, elevator rails 32 for boarding and for alighting and elevator rail 32 for connection form a diamond crossing. Therefore, after unmanned transport vehicle 110c boards elevator carriage 210, when elevator carriage 210 is moving up or down, unmanned transport vehicle 110c moves from elevator rail 32 for boarding to elevator rail 32 for alighting via elevator rail 32 for connection.

In such unmanned transport vehicle 110c, when four wheels 113 are placed on second story rail 31b, actuator 140 drives the four wheels 113 to move from second story rail 31b to elevator rail 32 for boarding. Unmanned transport vehicle 110c moves to a portion where elevator rail 32 for boarding and elevator rail 32 for connection form a diamond crossing.

At a portion where elevator rail 32 for boarding and elevator rail 32 for connection form a diamond crossing, when the four wheels 113 and the four lifting wheels 133 are in the second state, the four wheels 113 are in contact with elevator rail 32 for boarding, and the four lifting wheels 133 are positioned on elevator rail 32 for connection, controller 120 changes the four wheels 113 and the four lifting wheels 133 to the first state. This causes the four lifting wheels 133 to be brought into contact with elevator rail 32 for connection.

When elevator carriage 210 starts moving up or down, unmanned transport vehicle 110c starts moving on elevator rail 32.

More specifically, actuator 140, under control by controller 120, places the four lifting wheels 133 on elevator rail 32 for connection as described above, and causes the four wheels 113 to separate from (be separated from) elevator rail 32 for boarding (first state). Actuator 140, under control by controller 120, rotationally drives the four lifting wheels 133. Unmanned transport vehicle 110c travels on elevator rail 32 for connection and moves to elevator rail 32 for alighting. Unmanned transport vehicle 110c moves to a portion where elevator rail 32 for alighting and elevator rail 32 for connection form a diamond crossing.

Here, at a portion where elevator rail 32 for alighting and elevator rail 32 for connection form a diamond crossing, when the four wheels 113 and the four lifting wheels 133 are in the first state, the four lifting wheels 133 are in contact with elevator rail 32 for connection, and the four wheels 113 are positioned on elevator rail 32 for alighting, controller 120 changes the four wheels 113 and the four lifting wheels 133 to the second state. This causes the four wheels 113 to be brought into contact with elevator rail 32 for alighting.

Stated differently, actuator 140, under control by controller 120, causes the four lifting wheels 133 to separate from elevator rail 32 for connection as described above, and places the four wheels 113 on elevator rail 32 for alighting (second state). Actuator 140, under control by controller 120, rotationally drives the four wheels 113. This causes unmanned transport vehicle 110c to move to a location near second carriage door 232 of second elevator space 212 on elevator rail 32 for alighting.

Note that the direction in which unmanned transport vehicle 110c travels on elevator rail 32 for connection intersects the direction in which it travels on elevator rail 32 for boarding and the direction in which it travels on elevator rail 32 for alighting.

In this way, unmanned transport vehicle 110c travels on a plurality of elevator rails 32 and moves to near second carriage door 232 of second elevator space 212 on elevator rail 32 for alighting while elevator carriage 210 is moving up or down. Therefore, when elevator carriage 210 stops in a predetermined story area, unmanned transport vehicle 110c can smoothly alight from elevator carriage 210.

FIG. 66B illustrates an example of another elevator carriage 210 according to the present embodiment. In (a) in FIG. 66B, a state in which second carriage door 232 of elevator carriage 210 having upper and lower two-tier (upper tier, lower tier) elevator rails 32 configured to be movable up and down is open, and the upper tier elevator rails 32 and second story rails 31b are connected is illustrated. In (b) in FIG. 66B, a state in which elevator rails 32 have risen, second carriage door 232 of elevator carriage 210 having upper and lower two-tier elevator rails 32 configured to be movable up and down is open, and the lower tier elevator rails 32 and second story rails 31b are connected is illustrated. Note that even when reference signs are not provided in this figure, the description will use the same reference signs as those described above.

As illustrated in (a) and (b) in FIG. 66B, elevator carriage 210 includes a plurality of tiers of elevator rails 32 arranged in second elevator space 212. In (a) and (b) in FIG. 66B, upper and lower two-tier elevator rails 32 are illustrated as examples.

Rail lifting device 33 raises and lowers at least one tier of the plurality of tiers of elevator rails 32 arranged in second elevator space 212. Stated differently, rail lifting device 33 is configured to change the distance between elevator rail 32 and the ceiling of second elevator space 212 according to the story height of each story of the building.

In the present embodiment, rail lifting device 33 raises and lowers the upper and lower two-tier elevator rails 32 simultaneously or individually. The upper and lower two-tier elevator rails 32 include an upper tier elevator rail 32 and a lower tier elevator rail 32 located below the upper tier elevator rail 32. Note that to avoid contact with unmanned transport vehicle 110c, the upper tier elevator rail 32 and the lower tier elevator rail 32 do not need to be raised and lowered independently and separately.

Rail lifting device 33 aligns the height of the upper tier elevator rail 32 or the lower tier elevator rail 32 with the height of story rail 31 by raising and lowering the upper and lower two-tier elevator rails 32. The upper tier elevator rail 32 is an example of the second tier of the plurality of tiers. The lower tier elevator rail 32 is an example of the first tier of the plurality of tiers.

In elevator carriage 210, while elevator carriage 210 is moving, at least one tier of elevator rails 32 among the plurality of tiers of elevator rails 32 is raised and lowered by rail lifting device 33. Stated differently, controller 501 controls rail lifting device 33 while elevator carriage 210 is being raised and lowered. More specifically, controller 501 obtains, from a storage in which the height of second story rail 31b in each story area is stored, information indicating the height of second story rail 31b in the story area where elevator carriage 210 is scheduled to stop. Controller 501 controls rail lifting device 33 based on the information indicating the height of second story rail 31b in the story area where elevator carriage 210 is scheduled to stop. Accordingly, rail lifting device 33 raises or lowers elevator rail 32 while elevator carriage 210 is moving up or down to adjust the height of elevator rail 32 so as to match the height of second story rail 31b in the story area where elevator carriage 210 is scheduled to stop.

In (a) in FIG. 66B, a case in which rail lifting device 33 appropriately aligns the height of the upper tier elevator rail 32 with story rail 31 is illustrated. In (b) in FIG. 66B, a case in which rail lifting device 33 appropriately aligns the height of the lower tier elevator rail 32 with story rail 31 is illustrated.

For example, as illustrated in (a) in FIG. 66B, the upper tier elevator rail 32 is in a first first rail state in the first predetermined story of the building, and as illustrated in (b) in FIG. 66B, is in a second first rail state in the second predetermined story of the building.

In this way, since a plurality of unmanned transport vehicles 110c can board the upper tier elevator rail 32 and the lower tier elevator rail 32, office building delivery system Sy1 can improve the transport efficiency of unmanned transport vehicles 110c with respect to elevator carriage 210. As a result, in office building delivery system Sy1, the transport efficiency of packages transported by unmanned transport vehicle 110c can be improved.

FIG. 66C illustrates an example of yet another elevator carriage 210 according to the present embodiment. In (a) in FIG. 66C, a state in which second carriage door 232 of elevator carriage 210 having three vertical tiers (lower tier, middle tier, upper tier) of elevator rails 32 configured to be movable up and down is open, and the middle tier elevator rails 32 and second story rails 31b are connected is illustrated. In (b) in FIG. 66C, a state in which elevator rails 32 have risen, second carriage door 232 of elevator carriage 210 having three vertical tiers of elevator rails 32 configured to be movable up and down is open, and the uppermost tier elevator rails 32 and second story rails 31b are connected is illustrated. In (c) in FIG. 66C, a state in which elevator rails 32 have risen, second carriage door 232 of elevator carriage 210 having three vertical tiers of elevator rails 32 configured to be movable up and down is open, and the middle tier elevator rails 32 and second story rails 31b are connected is illustrated. Note that even when reference signs are not provided in this figure, the description will use the same reference signs as those described above.

As illustrated in (a), (b), and (c) in FIG. 66C, elevator carriage 210 includes a plurality of tiers of elevator rails 32 arranged in second elevator space 212. In (a), (b), and (c) in FIG. 66C, three vertical tiers of elevator rails 32 are illustrated as examples.

Except that FIG. 66C is elevator carriage 210 having three vertical tiers of elevator rails 32, the configuration is the same as elevator carriage 210 in FIG. 66B.

FIG. 66D illustrates an example of another elevator carriage 210 according to the present embodiment. In (a) in FIG. 66D, a state in which second carriage door 232 of elevator carriage 210 having upper and lower two-tier elevator rails 32 configured to be movable up and down is open, and elevator rails 32 and second story rails 31b are connected is illustrated as viewed from above. In elevator carriage 210 in FIG. 66D, the upper and lower two-tier elevator rails 32 configured to be movable up and down (lifting portion 32u) and elevator rails 32 fixed to second elevator space 212 so that unmanned transport vehicle 110c can wait (fixed portion 32f) are separated. In (b) in FIG. 66D, a state in which second carriage door 232 of elevator carriage 210 having upper and lower two-tier elevator rails 32 configured to be movable up and down is open, and the upper tier elevator rails 32 and second story rails 31b are connected is illustrated. In (c) in FIG. 66D, a state in which lifting portion 32u has risen, second carriage door 232 of elevator carriage 210 having upper and lower two-tier elevator rails 32 configured to be movable up and down is open, and the lower tier elevator rails 32 and second story rails 31b are connected is illustrated. Note that even when reference signs are not provided in this figure, the description will use the same reference signs as those described above.

The plurality of tiers of elevator rails 32 include, at each tier of the plurality of tiers, at least one elevator rail 32 for boarding and elevator rail 32 for alighting that extend in the first direction, and at least one elevator rail 32 for connection that extends in a second direction intersecting the first direction.

When the plurality of tiers of elevator rails 32 (plurality of tiers) are viewed along the vertical direction, the plurality of tiers of elevator rails 32 are divided into a predetermined area and an area other than the predetermined area. The plurality of tiers of elevator rails 32 include a plurality of tiers of lifting portions 32u that are movable up and down in the vertical direction in second elevator space 212, and a plurality of tiers of fixed portions 32f that are fixed to elevator carriage 210 in second elevator space 212.

In elevator carriage 210 in FIG. 66D, the upper and lower two-tier elevator rails 32 (lifting portion 32u) and the three vertical tiers of elevator rails 32 (fixed portion 32f) are arranged in second elevator space 212.

Fixed portion 32f is a plurality of tiers of elevator rails 32 that correspond to the predetermined area, and is fixed to elevator carriage 210.

Lifting portion 32u is a plurality of tiers of elevator rails 32 that correspond to an area other than the predetermined area, and moves in the up and down directions inside second elevator space 212.

Elevator carriage 210 includes rail lifting device 33. Rail lifting device 33 is configured to change the positional relationship in the up-down direction between the plurality of tiers of elevator rails 32 that correspond to the predetermined area and the plurality of tiers of elevator rails 32 that correspond to an area other than the predetermined area. Stated differently, rail lifting device 33 includes an actuator that moves lifting portion 32u in the up and down directions relative to fixed portion 32f.

Elevator carriage 210 further includes controller 501 (control device) that controls rail lifting device 33. The plurality of tiers of elevator rails 32 include an upper tier elevator rail 32 (first elevator rail) and a lower tier elevator rail 32 (second elevator rail) located below the upper tier elevator rail 32.

When the height of fixed portion 32f and the height of the upper tier elevator rail 32 that corresponds to lifting portion 32u match, controller 501 controls rail lifting device 33 to change the positional relationship in the up-down direction between the plurality of tiers of elevator rails 32 that correspond to fixed portion 32f and the plurality of tiers of elevator rails 32 that correspond to lifting portion 32u, so as to align the height of the upper tier elevator rail 32 that corresponds to fixed portion 32f and the height of second elevator rail 32 that corresponds to lifting portion 32u. With this, unmanned transport vehicle 110c can move between lifting portion 32u and fixed portion 32f.

The positional relationship in the up-down direction between the plurality of tiers of elevator rails 32 that correspond to fixed portion 32f and the plurality of tiers of elevator rails 32 that correspond to lifting portion 32u is changed at a timing after unmanned transport vehicle 110c has boarded fixed portion 32f. Stated differently, controller 501 raises and lowers lifting portion 32u after unmanned transport vehicle 110c boards fixed portion 32f. With this, unmanned transport vehicle 110c that has boarded fixed portion 32f can move to lifting portion 32u after lifting portion 32u has moved. For example, unmanned transport vehicle 110c that has boarded fixed portion 32f of the middle tier can move to the upper-tier lifting portion 32u after descending. Unmanned transport vehicle 110c that has boarded fixed portion 32f of the middle tier can move to lower-tier lifting portion 32u after ascending.

As one example, a case will be described in which unmanned transport vehicle 110c that is on lifting portion 32u of the upper tier is moved to lifting portion 32u of the lower tier, and then moved from lifting portion 32u of the lower tier to second story rail 31b.

As illustrated in (a) and (b) in FIG. 66D, controller 501 outputs a control instruction to unmanned transport vehicle 110c positioned at lifting portion 32u of the upper tier, whereby unmanned transport vehicle 110c moves from lifting portion 32u of the upper tier to fixed portion 32f of the middle tier based on the control instruction. Here, controller 501 keeps track of all positions of the one or more unmanned transport vehicles 110c that are on each of the plurality of tiers of elevator rails 32. For example, controller 501 may obtain position information from unmanned transport vehicle 110c, or may keep track using sensors or the like provided on unmanned transport vehicle 110c or elevator carriage 210.

As illustrated in (c) in FIG. 66D, controller 501 outputs a control instruction to cause unmanned transport vehicle 110c to wait at fixed portion 32f of the middle tier, and controls rail lifting device 33 to raise the upper and lower two-tier lifting portions 32u. Here, controller 501 controls rail lifting device 33 to raise the plurality of lifting portions 32u so that the height of lifting portion 32u of the lower tier matches the height of second story rail 31b.

When the raising of the upper and lower two-tier lifting portions 32u is completed, controller 501 outputs a control instruction to move unmanned transport vehicle 110c waiting at fixed portion 32f of the middle tier to lifting portion 32u of the lower tier. After unmanned transport vehicle 110c moves from fixed portion 32f to lifting portion 32u, it can move to second story rail 31b.

The same applies to a case in which unmanned transport vehicle 110c that is on lifting portion 32u of the lower tier is moved to lifting portion 32u of the upper tier, and then moved from lifting portion 32u of the upper tier to second story rail 31b.

In this way, unmanned transport vehicle 110c can move to lifting portion 32u of the upper tier or move to lifting portion 32u of the lower tier by moving from lifting portion 32u to fixed portion 32f.

FIG. 66E illustrates an example of another elevator carriage 210 according to the present embodiment. In (a) in FIG. 66E, a state in which second carriage door 232 of elevator carriage 210 is open is illustrated. In (b) in FIG. 66E, a state in which second carriage door 232 of elevator carriage 210 is closed is illustrated. Note that even when reference signs are not provided in this figure, the description will use the same reference signs as those described above.

Elevator carriage 210 in FIG. 66E includes rail extension-contraction device 34.

Rail extension-contraction device 34, when controlled by controller 501, extends and contracts elevator rail 32 by moving the above-mentioned movable rail 32a included in elevator rail 32 in the horizontal direction so as to connect with second story rail 31b. Stated differently, movable rail 32a is switched between a first rail state and a second rail by state actuation of rail extension-contraction device 34 controlled by controller 501.

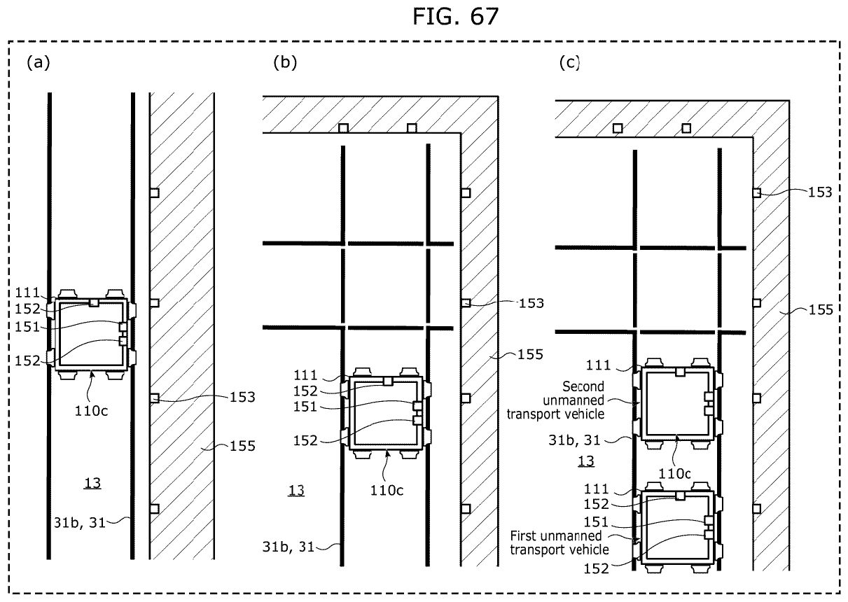

FIG. 67 illustrates an unmanned transport vehicle system. Note that even when reference signs are not provided in this figure, the description will use the same reference signs as those described above. In FIG. 67, (a) illustrates unmanned transport vehicle 110c traveling along second story rail 31b along wall surface 155. In FIG. 67, (b) illustrates unmanned transport vehicle 110c traveling along second story rail 31b that turns, so as to follow wall surface 155 with a corner. In FIG. 67, (c) illustrates two unmanned transport vehicles 110c traveling side by side.

Story rail 31 is arranged in third story space 13, but third story space 13 in which second story rail 31b is arranged does not have lighting devices attached, and third story space 13 is surrounded by the ceiling, second horizontal wall 22b, and other side walls, so the interior is dark. Therefore, unmanned transport vehicle 110c is in a situation where it has difficulty determining its location within the story area.

In view of this, as illustrated in (a) in FIG. 67, in the unmanned transport vehicle system that includes a control device and unmanned transport vehicle 110c, radio frequency identification (RFID) reader 151 and sensor 152 are used to identify the position of unmanned transport vehicle 110c. The control device may be equipped on unmanned transport vehicle 110c. In such cases, the control device may be controller 501. The control device may be equipped in a management server that manages the unmanned transport vehicle system.

More specifically, unmanned transport vehicle 110c includes RFID reader 151 and sensor 152. A plurality of RFID tags 153 are provided at predetermined intervals on the ceiling and wall surface 155 of third story space 13 that is arranged along second story rail 31b.

Accordingly, RFID reader 151 can obtain RFID information from the plurality of RFID tags 153 when unmanned transport vehicle 110c travels along second story rail 31b. The RFID information includes information indicating the position where RFID tag 153 is arranged, or the position where unmanned transport vehicle 110c is estimated to be present. Note that the control device may estimate the position of unmanned transport vehicle 110c, that is, the distance from the ceiling and wall surface 155, based on the RFID information obtained by RFID reader 151.

Sensor 152 includes any one of an ultrasonic sensor, an optical sensor, or a laser sensor. Sensor 152 is preferably arranged on at least two directional surfaces of enclosure 111 of unmanned transport vehicle 110c (at least two surfaces of the six surfaces of rectangular parallelepiped-shaped enclosure 111). Sensor 152 can sense the distance from sensor 152 to obstacles such as the ceiling of third story space 13, second horizontal wall 22b, and other side walls.

The control device identifies the position of a predetermined unmanned transport vehicle 110c based on information indicating the RFID signal from RFID tag 153 obtained by RFID reader 151 of the predetermined unmanned transport vehicle 110c, and information indicating the sensing result by sensor 152 of the predetermined unmanned transport vehicle 110c.

With this, as illustrated in (b) in FIG. 67, at the turn portion of second story rail 31b, the control device can identify the position of unmanned transport vehicle 110c, that is, the distance from the ceiling and wall surface 155, and therefore can control unmanned transport vehicle 110c to decelerate. Therefore, unmanned transport vehicle 110c can travel without derailing from second story rail 31b.

As illustrated in (c) in FIG. 67, a plurality of unmanned transport vehicles 110c may travel on second story rail 31b. For example, the plurality of unmanned transport vehicles 110c include a first unmanned transport vehicle and a second unmanned transport vehicle.

When a second unmanned transport vehicle is present ahead of the first unmanned transport vehicle traveling on the second story rail, the sensor would sense the distance to the unmanned transport vehicle ahead, and it is considered that the control device would not be able to accurately grasp the position of the first unmanned transport vehicle.

Therefore, the control device identifies the position of the first unmanned transport vehicle and/or the second unmanned transport vehicle based on (i) information indicating the RFID signal from RFID tag 153 obtained by RFID reader 151 of the first unmanned transport vehicle and/or information indicating the RFID signal from RFID tag 153 obtained by RFID reader 151 of the second unmanned transport vehicle, (ii) information indicating the sensing result by sensor 152 of the first unmanned transport vehicle, and (iii) information indicating the sensing result by sensor 152 of the second unmanned transport vehicle. Here, the control device identifies the position of the first unmanned transport vehicle and/or the second unmanned transport vehicle based on (i) to (iii) while taking into account the overall length of the second unmanned transport vehicle.

For example, the control device can identify the distance from wall surface 155 located ahead of the first unmanned transport vehicle and the second unmanned transport vehicle to the second unmanned transport vehicle based on the sensing result from sensor 152 positioned ahead of the first unmanned transport vehicle, the sensing result from sensor 152 positioned ahead of the second unmanned transport vehicle, and the overall length of the first unmanned transport vehicle.

The control device can also identify the distance between the first unmanned transport vehicle and the second unmanned transport vehicle traveling on second story rail 31b. Therefore, the control device can also control the travel of the first unmanned transport vehicle and the second unmanned transport vehicle so that the first unmanned transport vehicle and the second unmanned transport vehicle do not collide.

With this, the control device can also keep track of all positions of the one or more unmanned transport vehicles 110c present on elevator rail 32 of elevator carriage 210. Therefore, the control device can optimize the rearrangement of the one or more unmanned transport vehicles 110c present on elevator rail 32.

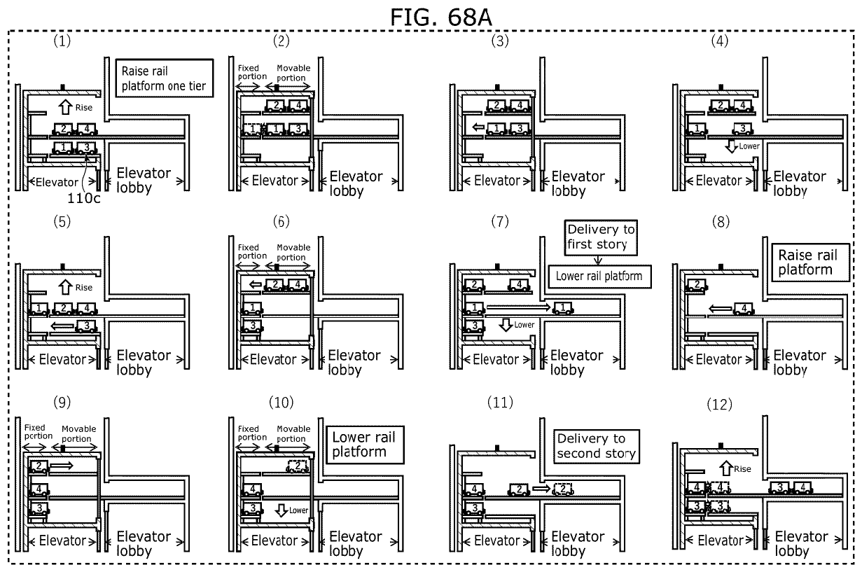

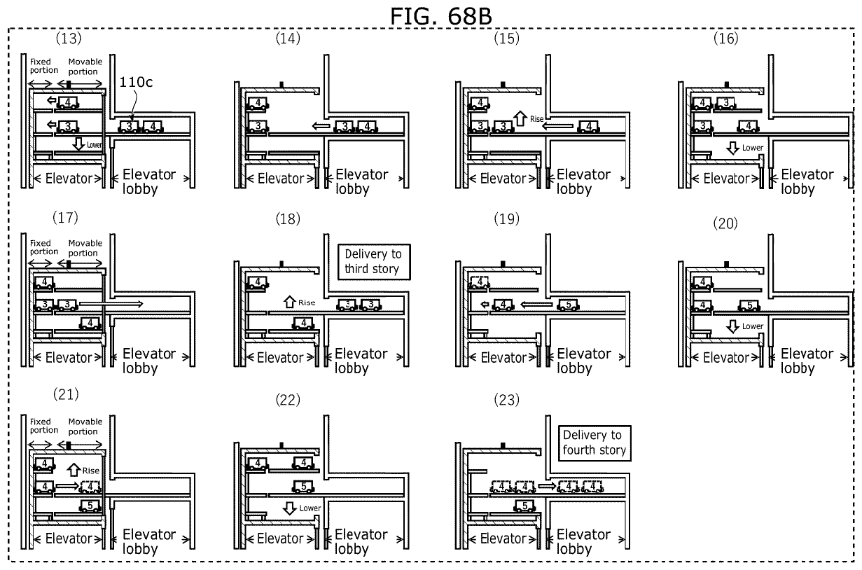

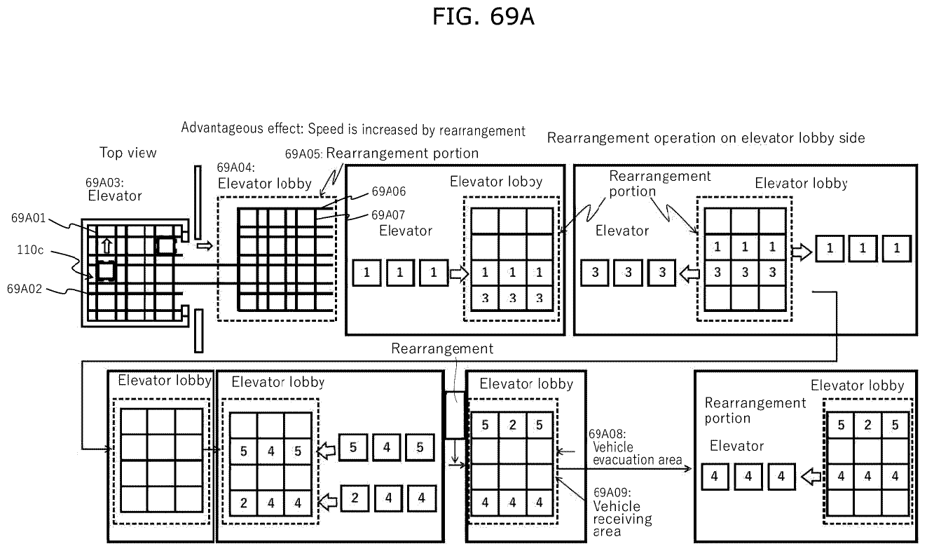

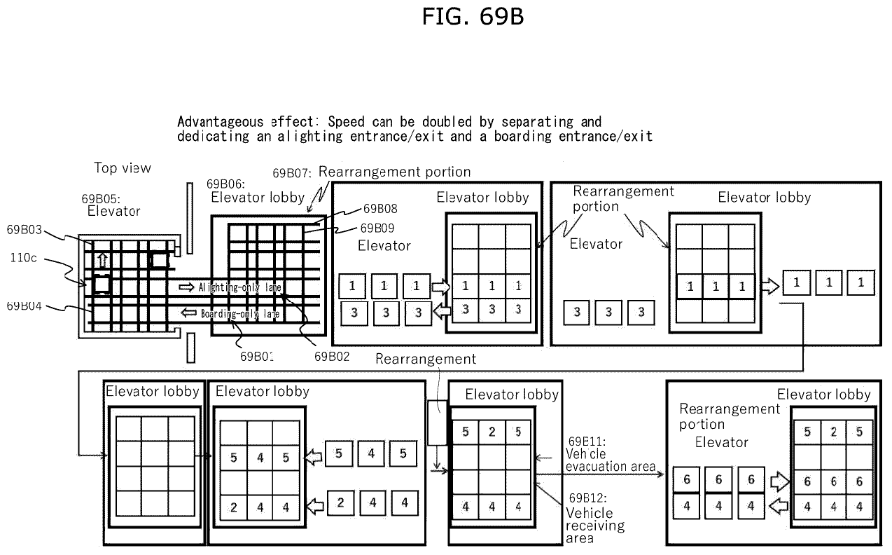

FIG. 68A and FIG. 68B illustrate an example of unmanned transport vehicles boarded in an elevator carriage that moves up and down. FIG. 69A illustrates an example of unmanned transport vehicles boarded in an elevator carriage being rearranged. FIG. 69B illustrates another example of unmanned transport vehicles being rearranged in an elevator carriage.

In FIG. 68A through FIG. 69B, when the unmanned transport vehicles board the elevator carriage and the elevator carriage starts moving, the unmanned transport vehicles rearrange themselves near second carriage door of second elevator space on elevator rail for alighting so that they can smoothly alight from second elevator space.

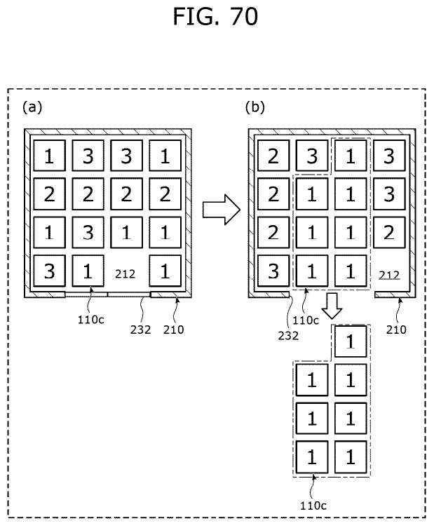

FIG. 70 illustrates an elevator system. Note that even when reference signs are not provided in this figure, the description will use the same reference signs as those described above.

In FIG. 70, (a) and (b) illustrate unmanned transport vehicles 110c indicated by numbered square frames. Numbers 1 to 3 indicate the order in which unmanned transport vehicles 110c alight for each story where elevator carriage 210 stops. In FIG. 70, unmanned transport vehicles 110c with the same number alight on the same story of the building.

In FIG. 70, (a) illustrates a case in which unmanned transport vehicles 110c numbered 1 to 3 are randomly arranged. In FIG. 70, (b) illustrates a case in which unmanned transport vehicles 110c numbered 1 to 3 are rearranged, and unmanned transport vehicle 110c numbered 1 is rearranged (repositioned) near second carriage door 232 of second elevator space 212 shown in (f) in FIG. 70.

The story on which each of the plurality of unmanned transport vehicles 110c aboard elevator carriage 210 alights from elevator carriage 210 may differ. In an elevator system that includes elevator carriage 210 and controller 501, controller 501 controls the plurality of unmanned transport vehicles 110c positioned within second elevator space 212 (outputs control instructions) to rearrange the plurality of unmanned transport vehicles 110c so that the plurality of unmanned transport vehicles 110c achieve a target arrangement. The target arrangement is an arrangement in which a plurality of predetermined unmanned transport vehicles 110c are positioned at locations where they can easily move to the outside of elevator carriage 210 of the elevator through the opening formed in elevator carriage 210 that leads to second elevator space 212 (the opening in which second carriage door 232 is arranged). The target arrangement may be an arrangement in which a plurality of predetermined unmanned transport vehicles 110c are positioned on a predetermined tier and at locations where they can easily move to the outside of elevator carriage 210 of the elevator through the opening formed in elevator carriage 210 that leads to second elevator space 212 (the opening in which second carriage door 232 is arranged).

Stated differently, controller 501 can rearrange the arrangement of the plurality of unmanned transport vehicles 110c aboard elevator carriage 210 while elevator carriage 210 is moving up or down so that unmanned transport vehicles 110c can smoothly alight. A location where movement is easy is, for example, a location near the opening of elevator carriage 210 where second carriage door 232 is arranged (second carriage door 232), and is a location that extends in a perpendicular direction from the opening surface of the opening in elevator carriage 210 toward the interior of second elevator space 212 (the direction of movement when unmanned transport vehicle 110c boards elevator carriage 210).

As illustrated in (a) in FIG. 70, unmanned transport vehicles 110c numbered 1, which alight first from elevator carriage 210, are randomly arranged in elevator carriage 210.

When unmanned transport vehicles 110c start moving up or down, controller 501 rearranges the arrangement of the plurality of unmanned transport vehicles 110c so that unmanned transport vehicles 110c numbered 1 can smoothly alight from second elevator space 212. For example, controller 501 controls unmanned transport vehicles 110c numbered 1 to 3 so that unmanned transport vehicles 110c numbered 1 are rearranged near second carriage door 232 of second elevator space 212.

As illustrated in (b) in FIG. 70, controller 501 controls unmanned transport vehicles 110c numbered 1 to 3 so that unmanned transport vehicles 110c numbered 1 are arranged starting from second carriage door 232 of second elevator space 212. Stated differently, controller 501 aligns unmanned transport vehicles 110c numbered 1 in one or more rows from the opening surface of the opening in elevator carriage 210, as indicated by the double-dotted line, by the time elevator carriage 210 arrives at the story where it is scheduled to stop.

With this, when elevator carriage 210 arrives at the destination story and stops, unmanned transport vehicles 110c numbered 1 can smoothly alight from elevator carriage 210.

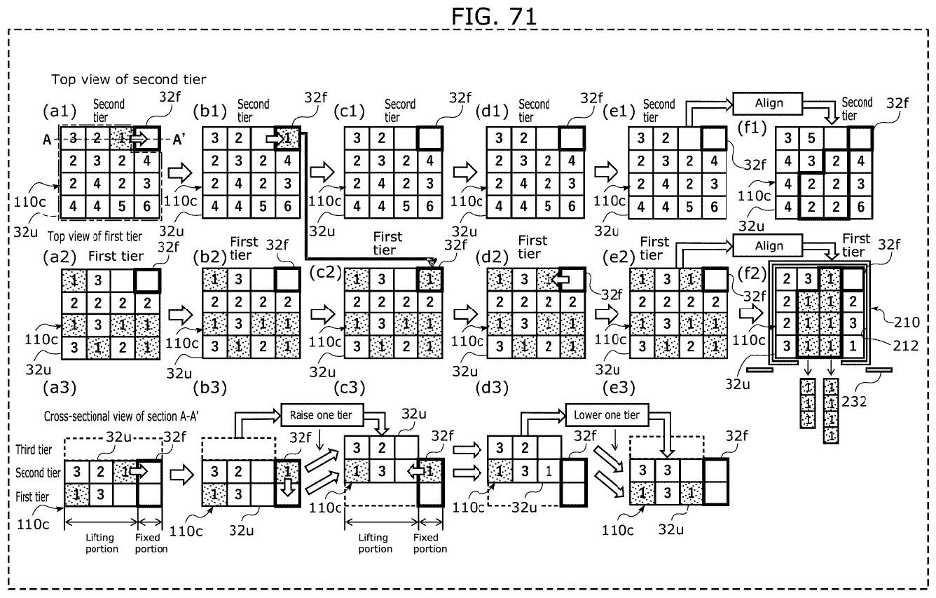

FIG. 71 illustrates an elevator system in which a plurality of unmanned transport vehicles 110c have boarded elevator carriage 210. Note that even when reference signs are not provided in this figure, the description will use the same reference signs as those described above.

In FIG. 71, a plurality of unmanned transport vehicles 110c in second elevator space 212 are illustrated as viewed from above. FIG. 71 illustrates unmanned transport vehicles 110c numbered 1, which alight first from elevator carriage 210, being rearranged.

As described above with reference to FIG. 66B and the like, elevator carriage 210 in FIG. 71 includes a plurality of tiers of elevator rails 32 arranged in second elevator space 212. In FIG. 71, upper and lower two-tier (first tier, second tier) elevator rails 32 are illustrated. Second elevator space 212 has a height that allows for arrangement of three vertical tiers of elevator rails 32.

The plurality of tiers of elevator rails 32 include a plurality of tiers of lifting portions 32u that are movable up and down in the vertical direction in second elevator space 212, and a plurality of tiers of fixed portions 32f that are fixed to elevator carriage 210 in second elevator space 212. In FIG. 71, thick solid rectangular frames are fixed portions 32f, and in (a1) in FIG. 71, portions other than fixed portions 32f indicated by double-dotted lines are lifting portions 32u.

In FIG. 71, upper and lower two-tier (lower tier first tier, upper tier second tier) elevator rails 32 are illustrated as an example, and fixed portion 32f has three vertical tiers of elevator rails 32 arranged in second elevator space 212. Lifting portion 32u has upper and lower two-tier elevator rails 32 arranged in second elevator space 212.

In FIG. 71, unmanned transport vehicles 110c numbered 1 to 6 are illustrated distributed and arranged on the upper and lower two-tier lifting portions 32u. In FIG. 71, when alighting unmanned transport vehicles 110c from elevator carriage 210, the height of the first tier elevator rail 32 is aligned with the height of story rail 31, and unmanned transport vehicles 110c move from the first tier elevator rail 32 to story rail 31. Since only one unmanned transport vehicle 110c numbered 1 indicated by dot hatching is in the second tier lifting portion 32u, the elevator system rearranges unmanned transport vehicle 110c numbered 1 to move to the first tier lifting portion 32u.

First, as illustrated in (a1) to (a3) in FIG. 71, no unmanned transport vehicle 110c is present on fixed portion 32f, and space is available for unmanned transport vehicles 110c to move.

Next, as illustrated in (a1) to (a3) and (b1) to (b3) in FIG. 71, unmanned transport vehicle 110c numbered 1 that is in the second tier lifting portion 32u moves to the second tier fixed portion 32f. For example, unmanned transport vehicle 110c obtains a movement instruction from controller 501 of the elevator system, and unmanned transport vehicle 110c moves to the second tier fixed portion 32f in order to move to the first tier lifting portion 32u.

Next, as illustrated in (b1) to (b3) and (c1) to (c3) in FIG. 71, controller 501 controls rail lifting device 33 to raise the upper and lower two-tier lifting portions 32u by one tier. This causes the upper and lower two-tier lifting portions 32u to rise in second elevator space 212 from the first tier and second tier to the second tier and third tier.

Next, as illustrated in (c1) to (c3) in FIG. 71, unmanned transport vehicle 110c numbered 1 that moved from the second tier lifting portion 32u reaches the same height as the first tier lifting portion 32u. In (c2) in FIG. 71, no unmanned transport vehicle 110c is present at a location adjacent to fixed portion 32f of the second tier (lifting portion 32u of the first tier), and space is available for unmanned transport vehicles 110c to move.

Next, as illustrated in (c1) to (c3) and (d1) to (d3) in FIG. 71, unmanned transport vehicle 110c numbered 1 that moved from the second tier lifting portion 32u moves to this space in the first tier lifting portion 32u. For example, unmanned transport vehicle 110c obtains a movement instruction from controller 501 of the elevator system, and unmanned transport vehicle 110c moves to an available space in the first tier lifting portion 32u.

Next, as illustrated in (d1) to (d3) and (e1) to (e3) in FIG. 71, controller 501 controls rail lifting device 33 to lower the upper and lower two-tier lifting portions 32u by one tier. This causes the upper and lower two-tier lifting portions 32u to descend in second elevator space 212 from the second tier and third tier to the first tier and second tier.

Next, as illustrated in (e1) to (e3), (f1), and (f2) in FIG. 71, controller 501 controls unmanned transport vehicles 110c numbered 1 to 3 so that unmanned transport vehicles 110c numbered 1 are arranged starting from second carriage door 232 of second elevator space 212. Stated differently, controller 501 aligns unmanned transport vehicles 110c numbered 1 along a direction perpendicular to the opening surface of the opening in elevator carriage 210 toward the interior of second elevator space 212 (the direction of movement when unmanned transport vehicle 110c boards elevator carriage 210), as indicated by the double-dotted line, by the time elevator carriage 210 arrives at the story where it is scheduled to stop. With this, when elevator carriage 210 arrives at the destination story and stops, unmanned transport vehicles 110c numbered 1 can smoothly alight from elevator carriage 210.

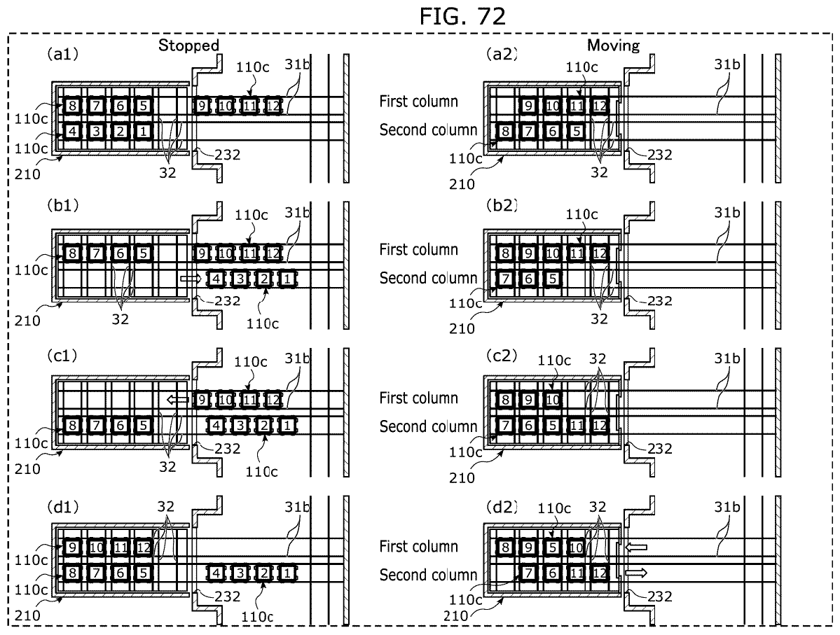

FIG. 72 illustrates an elevator system in which a plurality of unmanned transport vehicles 110c have boarded elevator carriage 210. Note that even when reference signs are not provided in this figure, the description will use the same reference signs as those described above.

In FIG. 72, a plurality of unmanned transport vehicles 110c in second elevator space 212 are illustrated as viewed from above. FIG. 72 illustrates eight unmanned transport vehicles 110c numbered 1 to 8 riding in elevator carriage 210, and four unmanned transport vehicles 110c numbered 9 to 12 waiting in the elevator lobby.

In FIG. 72, (a1) illustrates four unmanned transport vehicles 110c numbered 1 to 4 alighting from elevator carriage 210. In FIG. 72, (b1) illustrates four unmanned transport vehicles 110c numbered 5 to 8 moving from elevator rails 32 for boarding to elevator rails 32 for alighting. In FIG. 72, (c1) illustrates four unmanned transport vehicles 110c numbered 9 to 12 boarding elevator carriage 210. In FIGS. 72, (d1), (a2), (b2), (c2), and (d2) illustrate eight unmanned transport vehicles 110c numbered 5 to 12 rearranging in elevator carriage 210.

In second elevator space 212, there are two rows of portions where elevator rails 32 for boarding and for alighting and elevator rail 32 for connection form diamond crossings at five locations. Stated differently, elevator carriage 210 can accommodate a maximum of 10 unmanned transport vehicles 110c.

In an elevator system that includes elevator carriage 210 and controller 501, controller 501 controls the plurality of unmanned transport vehicles 110c positioned within second elevator space 212 (outputs control instructions) to rearrange the plurality of unmanned transport vehicles 110c so that the plurality of unmanned transport vehicles 110c achieve a target arrangement. The target arrangement is an arrangement in which a plurality of predetermined unmanned transport vehicles 110c form groups. The groups include a first group that includes unmanned transport vehicles 110c scheduled to board elevator carriage 210 of an elevator heading in a first direction, and a second group that includes unmanned transport vehicles 110c scheduled to board elevator carriage 210 of an elevator heading in a direction opposite to the first direction. The first direction indicates an upward direction or a downward direction.

The target arrangement may be an arrangement in which a plurality of predetermined unmanned transport vehicles 110c form groups. The groups may be positioned such that unmanned transport vehicles 110c scheduled to alight at a story farther from a predetermined story are positioned closer to the second carriage door 232 side (entrance side) positioned at the opening of elevator carriage 210 of the elevator. The groups may be positioned such that unmanned transport vehicles 110c scheduled to alight at a later timing are positioned closer to the second carriage door 232 side positioned at the opening of elevator carriage 210 of the elevator.

FIG. 72 assumes a case where a plurality of unmanned transport vehicles 110c board elevator carriage 210 when it stops, and the plurality of unmanned transport vehicles 110c rearrange while elevator carriage 210 is moving up or down.

First, as illustrated in (a1) and (b1) in FIG. 72, in the elevator system, when elevator carriage 210 stops at a story area and second carriage door 232 positioned at the opening of second elevator space 212 opens, four unmanned transport vehicles 110c numbered 1 to 4 obtain control instructions from controller 501, whereby controllers 120 control actuators 140 and unmanned transport vehicles 110c alight from elevator carriage 210. Stated differently, four unmanned transport vehicles 110c numbered 1 to 4 move from elevator rails 32 for alighting to second story rails 31b for alighting, and alight from elevator carriage 210.

Next, as illustrated in (b1) and (c1) in FIG. 72, in the elevator system, four unmanned transport vehicles 110c numbered 5 to 8 obtain control instructions from controller 501, whereby controller 120 controls actuator 140, and move from elevator rails 32 for boarding to elevator rails 32 for alighting via elevator rails 32 for connection.

Next, as illustrated in (c1) and (d1) in FIG. 72, four unmanned transport vehicles 110c numbered 9 to 12 obtain control instructions from controller 501, whereby controller 120 controls actuator 140, and board elevator carriage 210. Stated differently, four unmanned transport vehicles 110c numbered 9 to 12 move from elevator rails 32 for boarding to second story rails 31b for boarding, and board elevator carriage 210.

Thus, when the four unmanned transport vehicles 110c numbered 9 to 12 finish boarding elevator carriage 210, controller 501 controls an actuator to close second carriage door 232 positioned at the opening of second elevator space 212. Controller 501 then controls winch 204, whereby elevator carriage 210 moves up and down.

As illustrated in (a2), (b2), (c2), and (d2) in FIG. 72, in the elevator system, while elevator carriage 210 is moving up and down, unmanned transport vehicles 110c aboard elevator carriage 210 are rearranged.

In FIGS. 72, (a2), (b2), (c2), and (d2) assume a case where four unmanned transport vehicles 110c numbered 7, 6, 11, and 12 get off next.

First, as illustrated in (a2) in FIG. 72, on the first row of elevator rails 32 for boarding, four unmanned transport vehicles 110c numbered 9 to 12 are aboard in this order from the far side of second carriage door 232, and on the second row of elevator rails 32 for alighting, four unmanned transport vehicles 110c numbered 5 to 8 are aboard in this order from the second carriage door 232 side. Therefore, the two unmanned transport vehicles 110c numbered 11 and 12 must be moved to elevator rails 32 for alighting.

Accordingly, as illustrated in (a2) and (b2) in FIG. 72, controller 501 outputs a control instruction to unmanned transport vehicle 110c numbered 8 to move unmanned transport vehicle 110c numbered 8 to the available space (the portion forming a diamond crossing) on the first row of elevator rails 32 for boarding. This space is located on the far side farthest from second carriage door 232 on the first row of elevator rails 32 for boarding. This causes unmanned transport vehicle 110c numbered 8 to move to the first row of elevator rails 32 for boarding. This causes the five unmanned transport vehicles 110c numbered 8 to 12 to be arranged in this order from the far side of second carriage door 232 on the first row of elevator rails 32 for boarding.

Next, as illustrated in (b2) and (c2) in FIG. 72, controller 501 outputs a control instruction to unmanned transport vehicles 110c numbered 11 and 12 to move unmanned transport vehicles 110c numbered 11 and 12 to the two available spaces (the portions forming a diamond crossing) on the second row of elevator rails 32 for alighting. These spaces are located on the second carriage door 232 side on the second row of elevator rails 32 for alighting. This causes unmanned transport vehicles 110c numbered 11 and 12 to move to the second row of elevator rails 32 for alighting. This causes the five unmanned transport vehicles 110c numbered 7, 6, 5, 11, and 12 to be arranged in this order from the far side of second carriage door 232 on the first row of elevator rails 32 for boarding.

Next, as illustrated in (c2) and (d2) in FIG. 72, controller 501 outputs a control instruction to unmanned transport vehicle 110c numbered 10 to move unmanned transport vehicle 110c numbered 10 to the available space (the portion forming a diamond crossing) on the first row of elevator rails 32 for boarding. This space is located on the second carriage door 232 side on the first row of elevator rails 32 for boarding. This causes unmanned transport vehicle 110c numbered 5 to move to the position where unmanned transport vehicle 110c numbered 10 was present on the first row of elevator rails 32 for boarding. This causes the four unmanned transport vehicles 110c numbered 8, 9, 5, and 10 to be arranged in this order from the far side of second carriage door 232 on the first row of elevator rails 32 for boarding.

On the second row of elevator rails 32 for alighting, space has been created at the location where unmanned transport vehicle 110c numbered 5 was present. Accordingly, controller 501 moves unmanned transport vehicles 110c numbered 7 and 6 that are located on the second row of elevator rails 32 for alighting so as to fill the space at the location where unmanned transport vehicle 110c numbered 5 was present. This causes the four unmanned transport vehicles 110c numbered 7, 6, 11, and 12 to be arranged closely in this order from the far side of second carriage door 232.

Thus, in the elevator system, a plurality of predetermined unmanned transport vehicles 110c scheduled to get off next are grouped together, and the group is arranged (rearranged) on elevator rails 32 for alighting near second carriage door 232 of second elevator space 212. This rearrangement of the plurality of unmanned transport vehicles 110c is performed between when elevator carriage 210 arrives at a predetermined story and before the opening of second elevator space 212 of elevator carriage 210 opens. Unmanned transport vehicles 110c scheduled to alight at a story farther from a predetermined story or scheduled to alight at a later timing are positioned closer to the second carriage door 232 side of second elevator space 212 on elevator rails 32 for boarding.

For example, if the first group is scheduled to alight at a story farther from a predetermined story than the second group, the elevator system arranges the second group on elevator rails 32 for alighting near second carriage door 232 of second elevator space 212. However, if the second group is scheduled to alight at a story farther from a predetermined story than the first group, the elevator system arranges the first group on elevator rails 32 for alighting near second carriage door 232 of second elevator space 212.

This causes unmanned transport vehicles 110c to travel on a plurality of elevator rails 32 and line up near second carriage door 232 of second elevator space 212 while elevator carriage 210 is moving up or down. Therefore, in the elevator system, when elevator carriage 210 stops in a predetermined story area, unmanned transport vehicles 110c can smoothly alight from elevator carriage 210.

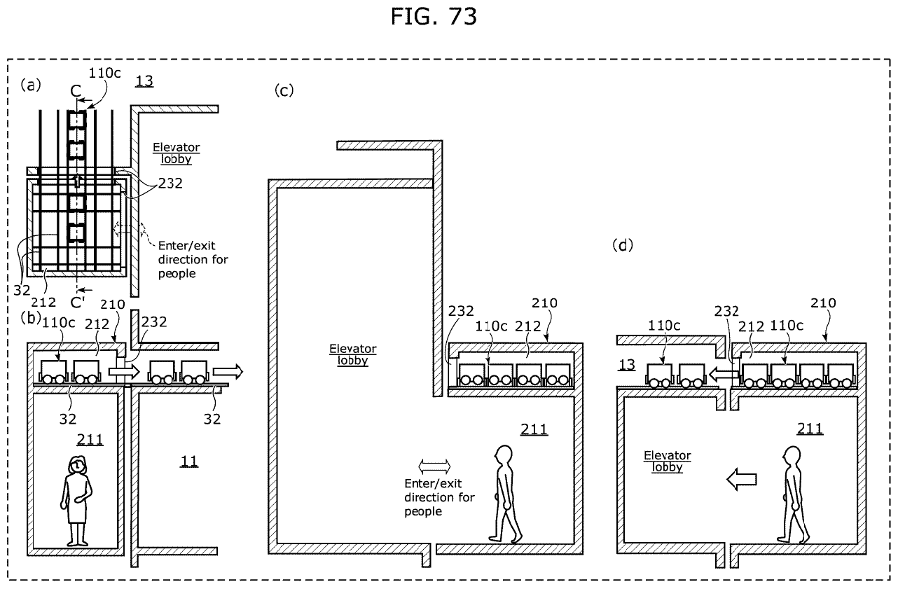

FIG. 73 illustrates an example of unmanned transport vehicles 110c that have alighted from elevator carriage 210 bypassing the elevator lobby. Note that even when reference signs are not provided in this figure, the description will use the same reference signs as those described above.

(a) in FIG. 73 illustrates elevator carriage 210 and the elevator lobby of the building viewed from above. (b) in FIG. 73 illustrates the building and elevator carriage 210 viewed along line CC′ in (a) in FIG. 73. (c) in FIG. 73 illustrates the building elevator lobby and elevator carriage 210 viewed from the side along line CC′. (d) in FIG. 73 illustrates a case in which third story space 13 is formed on the front side of second elevator space 212 in elevator carriage 210 (the side in the direction of people entering and exiting).

When the ceiling of the building elevator lobby is high and forms an atrium, since first story space 11 is tall, there may be cases where third story space 13 that can connect with second elevator space 212 cannot be arranged. Stated differently, there are cases in which third story space 13 is not formed on the front side of second elevator space 212 in elevator carriage 210. In such cases, unmanned transport vehicle 110c travels so as to avoid (so as to bypass) first story space 11.

More specifically, as illustrated in (a) to (c) in FIG. 73, elevator carriage 210 includes two openings formed in a portion corresponding to second elevator space 212. One of the two openings is formed on the front side of second elevator space 212. The other of the two openings is formed on the left side, right side, or rear side other than the front side of second elevator space 212. Second carriage door 232 is arranged at each of the two openings. Second carriage door 232 at each of the two openings is opened and closed by an actuator controlled by controller 501. Each of the two openings is oriented in different directions in second elevator space 212.

Note that elevator carriage 210 may include three or more openings formed in a portion corresponding to second elevator space 212.

When elevator carriage 210 stops in a story area where third story space 13 is not formed, controller 501 controls an actuator to open second carriage door 232 positioned at the other opening. Furthermore, controller 501 controls an actuator to also open second carriage door 232 provided at the opening of third story space 13.

Controller 501 controls actuator 503 to connect elevator rails 32 on the left side, right side, or rear side with second story rails 31b. Second story rails 31b are arranged so as to avoid (bypass) the elevator lobby. Stated differently, as illustrated in (a) to (c) in FIG. 73, unmanned transport vehicle 110c moves in a horizontal direction that is perpendicular to the direction in which people enter and exit.

Unmanned transport vehicle 110c obtains control instructions from controller 501, whereby controller 120 controls actuator 140, and can board or alight from elevator carriage 210.

In this way, by forming a plurality of openings in elevator carriage 210, even if second story rails 31b are not arranged on the front side of second elevator space 212, unmanned transport vehicle 110c can board and alight from elevator carriage 210 through another opening.

As illustrated in (d) in FIG. 73, when second story rails 31b are arranged on the front side of second elevator space 212, controller 501 controls actuator 503 to connect elevator rails 32 on the front side with second story rails 31b.

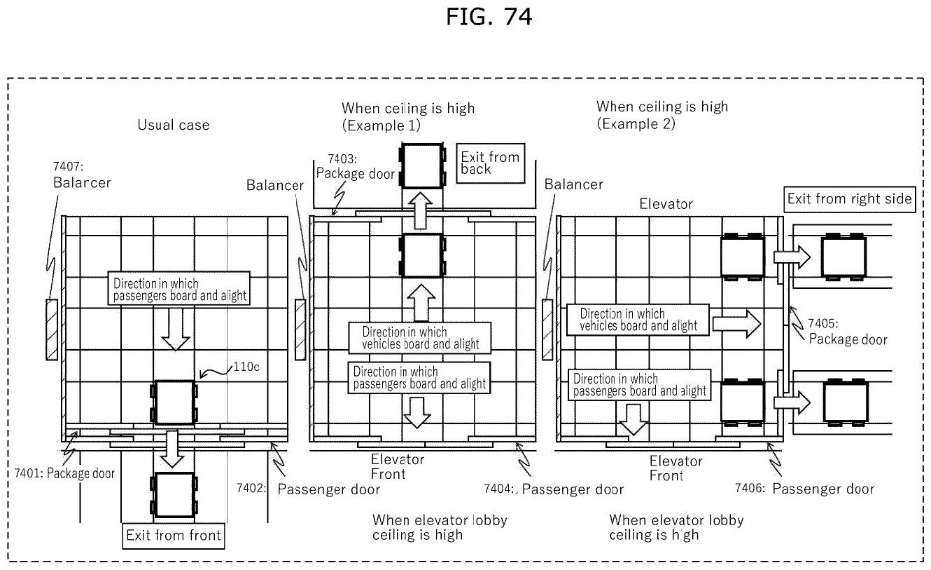

FIG. 74 illustrates an elevator carriage and an unmanned transport vehicle riding in the elevator carriage. In FIG. 74, second elevator space 212 and the unmanned transport vehicle are illustrated as viewed from above.

The elevator carriage includes a first opening leading to the second elevator space. The first opening is positioned on any one of the front side, lateral sides, or rear side of the elevator carriage in the elevator.

The elevator carriage includes a second opening leading to the second elevator space. The second opening is positioned on any one of the front side, lateral sides, or rear side of the elevator carriage in the elevator. The second opening is provided at a location that does not face the location where the counterweight (balancer) of the elevator carriage in the elevator is provided.

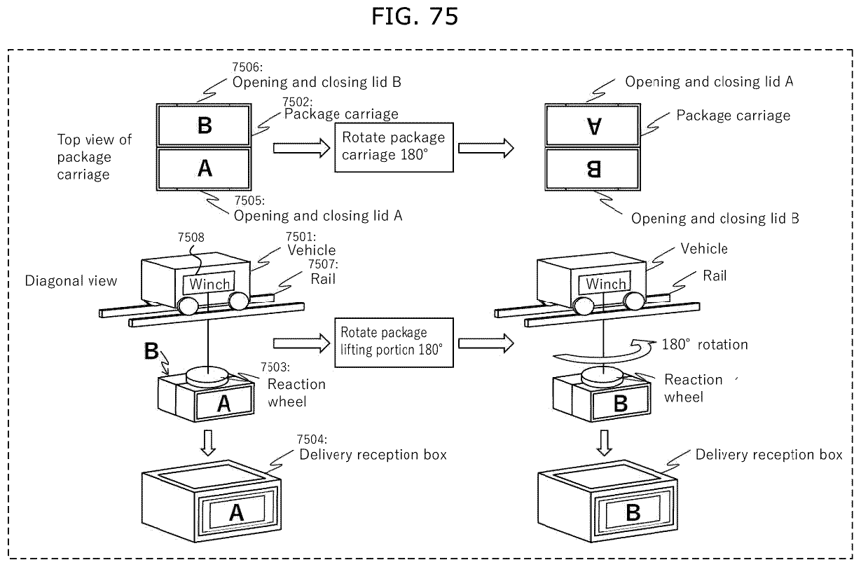

FIG. 75 illustrates a system for adjusting the attitude of a package carriage.

The package carriage is divided into a region for the first package and a region for the second package.

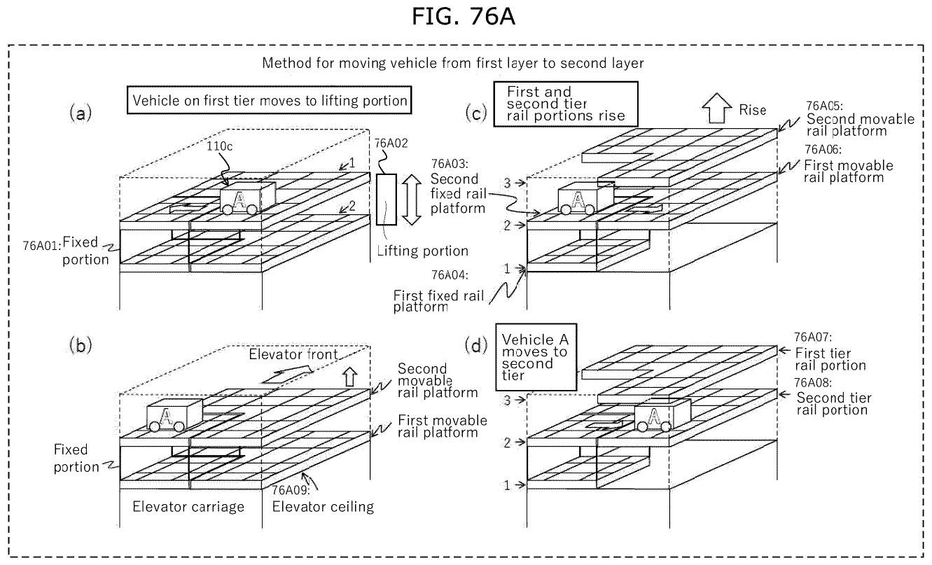

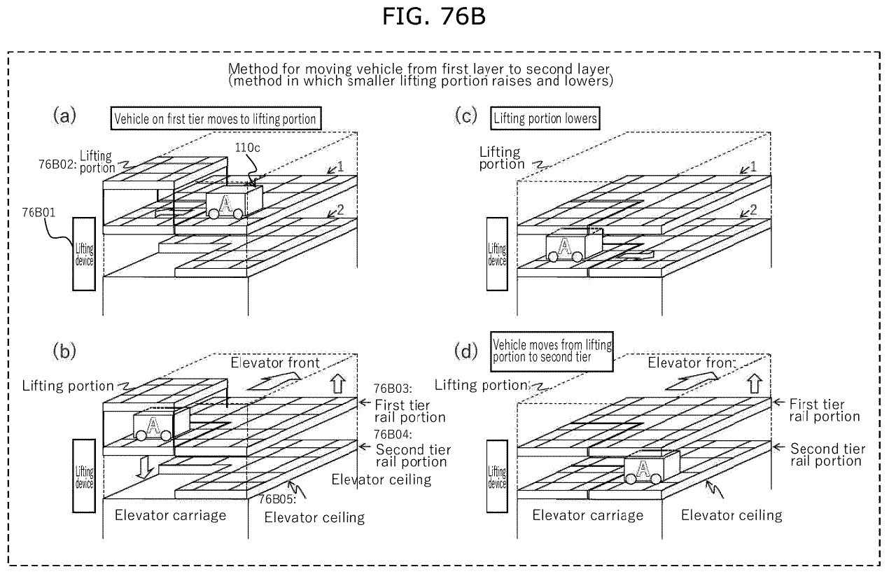

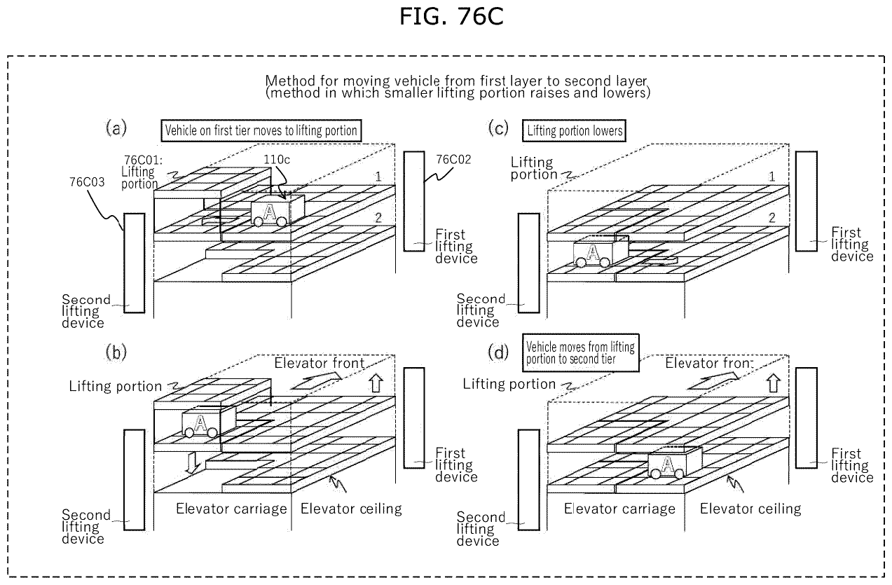

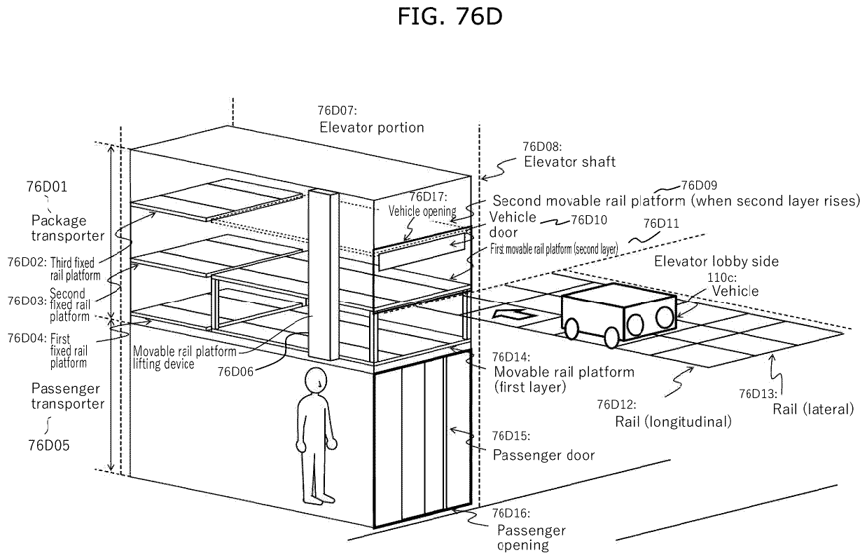

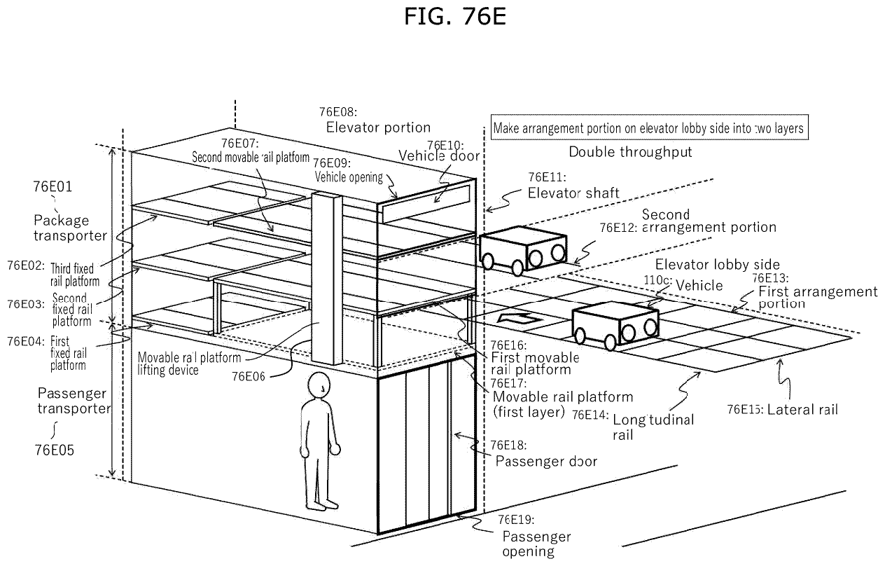

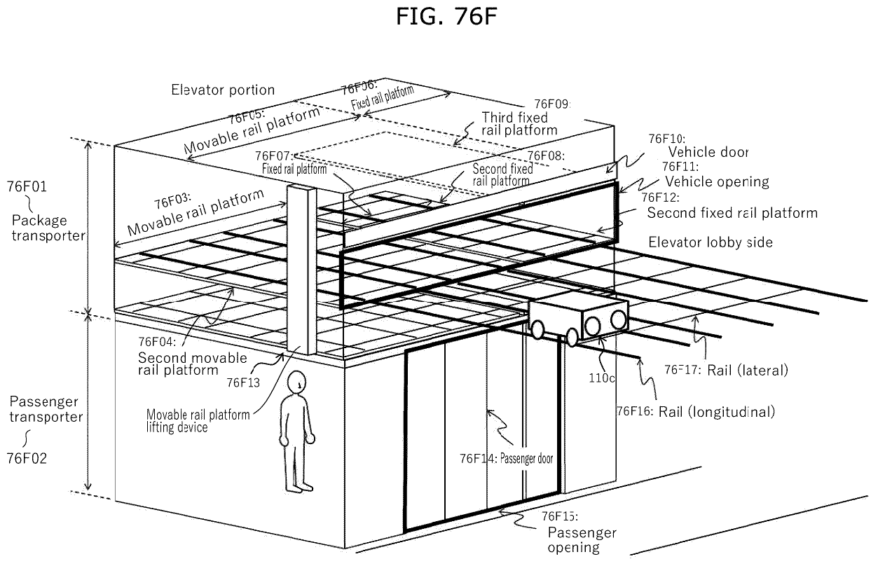

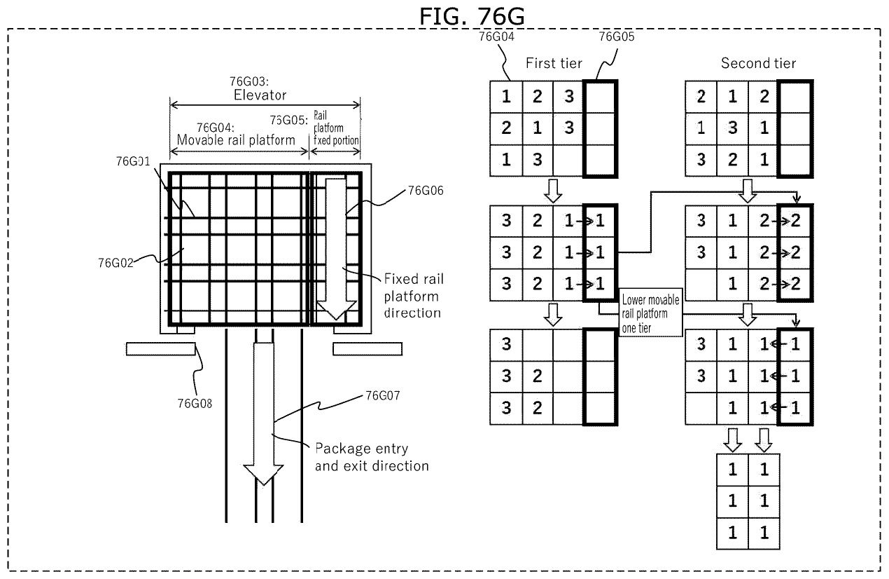

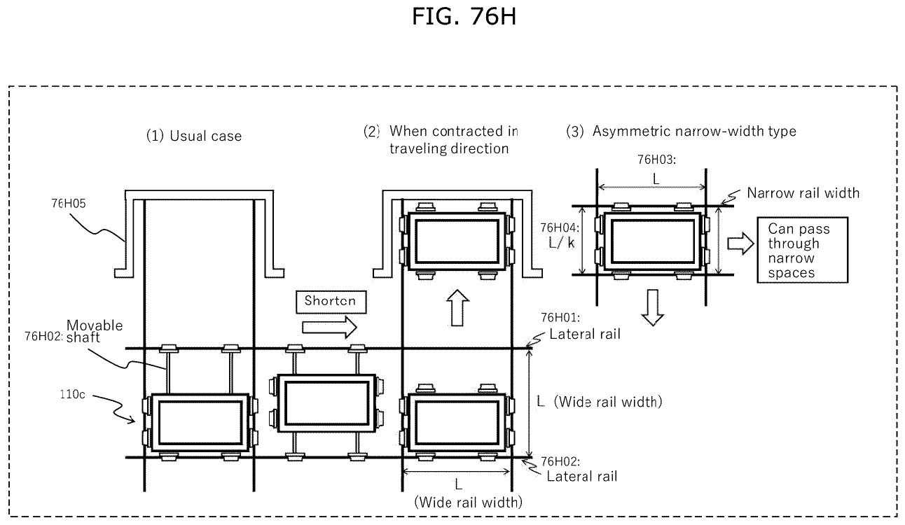

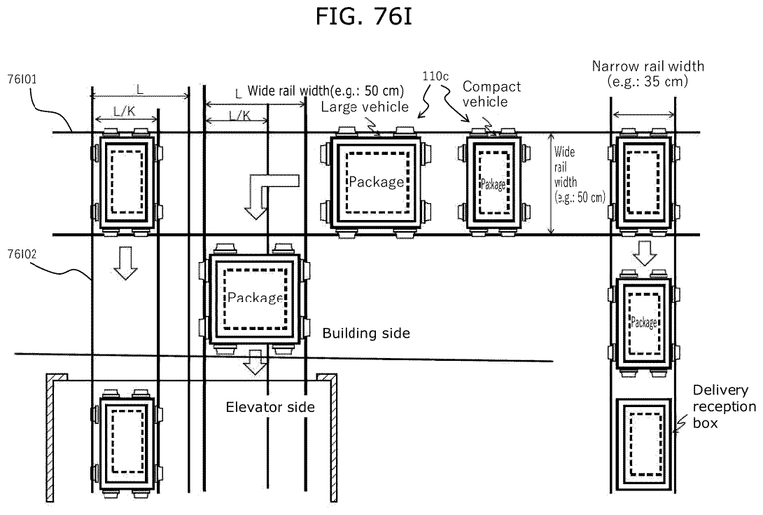

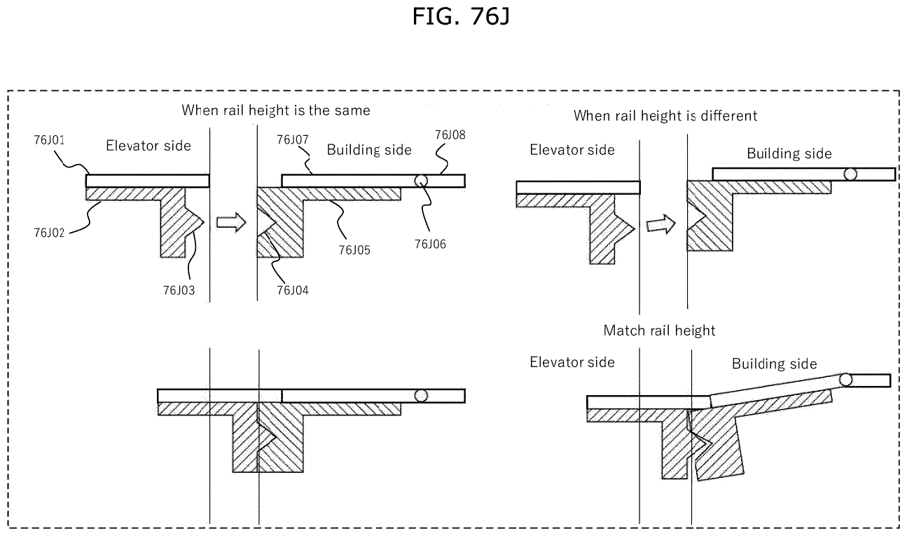

FIG. 76A illustrates an elevator system for moving unmanned transport vehicle c located on a first tier lifting portion to a second tier lifting portion.

FIG. 76B illustrates another elevator system for moving an unmanned transport vehicle located on a first tier lifting portion to a second tier lifting portion.

FIG. 76C illustrates another elevator system including two lifting portions.

FIG. 76D illustrates another elevator system including a movable rail platform lifting device.

FIG. 76E illustrates another elevator system including a two-tier movable rail platform lifting device.

FIG. 76F illustrates yet another elevator system including a two-tier movable rail platform lifting device.

FIG. 76G illustrates an example of rearranging a plurality of unmanned transport vehicles boarded in an elevator carriage that moves up and down.

FIG. 76H illustrates an example of extending the wheels of an unmanned transport vehicle.

FIG. 76I illustrates unmanned transport vehicles according to rail width.

FIG. 76J illustrates a height-adjustable rail.

As described above, unmanned transport vehicles 100, 110, 110a, and 110b according to Technique 1 according to one aspect of the present embodiment include an enclosure (vehicle main body 3501), front wheel 113a1 provided on the enclosure (vehicle main body 3501), and rear wheel 113b1 provided on the enclosure (vehicle main body 3501).

With this configuration, unmanned transport vehicles 100, 110, 110a, and 110b can travel along rail 7 with front wheel 113a1 and rear wheel 113b1.

Unmanned transport vehicles 100, 110, 110a, and 110b according to Technique 2 according to one aspect of the present embodiment are unmanned transport vehicles 100, 110, 110a, and 110b according to Technique 1 in which front wheel 113a1 is configured to allow steering angle adjustment.

With this configuration, the steering angle of front wheel 113a1 can be automatically adjusted, allowing unmanned transport vehicles 100, 110, 110a, and 110b to automatically turn right or left.

Unmanned transport vehicles 100, 110, 110a, and 110b according to Technique 3 according to one aspect of the present embodiment are unmanned transport vehicles 100, 110, 110a, and 110b according to Technique 1 or 2 in which rear wheel 113b1 is configured to not allow steering angle adjustment.

With this configuration, unmanned transport vehicles 100, 110, 110a, and 110b can turn right or left simply by adjusting the steering angle of front wheel 113a1, so there is no need to mount a mechanism for adjusting the steering angle of rear wheel 113b1 on unmanned transport vehicles 100, 110, 110a, and 110b. Therefore, this can prevent a surge in the manufacturing cost of unmanned transport vehicles 100, 110, 110a, and 110b.

Unmanned transport vehicles 100, 110, 110a, and 110b according to Technique 4 according to one aspect of the present embodiment are unmanned transport vehicles 100, 110, 110a, and 110b according to any one of Techniques 1 to 3 that are further provided with a steering device (steering angle device 145) for changing the steering angle of front wheel 113a1.

With this configuration, unmanned transport vehicles 100, 110, 110a, and 110b can turn right or left simply by adjusting the steering angle of front wheel 113a1.

Unmanned transport vehicles 100, 110, 110a, and 110b according to Technique 5 according to one aspect of the present embodiment are unmanned transport vehicles 100, 110, 110a, and 110b according to any one of Techniques 1 to 4 in which a radius of front wheel 113a1 is smaller than a radius of rear wheel 113b1.

With this configuration, the diameter of front wheel 113a1 can be made smaller than the diameter of rear wheel 113b1, making it easier for unmanned transport vehicles 100, 110, 110a, and 110b to turn right and left. Therefore, this can inhibit a decrease in the maneuverability of unmanned transport vehicles 100, 110, 110a, and 110b (i.e., can improve their ability to make tight turns).

Unmanned transport vehicles 100, 110, 110a, and 110b according to Technique 6 according to one aspect of the present embodiment are unmanned transport vehicles 100, 110, 110a, and 110b according to any one of Techniques 1 to 5 that further include arms (first arm 3511 and second arm 3512) connected to the enclosure (vehicle main body 3501), and wheels 3511a and 3512a connected to the leading end side of the arms (first arm 3511 and second arm 3512).

With this configuration, wheel 3511a of first arm 3511 and wheel 3512a of second arm 3512 can be connected to rail 7. Therefore, unmanned transport vehicles 100, 110, 110a, and 110b can travel along rail 7 with first arm 3511 and second arm 3512.

Unmanned transport vehicles 100, 110, 110a, and 110b according to Technique 7 according to one aspect of the present embodiment are unmanned transport vehicles 100, 110, 110a, and 110b according to any one of Techniques 1 to 6 that further include at least one actuator (arm actuator 146) that actuates the arms (first arm 3511 and second arm 3512), wherein the arms (first arm 3511 and second arm 3512) are switched between a first arm state and a second arm state by actuation of the at least one actuator (arm actuator 146), in the first arm state, wheels 3511a, 3512a are positioned at a first position above front wheel 113a1 and rear wheel 113b1, and in the second arm state, wheels 3511a, 3512a are positioned at a second position below the first position.

With this configuration, first arm 3511 and second arm 3512 can be switched between the first arm state and the second arm state. Therefore, unmanned transport vehicles 100, 110, 110a, and 110b can travel in the first arm state, and unmanned transport vehicles 100, 110, 110a, and 110b can travel in the second arm state.

Unmanned transport vehicle 100, 110, 110a, 110b according to Technique 8 according to one aspect of the present embodiment is unmanned transport vehicle 100, 110, 110a, 110b according to Technique 7, further including controller 120. In a case in which front wheel 113a1 and rear wheel 113b1 are traveling on a first rail (rail 7) from a first section toward a second section, where no second rail (elevated rail 7d1) exists above the first rail (rail 7) in the first section and the second rail (elevated rail 7d1) exists above the first rail (rail 7) in the second section, when front wheel 113a1 and rear wheel 113b1 are in the first section, controller 120 controls the at least one actuator (arm actuator 146) to change the arms (first arm 3511 and second arm 3512) from the second arm state to the first arm state to travel with wheels 3511a, 3512a on the second rail (elevated rail 7d1) when the second rail (elevated rail 7d1) is positioned below wheels 3511a, 3512a.

With this configuration, when first arm 3511 and second arm 3512 are in the first arm state, unmanned transport vehicles 100, 110, 110a, and 110b can transfer from rail 7 to elevated rail 7d1. When unmanned transport vehicles 100, 110, 110a, and 110b transfer from elevated rail 7d1 to rail 7, first arm 3511 and second arm 3512 can be in the second arm state. Therefore, by unmanned transport vehicles 100, 110, 110a, and 110b being displaced between the first arm state and the second arm state, they can travel mutually between rail 7 and elevated rail 7d1.

Because unmanned transport vehicles 100, 110, 110a, and 110b are displaced between the first arm state and the second arm state while traveling, unmanned transport vehicles 100, 110, 110a, and 110b can travel mutually between rail 7 and elevated rail 7d1 smoothly without stopping.

Unmanned transport vehicles 100, 110, 110a, and 110b according to Technique 9 according to one aspect of the present embodiment are unmanned transport vehicles 100, 110, 110a, and 110b according to Technique 7 or Technique 8 in which the arms (first arm 3511 and second arm 3512) are further switched to a third arm state by actuation of the at least one actuator (arm actuator 146), and in the third arm state, wheels 3511a, 3512a are positioned at a third position below the first position and above the second position.

With this configuration, first arm 3511 and second arm 3512 can be switched to the third arm state, allowing vehicle main body 3501 of unmanned transport vehicles 100, 110, 110a, and 110b to be lifted. Therefore, unmanned transport vehicles 100, 110, 110a, and 110b can travel along elevated rail 7d1 with vehicle main body 3501 and elevated rail 7d1 positioned as close together as possible. With this, the height (width) from the bottom end of unmanned transport vehicles 100, 110, 110a, and 110b to the top end of elevated rail 7d1 during travel can be prevented from becoming excessively high, making it possible to inhibit enlargement of the operating area of the system including unmanned transport vehicles 100, 110, 110a, and 110b and elevated rail 7d1.

In particular, unmanned transport vehicles 100, 110, 110a, and 110b are useful when unmanned transport vehicles 100, 110, 110a, and 110b travel in areas with height restrictions.

Because unmanned transport vehicles 100, 110, 110a, and 110b are displaced to the third arm state while traveling, unmanned transport vehicles 100, 110, 110a, and 110b can travel on elevated rail 7d1 smoothly without stopping.

Unmanned transport vehicles 100, 110, 110a, and 110b according to Technique 10 according to one aspect of the present embodiment are unmanned transport vehicles 100, 110, 110a, and 110b according to Technique 8 or Technique 9 in which controller 120 controls the at least one actuator (arm actuator 146) to change the arms (first arm 3511 and second arm 3512) from the first arm state to the second arm state after front wheel 113a1 and rear wheel 113b1 are traveling on the first rail (rail 7) and wheels 3511a and 3512a have separated from the second rail (elevated rail 7d1).

Accordingly, when unmanned transport vehicles 100, 110, 110a, and 110b transfer from elevated rail 7d1 to rail 7, first arm 3511 and second arm 3512 can be in the second arm state. Therefore, unmanned transport vehicles 100, 110, 110a, and 110b can inhibit first arm 3511 and second arm 3512 from interfering with other objects when traveling along rail 7.

In particular, unmanned transport vehicles 100, 110, 110a, and 110b are useful when unmanned transport vehicles 100, 110, 110a, and 110b travel in areas with height restrictions.

Because unmanned transport vehicles 100, 110, 110a, and 110b are displaced between the first arm state and the second arm state while traveling, unmanned transport vehicles 100, 110, 110a, and 110b can travel mutually between rail 7 and elevated rail 7d1 smoothly without stopping.

Unmanned transport vehicles 100, 110, 110a, and 110b according to Technique 11 according to one aspect of the present embodiment are unmanned transport vehicles 100, 110, 110a, and 110b according to any one of Techniques 1 to 10 in which, when the enclosure (vehicle main body 3501), front wheel 113a1, and the first rail (rail 7) on which front wheel 113a1 travels are viewed along the direction in which the axles of wheels 3511a and 3512a are arranged, the bottom surface of the enclosure (vehicle main body 3501) is positioned between front wheel 113a1 and the position of the coupling point between front wheel 113a1 and the first rail (rail 7).

With this configuration, front wheel 113a1 can be disposed on the side surface of vehicle main body 3501, making it possible to prevent the height from the bottom end to the top end of unmanned transport vehicles 100, 110, 110a, and 110b from becoming excessively high, thereby making it possible to inhibit enlargement of the operating area of the system including unmanned transport vehicles 100, 110, 110a, and 110b and rail 7.

Unmanned transport vehicles 100, 110, 110a, and 110b according to Technique 12 according to one aspect of the present embodiment are unmanned transport vehicles 100, 110, 110a, and 110b according to Technique 11 in which, when the enclosure (vehicle main body 3501), front wheel 113a1, and the first rail (rail 7) are viewed along the direction in which the axles of wheels 3511a and 3512a are arranged, the distance between the bottom surface of the enclosure (vehicle main body 3501) and the position of the coupling point is greater than or equal to 5 mm and less than or equal to 15 mm.

With this configuration, the height between the position of the coupling point and the bottom surface of vehicle main body 3501 can be prevented from becoming excessively high, thereby making it possible to make unmanned transport vehicles 100, 110, 110a, and 110b thinner and to inhibit enlargement of the operating area of the system including unmanned transport vehicles 100, 110, 110a, and 110b and rail 7.

Unmanned transport vehicles 100, 110, 110a, and 110b according to Technique 13 according to one aspect of the present embodiment are unmanned transport vehicles 100, 110, 110a, and 110b according to Technique 12 in which front wheel 113a1 includes a first front wheel and a second front wheel, front wheel 113a1 is configured to allow adjustment of the distance between the first front wheel and the second front wheel, rear wheel 113b1 includes a first rear wheel and a second rear wheel, and rear wheel 113b1 is configured to allow adjustment of the distance between the first rear wheel and the second rear wheel.

With this configuration, the widths of front wheel 113a1 and rear wheel 113b1 can be adjusted, allowing for adjustment according to the width of a pair of rails 7 consisting of two rails when unmanned transport vehicles 100, 110, 110a, and 110b travel on the pair of rails 7. Therefore, unmanned transport vehicles 100, 110, 110a, and 110b can move between a plurality of pairs of rails 7 having different widths.

Groove structure 7p according to Technique 14 according to one aspect of the present embodiment includes: at least one of (i) a pair of grooves for right turn (pair of rails 7a3) or (ii) a pair of grooves for left turn (pair of rails 7a2); and a pair of grooves for straight travel (pair of rails 7a1). The width of the pair of grooves for right turn (pair of rails 7a3) and the width of the pair of grooves for left turn are different from the width of the pair of grooves for straight travel (pair of rails 7a1).

With this configuration, by having different groove widths, at least one of the pair of rails 7a2 or the pair of rails 7a3 and the pair of rails 7a1 can be arranged together. Therefore, enlargement of groove structure 7p can be inhibited.

Groove structure 7p according to Technique 15 according to one aspect of the present embodiment is groove structure 7p according to Technique 14, wherein at least one of the depth of the pair of grooves for right turn (pair of rails 7a3) or the depth of the pair of grooves for left turn (pair of rails 7a2) is different from the depth of the pair of grooves for straight travel (pair of rails 7a1).

With this configuration, by having different groove depths, when unmanned transport vehicles 100, 110, 110a, and 110b travel on groove structure 7p, they can travel without interference between the pair of grooves for right turn (pair of rails 7a3) and the pair of grooves for straight travel (pair of rails 7a1), and between the pair of grooves for left turn (pair of rails 7a2) and the pair of grooves for straight travel (pair of rails 7a1). Unmanned transport vehicle 110c according to Technique 1 according to one aspect of the present embodiment includes: an enclosure having first side surface 111L and second side surface 111R opposite each other, and third side surface 112L and fourth side surface 112R opposite each other; a first wheel (lifting wheel 133) positioned on first side surface 111L; a second wheel (lifting wheel 133) positioned on second side surface 111R; a third wheel (wheel 113) positioned on third side surface 112L; a fourth wheel (wheel 113) positioned on fourth side surface 112R; and at least one actuator that moves the first wheel (lifting wheel 133) and the second wheel (lifting wheel 133) in the up-down direction.

With this configuration, the actuator provided on unmanned transport vehicle 110c can change the height position between lifting wheel 133 and wheel 113, so the traveling direction can be changed. More specifically, when lifting wheel 133 is positioned below and wheel 113 is positioned above, travel by lifting wheel 133 becomes possible, and when the height relationship is reversed, travel by wheel 113 becomes possible. As a result, by switching between the traveling direction by lifting wheel 133 and the traveling direction by wheel 113, it is possible to switch between, for example, travel on elevator rails 32 for boarding or for alighting and travel on elevator rail 32 for connection.

In unmanned transport vehicle 110c according to Technique 2 according to one aspect of the present embodiment, the first wheel (lifting wheel 133) is for traveling on a first rail (elevator rail 32), the second wheel (lifting wheel 133) is for traveling on a second rail (elevator rail 32) parallel to the first rail (elevator rail 32), the third wheel is for traveling on a third rail (elevator rail 32), and the fourth wheel is for traveling on a fourth rail (elevator rail 32) parallel to the third rail (elevator rail 32).

With this configuration, travel by lifting wheel 133 and travel by wheel 113 can be switched, so unmanned transport vehicle 110c can be moved along a predetermined path.

In unmanned transport vehicle 110c according to Technique 3 according to one aspect of the present embodiment, the first wheel (lifting wheel 133) includes a first first wheel (lifting wheel 133) and a second first wheel (lifting wheel 133), the second wheel (lifting wheel 133) includes a first second wheel (lifting wheel 133) and a second second wheel (lifting wheel 133), the third wheel (wheel 113) includes a first third wheel (wheel 113) and a second third wheel (wheel 113), and the fourth wheel (wheel 113) includes a first fourth wheel (wheel 113) and a second fourth wheel (wheel 113).

With this configuration, by having a plurality of wheels present on each side, it is possible to inhibit a decrease in the load support capability of unmanned transport vehicle 110c. Since unmanned transport vehicle 110c can be supported by a plurality of wheels rather than a single wheel, unmanned transport vehicle 110c can travel more stably.

In unmanned transport vehicle 110c according to Technique 4 according to one aspect of the present embodiment, the first wheel (lifting wheel 133), the second wheel (lifting wheel 133), the third wheel (wheel 113), and the fourth wheel (wheel 113) are changeable between a first state and a second state by driving at least one actuator. In the first state, the first wheel (lifting wheel 133) and the second wheel (lifting wheel 133) are positioned below the third wheel (wheel 113) and the fourth wheel (wheel 113), and in the second state, the third wheel (wheel 113) and the fourth wheel (wheel 113) are positioned below the first wheel (lifting wheel 133) and the second wheel (lifting wheel 133).

With this configuration, by driving the actuator, the position of the wheels can be switched between the first state and the second state. Stated differently, since it is possible to switch between the traveling direction by lifting wheel 133 and the traveling direction by wheel 113, the state of the wheels can be switched so as to, for example, travel on elevator rails 32 for boarding or for alighting in the first state or the second state, or travel on elevator rail 32 for connection in the second state or the first state. Accordingly, the traveling of unmanned transport vehicle 110c can be flexibly changed according to the situation.

In unmanned transport vehicle 110c according to Technique 5 according to one aspect of the present embodiment, the vehicle further includes a control device (controller 120). When the first wheel (lifting wheel 133), the second wheel (lifting wheel 133), the third wheel (wheel 113), and the fourth wheel (wheel 113) are in the first state, the first wheel (lifting wheel 133) is in contact with the first rail (elevator rail 32), the second wheel (lifting wheel 133) is in contact with the second rail (elevator rail 32), the third wheel (wheel 113) is positioned on the third rail (elevator rail 32), and the fourth wheel (wheel 113) is positioned on the fourth rail (elevator rail 32), the control device (controller 120) changes the first wheel (lifting wheel 133), the second wheel (lifting wheel 133), the third wheel (wheel 113), and the fourth wheel (wheel 113) to the second state, makes the third wheel (wheel 113) contact the third rail (elevator rail 32), and makes the fourth wheel (wheel 113) contact the fourth rail (elevator rail 32).

With this configuration, by using controller 120 to change the state of the wheels, it is possible to control unmanned transport vehicle 110c to change its traveling direction. For example, by changing between the first state and the second state, the stability of unmanned transport vehicle 110c when making right and left turns can be improved. Accordingly, the mobility performance of unmanned transport vehicle 110c can be enhanced, making it possible to handle more complex traveling routes.

In unmanned transport vehicle 110c according to Technique 6 according to one aspect of the present embodiment, each of the first wheel (lifting wheel 133), the second wheel (lifting wheel 133), the third wheel (wheel 113), and the fourth wheel (wheel 113) includes a flange portion with an enlarged diameter provided on the periphery of the wheel (wheel main body).

With this configuration, the flange portion with an enlarged diameter provided on the periphery of each wheel engages with the side edge of the rail (for example, elevator rail 32, second story rail 31b, etc.) to inhibit derailment from the rail. This makes it possible to further improve the traveling stability of unmanned transport vehicle 110c.

An elevator according to Technique 1 according to one aspect of the present embodiment is an elevator provided in a building, and includes: elevator carriage 210 that moves up and down; partition 221 that divides a space within elevator carriage 210 into a first space (first elevator space 211) for a person to board and a second space (second elevator space 212) for unmanned transport vehicle 110c to board; and elevator rail 32 that is arranged in the second space (second elevator space 212), wherein unmanned transport vehicle 110c travels along elevator rail 32, and elevator rail 32 includes at least one first elevator rail (elevator rail 32 for boarding and for alighting) that extends in the first direction, and at least one second elevator rail (elevator rail 32 for connection) that extends in a second direction intersecting the first direction.

With this configuration, since elevator rail 32 extends in the first direction and in the second direction intersecting the first direction, unmanned transport vehicle 110c can move not only in the depth direction of second elevator space 212, but also in the lateral direction of second elevator space 212. This makes it possible for unmanned transport vehicle 110c to flexibly move on elevator rail 32.

The elevator according to Technique 2 according to one aspect of the present embodiment further includes rail lifting device 33 that raises and lowers elevator rail 32.

With this configuration, by including rail lifting device 33 that raises and lowers elevator rail 32, even when the story height of the building differs from story to story, unmanned transport vehicle 110c can board and alight from elevator carriage 210 while adjusting the height of elevator rail 32. This makes it possible for unmanned transport vehicle 110c to smoothly move and perform transport work.

In the elevator according to Technique 3 according to one aspect of the present embodiment, elevator rail 32 includes movable rail 32a, and the elevator further includes actuator (actuator 503) that moves movable rail 32a. Movable rail 32a is switched between a first rail state and a second rail state by actuation of the actuator (actuator 503). In the first rail state, first end 32k of movable rail 32a is connected to second end 31k of story rail (second story rail 31b) provided on a predetermined story of the building, and in the second rail state, first end 32k is not connected to second end 31k.

According to this configuration, in the first rail state, since first end 32k of movable rail 32a is connected to second end 31k of second story rail 31b provided on a predetermined story of the building, unmanned transport vehicle 110c can achieve smooth movement between elevator rail 32 and second story rail 31b. In the second rail state, unmanned transport vehicle 110c can travel independently within elevator rail 32 or second story rail 31b.

An elevator system according to Technique 1 according to one aspect of the present embodiment includes: an elevator provided in a building; and a control device (controller 501). The elevator includes: elevator carriage 210 that moves up and down; partition 221 that divides a space within elevator carriage 210 into a first space (first elevator space 211) for a person to board and a second space (second elevator space 212) for unmanned transport vehicle 110c to board; and elevator rail 32 that is arranged in the second space (second elevator space 212). Unmanned transport vehicle 110c travels along elevator rail 32. The control device (controller 501) controls a plurality of unmanned transport vehicles 110c located within the second space (second elevator space 212) to rearrange the plurality of unmanned transport vehicles 110c so that the plurality of unmanned transport vehicles 110c achieve a target arrangement.

With this configuration, the plurality of unmanned transport vehicles 110c can be rearranged into the target arrangement within elevator carriage 210. This makes it possible for unmanned transport vehicle 110c to efficiently board and alight from the elevator, and the efficiency of transport operations can be improved. By partitioning first elevator space 211 for people to board and second elevator space 212 for unmanned transport vehicle 110c to board, safe coexistence between people and unmanned transport vehicle 110c can be achieved.

In the elevator system according to Technique 2 according to one aspect of the present embodiment, the target arrangement is an arrangement in which a plurality of predetermined unmanned transport vehicles 110c are positioned at locations where they can easily move to the outside of the elevator through the opening formed in elevator carriage 210 that leads to the second space (second elevator space 212).

With this configuration, unmanned transport vehicle 110c can smoothly board and alight when the door of elevator carriage 210 is opened. This makes it possible to further improve the utilization efficiency of elevator carriage 210 and the operational efficiency of unmanned transport vehicle 110c.

In the elevator system according to Technique 3 according to one aspect of the present embodiment, changing to the target arrangement is performed while elevator carriage 210 is moving.

With this configuration, the plurality of unmanned transport vehicles 110c can be changed to the target arrangement while elevator carriage 210 is moving. Therefore, it is not necessary to rearrange unmanned transport vehicles 110c during the stop time of elevator carriage 210, which can lead to improved utilization efficiency of elevator carriage 210 and improved operational efficiency of unmanned transport vehicles 110c.

In the elevator system according to Technique 4 according to one aspect of the present embodiment, elevator rail 32 includes at least one first elevator rail (elevator rail 32 for boarding and for alighting) that extends in the first direction, and at least one second elevator rail (elevator rail 32 for connection) that extends in a second direction intersecting the first direction.

With this configuration, since elevator rail 32 extends in the first direction and in the second direction intersecting the first direction, unmanned transport vehicle 110c can move not only in the depth direction of second elevator space 212, but also in the lateral direction of second elevator space 212. This makes it possible for unmanned transport vehicle 110c to flexibly move on elevator rail 32, and improve both the utilization efficiency of elevator carriage 210 and effective utilization of space in elevator carriage 210.

In the elevator system according to Technique 5 according to one aspect of the present embodiment, elevator rail 32 forms a plurality of tiers and further includes rail lifting device 33 that raises and lowers at least any one tier of the plurality of tiers, and when the plurality of tiers are viewed from vertically above, the plurality of tiers are divided into a predetermined area and an area other than the predetermined area, and rail lifting device 33 is configured to change the positional relationship in the up-down direction between the plurality of tiers that correspond to the predetermined area and the plurality of tiers that correspond to the area other than the predetermined area.

With this configuration, rail lifting device 33 can change the vertical position of elevator rail 32. This makes it possible to increase the loading capacity for unmanned transport vehicles 110c and flexibly adjust the arrangement positions of unmanned transport vehicles 110c that correspond to the predetermined area and the area other than the predetermined area, which can lead to improved utilization efficiency of elevator carriage 210 and improved operational efficiency of unmanned transport vehicles 110c.

In the elevator system according to Technique 6 according to one aspect of the present embodiment, the system further includes a control device (controller 501) that controls rail lifting device 33, the plurality of tiers include a first tier and a second tier positioned below the first tier, and when the height of the first tier that corresponds to the predetermined area and the height of the first tier that corresponds to the area other than the predetermined area match, the control device (controller 501) controls rail lifting device 33 to change the positional relationship in the up-down direction between the plurality of tiers that correspond to the predetermined area and the plurality of tiers that correspond to the area other than the predetermined area, so as to align the height of the first tier that corresponds to the predetermined area and the height of the second tier that corresponds to the area other than the predetermined area.

With this configuration, the control device (controller 501) can control rail lifting device 33 to change the positional relationship in the up-down direction between the tiers that correspond to the predetermined area and the tiers that correspond to the area other than the predetermined area. This makes it possible to more flexibly adjust the arrangement positions of unmanned transport vehicles 110c, and because unmanned transport vehicles 110c positioned in specific areas can smoothly board and alight, efficient operation of elevator carriage 210 can be realized.

In the elevator system according to Technique 7 according to one aspect of the present embodiment, the target arrangement is an arrangement in which a plurality of predetermined unmanned transport vehicles 110c are positioned on a predetermined tier and at locations where they can easily move to the outside of the elevator (elevator carriage 210) through the opening formed in elevator carriage 210 that leads to the second space (second elevator space 212).

With this configuration, by considering the arrangement of unmanned transport vehicles 110c positioned on a predetermined tier, it is possible to increase loading efficiency and at the same time enable unmanned transport vehicles 110c to smoothly board and alight when the door of elevator carriage 210 is opened. This makes it possible to further improve the utilization efficiency of elevator carriage 210 and the operational efficiency of unmanned transport vehicle 110c.

An elevator system according to Technique 1 according to one aspect of the present embodiment includes: an elevator provided in a building; and a control device (controller 501). The elevator includes: elevator carriage 210 that moves up and down; partition 221 that divides a space within elevator carriage 210 into a first space (first elevator space 211) for a person to board and a second space (second elevator space 212) for unmanned transport vehicle 110c to board; elevator rail 32 that includes movable rail 32a and is arranged in the second space (second elevator space 212); and an actuator that moves movable rail 32a. Unmanned transport vehicle 110c travels along elevator rail 32. Movable rail 32a is switched between a first rail state and a second rail state by driving of the actuator. In the first rail state, first end 32k of movable rail 32a is connected to second end 31k of a story rail installed in a boarding and alighting area on a predetermined story of the building. In the second rail state, first end 32k is not connected to second end 31k. The control device (controller 501) controls a plurality of unmanned transport vehicles 110c located within the boarding and alighting area to rearrange the plurality of unmanned transport vehicles 110c so that the plurality of unmanned transport vehicles 110c achieve a target arrangement.

According to this configuration, in the first rail state, since first end 32k of movable rail 32a is connected to second end 31k of second story rail 31b provided on a predetermined story of the building, unmanned transport vehicle 110c can achieve smooth movement between elevator rail 32 and second story rail 31b. In the second rail state, unmanned transport vehicle 110c can travel independently within elevator rail 32 or second story rail 31b.

Unmanned transport vehicles 110c can be rearranged into the target arrangement within elevator carriage 210. This makes it possible for unmanned transport vehicle 110c to efficiently board and alight from elevator carriage 210, and the efficiency of transport operations can be improved.

By partitioning first elevator space 211 for people to board and second elevator space 212 for unmanned transport vehicle 110c to board, safe coexistence between people and unmanned transport vehicle 110c can be achieved.

In the elevator system according to Technique 2 according to one aspect of the present embodiment, the target arrangement is an arrangement in which a plurality of predetermined unmanned transport vehicles 110c form groups, and the groups include a first group that includes unmanned transport vehicle 110c scheduled to board an elevator heading in a first direction, and a second group that includes unmanned transport vehicle 110c scheduled to board an elevator heading in a direction opposite to the first direction, and the first direction indicates an upward direction or a downward direction.

With this configuration, by separating unmanned transport vehicles 110c of the first group and unmanned transport vehicles 110c of the second group in advance, it is possible to inhibit an increase in the time required for rearranging unmanned transport vehicles 110c within elevator carriage 210, and it is also possible to inhibit an increase in the amount of movement of unmanned transport vehicles 110c within elevator carriage 210. This makes it possible to improve the utilization efficiency of elevator carriage 210 and the operational efficiency of unmanned transport vehicle 110c.

In the elevator system according to Technique 3 according to one aspect of the present embodiment, the target arrangement is an arrangement in which a plurality of predetermined unmanned transport vehicles 110c form groups, and in the groups, unmanned transport vehicles 110c scheduled to alight at stories farther from a predetermined story are positioned closer to the entrance (opening) side of the elevator.

With this configuration, by arranging unmanned transport vehicles 110c according to the proximity of the stories where they are scheduled to alight, the amount of movement of unmanned transport vehicles 110c within elevator carriage 210 can be minimized. By arranging unmanned transport vehicles 110c scheduled to alight at stories farther away toward the back side of second elevator space 212, unmanned transport vehicles 110c closer to the door side of second elevator space 212 can alight first. For this reason, unmanned transport vehicle 110c can efficiently board and alight from elevator carriage 210, and the efficiency of transport operations can be improved.

In the elevator system according to Technique 4 according to one aspect of the present embodiment, the target arrangement is an arrangement in which a plurality of predetermined unmanned transport vehicles 110c form groups, and in the groups, unmanned transport vehicles 110c scheduled to alight at later timing are positioned closer to the entrance side of the elevator.

With this configuration, the position of unmanned transport vehicle 110c within second elevator space 212 can be changed according to the timing at which it is scheduled to alight. By positioning unmanned transport vehicles 110c with later alighting timing closer to the entrance side of second elevator space 212, unmanned transport vehicles 110c can efficiently board and alight from elevator carriage 210, and the efficiency of transport operations can be improved.

The elevator system according to Technique 5 according to one aspect of the present embodiment further includes a carriage door (second carriage door 232) that opens and closes an opening formed in elevator carriage 210 that leads to the second space (second elevator space 212). The rearrangement of the plurality of unmanned transport vehicles 110c is performed after the elevator arrives at a predetermined story and before second carriage door 232 opens.

With this configuration, unmanned transport vehicles 110c can be rearranged within second elevator space 212 after elevator carriage 210 arrives at a predetermined story and before second carriage door 232 opens. This makes it possible to effectively utilize the stop time of elevator carriage 210, and by rearranging unmanned transport vehicle 110c into the target arrangement, when second carriage door 232 of elevator carriage 210 opens, unmanned transport vehicles 110c can efficiently board and alight from elevator carriage 210, and the efficiency of transport operations can be improved.

An elevator according to Technique 1 according to one aspect of the present embodiment includes: elevator carriage 210 that moves up and down; partition 221 that divides a space within elevator carriage 210 into a first space (first elevator space 211) for a person to board and a second space (second elevator space 212) for unmanned transport vehicle 110c to board; and a control device (controller 501).

With this, by partitioning first elevator space 211 for people to board and second elevator space 212 for unmanned transport vehicle 110c to board, safe coexistence between people and unmanned transport vehicle 110c can be achieved.

In the elevator according to Technique 2 according to one aspect of the present embodiment, the control device (controller 501) does not stop elevator carriage 210 at the story where unmanned transport vehicle 110c is scheduled to alight when a person is boarded in the first space (first elevator space 211) and unmanned transport vehicle 110c is boarded in the second space (second elevator space 212).

With this, by controlling elevator carriage 210 so as not to stop at the story where unmanned transport vehicle 110c is scheduled to alight when a person is boarded in first elevator space 211 and unmanned transport vehicle 110c is boarded in second elevator space 212, the movement of people can be prioritized and unnecessary stops for unmanned transport vehicle 110c can be avoided. As a result, the operating efficiency of elevator carriage 210 is improved, and the convenience for people increases.

In the elevator according to Technique 3 according to one aspect of the present embodiment, the control device (controller 501) stops elevator carriage 210 at the story where unmanned transport vehicle 110c is scheduled to alight when a person is not boarded in the first space (first elevator space 211) and unmanned transport vehicle 110c is boarded in the second space (second elevator space 212).

With this, by controlling elevator carriage 210 so as to stop at the story where unmanned transport vehicle 110c is scheduled to alight when a person is not boarded in first elevator space 211 and unmanned transport vehicle 110c is boarded in second elevator space 212, transport of only packages in situations where there are no people boarded can be enabled, and the operational efficiency of unmanned transport vehicles 110c can be expected to be improved by efficiently operating unmanned transport vehicles 110c.

The elevator according to Technique 4 according to one aspect of the present embodiment further includes first carriage door 231 that opens and closes an opening formed in elevator carriage 210 that leads to the first space (first elevator space 211), and second carriage door 232 that opens and closes an opening formed in elevator carriage 210 that leads to the second space (second elevator space 212).

With this, by including first carriage door 231 and second carriage door 232 that open and close openings leading to first elevator space 211 and second elevator space 212, respectively, independent doors (first carriage door 231 and second carriage door 232) can be provided for the boarding and alighting of people and unmanned transport vehicle 110c. It is therefore possible to inhibit a decrease in safety and convenience during boarding and alighting of people and unmanned transport vehicles 110c.

In the elevator according to Technique 5 according to one aspect of the present embodiment, the control device (controller 501) opens first carriage door 231 and opens second carriage door 232 when a person and unmanned transport vehicle 110c alight at a predetermined story when a person is boarded in the first space (first elevator space 211) and unmanned transport vehicle 110c is boarded in the second space (second elevator space 212), and opens first carriage door 231 and keeps second carriage door 232 closed when a person alights at a predetermined story when a person is boarded in the first space (first elevator space 211) and unmanned transport vehicle 110c is not boarded in the second space (second elevator space 212).

With this, control can be performed to open both first carriage door 231 and second carriage door 232 when a person and unmanned transport vehicle 110c simultaneously board and alight, while opening only first carriage door 231 and keeping second carriage door 232 closed when only a person alights. Therefore, when no unmanned transport vehicle 110c is boarded, the opening and closing operation of second carriage door 232 can be omitted, and energy consumption can be reduced.

In the elevator according to Technique 6 according to one aspect of the present embodiment, the control device (controller 501) keeps first carriage door 231 closed and opens second carriage door 232 when unmanned transport vehicle 110c alights at a predetermined story when a person is boarded in the first space (first elevator space 211) and unmanned transport vehicle 110c is boarded in the second space (second elevator space 212).

With this, when a person and unmanned transport vehicle 110c are simultaneously boarded and only unmanned transport vehicle 110c should alight, by keeping first carriage door 231 closed and opening second carriage door 232, unmanned transport vehicle 110c can be given priority for boarding and alighting. This makes it possible to smoothly perform boarding and alighting of unmanned transport vehicle 110c without a person mistakenly thinking that they have arrived at their destination story.

The elevator according to Technique 7 according to one aspect of the present embodiment further includes a display, and when first carriage door 231 is kept closed and second carriage door 232 is open, the display displays that the elevator is stopped for unmanned transport vehicle 110c.

With this, by displaying on the display that the elevator is stopped for unmanned transport vehicle 110c when first carriage door 231 is kept closed and second carriage door 232 is open, the reason for the stop can be clearly communicated to people, and a sense of reassurance can be provided that the stop of elevator carriage 210 is not due to a malfunction.

The elevator according to Technique 7 according to one aspect of the present embodiment further includes a loudspeaker, and when first carriage door 231 is kept closed and second carriage door 232 is open, an announcement that the elevator is stopped for unmanned transport vehicle 110c is output from the loudspeaker.

With this, by outputting from the loudspeaker that the elevator is stopped for unmanned transport vehicle 110c when first carriage door 231 is kept closed and second carriage door 232 is open, the reason for the stop can be communicated to people through auditory information, and people can more accurately understand the state of elevator carriage 210.

An elevator according to Technique 1 according to one aspect of the present embodiment is an elevator provided in a building, and includes: elevator carriage 210 that moves up and down; partition 221 that divides a space within elevator carriage 210 into a first space (first elevator space 211) for a person to board and a second space (second elevator space 212) for unmanned transport vehicle 110c to board; elevator rail 32 that forms a plurality of tiers and is arranged in the second space (second elevator space 212); and rail lifting device 33 that raises and lowers at least any one tier of the plurality of tiers, wherein unmanned transport vehicle 110c travels along elevator rail 32.

With this, by partitioning first elevator space 211 for people to board and second elevator space 212 for unmanned transport vehicle 110c to board, safe coexistence between people and unmanned transport vehicle 110c can be achieved.

Rail lifting device 33 can change the vertical position of elevator rail 32. This makes it possible to increase the loading capacity for unmanned transport vehicles 110c and optimize the arrangement of unmanned transport vehicles 110c that correspond to each of the plurality of tiers, which can lead to improved loading efficiency of elevator carriage 210 and improved operational efficiency of unmanned transport vehicles 110c.

In the elevator according to Technique 2 according to one aspect of the present embodiment, the plurality of tiers include a first tier and a second tier that is located below the first tier.

With this, by providing a plurality of tiers including the first tier and the second tier, it becomes possible to arrange unmanned transport vehicles 110c in a hierarchical manner. Therefore, the space within elevator carriage 210 can be used more efficiently, and a reduction in loading capacity can be inhibited.

In the elevator according to Technique 3 according to one aspect of the present embodiment, raising and lowering at least one of the plurality of tiers by rail lifting device 33 is performed while elevator carriage 210 is moving.

With this configuration, the plurality of unmanned transport vehicles 110c can be rearranged while elevator carriage 210 is moving. Therefore, it is not necessary to rearrange unmanned transport vehicles 110c during the stop time of elevator carriage 210, which can lead to improved utilization efficiency of elevator carriage 210 and improved operational efficiency of unmanned transport vehicles 110c.

In the elevator according to Technique 4 according to one aspect of the present embodiment, rail lifting device 33 is configured to change the distance between elevator rail 32 and the ceiling of the second space (second elevator space 212) according to the story height of each story of the building.

With this configuration, because rail lifting device 33 is configured to change the distance of elevator rail 32 relative to the ceiling of second elevator space 212 according to the story height of each story of the building, the loading height of unmanned transport vehicle 110c can be optimized according to the conditions of each story. This makes it possible to flexibly adjust the available space of elevator carriage 210, and because unmanned transport vehicles 110c can smoothly board and alight, efficient operation of elevator carriage 210 can be realized.

In the elevator according to Technique 5 according to one aspect of the present embodiment, when the plurality of tiers are viewed from vertically above, the plurality of tiers are divided into a predetermined area and an area other than the predetermined area, and rail lifting device 33 is configured to change the positional relationship in the up-down direction between the plurality of tiers that correspond to the predetermined area and the plurality of tiers that correspond to the area other than the predetermined area.

With this configuration, rail lifting device 33 can change the vertical position of elevator rail 32. This makes it possible to increase the loading capacity for unmanned transport vehicles 110c and flexibly adjust the arrangement positions of unmanned transport vehicles 110c that correspond to the predetermined area and the area other than the predetermined area, which can lead to improved utilization efficiency of elevator carriage 210 and improved operational efficiency of unmanned transport vehicles 110c.

In the elevator according to Technique 6 according to one aspect of the present embodiment, the plurality of tiers that correspond to the predetermined area are fixed to elevator carriage 210, and rail lifting device 33 includes an actuator that moves the plurality of tiers that correspond to the area other than the predetermined area in the up-down direction.

With this configuration, because the plurality of tiers are divided into a predetermined area and an area other than the predetermined area, and rail lifting device 33 is configured to change the positional relationship in the up-down direction between these, the arrangement positions of unmanned transport vehicles 110c can be adjusted for each area. This makes it possible to more efficiently arrange unmanned transport vehicles 110c within the elevator, and inhibit a reduction in the loading efficiency of unmanned transport vehicles 110c in second elevator space 212.

In the elevator according to Technique 7 according to one aspect of the present embodiment, the system further includes a control device (controller 501) that controls rail lifting device 33, the plurality of tiers include a first tier and a second tier positioned below the first tier, and when the height of the first tier that corresponds to the predetermined area and the height of the first tier that corresponds to the area other than the predetermined area match, the control device (controller 501) controls rail lifting device 33 to change the positional relationship in the up-down direction between the plurality of tiers that correspond to the predetermined area and the plurality of tiers that correspond to the area other than the predetermined area, so as to align the height of the first tier that corresponds to the predetermined area and the height of the second tier that corresponds to the area other than the predetermined area.

With this configuration, the control device (controller 501) can control rail lifting device 33 to change the positional relationship in the up-down direction between the tiers that correspond to the predetermined area and the tiers that correspond to the area other than the predetermined area. This makes it possible to more flexibly adjust the arrangement positions of unmanned transport vehicles 110c, and because unmanned transport vehicles 110c positioned in specific areas can smoothly board and alight, efficient operation of elevator carriage 210 can be realized.

In the elevator according to Technique 8 according to one aspect of the present embodiment, changing the positional relationship in the up-down direction between the plurality of tiers that correspond to the predetermined area and the plurality of tiers that correspond to the area other than the predetermined area is performed after unmanned transport vehicle 110c has boarded the predetermined area.

With this configuration, since the positional relationship of the plurality of tiers is changed after unmanned transport vehicle 110c has boarded the predetermined area, it is possible to ensure stable boarding of unmanned transport vehicle 110c and then perform tier position adjustment according to the loading state.

In the elevator according to Technique 9 according to one aspect of the present embodiment, elevator rail 32 includes, at each tier of the plurality of tiers, at least one first elevator rail 32 that extends in the first direction, and at least one second elevator rail 32 that extends in a second direction intersecting the first direction.

With this configuration, since elevator rail 32 extends in the first direction and in the second direction intersecting the first direction, unmanned transport vehicle 110c can move not only in the depth direction of second elevator space 212, but also in the lateral direction of second elevator space 212. This makes it possible for unmanned transport vehicle 110c to flexibly move on elevator rail 32.

The unmanned transport vehicle system according to Technique 1 according to one aspect of the present embodiment includes at least one unmanned transport vehicle 110c and a control device. The at least one unmanned transport vehicle 110c includes RFID reader 151 and sensor 152.

With this configuration, by reading RFID tag 153 installed at the facility with RFID reader 151, it is possible to grasp the approximate position of unmanned transport vehicle 110c. Furthermore, by using sensor 152, it becomes possible to determine the precise location of unmanned transport vehicle 110c even in dark conditions. This accurate position detection enables unmanned transport vehicle 110c to navigate complex routes, such as curved pathways, with high precision.

In the unmanned transport vehicle system according to Technique 2 according to one aspect of the present embodiment, sensor 152 includes any one of an ultrasonic sensor, an optical sensor, or a laser sensor.

With this configuration, unmanned transport vehicle 110c can improve its position detection capability in environments according to the characteristics of each sensor 152. For example, an ultrasonic sensor can detect the position of unmanned transport vehicle 110c by utilizing acoustic reflection, an optical sensor can detect the position of unmanned transport vehicle 110c by utilizing light reflection, and a laser sensor can detect the position of unmanned transport vehicle 110c by utilizing laser light reflection. It is therefore possible to grasp the accurate position of unmanned transport vehicle 110c in various environments.

In the unmanned transport vehicle system according to Technique 3 according to one aspect of the present embodiment, the control device identifies the position of a predetermined unmanned transport vehicle 110c based on information indicating the RFID signal from RFID tag 153 obtained by RFID reader 151 of the predetermined unmanned transport vehicle 110c, and information indicating the sensing result by sensor 152 of the predetermined unmanned transport vehicle 110c.

With this, the control device can accurately identify the position of unmanned transport vehicle 110c based on information indicating the RFID signal from RFID tag 153 obtained by RFID reader 151 of unmanned transport vehicle 110c and information indicating the sensing result by sensor 152. This makes it possible to accurately grasp the position of unmanned transport vehicle 110c, enabling control such as setting more efficient transport routes for unmanned transport vehicle 110c or obstacle avoidance by unmanned transport vehicle 110c.

In the unmanned transport vehicle system according to Technique 4 according to one aspect of the present embodiment, at least one unmanned transport vehicle 110c includes a first unmanned transport vehicle and a second unmanned transport vehicle, and the control device identifies the position of the first unmanned transport vehicle and/or the second unmanned transport vehicle based on (i) information indicating the RFID signal from RFID tag 153 obtained by RFID reader 151 of the first unmanned transport vehicle and/or information indicating the RFID signal from RFID tag 153 obtained by RFID reader 151 of the second unmanned transport vehicle, (ii) information indicating the sensing result by sensor 152 of the first unmanned transport vehicle, and (iii) information indicating the sensing result by sensor 152 of the second unmanned transport vehicle.

With this, when a plurality of unmanned transport vehicles 110c including the first unmanned transport vehicle and the second unmanned transport vehicle exist, the position of each of the plurality of unmanned transport vehicles 110c can be identified based on the RFID signal and sensing result obtained by each unmanned transport vehicle 110c. By taking into account how unmanned transport vehicles 110c are positioned relative to one another, it becomes possible to precisely determine the precise location of each unmanned transport vehicle 110c. Accordingly, collisions between unmanned transport vehicles 110c can be avoided and efficient operation can be achieved.

An elevator according to Technique 1 according to one aspect of the present embodiment is an elevator provided in a building, and includes: elevator carriage 210 that moves up and down; partition 221 that divides a space within elevator carriage 210 into a first space (first elevator space 211) for a person to board and a second space (second elevator space 212) for unmanned transport vehicle 110c to board; and elevator rail 32 that is arranged in the second space (second elevator space 212), wherein unmanned transport vehicle 110c travels along elevator rail 32, elevator carriage 210 has a first opening formed therein that leads to the second space (second elevator space 212), and the first opening is located on any one of a front side, a lateral side, or a rear side of the elevator.

With this, by partitioning the space within elevator carriage 210 into first elevator space 211 for people to board and second elevator space 212 for unmanned transport vehicle 110c to board, safety and efficiency can be improved when people and unmanned transport vehicle 110c simultaneously use the elevator. By selecting the position of the first opening according to the structure of the building, the convenience of entry and exit of unmanned transport vehicle 110c can be enhanced. For example, even when entry and exit from the front side is difficult due to a high ceiling in the elevator lobby, by providing openings on the lateral side or rear side, it becomes possible to smoothly perform entry and exit of unmanned transport vehicle 110c.

In the elevator according to Technique 2 according to one aspect of the present embodiment, elevator carriage 210 has a second opening formed therein that leads to the second space (second elevator space 212), and the second opening is located on any one of a front side, a lateral side, or a rear side of the elevator.

With this, by providing the second opening, an entrance/exit for unmanned transport vehicle 110c can be provided at a position different from the first opening. This makes it possible to enhance the flexibility of entry and exit of unmanned transport vehicle 110c according to the structure of the building and the installation situation of the elevator. For example, even when the entrance/exit on the front side cannot be used on a specific story, by providing the second opening on a lateral side or the rear side, accessibility for unmanned transport vehicle 110c to enter and exit elevator carriage 210 can be enhanced.

In the elevator according to Technique 3 according to one aspect of the present embodiment, the second opening is provided at a location that does not face the location where the counterweight of the elevator is provided.

With this configuration, the second opening can be positioned so as not to interfere with the counterweight of elevator carriage 210, so unmanned transport vehicle 110c can smoothly enter and exit.

In the elevator according to Technique 4 according to one aspect of the present embodiment, elevator rail 32 includes movable rail 32a, and the elevator further includes an actuator that moves movable rail 32a. Movable rail 32a is switched between a first rail state and a second rail state by actuation of the actuator. In the first rail state, the first end of movable rail 32a is connected to the second end of a story rail provided on a predetermined story of the building, and in the second rail state, the first end is not connected to second end.

According to this configuration, in the first rail state, since first end 32k of movable rail 32a is connected to second end 31k of second story rail 31b provided on a predetermined story of the building, unmanned transport vehicle 110c can achieve smooth movement between elevator rail 32 and second story rail 31b. In the second rail state, unmanned transport vehicle 110c can travel independently within elevator rail 32 or second story rail 31b.

In the elevator according to Technique 5 according to one aspect of the present embodiment, elevator rail 32 includes at least one first elevator rail (elevator rail 32 for boarding and for alighting) that extends in the first direction, and at least one second elevator rail (elevator rail 32 for connection) that extends in a second direction intersecting the first direction.

With this configuration, since elevator rail 32 extends in the first direction and in the second direction intersecting the first direction, unmanned transport vehicle 110c can move not only in the depth direction of second elevator space 212, but also in the lateral direction of second elevator space 212. This makes it possible for unmanned transport vehicle 110c to flexibly move on elevator rail 32, and improve both the utilization efficiency of elevator carriage 210 and effective utilization of space in elevator carriage 210.

The system according to Technique 1 according to one aspect of the present embodiment is a system including unmanned transport vehicle 110c, and includes: unmanned transport vehicle 110c; a first winch (winch 143) connected to unmanned transport vehicle 110c and capable of reeling out and in wire 104; package carriage 112 connected to wire 104, for putting a package to be transported by unmanned transport vehicle 110c into; and a controller (controller 120), and when package carriage 112 is viewed from vertically above, package carriage 112 is divided into a region for a first package and a region for a second package.

With this configuration, since package carriage 112 has regions for putting packages in two separate and independent locations, unmanned transport vehicle 110c can deliver packages to a plurality of locations. Since space becomes available after packages are delivered, packages can also be collected in the space that becomes available at the delivery destination. Therefore, since unmanned transport vehicle 110c can deliver packages to a plurality of locations in a single delivery, an increase in the number of round trips between the delivery destination and delivery origin can be inhibited, and a reduction in energy efficiency in the system can be inhibited.

The system according to Technique 2 according to one aspect of the present embodiment further includes a controller (controller 120), package carriage 112 includes an attitude control device including a flywheel that rotates around a rotary shaft extending in a vertical direction, package carriage 112 includes an accommodation space for accommodating a package, and the controller (controller 120) obtains a sensing result from a sensor capable of detecting an attitude of package carriage 112, and based on the obtained sensing result, controls rotation of the flywheel to rotate package carriage 112 around the rotary shaft and orient package carriage 112 to a target attitude.

With this, even if the attitude of package carriage 112 is tilted relative to the horizontal direction or rotates around the vertical direction, the attitude control device can control the flywheel to orient package carriage 112 to the target attitude. As a result, the package can be delivered to the recipient's delivery reception box (delivery box).

As described above, the transport vehicle, turntable, architectural structure, and rail structure according to the present embodiment are classified into, for example, the following aspect groups A to J. Each aspect group is classified into various aspects.

### <A1>

A transport vehicle including:
an enclosure including a first side surface and a second side surface that oppose each other;
a first wheel provided on the first side surface; and
a second wheel provided on the second side surface, wherein
the first wheel is for traveling on a first rail,
the second wheel is for traveling on a second rail parallel to the first rail,
when the enclosure, the first wheel, and the second wheel are viewed from the direction in which the first rail and the second rail extend,
axles of the first wheel and the second wheel are each positioned lower than an upper surface of the enclosure and higher than a lower surface of the enclosure.

### <A2>

The transport vehicle according to <A1>, wherein
when the transport vehicle is viewed from vertically above,
the enclosure and the first wheel do not overlap, and
the enclosure and the second wheel do not overlap.

### <A2-1>

The transport vehicle according to <A1> or <A2>, wherein
when the enclosure, the first wheel, and the second wheel are viewed from the direction in which the first rail and the second rail extend,
the enclosure is positioned between the first rail and the second rail.

### <A2-2>

The transport vehicle according to <A1> to <A2-1>, wherein
when the transport vehicle is viewed from vertically above,
a width of the enclosure in a direction perpendicular to the direction along the first rail and the second rail is shorter than a distance between the first rail and the second rail.

### <A2-3>

The transport vehicle according to <A1> to <A2-2>, wherein
when the transport vehicle is viewed from vertically above,
a width of the enclosure in a direction perpendicular to the direction along the first rail and the second rail is shorter than a distance between the first wheel and the second wheel.

### <A3>

The transport vehicle according to <A1> or <A2>, further including:
a package carriage connected to a wire;
a winch capable of reeling out and reeling in the wire; and
a pulley, wherein
the package carriage is suspended by the wire being passed over the pulley, and
when the transport vehicle is viewed from vertically above, the package carriage and the winch do not overlap.

### <A3-1>

The transport vehicle according to <A3>, wherein
the winch is positioned at a corner within the enclosure.

### <A4>

The transport vehicle according to any one of <A1> to <A3-1>, further including:
a first motor that is positioned within the enclosure and rotates the first wheel; and
a second motor that is positioned within the enclosure and rotates the second wheel, wherein
when the transport vehicle is viewed from vertically above,
the first motor does not overlap with the package carriage, and
the second motor does not overlap with the package carriage.

### <A5>

The transport vehicle according to any one of <A1> to <A4>, further including:
a first arm and a second arm each connected to the enclosure;
a third wheel connected to the leading end side of the first arm;
a fourth wheel connected to the leading end side of the second arm; and
at least one actuator that actuates the first arm and the second arm, wherein
the first wheel provided on the enclosures includes two or more first wheels,
the second wheel provided on the enclosures includes two or more second wheels,
the first arm and the second arm are switched between a first arm state and a second arm state by actuation of the at least one actuator,
in the first arm state, the third wheel and the fourth wheel are positioned at a first position above the first wheel and the second wheel, and
in the second arm state, the third wheel and the fourth wheel are positioned at a second position below the first position.

### <A6>

The transport vehicle according to <A5>, further including:
a controller, wherein
the controller:
   in a case in which the first wheel and the second wheel are traveling on the first rail and the second rail, respectively, from a first section toward a second section, where no third rail is present above the first rail and the second rail in the first section and the third rail is present above the first rail and the second rail in the second section,
   when the first wheel and the second wheel are in the first section, controls the at least one actuator to transition the first arm and the second arm from the second arm state to the first arm state to cause the third wheel and the fourth wheel to travel on the third rail when the third rail is positioned below the third wheel and the fourth wheel.

### <A7>

The transport vehicle according to <A6>, wherein
the first arm and the second arm are further switched to a third arm state by actuation of the at least one actuator, and
in the third arm state, the third wheel and the fourth wheel are positioned at a third position that is below the first position and above the second position.

### <A8>

The transport vehicle according to <A6> or <A7>, wherein
the controller controls the at least one actuator to change the first arm and the second arm from the first arm state to the second arm state after the first wheel and the second wheel are traveling on the first rail and the second rail, respectively, and the third wheel and the fourth wheel have separated from the third rail.

### <B1>

A turntable including:
a base;
a rotating member rotatably attached to the base so as to be rotatable around a rotary shaft extending in the vertical direction;
a first movable rail connected to the rotating member; and
a second movable rail connected to the rotating member.

### <B2>

The turntable according to <B1>, further including:
an actuator that rotates the rotating member, wherein
the rotating member is switched between a first rotation state and a second rotation state by actuation of the actuator,
in the first rotation state:
   the first movable rail is connected to a first-direction first fixed rail extending in a first direction; and
   the second movable rail is connected to a first-direction second fixed rail extending in the first direction, and
in the second rotation state:
   the first movable rail is connected to a second-direction first fixed rail extending in a second direction; and
   the second movable rail is connected to a second-direction second fixed rail extending in the second direction.

### <C1>

An architectural structure including:
a first building;
a second building;
a connecting bridge that connects the first building and the second building; and
a rail for a transport vehicle to travel on that extends from inside the first building, across the connecting bridge, and to inside the second building, wherein
the first building includes a first predetermined story and a second predetermined story,
a first space for the transport vehicle to travel in is provided between the ceiling of the first predetermined story and the floor of the second predetermined story of the first building,
the second building includes a first predetermined story and a second predetermined story,
a second space for the transport vehicle to travel in is provided between the ceiling of the first predetermined story and the floor of the second predetermined story of the second building,
the connecting bridge further includes a walkway that connects the floor of the second predetermined story of the first building and the floor of the second predetermined story of the second building,
below the walkway, a third space for the transport vehicle to travel in is provided that connects to the first space and the second space, and
the rail is disposed across the first space, the third space, and the second space.

### <D1>

A rail structure including:
a pair of second rails disposed inside the first building, for the transport vehicle to travel indoors; and
a first rail positioned outside the first building, for the transport vehicle to travel outdoors, wherein
a first region exists for the transport vehicle to transfer from the first rail to the pair of second rails, or from the pair of second rails to the first rail.

### <D2>

The rail structure according to <D1>, wherein
when the first region is viewed from vertically above, the first rail is positioned between the pair of second rails.

### <D3>

The rail structure according to <D2>, wherein
when the first region is viewed from a horizontal direction, the first rail is positioned above the pair of second rails,
when the first region is viewed from the horizontal direction, there is a first part where the distance between the first rail and the pair of second rails increases as it extends in a first direction, and
the first direction is the direction in which the transport vehicle moves from inside the first building to outside the first building.

### <D4>

The rail structure according to <D3>, wherein
in the first part, the height of the first rail from the ground increases as it extends in the first direction.

### <D5>

The rail structure according to <D3>, wherein
in the first part, the height of the pair of second rails from the ground increases as they extend in a second direction, and
the second direction is the direction in which the transport vehicle moves from outside the first building to inside the first building.

### <D6>

An unmanned transport vehicle including:
at least one first wheel; and
at least two second wheels, wherein
the at least one first wheel is for traveling on the first rail, the first rail is positioned outside the first building and is used for the transport vehicle to travel outdoors, and
the at least two second wheels are for traveling on a pair of second rails, the pair of second rails are arranged inside the first building and are used for the transport vehicle to travel indoors.

### <D7>

The transport vehicle according to <D6>, wherein

the transport vehicle is configured to be changeable between a first travel mode in which the at least one first wheel travels along the first rail and a second travel mode in which the at least two second wheels travel along the pair of second rails.

### <E1>

A rail structure including:
a first rail; and
a second rail positioned above the first rail, wherein
when regions that exist sequentially along the direction in which the second rail extends are defined as a first region, a second region, a third region, and a fourth region,
the first rail is located in the second region and the third region,
the second region includes a first slope region in which the distance in the height direction between the first rail and the second rail narrows with increasing distance from the first region, and
in the third region, the first rail includes a first portion in which the distance between the first rail and the second rail increases with increasing distance from the second region when viewed from above in the vertical direction.

### <E2>

The rail structure according to <E1>, wherein
in the first slope region, the first rail is inclined relative to the horizontal direction, and the second rail extends along the horizontal direction.

### <E3>

The rail structure according to <E1> or <E2>, wherein
the first portion includes a first shift portion that connects to a first parallel portion of the first rail while shifting so as to move away from the second rail in the horizontal direction with increasing distance from the second region, and
in the third region, the first parallel portion and the second rail are parallel.

### <E4>

The rail structure according to any one of <E1> to <E3>, wherein
the first portion includes a first curve portion that has a shape that curves in the horizontal direction and changes the traveling direction of the first rail.

### <F1>

A rail structure including:
a first lower rail;
a second lower rail; and
an upper rail positioned above the first lower rail and the second lower rail, wherein
when regions that exist sequentially along the direction in which the upper rail extends are defined as a first region, a second region, a third region, a fourth region, and a fifth region,
the first lower rail is located in the second region and the third region,
the second lower rail is located in the fourth region and the fifth region,
the second region includes a first slope region in which the distance in the height direction between the first lower rail and the upper rail narrows with increasing distance from the first region,
in the third region, the first lower rail includes a first portion in which the distance between the first lower rail and the upper rail increases with increasing distance from the second region when viewed from above in the vertical direction,
the fourth region includes a second slope region in which the distance in the height direction between the second lower rail and the upper rail narrows with increasing distance from the third region, and
in the fifth region, the second lower rail includes a second portion in which the distance between the second lower rail and the upper rail increases with increasing distance from the fourth region when viewed from above in the vertical direction.

### <F2>

The rail structure according to <F1>, wherein
in the first slope region, the first lower rail is inclined relative to the horizontal direction, and the upper rail extends along the horizontal direction, and
in the second slope region, the second lower rail is inclined relative to the horizontal direction, and the upper rail extends along the horizontal direction.

### <F3>

The rail structure according to <F1> or <F2>, wherein
the first portion includes a first shift portion that connects to a first parallel portion of the first lower rail while shifting so as to move away from the upper rail in the horizontal direction with increasing distance from the second region,
in the third region, the first parallel portion and the upper rail are parallel,
the second portion includes a second shift portion that connects to a second parallel portion of the second lower rail while shifting so as to move away from the upper rail in the horizontal direction with increasing distance from the fourth region, and
in the fifth region, the second parallel portion and the upper rail are parallel.

### <F4>

The rail structure according to any one of <F1> to <F3>, wherein
the first portion includes a first curve portion that has a shape that curves in the horizontal direction and changes the traveling direction of the first lower rail, and
the second portion includes a second curve portion that has a shape that curves in the horizontal direction and changes the traveling direction of the second lower rail.

### <G1>

A rail structure including:
a first rail; and
a second rail positioned above the first rail, wherein
when regions that exist sequentially along the direction in which the first rail extends are defined as a first region and a second region,
the second rail is located in the second region,
the second region includes a slope region in which the distance in the height direction between the first rail and the second rail widens with increasing distance from the first region, and
in the second region, the second rail includes a first portion in which the distance between the second rail and the first rail increases with increasing distance from the first region when viewed from above in the vertical direction.

### <G2>

The rail structure according to <G1>, wherein
in the slope region, the first rail extends along the horizontal direction, and the second rail is inclined relative to the horizontal direction.

### <G3>

The rail structure according to <G1> or <G2>, wherein
the first portion includes a curve portion that has a shape that curves in the horizontal direction and changes the traveling direction of the second rail.

### <H1>

A transport vehicle including:
an enclosure;
a first wheel provided on the enclosure;
a first arm including a first end connected to the enclosure;
at least one actuator that actuates the first arm; and
a second wheel connected to a second end of the first arm, wherein
the first wheel is for traveling on a first rail,
the second wheel is for traveling on a second rail positioned above the first rail,
the first arm is switched between a first arm state and a second arm state by actuation of the at least one actuator, in the first arm state, the second wheel is positioned at a first position above the first wheel, and
in the second arm state, the second wheel is positioned at a second position below the first position.

### <H2>

The transport vehicle according to <H1>, wherein
the first arm is further switched to a third arm state by actuation of the at least one actuator, and
in the third arm state, the second wheel is positioned at a third position that is below the first position and above the second position.

### <H3>

The transport vehicle according to <H1> or <H2>, wherein
when the first arm is in the first arm state and the second wheel is traveling on the second rail, when the first wheel travels on the first rail causing the second wheel to separate from the second rail, and
the first arm changes from the first arm state to the second arm state by actuation of the at least one actuator.

### <H4>

The transport vehicle according to any one of <H1> to <H3>, wherein
when the first arm is in the first arm state and the second wheel is traveling on the second rail,
the first arm changes from the first arm state to the third arm state by actuation of the at least one actuator so that the first wheel does not contact the structure.

### <H5>

The transport vehicle according to any one of <H1> to <H4>, wherein
when the first arm is in the first arm state and the second wheel is traveling on the second rail,
the first arm:
   after changing from the first arm state to the third arm state by actuation of the at least one actuator so that the first wheel does not contact the structure,
   changes from the third arm state to the first arm state by actuation of the at least one actuator.

### <I1>

A transport vehicle including:
an enclosure;
a first arm including a first end connected to the enclosure;
one or more first wheels connected to a second end of the first arm;
a second arm including a first end connected to the enclosure;
one or more second wheels connected to a second end of the second arm;
a rotation structure that changes the orientation of the one or more first wheels and the orientation of the one or more second wheels; and
at least one actuator that actuates the first arm, the second arm, and the rotation structure, wherein
the one or more first wheels are for traveling on a rail, and
the one or more second wheels are for traveling on the rail.

### <I2>

The transport vehicle according to <I1>, wherein
the one or more first wheels include a first first wheel and a second first wheel, and
the one or more second wheels include a first second wheel and a second second wheel.

### <I3>

The transport vehicle according to <I1> or <I2>, wherein
the rotation structure varies the degree of change in the orientation of the one or more first wheels and the orientation of the one or more second wheels according to the curvature of curves in the rail.

### <J1>

A structure including:
a wall;
a door pivotably connected to the wall;
a support portion connected to the door; and
a movable rail connected to the support portion for the transport vehicle to travel on, the movable rail pivoting together with the door.

### <J2>

The structure according to <J1>, wherein
The structure is capable of transitioning between a first door state in which the door is in an open state and a second door state in which the door is in a closed state,
in the first door state, the movable rail is coupled to a fixed rail, and
in the second door state, the movable rail is not coupled to the fixed rail.

### <J3>

The structure according to <J1> or <J2>, further including a stopper that prevents movement of the door to maintain the first door state.

### <J4>

The structure according to any one of <J1> to <J3>, wherein
the movable rail includes a first protrusion,
the fixed rail includes a second protrusion, and
in the first door state, the movable rail is coupled to the fixed rail by the first protrusion and the second protrusion contacting each other.

### <J5>

The structure according to any one of <J1> to <J4>, wherein
the door includes a first surface and a second surface,
the movable rail and the support portion are provided on the first surface, and
the structure further includes a counterweight provided on the second surface.

### <K1>

A transport vehicle including:
an enclosure;
a front wheel provided on the enclosure; and
a rear wheel provided on the enclosure.

### <K2>

The transport vehicle according to <K1>, wherein
the front wheel is configured to have an adjustable steering angle.

### <K3>

The transport vehicle according to <K1> or <K2>, wherein
the rear wheel is configured to have a non-adjustable steering angle.

### <K4>

The transport vehicle according to any one of <K1> to <K3>, further including:
a steering device for changing the steering angle of the front wheel.

### <K5>

The transport vehicle according to any one of <K1> to <K4>, wherein
the radius of the front wheel is smaller than the radius of the rear wheel.

### <K6>

The transport vehicle according to any one of <K1> to <K5>, further including:
an arm connected to the enclosure; and
a wheel connected to the leading end side of the arm.

### <K7>

The transport vehicle according to any one of <K1> to <K6>, further including:
at least one actuator that actuates the arm, wherein
the arm is switched between a first arm state and a second arm state by actuation of the at least one actuator,
in the first arm state, the wheel is positioned at a first position above the front wheel and the rear wheel, and
in the second arm state, the wheel is positioned at a second position below the first position.

### <K8>

The transport vehicle according to <K7>, further including:
a controller, wherein
the controller:
   in a case in which the front wheel and the rear wheel are traveling on the first rail from a first section toward a second section, where no second rail is present above the first rail in the first section and the second rail is present above the first rail in the second section,
   when the front wheel and the rear wheel are in the first section, controls the at least one actuator to transition the arm from the second arm state to the first arm state to cause the wheel to travel on the second rail when the second rail is positioned below the wheel.

### <K9>

The transport vehicle according to <K7> or <K8>, wherein
the arm is further switched to a third arm state by actuation of the at least one actuator, and
in the third arm state, the wheel is positioned at a third position that is below the first position and above the second position.

### <K10>

The transport vehicle according to <K8> or <K9>, wherein
the controller:
   after the front wheel and the rear wheel are each traveling on the first rail, and the wheel has separated from the second rail,
   controls the at least one actuator to change the arm from the first arm state to the second arm state.

### <K11>

The transport vehicle according to any one of <K1> to <K10>, wherein
when the enclosure, the front wheel, and the first rail on which the front wheel travels are viewed along the direction in which the axles of the front wheel and the rear wheel are arranged,
the bottom surface of the enclosure is positioned between the front wheel and the position of a contact point where the front wheel contacts the first rail.

### <K12>

The transport vehicle according to <K11>, wherein
when the enclosure, the front wheel, and the first rail are viewed along the direction in which the axles of the front wheel and the rear wheel are arranged,
the distance between the bottom surface of the enclosure and the position of the contact point is greater than or equal to 5 mm and less than or equal to 15 mm.

### <K13>

The transport vehicle according to any one of <K1> to <K12>, wherein
the front wheel includes a first front wheel and a second front wheel,
the front wheel is configured such that the distance between the first front wheel and the second front wheel is adjustable,
the rear wheel includes a first rear wheel and a second rear wheel, and
the rear wheel is configured such that the distance between the first rear wheel and the second rear wheel is adjustable.

### <L1>

A groove structure including:
at least one of (i) a pair of grooves for right turn or (ii) a pair of grooves for left turn; and
a pair of grooves for straight travel, wherein
the width of the pair of grooves for right turn and the width of the pair of grooves for left turn are different from the width of the pair of grooves for straight travel.

### <L2>

The groove structure according to <L1>, wherein
at least one of the depth of the pair of grooves for right turn or the depth of the pair of grooves for left turn is different from the depth of the pair of grooves for straight travel.

### <M1>

An unmanned transport vehicle including:
an enclosure including a first side surface and a second side surface that oppose each other, and a third side surface and a fourth side surface that oppose each other;
a first wheel positioned on the first side surface;
a second wheel positioned on the second side surface;
a third wheel positioned on the third side surface;
a fourth wheel positioned on the fourth side surface; and
at least one actuator that moves the first wheel and the second wheel in the up-down direction.

### <M2>

The unmanned transport vehicle according to <M1>, wherein
the first wheel is for traveling on a first rail,
the second wheel is for traveling on a second rail parallel to the first rail,
the third wheel is for traveling on a third rail, and
the fourth wheel is for traveling on a fourth rail parallel to the third rail.

### <M3>

The unmanned transport vehicle according to <M1> or <M2>, wherein
the first wheel includes a first first wheel and a second first wheel,
the second wheel includes a first second wheel and a second second wheel,
the third wheel includes a first third wheel and a second third wheel, and
the fourth wheel includes a first fourth wheel and a second fourth wheel.

### <M4>

The unmanned transport vehicle according to any one of <M1> to <M3>, wherein
by driving the at least one actuator, the first wheel, the second wheel, the third wheel, and the fourth wheel can be changed between a first state and a second state,
in the first state, the first wheel and the second wheel are positioned below the third wheel and the fourth wheel, and
in the second state, the third wheel and the fourth wheel are positioned below the first wheel and the second wheel.

### <M5>

The unmanned transport vehicle according to any one of <M1> to <M4>, further including:
a control device, wherein
when the first wheel, the second wheel, the third wheel, and the fourth wheel are in the first state, the first wheel is in contact with the first rail, the second wheel is in contact with the second rail, the third wheel is positioned on the third rail, and the fourth wheel is positioned on the fourth rail, the control device changes the first wheel, the second wheel, the third wheel, and the fourth wheel to the second state to cause the third wheel to contact the third rail and cause the fourth wheel to contact the fourth rail.

### <M6>

The unmanned transport vehicle according to any one of <M1> to <M5>, wherein
each of the first wheel, the second wheel, the third wheel, and the fourth wheel includes a flange portion with an enlarged diameter provided on the periphery of the wheel.

### <M7>

The unmanned transport vehicle according to any one of <M1> to <M6>, wherein
the first wheel and the second wheel are configured such that distance between the first wheel and the second wheel is adjustable.

For example, this may be realized by configuring a shaft connected to the first wheel and the second wheel to be extendable.

### <M8>

The unmanned transport vehicle according to <M7>, wherein
the third wheel and the fourth wheel are configured such that distance between the third wheel and the fourth wheel is adjustable.

For example, this may be realized by configuring a shaft connected to the third wheel and the fourth wheel to be extendable.

### <M9>

The unmanned transport vehicle according to any one of <M1> to <M8>, wherein
the enclosure has a first length in a first direction that is longer than a second length in a second direction orthogonal to the first direction.

The enclosure may have an approximately rectangular shape when viewed from above in the vertical direction.

### <N1>

An elevator provided in a building, the elevator including:
an elevator carriage that moves up and down;
a partition that divides a space within the elevator carriage into a first space for a person to board and a second space for an unmanned transport vehicle to board; and
an elevator rail arranged in the second space, wherein
the unmanned transport vehicle travels along the elevator rail, and
the elevator rail includes:
   at least one first elevator rail that extends in a first direction; and
   at least one second elevator rail that extends in a second direction intersecting the first direction.

### <N2>

The elevator according to <N1>, further including a rail lifting device that raises and lowers the elevator rail.

### <N3>

The elevator according to <N1> or <N2>, wherein
the elevator rail includes a movable rail,
the elevator further includes an actuator that moves the movable rail,
the movable rail is switched between a first rail state and a second rail state by actuation of the actuator,
in the first rail state, a first end of the movable rail is connected to a second end of a story rail provided on a predetermined story of the building, and
in the second rail state, the first end is not connected to the second end.

### <N4>

The elevator according to any one of <N1> to <N3>, wherein
at least one first elevator rail that extends in a first direction includes:
a first pair of rails corresponding to a first width; and
a second pair of rails corresponding to a second width different from the first width.

### <N5>

The elevator according to <N4>, wherein
the enclosure has a first length in a first direction that is longer than a second length in a second direction orthogonal to the first direction.

### <O1>

An elevator system including:
an elevator provided in a building; and
a control device, wherein
the elevator includes:
   an elevator carriage that moves up and down;
   a partition that divides a space within the elevator carriage into a first space for a person to board and a second space for an unmanned transport vehicle to board; and
   an elevator rail arranged in the second space,
the unmanned transport vehicle travels along the elevator rail, and
the control device controls a plurality of the unmanned transport vehicles positioned within the second space to rearrange the plurality of unmanned transport vehicles so that the plurality of unmanned transport vehicles achieve a target arrangement.

### <O2>

The elevator system according to <O1>, wherein
the target arrangement is an arrangement in which a plurality of predetermined unmanned transport vehicles are positioned at locations where they can easily move to the outside of the elevator through an opening formed in the elevator carriage that leads to the second space.

### <O3>

The elevator system according to <O1> or <O2>, wherein
the changing to the target arrangement is performed while the elevator carriage is moving.

### <O4>

The elevator system according to any one of <O1> to <O3>, wherein
the elevator rail includes:
   at least one first elevator rail that extends in a first direction; and
   at least one second elevator rail that extends in a second direction intersecting the first direction.

### <O5>

The elevator system according to at least one of <O1> to <O4>, wherein
the elevator rail forms a plurality of tiers,
the elevator system further includes a rail lifting device that raises and lowers at least one tier of the plurality of tiers,
when the plurality of tiers are viewed from vertically above,
the plurality of tiers are divided into a first area and a second area, and
the rail lifting device is configured to change the positional relationship in the up-down direction between the plurality of tiers that correspond to the first area and the plurality of tiers that correspond to the second area.

### <O6>

The elevator system according to any one of <O1> to <O5>, wherein
the plurality of tiers include a first tier and a second tier located below the first tier, and
the control device controls the rail lifting device when the height of the first tier that corresponds to the first area and the height of the first tier that corresponds to the second area match, to change the positional relationship in the up-down direction between the plurality of tiers that correspond to the first area and the plurality of tiers that correspond to the second area, so as to align the height of the first tier that corresponds to the first area and the height of the second tier that corresponds to the second area.

### <O7>

The elevator system according to <O5> or <O6>, wherein
the target arrangement is an arrangement in which a plurality of predetermined unmanned transport vehicles are positioned on a predetermined tier.

### <O8>

The elevator system according to <O5> or <O6>, wherein
the control device controls a plurality of predetermined unmanned transport vehicles to move the plurality of predetermined unmanned transport vehicles to a predetermined tier, and then controls the plurality of unmanned transport vehicles to rearrange the plurality of unmanned transport vehicles so that the plurality of unmanned transport vehicles achieve the target arrangement, and
the target arrangement is an arrangement in which the plurality of predetermined unmanned transport vehicles are positioned at locations where they can easily move to the outside of the elevator through an opening formed in the elevator carriage that leads to the second space.

### <O9>

The elevator system according to any one of <O1> to <O7>, wherein
the plurality of tiers include a first tier and a second tier located below the first tier, and
the control device controls the rail lifting device when the height of the second tier that corresponds to the first area and the height of the first tier that corresponds to the second area match, to change the positional relationship in the up-down direction between the plurality of tiers that correspond to the first area and the plurality of tiers that correspond to the second area, so as to align the height of the second tier that corresponds to the first area and the height of the second tier that corresponds to the second area.

### <O10>

The elevator system according to any one of <O1> to <O8>, wherein
the elevator rail includes:
a plurality of first elevator rails that extend in a first direction; and
a plurality of second elevator rails that extend in a second direction intersecting the first direction,
N (where N is a natural number of 2 or more) stopping areas where the unmanned transport vehicle stops are defined by the elevator rail, and
the control device causes N−1 or fewer of the unmanned transport vehicles to board the second space.

This makes it possible to rearrange the plurality of unmanned transport vehicles since at least one empty space is created in the stopping area.

### <O11>

The elevator system according to <O2> or <O8>, wherein
an arrangement in which the plurality of predetermined unmanned transport vehicles are positioned at locations where they can easily move to the outside of the elevator through an opening formed in the elevator carriage that leads to the second space is an arrangement in which, when the plurality of predetermined unmanned transport vehicles move to the outside, the plurality of unmanned transport vehicles other than the plurality of predetermined unmanned transport vehicles do not obstruct movement by the plurality of predetermined unmanned transport vehicles.

### <O12>

The elevator system according to any one of <O2>, <O8>, and <O11>, wherein
an arrangement in which the plurality of predetermined unmanned transport vehicles are positioned at locations where they can easily move to the outside of the elevator through an opening formed in the elevator carriage that leads to the second space is an arrangement in which the plurality of predetermined unmanned transport vehicles form a line from the front side of the elevator toward the rear side of the elevator.

### <P1>

An elevator system including:
an elevator provided in a building; and
a control device, wherein
the elevator includes:
   an elevator carriage that moves up and down;
   a partition that divides a space within the elevator carriage into a first space for a person to board and a second space for an unmanned transport vehicle to board;
   an elevator rail that includes a movable rail and is arranged in the second space; and
   an actuator that moves the movable rail,
the unmanned transport vehicle travels along the elevator rail,
the movable rail is switched between a first rail state and a second rail state by actuation of the actuator,
in the first rail state, a first end of the movable rail is connected to a second end of a story rail provided in a boarding and alighting area for an unmanned transport vehicle on a predetermined story of the building,
in the second rail state, the first end is not connected to the second end, and
the control device controls a plurality of the unmanned transport vehicles positioned within the boarding and alighting area to rearrange the plurality of unmanned transport vehicles so that the plurality of unmanned transport vehicles achieve a target arrangement.

### <P2>

The elevator system according to <P1>, wherein
the target arrangement is an arrangement in which a plurality of predetermined unmanned transport vehicles form groups,
the groups include:
   a first group that includes unmanned transport vehicles scheduled to board the elevator heading in the first direction; and
   a second group that includes unmanned transport vehicles scheduled to board the elevator heading in a direction opposite to the first direction, and
the first direction indicates an upward direction or a downward direction.

### <P3>

The elevator system according to <P1> or <P2>, wherein
the target arrangement is an arrangement in which a plurality of predetermined unmanned transport vehicles form groups, and
in the groups, unmanned transport vehicles scheduled to alight at stories farther from the predetermined story are positioned closer to the entrance side of the elevator.

### <P4>

The elevator system according to any one of <P1> to <P3>, wherein
the target arrangement is an arrangement in which a plurality of predetermined unmanned transport vehicles form groups, and
in the groups, unmanned transport vehicles scheduled to alight at a later timing are positioned closer to the entrance side of the elevator.

### <P5>

The elevator system according to any one of <P1> to <P4>, further including
a carriage door that opens and closes an opening that is provided in the elevator carriage and leads to the second space, wherein
the rearrangement of the plurality of unmanned transport vehicles is performed between when the elevator arrives at the predetermined story and before the carriage door opens.

### <P6>

The elevator system according to any one of <P1> to <P5>, wherein
the elevator rail includes, in each tier of the plurality of tiers:
   at least one first elevator rail that extends in a first direction; and
   at least one second elevator rail that extends in a second direction intersecting the first direction.

### <P7>

The elevator system according to any one of <P1> to <P6>, wherein
the story rail includes:
   at least one first story rail that extends in a first direction; and
   at least one second story rail that extends in a second direction intersecting the first direction.

### <Q1>

An elevator including:
an elevator carriage that moves up and down;
a partition that divides a space within the elevator carriage into a first space for a person to board and a second space for an unmanned transport vehicle to board; and
a control device.

### <Q2>

The elevator according to <Q1>, wherein
the control device does not stop the elevator carriage at stories where the unmanned transport vehicle is scheduled to alight when the person is boarded in the first space and the unmanned transport vehicle is boarded in the second space.

### <Q3>

The elevator according to <Q1> or <Q2>, wherein
the control device stops the elevator carriage at stories where the unmanned transport vehicle is scheduled to alight when the person is not boarded in the first space and the unmanned transport vehicle is boarded in the second space.

### <Q4>

The elevator according to any one of <Q1> to <Q3>, further including:
a first carriage door that opens and closes an opening that is provided in the elevator carriage and leads to the first space; and
a second carriage door that opens and closes an opening that is provided in the elevator carriage and leads to the second space.

### <Q5>

The elevator according to any one of <Q1> to <Q4>, wherein
the control device:
   when the person is boarded in the first space and the unmanned transport vehicle is boarded in the second space, opens the first carriage door and opens the second carriage door when the person and the unmanned transport vehicle alight at a predetermined story; and
when the person is boarded in the first space and the unmanned transport vehicle is not boarded in the second space, opens the first carriage door and keeps the second carriage door closed when the person alights at the predetermined story.

### <Q6>

The elevator according to any one of <Q1> to <Q5>, wherein
when the person is boarded in the first space and the unmanned transport vehicle is boarded in the second space, the control device keeps the first carriage door closed and opens the second carriage door when the unmanned transport vehicle alights at a predetermined story.

### <Q7>

The elevator according to <Q6>, further including:
a display, wherein
when the first carriage door is kept closed and the second carriage door is open, the display displays that the elevator is stopped for the unmanned transport vehicle.

### <Q8>

The elevator according to <Q6> or <Q7>, further including:
a loudspeaker, wherein
when the first carriage door is kept closed and the second carriage door is open, an announcement that the elevator is stopped for the unmanned transport vehicle is output from the loudspeaker.

### <R1>

An elevator provided in a building, the elevator including:
an elevator carriage that moves up and down;
a partition that divides a space within the elevator carriage into a first space for a person to board and a second space for an unmanned transport vehicle to board;
an elevator rail that forms a plurality of tiers and is arranged in the second space; and
a rail lifting device that raises and lowers at least one tier of the plurality of tiers, wherein
the unmanned transport vehicle travels along the elevator rail.

### <R2>

The elevator according to <R1>, wherein
the plurality of tiers include a first tier and a second tier located below the first tier.

### <R3>

The elevator according to <R1> or <R2>, wherein
the raising and lowering of the at least one tier of the plurality of tiers by the rail lifting device is performed while the elevator carriage is moving.

### <R4>

The elevator according to any one of <R1> to <R3>, wherein
the rail lifting device is configured to change a distance between the elevator rail and a ceiling of the second space according to a story height of each story of the building.

### <R5>

The elevator according to any one of <R1> to <R4>, wherein
when the plurality of tiers are viewed from vertically above, the plurality of tiers are divided into a first area and a second area, and
the rail lifting device is configured to change the positional relationship in the up-down direction between the plurality of tiers that correspond to the first area and the plurality of tiers that correspond to the second area.

### <R6>

The elevator according to any one of <R1> to <R5>, wherein
the plurality of tiers that correspond to the first area are fixed to the elevator carriage, and
the rail lifting device includes an actuator that moves the plurality of tiers that correspond to the second area in the up-down direction.

### <R7>

The elevator according to any one of <R1> to <R6>, further including
a control device that controls the rail lifting device, wherein
the plurality of tiers include a first tier and a second tier located below the first tier, and
the control device controls the rail lifting device when the height of the first tier that corresponds to the first area and the height of the first tier that corresponds to the second area match, to change the positional relationship in the up-down direction between the plurality of tiers that correspond to the first area and the plurality of tiers that correspond to the second area, so as to align the height of the first tier that corresponds to the first area and the height of the second tier that corresponds to the second area.

### <R8>

The elevator according to any one of <R1> to <R7>, wherein
changing the positional relationship in the up-down direction between the plurality of tiers that correspond to the predetermined area and the plurality of tiers that correspond to the second area is performed after the unmanned transport vehicle has boarded the predetermined area.

### <R9>

The elevator system according to any one of <R1> to <R8>, wherein
the elevator rail includes, in each tier of the plurality of tiers:
   at least one first elevator rail that extends in a first direction; and
   at least one second elevator rail that extends in a second direction intersecting the first direction.

### <R10>

The elevator according to any one of <R1> to <R9>, wherein
an area of the first area is smaller than an area of the second area.

### <R11>

The elevator according to any one of <R1> to <R9>, wherein
an area of the second area is smaller than an area of the first area.

### <R12>

The elevator according to any one of <R1> to <R5> and <R6> to <R11>, wherein
the rail lifting device includes:
   a first actuator that moves the plurality of tiers that correspond to the first area in the up-down direction; and
   a second actuator that moves the plurality of tiers that correspond to the second area in the up-down direction.

### <R13>

The elevator according to any one of <R1> to <R6> and <R7> to <R12>, further including:
a control device that controls the rail lifting device, wherein
the plurality of tiers include a first tier and a second tier located below the first tier, and
the control device controls the rail lifting device when the height of the second tier that corresponds to the first area and the height of the first tier that corresponds to the second area match, to change the positional relationship in the up-down direction between the plurality of tiers that correspond to the first area and the plurality of tiers that correspond to the second area, so as to align the height of the second tier that corresponds to the first area and the height of the second tier that corresponds to the second area.

### <R14>

The elevator according to any one of <R1> to <R13>, wherein
the plurality of tiers include a first tier and a second tier located below the first tier, and a third tier located below the second tier.

### <R15>

The elevator according to any one of <R1> to <R14>, wherein
the elevator rail includes a movable rail,
the elevator further includes an actuator that moves the movable rail,
the movable rail is switched between a first rail state and a second rail state by actuation of the actuator,
in the first rail state, a first end of the movable rail is connected to a second end of a story rail provided on a predetermined story of the building,
in the second rail state, the first end is not connected to the second end, and
the movable rail is provided in each of the plurality of tiers.

### <R16>

The elevator according to <R15>, wherein
the plurality of tiers include a first tier and a second tier located below the first tier, and
on a first predetermined story corresponding to a first story height, the movable rail of the first tier is used, and
on a second predetermined story corresponding to a story height lower than the first story height, the movable rail of the second tier is used.

### <R17>

The elevator according to any one of <R1> to <R16>, wherein
when the plurality of tiers are viewed from vertically above, the plurality of tiers are divided into a first area and a second area,
the rail lifting device is configured to change the positional relationship in the up-down direction between the plurality of tiers that correspond to the first area and the plurality of tiers that correspond to the second area,
the plurality of tiers that correspond to the first area are fixed to the elevator carriage,
the rail lifting device includes an actuator that moves the plurality of tiers that correspond to the second area in the up-down direction,
the elevator rail includes, in each tier of the plurality of tiers, at least one first elevator rail that extends in a first direction,
the first direction is a direction that extends from a front side of the elevator to a rear side of the elevator, and
when the plurality of tiers are viewed from vertically above, the first area is positioned on a rear side of the elevator, and the second area is positioned on a front side of the elevator.

### <R18>

The elevator according to any one of <R1> to <R16>, wherein
when the plurality of tiers are viewed from vertically above, the plurality of tiers are divided into a first area and a second area,
the rail lifting device is configured to change the positional relationship in the up-down direction between the plurality of tiers that correspond to the first area and the plurality of tiers that correspond to the second area,
the elevator rail includes, in each tier of the plurality of tiers:
   at least one first elevator rail that extends in a first direction; and
   at least one second elevator rail that extends in a second direction intersecting the first direction,
the first direction is a direction that extends from a front side of the elevator to a rear side of the elevator, and
when the plurality of tiers are viewed from vertically above, the first area extends along the first direction.

With this, the first area, which functions as a buffer region for temporarily placing packages, is aligned with the direction of package entry and exit, for example, the direction extending from the rear side of the elevator to the front side (hereinafter the first direction). Therefore, a plurality of unmanned transport vehicles can be made to wait in the first area in a formation that forms a line along the first direction. Furthermore, the plurality of unmanned transport vehicles made to wait in the first area can be moved laterally, for example, in a direction that intersects the first direction at a right angle, and moved to the second area other than the first area. Here, the plurality of unmanned transport vehicles that have moved to the second area are aligned in a line along the first direction. Therefore, the plurality of unmanned transport vehicles that have moved to the second area can move directly toward the outside of the elevator while aligned in a line along the first direction. Thus, according to the above aspect, a plurality of unmanned transport vehicles can be efficiently transported out of the elevator.

### <R19>

The elevator according to <R18>, wherein
the plurality of tiers that correspond to the first area are fixed to the elevator carriage, and
the rail lifting device includes an actuator that moves the plurality of tiers that correspond to the second area in the up-down direction.

### <S1>

An unmanned transport vehicle system including:
at least one unmanned transport vehicle; and
a control device, wherein
the at least one unmanned transport vehicle includes:
   an RFID reader; and
   a sensor.

### <S2>

The unmanned transport vehicle system according to <S1>, wherein
The sensor includes any one of an ultrasonic sensor, an optical sensor, or a laser sensor.

### <S3>

The unmanned transport vehicle system according to <S1> or <S2>, wherein
the control device identifies the position of a predetermined unmanned transport vehicle based on information indicating an RFID signal from an RFID tag obtained by the RFID reader of the predetermined unmanned transport vehicle, and information indicating a sensing result by the sensor of the predetermined unmanned transport vehicle.

### <S4>

The unmanned transport vehicle system according to any one of <S1> to <S3>, wherein
the at least one unmanned transport vehicle includes:
   a first unmanned transport vehicle and a second unmanned transport vehicle, and
the control device identifies the position of the first unmanned transport vehicle and/or the second unmanned transport vehicle based on (i) information indicating an RFID signal from an RFID tag obtained by the RFID reader of the first unmanned transport vehicle and/or information indicating an RFID signal from an RFID tag obtained by the RFID reader of the second unmanned transport vehicle, (ii) information indicating a sensing result by the sensor of the first unmanned transport vehicle, and (iii) information indicating a sensing result by the sensor of the second unmanned transport vehicle.

### <T1>

An elevator provided in a building, the elevator including:
an elevator carriage that moves up and down;
a partition that divides a space within the elevator carriage into a first space for a person to board and a second space for an unmanned transport vehicle to board;
an elevator rail arranged in the second space; and
a first carriage door that opens and closes an opening that is provided in the elevator carriage and leads to the first space, wherein
the unmanned transport vehicle travels along the elevator rail,
when the elevator is viewed from vertically above, the first carriage door is positioned on any one of the front side, lateral sides, or rear side of the elevator.

### <T2>

The elevator according to <T1>, further including:
a second carriage door that opens and closes an opening that is provided in the elevator carriage and leads to the second space, wherein
when the elevator is viewed from vertically above, the second carriage door is positioned on any one of the front side, lateral sides, or rear side of the elevator.

### <T3>

The elevator according to <T1> or <T2>, wherein
the second carriage door is provided at a location that does not face the location where the counterweight of the elevator is provided.

The counterweight of the elevator may be a counterweight having a weight corresponding to the weight of the elevator (for example, a balancer).

### <T4>

The elevator according to any one of <T1> to <T3>, wherein
the elevator rail includes a movable rail,
the elevator further includes an actuator that moves the movable rail,
the movable rail is switched between a first rail state and a second rail state by actuation of the actuator,
in the first rail state, a first end of the movable rail is connected to a second end of a story rail provided on a predetermined story of the building, and
in the second rail state, the first end is not connected to the second end.

### <T5>

The elevator according to any one of <T1> to <T4>, wherein
the elevator rail includes:
   at least one first elevator rail that extends in a first direction; and
   at least one second elevator rail that extends in a second direction intersecting the first direction.

### <T6>

The elevator according to any one of <T1> to <T5>, further including:
a second carriage door that opens and closes an opening that is provided in the elevator carriage and leads to the second space, wherein
when the elevator is viewed from vertically above,
the first carriage door is positioned on a front side of the elevator, and
the second carriage door is positioned on a front side of the elevator.

### <T7>

The elevator according to any one of <T1> to <T5>, further including:
a second carriage door that opens and closes an opening that is provided in the elevator carriage and leads to the second space, wherein
when the elevator is viewed from vertically above,
the first carriage door is positioned on a front side of the elevator, and
the second carriage door is positioned on a rear side of the elevator.

### <T8>

The elevator according to any one of <T1> to <T5>, further including:
a second carriage door that opens and closes an opening that is provided in the elevator carriage and leads to the second space, wherein
when the elevator is viewed from vertically above,
the first carriage door is positioned on a front side of the elevator, and
the second carriage door is positioned on a lateral side of the elevator.

### <T9>

An elevator system including:
an elevator provided in a building, wherein
the elevator is provided in a building, and includes:
   an elevator carriage that moves up and down;
   a partition that divides a space within the elevator carriage into a first space for a person to board and a second space for an unmanned transport vehicle to board;
   an elevator rail arranged in the second space;
   a first carriage door that opens and closes an opening that is provided in the elevator carriage and leads to the first space;
   a second carriage door that opens and closes an opening that is provided in the elevator carriage and leads to the second space; and
   a third carriage door that opens and closes an opening that is provided in the elevator carriage and leads to the second space, wherein
the unmanned transport vehicle travels along the elevator rail,
when the elevator is viewed from vertically above,
the first carriage door is positioned on a front side of the elevator,
the second carriage door is positioned on a front side of the elevator, and
the third carriage door is positioned on a lateral side or a rear side of the elevator.

### <T10>

The elevator system according to <T9>, further including:
at least one actuator that opens and closes the first carriage door, the second carriage door, and the third carriage door; and
a control device that controls the actuator, wherein
the control device controls the at least one actuator to open the third carriage door when the elevator arrives at a predetermined story and the unmanned transport vehicle cannot enter or exit via the second carriage door.

### <T11>

The elevator according to <T9> or <T10>, wherein
the elevator rail includes a movable rail,
the elevator further includes an actuator that moves the movable rail,
the movable rail is switched between a first rail state and a second rail state by actuation of the actuator,
in the first rail state, a first end of the movable rail is connected to a second end of a story rail provided on a predetermined story of the building, and
in the second rail state, the first end is not connected to the second end.

### <U1>

A system including an unmanned transport vehicle, the system including:
the unmanned transport vehicle;
a first winch connected to the unmanned transport vehicle and capable of reeling out and in a wire;
a package carriage connected to the wire, for putting a package to be transported by the unmanned transport vehicle into; and
a controller, wherein
the package carriage includes an accommodation space for accommodating the package,
when the accommodation space is viewed from vertically above, the accommodation space is divided into a first space for a first package and a second space for a second package.

### <U2>

The system according to <U1>, further including:
a controller, wherein
the package carriage includes an attitude control device including a flywheel that rotates around a rotary shaft extending in a vertical direction,
the controller:
   obtains a sensing result from a sensor capable of detecting the attitude of the package carriage; and
   based on the sensing result obtained, controls rotation of the flywheel to rotate the package carriage around the rotary shaft and orient the package carriage to a target attitude.

### <U3>

The system according to <U1> or <U2>, wherein
the package box includes:
   a first opening and closing lid provided on a first side surface and leading to the first space; and
   a second opening and closing lid provided on a second side surface opposite the first side surface and leading to the second space.

### <V1>

An elevator system including:
an elevator provided in a building;
a story rail that forms a plurality of tiers and is provided in a boarding and alighting area for an unmanned transport vehicle on a predetermined story of the building; and
a control device, wherein
the elevator includes:
   an elevator carriage that moves up and down;
   a partition that divides a space within the elevator carriage into a first space for a person to board and a second space for the unmanned transport vehicle to board; and
   an elevator rail that forms a plurality of tiers and is arranged in the second space, and
the unmanned transport vehicle travels along the elevator rail.

### <V2>

The elevator system according to <V1>, wherein
the elevator rail further includes a movable rail,
the elevator further includes an actuator that moves the movable rail,
the movable rail is switched between a first rail state and a second rail state by actuation of the actuator,
in the first rail state, a first end of the movable rail is connected to a second end of the story rail, and
in the second rail state, the first end is not connected to the second end.

### <V3>

The elevator system according to <V1> or <V2>, further including:
a rail lifting device that raises and lowers at least one tier of the plurality of tiers of the story rail.

### <V4>

The elevator according to any one of <V1> to <V3>, wherein
the rail lifting device is configured to change a distance between the elevator rail and a ceiling of the second space according to a story height of each story of the building.

### <W1>

An elevator system including:
an elevator provided in a building; and
a story rail provided in a boarding and alighting area for an unmanned transport vehicle on a predetermined story of the building, wherein
the elevator includes:
   an elevator carriage that moves up and down; and
   a partition that divides a space within the elevator carriage into a first space for a person to board and a second space for the unmanned transport vehicle to board, wherein
the unmanned transport vehicle travels along the elevator rail,
the elevator further includes:
   a first carriage door that opens and closes an opening that is provided in the elevator carriage and leads to the first space; and
   a second carriage door that opens and closes an opening that is provided in the elevator carriage and leads to the second space,
the first carriage door opens and closes in a horizontal direction, and
the second carriage door opens and closes in a vertical direction.

The second carriage door is, for example, a shutter.

### <W2>

The elevator system according to <W1>, wherein
when the elevator system is viewed from the front,
a horizontal length of an opening formed when the second carriage door is open is greater than a horizontal length of an opening formed when the first carriage door is open.

### <X1>

A rail structure including:
a plurality of first rails that extend in a first direction; and
a plurality of second rails that extend in a second direction intersecting the first direction, wherein
the plurality of first rails include:
   a first pair of rails corresponding to a first width; and
   a second pair of rails corresponding to a second width different from the first width.

### <X2>

The rail structure according to <X1>, wherein
the plurality of second rails further include a pair of rails corresponding to a third width.

### <X3>

The rail structure according to <X2>, wherein
the first width and the third width are equal.

### <X4>

An elevator system including:
an elevator provided in a building; and
a control device, wherein
the elevator includes:
   an elevator carriage that moves up and down;
   a partition that divides a space within the elevator carriage into a first space for a person to board and a second space for an unmanned transport vehicle to board;
   an elevator rail that includes a movable rail and is arranged in the second space; and
   an actuator that moves the movable rail,
the unmanned transport vehicle travels along the elevator rail,
the movable rail is switched between a first rail state and a second rail state by actuation of the actuator,
in the first rail state, a first end of the movable rail is connected to a second end of a story rail provided in a boarding and alighting area for an unmanned transport vehicle on a predetermined story of the building,
in the second rail state, the first end is not connected to the second end,
the story rail includes:
   a plurality of first rails that extend in a first direction; and
   a plurality of second rails that extend in a second direction intersecting the first direction, and
the plurality of first rails include:
   a first pair of rails corresponding to a first width; and
   a second pair of rails corresponding to a second width different from the first width.

### <X5>

The elevator system according to <X4>, wherein
the enclosure has a first length in a first direction that is longer than a second length in a second direction orthogonal to the first direction.

### <Y1>

A rail structure including:
a first rail;
a second rail;
a first structure connected to the first rail and including a first part that protrudes; and
a second structure connected to the second rail and including a second part into which the protruding part fits.

### <Y2>

The rail structure according to <Y1>, wherein
the first rail or the second rail includes a fixed portion, a movable portion, and a connection portion that connects the fixed portion and the movable portion,

### <Y3>

An elevator system including:
an elevator provided in a building; and
a control device, wherein
the elevator includes:
   an elevator carriage that moves up and down;
   a partition that divides a space within the elevator carriage into a first space for a person to board and a second space for an unmanned transport vehicle to board;
   an elevator rail that includes a movable rail and is arranged in the second space; and
   an actuator that moves the movable rail,
the unmanned transport vehicle travels along the elevator rail,
the movable rail is switched between a first rail state and a second rail state by actuation of the actuator,
in the first rail state, a first end of the movable rail is connected to a second end of a story rail provided in a boarding and alighting area for an unmanned transport vehicle on a predetermined story of the building,
in the second rail state, the first end is not connected to the second end,
a first structure including a first part that protrudes is connected to the elevator rail,
a second structure including a second part into which the protruding portion fits is connected to the story rail, and
when transitioning from the first state to the second state, the first part fits into the second part, bringing the height of the first end and the height of the second end closer together.

### <Y4>

The elevator system according to <Y3>, wherein
the story rail further includes a fixed portion, a movable portion, and a connection portion that connects the fixed portion and the movable portion, and
by the movable portion being movable by the connection portion, the height of the first end and the height of the second end are brought closer together.

### <Y5>

The elevator system according to <Y3> or <Y4>, wherein
the elevator rail further includes a fixed portion, a movable portion, and a connection portion that connects the fixed portion and the movable portion, and
by the movable portion being movable by the connection portion, the height of the first end and the height of the second end are brought closer together.

### <Z1>

An elevator provided in a building, the elevator including:
an elevator carriage that moves up and down;
a partition that divides a space within the elevator carriage into a first space for a person to board and a second space for an unmanned transport vehicle to board; and
an elevator rail arranged in the second space, wherein
the unmanned transport vehicle travels along the elevator rail,
the elevator rail includes:
   at least one first elevator rail that extends in a first direction; and
   at least one second elevator rail that extends in a second direction intersecting the first direction,
the elevator rail includes a movable rail,
the elevator further includes an actuator that moves the movable rail,
the movable rail is switched between a first rail state and a second rail state by actuation of the actuator,
in the first rail state, a first end of the movable rail is connected to a second end of a story rail provided on a predetermined story of the building,
in the second rail state, the first end is connected to the second end, and
in the second rail state, a boarding-only lane for the unmanned transport vehicle to board the elevator and an alighting-only lane for the unmanned transport vehicle to alight from the elevator to the predetermined story are formed.

### <Z2>

The elevator according to <Z1>, wherein
the boarding-only lane and the alighting-only lane are formed by the movable rail.

Hereinbefore, the elevator, the transport vehicle, the rail structure, the architectural structures, the turntable, and the delivery system according to the present disclosure have been described based on the above embodiments, but the present disclosure is not limited to these embodiments. Various modifications that may be conceived by those skilled in the art and applied to the above embodiments and variations may also be included in the present disclosure as long as they do not depart from the essence of the present disclosure.

For example, the content of arm state changes and the timing for changing the arm state may be determined based on predetermined information including current position information of a transport vehicle such as unmanned transport vehicle 100 or 110. The predetermined information may further include information indicating a current arm state, information indicating a destination, or information indicating a route of the rail. The aforementioned determination may be made by the transport vehicle, or may be made by a computer other than the transport vehicle, and the transport vehicle may obtain information indicating arm state changes and/or timing from the computer via a network. The current position information of the transport vehicle may be obtained by any means. For example, the current position information of the transport vehicle may be obtained by utilizing a Global Navigation Satellite System (GNSS). The current position information of the transport vehicle may be obtained by utilizing an optical sensor provided in the transport vehicle. Data including identification information or position information of the rail may be recorded on the rail, and the current position information of the transport vehicle may be obtained by reading this data with a sensor provided on the transport vehicle. At this time, technologies used for writing data to recording media such as optical drives like CD-ROM or magnetic disks may be used. The current position information of the transport vehicle may be obtained by using wireless communication technology including short-range wireless communication. The current position information of the transport vehicle may be obtained by utilizing a database that correlates tire rotation speed with travel distance to estimate the distance traveled from a predetermined location. Furthermore, the current position information of the transport vehicle may be obtained by utilizing a camera provided on the transport vehicle. The current position information of the transport vehicle may be obtained by using technology for detecting the current position of trains or vehicles in railways, for example, track circuits.

In the above embodiment, each element may be configured using dedicated hardware, or may be implemented by executing a software program suitable for the element. Each element may be implemented by a program executing unit, such as a central processing unit (CPU) or a processor, reading and executing a software program recorded on a recording medium, such as a hard disk or a semiconductor memory.

Note that the following cases are also included in the present disclosure.

(1) The at least one device or system described above is specifically a computer system that includes a microprocessor, ROM, random access memory (RAM), a hard disk unit, a display unit, a keyboard, and a mouse, for instance. A computer program is stored in the RAM or the hard disk unit. The at least one device or system described above achieves its functionality by the microprocessor operating in accordance with the computer program. Here, the computer program includes a combination of instruction codes indicating instructions to a computer in order to achieve predetermined functionality.

(2) Some or all of the elements included in the at least one device or system described above may include a single system large scale integration (LSI) circuit. A system LSI circuit is ultra-multifunctional LSI circuit manufactured by integrating a plurality of processing units on a single chip, and specifically, is a computer system including a microprocessor, ROM, RAM and the like. The RAM stores a computer program. The microprocessor operates in accordance with the computer program, thereby enabling the system LSI circuit to achieve its functionality.

(3) Some or all of the elements included in at least one device or system described above may include an IC card or a standalone module which can be attached to or detached from the device or system. The IC card or module is a computer system including a microprocessor, ROM, RAM, and any other suitable elements. The IC card or module may include the above-described ultra-multifunctional LSI circuit. The IC card or module achieves its functionality by the microprocessor operating in accordance with the computer program. The IC card or the module may be tamper resistant.

(4) The present disclosure may be a method described above. The present disclosure may be a computer program that realizes such a method using a computer or a digital signal that includes the computer program.

The present disclosure may also be a computer program or digital signal stored on a computer-readable recording medium, examples of which include a flexible disk, a hard disk, a compact disc (CD)-ROM, a DVD, a DVD-ROM, a DVD-RAM, a Blu-ray (registered trademark) disc (BD), semiconductor memory, and other media. Alternatively, one or more of the elements may be realized as a digital signal recorded on such a recording medium.

The present disclosure may also be realized by transmitting the computer program or digital signal over an electrical communication line, a wireless or wired communication line, a network typified by the Internet, or via data broadcasting, for instance.

The present disclosure may be implemented by another independent computer system by recording the program or digital signal on the recording medium and transferring it, or by transferring the program or digital signal via the network or the like.

### INDUSTRIAL APPLICABILITY

The elevator according to the present disclosure is applicable to systems that perform, for example, transportation of packages and people.

1. An elevator provided in a building, the elevator comprising:
an elevator carriage that moves up and down;
a partition that divides a space within the elevator carriage into a first space for a person to board and a second space for an unmanned transport vehicle to board;
an elevator rail that includes a movable rail and is arranged in the second space; and
an actuator that moves the movable rail, wherein
the unmanned transport vehicle travels along the elevator rail,
the movable rail is switched between a first rail state and a second rail state by actuation of the actuator,
in the first rail state, a first end of the movable rail is connected to a second end of a story rail provided on a predetermined story of the building, and
in the second rail state, the first end is not connected to the second end.

2. The elevator according to claim 1, further comprising:
a first carriage door that opens and closes an opening that is provided in the elevator carriage and leads to the first space; and
a second carriage door that opens and closes an opening that is provided in the elevator carriage and leads to the second space.

3. The elevator according to claim 2, wherein
the first carriage door and the second carriage door are integrated as a single unit.

4. The elevator according to claim 1, wherein
the second space is positioned above the first space, and
the elevator rail is provided on a ceiling of the second space.

5. The elevator according to claim 1, wherein
the unmanned transport vehicle includes:
a package carriage connected to a wire; and
a winch capable of reeling out and reeling in the wire.

6. The elevator according to claim 1, wherein
the elevator rail further includes a fixed rail, and
the movable rail is switched from the second rail state to the first rail state by sliding relative to the fixed rail and stopping at a predetermined position.

7. The elevator according to claim 1, further comprising:
a second partition arranged below a first partition, within the elevator carriage, the first partition being the partition; and
a second elevator rail that includes a movable rail and is different from a first elevator rail, the first elevator rail being the elevator rail, wherein
the space within the elevator carriage is divided by the first partition and the second partition into the first space, the second space, and a third space for the unmanned transport vehicle to board,
the second elevator rail is arranged in the third space,
the movable rail of the second elevator rail is switched between a third rail state and a fourth rail state by actuation of an actuator,
in the third rail state, a third end of the movable rail of the second elevator rail is connected to a fourth end of a story rail provided on a story one below the predetermined story of the building, and
in the fourth rail state, the third end is not connected to the fourth end.

8. The elevator according to claim 1, further comprising:
a rail lifting device that raises and lowers the elevator rail.

9. The elevator according to claim 8, wherein
the rail lifting device is configured to change a distance between the elevator rail and a ceiling of the second space according to a story height of each of stories of the building.

10. The elevator according to claim 9, wherein
a first story height of a first predetermined story of the building is different from a second story height of a second predetermined story of the building,
the elevator rail is in a first first rail state in the first predetermined story of the building, and in a second first rail state in the second predetermined story of the building, and
a first distance between the elevator rail and the ceiling of the second space in the first first rail state is different from a second distance between the elevator rail and the ceiling of the second space in the second first rail state.

11. The elevator according to claim 10, wherein
an absolute value of a difference between the first story height and the second story height is equal to an absolute value of a difference between the first distance and the second distance.

12. An elevator provided in a building, the elevator comprising:
an elevator carriage that moves up and down;
a partition that divides a space within the elevator carriage into a first space for a person to board and a second space for an unmanned transport vehicle to board;
an elevator rail arranged in the second space; and
a rail lifting device that raises and lowers the elevator rail, wherein
the unmanned transport vehicle travels along the elevator rail, and
the rail lifting device is configured to change a distance between the elevator rail and a ceiling of the second space according to a story height of each of stories of the building.

13. An elevator provided in a building, the elevator comprising:
an elevator carriage that moves up and down;
a first partition and a second partition that divide a space within the elevator carriage, the space within the elevator carriage including, sequentially from top to bottom vertically, a first second space for an unmanned transport vehicle to board, the first partition, a first space for a person to board, the second partition, and a second second space for the unmanned transport vehicle to board;
a first elevator rail arranged in the first second space for the unmanned transport vehicle to travel; and
a second elevator rail arranged in the second second space for the unmanned transport vehicle to travel.

14. The elevator according to claim 13, wherein
the first elevator rail includes a first movable rail,
the second elevator rail includes a second movable rail,
the elevator further comprises:
a first actuator that moves the first movable rail; and
a second actuator that moves the second movable rail,
the first movable rail is switched between a first first rail state and a first second rail state by actuation of the first actuator,
in the first first rail state, a first first end of the first movable rail is connected to a first second end of a story rail provided on a predetermined story of the building,
in the first second rail state, the first first end is not connected to the first second end,
the second movable rail is switched between a second first rail state and a second second rail state by actuation of the second actuator,
in the second first rail state, a second first end of the second movable rail is connected to a second second end of a story rail provided on a predetermined story of the building, and
in the second second rail state, the second first end is not connected to the second second end.

15. The elevator according to claim 13, further comprising:
a first rail lifting device that raises and lowers the first elevator rail; and
a second rail lifting device that raises and lowers the second elevator rail.

16. A delivery system comprising:
an elevator provided in a building;
a story rail that includes a movable rail and is provided on a predetermined story of the building; and
an actuator that moves the movable rail, wherein
the elevator includes:
an elevator carriage that moves up and down;
a partition that divides a space within the elevator carriage into a first space for a person to board and a second space for an unmanned transport vehicle to board; and
an elevator rail arranged in the second space,
the unmanned transport vehicle travels along the elevator rail,
the movable rail is switched between a first rail state and a second rail state by actuation of the actuator,
in the first rail state, a first end of the movable rail is connected to a second end of the elevator rail, and
in the second rail state, the first end is not connected to the second end.
